(19) United States
(12) Patent Application Publication
(10) Pub. No.: US 2008/0162220 A1
(43) Pub. Date: Jul. 3, 2008

(54) DECISION OBJECT FOR ASSOCIATING A PLURALITY OF BUSINESS PLANS

(75) Inventors: JAMES D. CLAYTON, REDWOOD, CA (US); MARK H. PAYNE, SPRING, TX (US); ROMESH T. WADHWANI, LOS ALTOS, CA (US); JOHN WEST, SUNNYVALE, CA (US); CHARLES R. GOODMAN, BERKELEY, CA (US); JOHN I. FORS, MELNO PARK, CA (US)

Correspondence Address: STRATEGIC PATENTS P.C.., C/O PORTFOLIOIP, P.O. BOX 52050, MINNEAPOLIS, MN, 55402, US

(73) Assignee: SYMPHONYRPM,INC.

(21) Appl. No.: 11/925,388

(22) Filed: Oct. 26, 2007

Related U.S. Application Data
(63) Continuation of application No. 11/151,746, filed on Jun. 13, 2005.
(60) Provisional application No. 60/580,003, filed on Jun. 14, 2004.
(60) Provisional application No. 60/589,458, filed on Jul. 19, 2004.
(60) Provisional application No. 60/589,549, filed on Jul. 19, 2004.
(60) Provisional application No. 60/589,491, filed on Jul. 19, 2004.
(60) Provisional application No. 60/589,550, filed on Jul. 19, 2004.

(51) Int. Cl. G06Q 10/00

(52) U.S. Cl. 705/7

(57) ABSTRACT

Enterprise methods and systems are provided in which decision types are defined with attributes that can be stored as decision objects that assist in storing and executing decisions. The methods and systems include methods for logically linking decision processes based on commonality of decision variables across different aspects of an enterprise.

### CROSS-REFERENCE TO RELATED APPLICATIONS

This application claims the benefit of the following commonly owned U.S. provisional patent applications, each of which is incorporated herein by reference in its entirety:

U.S. Provisional Application No. 60/589,550 filed Jul. 19, 2004; U.S. Provisional Application No. 60/580,003 filed Jun. 14, 2004; U.S. Provisional Application No. 60/589,491 filed Jul. 19, 2004; U.S. Provisional Application No. 60/589,458 filed Jul. 19, 2004; U.S. Provisional Application No. 60/589,549 filed Jul. 19, 2004;

This application is also related to commonly owned U.S. Pat. No. 5,918,232, incorporated herein by reference in its entirety.

This application is also related to the following commonly owned patent applications, filed on even date herewith, each incorporated herein by reference in its entirety:

An application entitled “METHODS AND SYSTEMS FOR ASSOCIATING BUSINESS PLANS,” Attorney Docket No. SRPM-0002-P01; an application entitled “DECISION OBJECT-BASED METHODS AND SYSTEMS FOR ASSOCIATING BUSINESS PLANS,” Attorney Docket No. SRPM-0003-P01; an application entitled “METHODS AND SYSTEMS FOR ASSOCIATING BUSINESS PLANS FOR DISCRETE MANUFACTURING,” Attorney Docket No. SRPM-0004-P01; an application entitled “METHODS AND SYSTEMS FOR ASSOCIATING BUSINESS PLANS FOR PROCESS MANUFACTURING,” Attorney Docket No. SRPM-0005-P01; an application entitled “METHODS AND SYSTEMS FOR ASSOCIATING A PLURALITY OF TELECOMMUNICATIONS BUSINESS PLANS,” Attorney Docket No. SRPM-0006-P01; an application entitled “METHODS AND SYSTEMS FOR ASSOCIATING A PLURALITY OF FINANCIAL SERVICES BUSINESS PLANS,” Attorney Docket No. SRPM-0007-P01; an application entitled “METHODS AND SYSTEMS FOR ASSOCIATING A PLURALITY OF BUSINESS PLANS OF A RETAILING ENTITY,” Attorney Docket No. SRPM-0008-P01; an application entitled “METHODS AND SYSTEMS FOR ASSOCIATING A PLURALITY OF PHARMACEUTICAL BUSINESS PLANS,” Attorney Docket No. SRPM-0009-P01; and an application entitled “TECHNIQUES FOR PERFORMING SCENARIOS ANALYSIS USING A MULTIDIMENSIONAL MODEL,” Attorney Docket No. 022304-000410US.

### BACKGROUND

1. Field of Invention

This invention relates to the field of enterprise planning and more particularly to methods and systems for storing decisions as objects and for linking, synchronizing, integrating, aggregating and/or aligning units, plans, functions, processes and/or other subsets of an enterprise.

2. Description of the Related Art

An enterprise may have a plurality of goals, missions and objectives. A typical enterprise is composed of many units, which are staffed with and served by many people, and which execute many plans, perform many functions and execute many processes. A typical enterprise also usually collects, maintains and stores data that characterizes aspects of the enterprise itself and relevant aspects of the world in which the enterprise operates.

In order to achieve its goals, missions and objectives, the enterprise must constantly make decisions, and take actions based on those decisions. In a typical enterprise a host of decisions take place at all levels of the enterprise on a daily, or even moment-to-moment basis. Despite efforts to integrate various data sources of business enterprises, decision makers may not have access to rapid, consistent information about other decisions that have taken place, or that are proposed to take place, within the enterprise. Also, even if decision makers operate based on good data and make good decisions, the objectives of decision makers in different parts of the enterprise may produce decisions that are inconsistent with achieving the strategic objectives of the enterprise as a whole. In theory, enterprises make decisions consistent with their goals and based on all available data. However, in practice enterprises typically lack a systematic method, process or system for making high-quality, informed decisions based on all relevant internal and external information and for coordinating, linking, synchronizing, integrating, aggregating and/or aligning, in real-time, the many decisions constantly being made by the many different decision makers operating in the units, and executing or performing the plans, functions and processes of the enterprise. For example, it is often the case that lower-level operational and tactical decisions are only loosely linked to the higher-level goals and strategies of the enterprise. As the effects of many operational and tactical decisions that diverge from the goals and strategies of an enterprise accumulate, an enterprise falls short of its goals. It is for these reasons that a need exists for methods, systems and processes that improve the decision-making processes of enterprises and that help support and synchronize all elements of an enterprise, allowing for high-quality, informed decisions at all levels of the enterprise that are consistent with the overall goals and strategies of the enterprise. In particular, a need exists for classifying decision types and the attributes of those types to better enable decisions to be stored and used across the various plans and functions of an enterprise.

### SUMMARY

In one aspect of the present invention, the methods and systems disclosed herein contemplate establishing a decision object that characterizes the relevant attributes of a type of decision and permits an enterprise to store values corresponding to the attributes of a specific decision of the decision type. The attributes of a decision type may include a name or identifier for the decision type, an identifier for a particular decision of that type, the identity of the decision maker, the inputs that affect the decision (such as data used to guide the decision, analytical methods used to guide the decision-maker and approvals required to make the decision), a time stamp, any metrics associated with the decision, and many other attributes. Once a decision type is defined and classified, decisions of that type can be stored, such as for future analysis. Also, proposed decisions can be propagated through an enterprise, such as to determine the effects of a decision on various aspects of the enterprise, including other decisions. By storing and manipulating decisions as decision objects, an enterprise can improve the quality of decision-making by ensuring that decisions are made in a systematic way, considering appropriate data, and taking into account appropriate inputs (including the effects of the decision on other aspects of the enterprise). By analyzing past decisions, an enterprise can also improve decision-making through quality control, testing and review.

In another aspect of the present invention, the various aspects of an enterprise can be catalogued into hierarchies or levels, which may be characterized by levels of abstraction or aggregation. Thus, the units, departments, groups, teams, people, plans, products, services, functions, processes and other aspects of an enterprise can each be categorized in hierarchies. For example, an organizational chart places the personnel of the enterprise in a hierarchy, grouped by department, title and the like. A functional chart may organize the functions of an enterprise into a functional flow diagram. An approval chain may place a decision-making process into a hierarchy, indicating what decision-makers are required to make what decisions. A product hierarchy may show what sub-components, assemblies or raw materials are required to make the product, and may show larger systems or bundles of which the product is a member. A process for completing a service may show steps required for accomplishing the service and the contributions of particular functions or personnel to achieving the service. In this aspect of the present invention, the variables that are considered by the various hierarchies and decision processes of an enterprise are catalogued, including the variables that are considered by decision-makers in making decisions, setting goals and objectives, making and executing plans, processes and actions, and performing functions in the enterprise. For example, a division of an enterprise may conduct weekly planning of its product purchases, so that its decision makers must consider weeks, product units, construction times, transport times, inventory levels, and costs of products. Another decision-maker in the enterprise may need to ensure that the raw material is available for any product the enterprise wishes to make, in which case the decision-maker may need to consider weeks, the cost of raw material, the amounts of raw material required to make products, the time required to convert raw material into products, the cost of raw material, and the like.

Once the variables relevant to two or more hierarchies or decision processes of an enterprise are catalogued, the different hierarchies or decision processes of the enterprise can be logically linked to each other, such as according to an intersection of the data and decisions that they share in common. For example, the product purchaser and the raw-material purchaser are both concerned with lead times, units of products, and costs. Thus, two or more hierarchies of an enterprise can be related according to a common set of variables, intersection, or least common level of abstraction, that each of the hierarchies or decision processes uses in making decisions. Once the least common level of abstraction has been identified, data that relates to the two or more hierarchies can be linked and shared to the extent of the commonality. The linking of the two hierarchies and decision processes allows the enterprise to improve decision-making, such as by ensuring that the impact of a decision made by a decision-maker in one part of an enterprise is reflected immediately in other parts of the enterprise, by ensuring that decisions are made using consistent data, by allowing decision-makers in one part of an enterprise to see the decisions made by decision-makers from another part of the enterprise in real-time, and by allowing decision-makers to see proposed decisions from another part of the enterprise before the decisions are made, so that effects of a decision on other parts of an enterprise can be considered before a decision is made.

An enterprise planning system and/or method enables improved planning and decision making within an enterprise, particularly an enterprise where numerous decision makers participate in a decision-making process. The system and/or method may enable continuous planning, and may link, synchronize, integrate, aggregate and/or align planning for a number of enterprise units, plans, functions, processes and/or other subsets of an enterprise. Within the system and/or method, each unit, plan, function, process and/or other subset of an enterprise may be planned independently, with the impact of any change or decision being reflected throughout the system and/or method. Planning may be synchronized using an allocation engine so that decisions are propagated through all levels above, and possibly below, the lowest common level of abstraction for a decision. A planning system and/or method constructed in this manner may provide more accurate information for decision making and permit greater participation in, and visibility into, a decision process, so that better decisions can be made more quickly within an enterprise.

In one aspect, an integrated planning system and/or method as described herein includes finding an intersection at the lowest common level of abstraction across the units, plans, functions, processes and/or other subsets of an enterprise to be linked, synchronized, integrated, aggregated and/or aligned. A decision making process may be synchronized at this level, while permitting a user, system and/or decision maker to go up levels through aggregation and achieve fully synchronized aggregate plans. At the same time, top-down planning may be achieved by permitting a user, system and/or decision maker to go down through layers of abstraction for any unit, plan, function, process and/or other subset of an enterprise. This top-down planning may be performed explicitly, or through allocation methods provided by the system. In this manner, once one or more units, plans, functions, processes and/or other subsets of an enterprise are linked, synchronized, integrated, aggregated and/or aligned at one level they are linked, synchronized, integrated, aggregated and/or aligned at all levels.

In one aspect, the methods and systems disclosed herein contemplate establishing a decision object that characterizes the relevant attributes of a type of decision and permits an enterprise to store values corresponding to the attributes of a specific decision of the decision type. The attributes of a decision type may include a name or identifier for the decision type, an identifier for a particular decision of that type, the identity of the decision maker, the inputs that affect the decision (such as data used to guide the decision, analytical methods used to guide the decision maker and approvals required to make the decision), a time stamp, any metrics associated with the decision and many other attributes. Once a decision type is defined and classified, decisions of that type can be stored, such as for future analysis. Also, proposed decisions can be propagated through an enterprise, such as to determine the effects of a decision on various aspects of the enterprise, including other decisions. By storing decisions as decision objects, an enterprise can improve the quality of decision-making by ensuring that decisions are made in a systematic way, considering appropriate data and taking into account appropriate inputs (including the effects of the decision on other aspects of the enterprise). By analyzing past decisions, an enterprise can also improve decision-making through quality control, testing and review.

In another aspect, the various aspects of an enterprise can be catalogued into hierarchies or levels, which may be characterized by levels of abstraction or aggregation. Thus, the units, departments, groups, teams, people, plans, products, services, functions, processes and other aspects of an enterprise can each be categorized in hierarchies. For example, an organizational chart places the personnel of the enterprise in a hierarchy, grouped by department, title and the like. A functional chart may organize the functions of an enterprise into a functional flow diagram. An approval chain may place a decision-making process into a hierarchy, indicating what decision makers are required to make what decisions. A product hierarchy may show what sub-components, assemblies or raw materials are required to make the product, and may show larger systems or bundles of which the product is a member. A process for completing a service may show steps required for accomplishing the service and the contributions of particular functions or personnel to achieving the service. In this aspect of the present invention, the variables that are considered by the various hierarchies of an enterprise are catalogued, including the variables that are considered by decision makers in making decisions, setting goals and objectives, making and executing plans, processes and actions and performing functions in an enterprise. For example, a division of an enterprise may conduct weekly planning of its product purchases, so that its decision makers must consider weeks, product units, construction times, transport times, inventory levels, and costs of products. Another decision maker in the enterprise may need to ensure that the raw material is available for any product the enterprise wishes to make, in which case the decision maker may need to consider weeks, the cost of raw material, the amounts of raw material required to make products, the time required to convert raw material into products, the cost of raw material and the like.

Once the variables relevant to two or more hierarchies of an enterprise are catalogued, the different hierarchies of the enterprise can be related to each other according to an intersection of the variables that they share in common. For example, the product purchaser and the raw material purchaser are both concerned with lead times, units of products and costs. Thus, two or more hierarchies of an enterprise can be related according to a common set of variables, intersections or least common level of abstraction, that each of the hierarchies uses in making decisions. Once the least common level of abstraction has been identified, data that relates to the two or more hierarchies can be linked and shared to the extent of the commonality. The linking of the two hierarchies allows the enterprise to improve decision-making, such as by ensuring that the impact of a decision made by a decision maker in one part of an enterprise is reflected immediately in other parts of the enterprise, by ensuring that decisions are made using consistent data, by allowing decision makers in one part of an enterprise to see the decisions made by decision makers from another part of the enterprise in real-time and by allowing decision makers to see proposed decisions from other parts of the enterprise before the decisions are made, so that effects of a decision on other parts of an enterprise can be considered before a decision is made.

In one aspect, a method and/or system disclosed herein for characterizing a decision type in a decision process as an object includes: classifying one or more attributes of a decision type, each of the attributes having a range of possible values; determining the values of the attributes for a decision in the decision process; and storing the decision and at least one of its attributes as a decision object.

The attributes may be selected from the group consisting of: production attributes, manufacturing attributes, supply attributes, supply-chain attributes, human resources attributes, recruiting attributes, procurement attributes, buying attributes, purchasing attributes, operations attributes, logistics attributes, product management attributes, research attributes, development attributes, engineering attributes, quality control attributes, program management attributes, inventory attributes, demand attributes, sales attributes, sales and order processing attributes, marketing attributes, channel attributes, distribution attributes, promotion attributes, executive attributes, management attributes, finance attributes, controlling attributes, compliance attributes, accounting attributes, audit attributes, attributes relating to any measurement of any aspect of a decision, measures of a decision along several dimensions, measurements, context of a decision, hierarchies or structures related to a decision, a decision's place in hierarchies or structures relating to a decision, parameters related to a decision, variable values related to a decision, weightings related to a decision, revenue, cost, margin, profit, volume, share, each change that was made, when each change was made, the user, system and/or decision maker which made a given change, any noted reasons for a given change, any noted assumptions for a given change, any noted conditions for a given change, each change or proposed change that was not made, when a change was proposed, when it was decided that a change should not be made, the user, system and/or decision maker which decided not to make a given change, any noted reasons for not accepting a given change, any noted assumptions for not accepting a given change, any noted conditions for not accepting a given change, a scenario version and/or any other attribute of a decision or a decision type.

A decision object and/or attribute(s) may be stored as, converted to and/or maintained as data. A decision may be located in a hierarchy of decisions in a decision process. A decision may be located in a decision process. A decision process may be represented by a flow diagram. A decision may be related to another decision. A decision may be associated with one or more hierarchies of data relevant to a decision. A decision may have one or more steps. A decision may include or consist of a plurality of decisions. A decision may involve one or more levels of abstraction within a hierarchy of levels of abstraction.

The method or system may allow for viewing of all past and current decisions, decision objects, prospective decision, prospective decision objects, proposed decisions, proposed decision objects, executed decisions, executed decision objects, implemented decisions and/or implemented decision objects.

In a decision process, a decision object may be associated with a plurality of parts of an enterprise hierarchy, such as from one or more enterprise units, plans, functions, processes and/or other subsets of an enterprise. The parts may be levels of an enterprise. A decision object(s) may be associated with various users of an enterprise hierarchy, such as decision makers, systems, enterprise units, plans, functions, processes and/or other subsets of an enterprise. The users may add data to a decision object, modify a decision object, implement a decision object, trigger implementation of a decision object and/or command or order implementation of a decision object. Users may be within the same level of an enterprise hierarchy or within the same part of an enterprise hierarchy. A user may be selected from the group consisting of: an enterprise, a division, a subsidiary, an affiliate, a business unit, an office, branch, a department, a group, a sub-group, a project team, a team, a geographically-defined unit, an employee, a contractor, an agent, an analyst, a consultant, a system, a decision maker, any human or machine user of the system in any capacity, any combination of any of the foregoing and the like.

A system may be selected from the group consisting of: production system, manufacturing system, supply system, supply-chain system, human resources system, recruiting system, procurement system, buying system, purchasing system, operations system, logistics system, product management system, research system, development system, engineering system, quality control system, program management system, inventory system, demand system, sales system, sales and order processing system, marketing system, channel system, distribution system, promotion system, executive system, management system, finance system, controlling system, compliance system, accounting system, audit system, user, decision maker, any combination of any of the foregoing and the like.

A decision maker may be selected from the group consisting of: an enterprise, a division, a subsidiary, an affiliate, a business unit, an office, a branch, a department, a group, a sub-group, a project team, a team, a geographically-defined unit, an employee, a contractor, an agent, an analyst, a consultant, a production system, a manufacturing system, a supply system, a supply-chain system, a human resources system, a recruiting system, a procurement system, a buying system, a purchasing system, an operations system, a logistics system, a product management system, a research system, a development system, an engineering system, a quality control system, a program management system, an inventory system, a demand system, a sales system, a sales and order processing system, a marketing system, a channel system, a distribution system, a promotion system, an executive system, a management system, a finance system, a controlling system, a compliance system, an accounting system, an audit system, a user, a system, any other decision maker, any combination of any of the foregoing and the like. A user may be at a higher level of abstraction than the aspects of an enterprise directly affected by a decision, at a lower level of abstraction than the aspects of an enterprise directly affected by a decision and/or at an equal level of abstraction with the aspects of an enterprise directly affected by a decision.

The association process may be driven by a method, system, user, plurality of users, some combination of foregoing or the like.

In the method or system, a decision may be made. The decision may be to modify a decision object, to present a decision object to or associate a decision object with one or more levels of an enterprise, to present a decision object to or associate a decision object with one or more parts of an enterprise hierarchy, to present a decision object to or associate a decision object with one or more users, systems and/or decision makers, to present a modified decision object to or associate a modified decision object with one or more levels an enterprise, to present a modified decision object to or associate a modified decision object with one or more parts of an enterprise hierarchy and/or to present a modified decision object to or associate a modified decision object with one or more users, systems and/or decision makers. A decision may be made to implement a decision in one or more of an enterprise unit, plan, process, function, subset of an enterprise or any other entity, organizational structure or other abstract or concrete medium in which a decision may be implemented.

The system or method may include an intelligent decision engine. An intelligent decision engine may analyze one or more decision objects. An intelligent decision engine may be applied to one or more decision objects, and may provide assistance with one or more decisions. An intelligent decision engine may break, decompose, disaggregate and/or divide a decision or decision object into more than one decision and/or decision object. An intelligent decision engine may link, join, aggregate and/or associate a decision or decision object with one or more other decisions and/or decision objects. An intelligent decision engine may suggest or emphasize relatedness between a decision or a decision object and one or more other decisions or decision objects. An intelligent decision engine may identify additional information to be requested in connection with a decision or a decision object. An intelligent decision engine may identify missing information. An intelligent decision engine may pose at least one question in connection with a decision or a decision object.

An intelligent decision engine may aggregate a decision or decision object with at least one other decision or decision object. An intelligent decision engine may aggregate a decision or decision object with at least one other decision or decision object to be decided. An intelligent decision engine may aggregate a decision or decision object with at least one other decision or decision object to be decided creating another decision or decision object. An intelligent decision engine may suggest actions to be taken in connection with a decision or decision object. An intelligent decision engine may recommend one or more courses of action in connection with a decision or decision object. An intelligent decision engine may provide advice in connection with a decision or a decision object.

Decisions may be prospective decisions, proposed decisions, executed decisions and/or implemented decisions. Decision objects may be prospective decision objects, proposed decision objects, executed decision objects or implemented decision objects.

An intelligent decision engine may utilize historical data, forecasts, plans, mathematics, statistics, calculus, algorithms, simulations, boot strapping, Monte Carlo methods, optimization methods, stochastic methods, Fourier methods, discrete or continuous linear models, regression models or any other tools or models useful in analyzing decisions. An intelligent decision engine may work with the comparison engine or any other useful engine, tool or software tool or system.

An intelligent decision engine may break, decompose, disaggregate and/or divide a decision or decision object into more than one sub-decision or sub-decision object. An intelligent decision engine may present the sub-decisions or sub-decision objects to a user, system and/or decision maker in a particular order, such as a logical order or other order such as a useful order for evaluation and/or resolution. An intelligent decision engine may guide the user, decision maker, and/or system through the sub-decisions or sub-decision objects. An intelligent decision engine may present each sub-decision in context. The context may include relevant data and analytics. An intelligent decision engine may present suggested courses of action in connection with a sub-decision or sub-decision object. A user, system and/or decision maker may accept or override the suggestions. A user, system and/or decision maker may modify the suggestions. The intelligent decision engine may update the sub-decisions or sub-decision objects left to be decided and/or related contextual information or other data after a sub-decision or sub-decision object is decided. An order, such as the logical order, of the remaining sub-decisions or sub-decision objects may be changed. Certain of the remaining sub-decisions or sub-decision objects may no longer be relevant. Certain other decisions or decision objects may become relevant. The remaining and/or other decisions, decision objects, sub-decisions and/or sub-decision objects may be returned or channeled back to an intelligent decision engine. Each sub-decision or sub-decision object may be a decision or decision object.

The system or method may include a decision collaboration engine. A decision collaboration engine may present a decision to or associate a decision with two or more levels of an enterprise hierarchy, parts of an enterprise hierarchy, users, systems and/or decision makers. A decision collaboration engine may present a decision object to or associate a decision with two or more levels of an enterprise hierarchy, parts of an enterprise hierarchy, users, systems and/or decision makers. A decision collaboration engine may aggregate input, feedback, decisions, results and/or other data from the various levels of an enterprise hierarchy, parts of an enterprise hierarchy, users, systems and/or decision makers. A decision collaboration engine may present the aggregated input and/or feedback to the levels of an enterprise hierarchy, parts of an enterprise hierarchy, users, systems and/or decision makers. An intelligent decision engine may cooperate with this process. A decision collaboration engine may associate the aggregated input and/or feedback with the levels of an enterprise hierarchy, parts of a enterprise hierarchy, users, systems and/or decision makers. An intelligent decision engine may cooperate with this process. A decision collaboration engine may create a new decision or decision object accounting for the input and/or feedback. The decisions or decision objects may be prospective decisions or decision objects, proposed decisions or decision objects, executed decisions or decision objects and/or implemented decisions or decision objects. A decision collaboration engine may present a subset of decisions for observation. A decision collaboration engine may present a subset of decisions to a user for observation. The subset may include all of the decisions or decision objects. The presentation may be for training, evaluation or performance review purposes.

The method or system may include a decision implementation engine. The system or method may classify decisions in a classification selected from the group consisting of: prospective decisions, proposed decisions, executed decisions and implemented decisions. A prospective decision may be a decision that has not been proposed. A proposed decision may be a decision that has not been executed or implemented. An executed decision may be a decision that has not been implemented. The method or system may classify decision objects in a classification selected from the group consisting of: prospective decision objects, proposed decision objects, executed decision objects and implemented decision objects. A prospective decision object may be a decision object that has not been proposed. A proposed decision object may be a decision object that has not been executed or implemented. An executed decision object may be a decision object that has not been implemented.

The method or system may store and/or maintain the attributes or data relating to one or more attributes of a decision, prospective decision, proposed decision, executed decision and/or implemented decision. The method or system may store and/or maintain data relating to a decision, prospective decision, proposed decision, executed decision, and/or implemented decision. The method or system may store and/or maintain the position of a decision, prospective decision, proposed decision, executed decision and/or implemented decision in the hierarchy of decisions in a decision process, or in one or more hierarchies of data relevant to the decision, prospective decision, proposed decision, executed decision and/or implemented decision. The method or system may store and/or maintain the attributes of or data relating to one or more attributes of a decision object, prospective decision object, proposed decision object, executed decision object and/or implemented decision object. The method or system may store and/or maintain the position of a decision object, prospective decision object, proposed decision object, executed decision object and/or implemented decision object in the hierarchy of decisions in a decision process or in one or more hierarchies of data relevant to the decision object, prospective decision object, proposed decision object, executed decision object and/or implemented decision object. The attributes, data and position in the hierarchies may be stored as data and made available to the other engines, functions and/or processes of the method or system. One of the proposed decisions or decision objects may be modified, and the modified proposed decision or decision object may be sent to an intelligent decision engine, a comparative engine or any other engine or other tool or aspect of the method or system. The attributes, data and/or position in the hierarchies of the modified proposed decision or decision object may be stored as data and made available to the other engines, functions, analytic tools and/or processes of the model or system.

A decision implementation engine may implement a proposed decision or decision object once executed. A decision implementation engine may effect or propagate the decision or decision object throughout an enterprise or a subset of an enterprise. The subset may be defined by a user, system and/or decision maker. A decision implementation engine may write an array of values to various systems, such as systems or data facilities of an enterprise. A decision implementation engine may communicate with and/or notify various units, plans, functions, processes and/or other subsets of an enterprise. A decision implementation engine may communicate and/or notify using a protocol, a database protocol, an Internet protocol, a computer language, code, email, voicemail, telephone, text message, SMS, a symbol, an icon, a window, an alert, an alarm, vibrations, audio, smell, taste, a graphical user interface and/or any other means of communication.

The method or system for manipulation, presentation and/or association of decisions or decision objects may be updated periodically. The period of updates may be annually, quarterly, monthly, weekly, daily, hourly, minutely, continuously, in real-time and/or at defined intervals, such as user-defined intervals. The processes and/or data feeding the intelligent decision engine may be updated periodically. The period of updates may be annually, quarterly, monthly, weekly, daily, hourly, minutely, continuously and/or in real-time and/or at defined intervals, such as user-defined intervals.

Forecast and/or plan data may be converted into historical and/or actual data with the passage of time. Forecast and/or plan data may be naturally converted into historical and/or actual data with the passage of time. Decision points and/or nodes may be redefined, modified and/or updated with the passage of time. The periods and/or time series may be mapped onto a calendar, clock, business timeline and/or any other timeline.

The method or system may include a decision tracking facility that tracks decisions or decision objects over time, throughout an enterprise and/or within, across or between levels of abstraction, parts of an enterprise, levels of an enterprise and hierarchies. A decision tracking facility may be associated with an enterprise planning method or system, a method or system of integration, a method or system for placing an element, object, item and/or idea into a hierarchy or structure, an analytic engine, a comparison engine, a feedback engine, any analytic tool and/or any other engines or tools. A decision tracking facility may maintain attributes, data and/or hierarchical position in connection with each decision. A decision tracking facility may allow for revisiting a decision or revisiting a decision in context. A decision or decision object can move up, down and/or laterally in an approval chain. A decision tracking facility may provide simulations, modeling and/or analysis of a decision or a decision object. The simulation, modeling and/or analysis may be conducted under actual or historical conditions and/or may be conducted under hypothetical, forecast and/or plan conditions. A decision or decision object may be modified and sent back to a decision tracking facility. The decisions may be prospective decisions, proposed decisions, executed decisions and/or implemented decisions. The decision objects may be prospective decision objects, proposed decision objects, executed decision objects and/or implemented decision objects.

In certain aspects, the method or system may be used in a continuous planning environment. For example, an analyst may need to make a supply decision. The method or system may decompose the supply decision into several steps: determining which parts to order, such as which parts are needed for a product, determining quantities, determining from whom and when to place the order and when to ask for delivery. The method or system may have various commands available to the analyst. The analyst may order, cancel an order, request updated pricing information, hold, rush, increase quantity, decrease quantity, search performance reviews of a particular part and/or search the department's comments on a particular supplier. A supplier may be selected based upon reviews of the supplier and its parts, the lead-time of the supplier and/or the supplier's likelihood of fulfilling its obligations. The decision may be updated or revised based upon new information. The supply decision may be created as several proposed decision objects that are fed them into the system. The method or system may analyze the decision objects and provide feedback. The analyst may adjust the decision objects until the results are satisfactory. The analyst may review the demand signals being fed to the decision or decision object from other units, plans, functions, processes, parts and/or other subsets of an enterprise.

Decision objects may be circulated, such as where an analyst determines that more information is needed about which parts are interchangeable and sends the decision object to manufacturing so that manufacturing can complete the missing information. Several simulations may be run on a proposed decision object and/or the proposed decision object may be finalized. The finalized decision object may be made available to a supervisor for review. Another user, such as a senior operations manager overseeing demand and supply, may review the decision object using a collaboration engine. A note may be added by the manager that the supply of a certain part will likely become scarce. The supervisor may approve the plan and execute it. The implementation engine may communicate the execution to the organization.

Continuing with this example, a user may notice that a supplier did not fulfill the entire order. The user may access an alternative proposed decision object using a different supplier and a different part, and simulate, using historical data, the result if the alternative proposed decision object had been chosen. If the method or system simulating the alternative proposed decision object predicts that the order would have been fulfilled on time, the user may notify a supervisor who may review the alternative proposed decision object and/or simulation results. The supervisor may also review the decision object that was implemented, and review any notes associated with the decision object, such as the note added by the manager that the part may become scarce. The supervisor may perform statistical analysis and suggest requesting more information about the demand signal. A further review of the initial demand signal may indicate that the demand signal was incorrect, and that there is now no demand for the product that used the part. A new analyst may review the decision object and the alternative proposed decision object and/or run simulations or statistical analysis to further investigate the history of this decision process, such as investigating how small changes in demand affect purchasing decisions within the entity.

In another example a decision maker may need to implement a promotion plan, choosing one from many pre-existing options. The promotion plans may have different lead-times to implementation. For example, one plan with a lead-time of six weeks may require the printing of a coupon on the product packaging, while another plan with a lead time of two days may be an automatic discount applied at check-out. Based on the requirements and goals for the promotions plan, the method or system may be able to suggest the optimal plan or guide the user through the decision process.

In a continuous environment, the method or system may track a number of types of products and assist in determining what products to make. The types of products may be types of toothpaste and the environment may assist in determining what types of toothpaste should be offered. The method or system may also assist in the determination of the number of products to be offered. For example, the method or system may suggest that an enterprise keep six of their ten current varieties of toothpaste and then add two new toothpaste products of a particular type, such as a pump as opposed to a tube. If there is a supply shortage, the environment may be used to determine which customers should receive current inventory of the enterprise. The environment may be used to assist in other planning, such as hiring employees, firing employees, performance review, evaluation, education, training, termination, retirement, and any other human resources functions. The continuous environment may be applied more generally to improve results and management in any enterprise function, including accounting, management, corporate governance, public company reporting, investments, marketing, advertising, strategic planning, information technology, compliance, auditing and so on. The continuous environment may be applied in any industry or organization including professional services, retail, electronic commerce, banking, financial services, manufacturing, international trade, technology, software, telecommunications, governmental, academic and so on. Any of the functionality or features of the method or system can exist outside of a continuous environment.

In another aspect, an enterprise planning method or system may include the steps of characterizing a plurality of data items that are relevant to a plurality of data schema of units, plans, functions, processes and/or other subsets of an enterprise; determining a class of data item that is common to the data schema of all or a subset of the units, plans, functions, processes and/or other subsets of an enterprise at a level of abstraction within the data schema; linking, synchronizing, integrating, aggregating and/or aligning the class of data items across the data schema of the plurality of units, plans, functions, processes and/or other subsets of an enterprise; and aggregating data within the plurality of units, plans, functions, processes and/or other subsets of an enterprise so that the data can be used or viewed at any of a plurality of levels of aggregation within the enterprise.

A subset may consist of less than all or all of the enterprise units, plans, functions, processes and/or other subsets of an enterprise. The enterprise units, plans, functions, processes and/or other subsets may be any or all of production, manufacturing, supply, supply-chain, human resources, recruiting, procurement, buy, purchasing, operations, logistics, product management, research, development, engineering, quality control, program management, inventory, demand, sales, sales and order processing, marketing, channel, distribution, promotion, executives, management, finance, controlling, compliance, accounting, audit, units, plans, functions and/or processes. The method or system may account for enterprise units, plans, functions, processes and/or other subsets at all levels of abstraction or at different levels of abstraction. The method or system may simultaneously account for enterprise units, plans, functions, processes and/or other subsets of an enterprise at all levels of abstraction or at different levels of abstraction. The enterprise units, plans, functions, processes, other subsets of an enterprise and/or levels of abstraction may be any one or more of: enterprise, division, subsidiary, affiliate, business unit, office, branch, department, group, sub-group, project team, team, geographically-defined unit, employee, contractor, agent, analyst, consultant and the like.

The method or system may be associated with, inform and/or be informed by a decision process. The method or system may create new data and/or attributes or modify existing data and/or attributes. The method or system may supply, feed and/or channel data, attributes and/or information into a decision process. The method or system may be linked to or associated with a decision tracking facility, association process, intelligent decision engine, comparison engine, collaboration engine, implementation process, implementation engine, analytical tool or any other engine, tool or other processes or functions of the method or system. The method or system may relate to a unified plan for the enterprise or may provide a unified strategic plan for the enterprise. The method or system may periodically refresh, re-compute, seek updates and/or access data. The period may be annually, quarterly, monthly, weekly, daily, hourly, minutely, continuously, in real-time and/or at defined intervals, such as user-defined intervals.

In the method or system, the lowest common level of abstraction may be a unit of a good or below or above a unit of a good. The good, or the level of abstraction of the good, may be one or more of: integrated good, system, bundle, kit, assembly, sub-assembly, part and component or any other level of abstraction applicable to goods. The good, or type of good, may be one or more of: consumer good, wholesale good, durable good, household good, mechanical good, business good, medical good, drugs, computer good, electronics, microchips, semi-conductors, vehicles, clothing, food, prepared food, groceries, fast food, restaurant food, integrated good, system, bundle, kit, assembly, sub-assembly, part, component and any other type of good. The unit of goods may be one or more of: land vehicle-load, truck-load, car-load, railcar-load, air vehicle-load, aircraft-load, airplane-load, helicopter-load, airship-load, blimp-load, water vehicle-load, ship-load, barge-load, submarine-load, hovercraft-load, inter-modal container, lot, pallet, crate, container, carton, data packet, transfer unit, integrated good, system, bundle, kit, assembly, sub-assembly, part, component, any unit of a good and any partial amount of any of the foregoing.

The kit or bundle may include a good and one or more of: a good or product, a service, a good or product accessory, a service accessory, a complementary good or product, a complementary service, a substitute good or product, a substitute service, an unrelated good or product and an unrelated service. All of the items in a kit or bundle may be saleable. At least one item in the kit or bundle may be not saleable. The kit or bundle may consist of one or more groups selected from the group consisting of: toothbrush and toothpaste, camera and film, computer and software, remote control vehicle and radio controller, cell phone and cell service, software and support services, software and maintenance services, software and development services, fast food serving and a drink, combination of foods, combination of beverages, combination of foods and beverages, computer keyboard and computer mouse, computer mouse and mouse pad, pens and pencils, pens of different colors, needle, thread and scissors, shampoo and conditioner, travel toiletry kits, oil and gas mix, matching clothes to make an outfit, coloring book and crayons and a bottle of wine and glasses, an automobile chassis and an automobile body or any other collection of related or unrelated products and/or services.

In the method or system, the lowest common level of abstraction may be a unit of a product or below or above a unit of a product. The product, or the level of abstraction of the product, may be one or more of: integrated product, system, bundle, kit, assembly, sub-assembly, part and component or any other level of abstraction applicable to products. The product, or type of product, may be one or more of: consumer product, wholesale product, durable product, household product, mechanical product, business product, medical product, drugs, computer product, electronics, microchips, semi-conductors, vehicles, clothing, food, prepared food, groceries, fast food, restaurant food, integrated product, system, bundle, kit, assembly, sub-assembly, part, component and any other type of product. The unit of products may be one or more of: land vehicle-load, truck-load, car-load, railcar-load, air vehicle-load, aircraft-load, airplane-load, helicopter-load, airship-load, blimp-load, water vehicle-load, ship-load, barge-load, submarine-load, hovercraft-load, inter-modal container, lot, pallet, crate, container, carton, data packet, transfer unit, integrated product, system, bundle, kit, assembly, sub-assembly, part, component, unit of a product and any partial amount of any of the foregoing.

The kit or bundle may include a product and one or more of: a product or good, a service, a good or product accessory, a service accessory, a complementary good or product, a complementary service, a substitute good or product, a substitute service, an unrelated good or product and an unrelated service. All of the items in a kit or bundle may be saleable. At least one item in the kit or bundle may be not saleable. The kit or bundle may consist of one or more groups selected from the group consisting of: toothbrush and toothpaste, camera and film, computer and software, remote control vehicle and radio controller, cell phone and cell service, software and support services, software and maintenance services, software and development services, a fast food serving and a drink, combination of foods, combination of beverages, combination of foods and beverages, computer keyboard and computer mouse, computer mouse and mouse pad, pens and pencils, pens of different colors, needle, thread and scissors, shampoo and conditioner, travel toiletry kits, oil and gas mix, matching clothes to make an outfit, coloring book and crayons and a bottle of wine and glasses, an automobile chassis and an automobile body or any other collection of related or unrelated products and/or services.

The lowest common level of abstraction may be a unit of service, or a level of abstraction above or below a unit of service. The service, or level of abstraction of the service, may be one or more of: a service suite, project, service, task, preparation, one-time service, on-going service, kit and bundle. The service may include one or more of: utilities, heating, cooling, electricity, telephone, Internet, cable, satellite television, satellite Internet, gas, healthcare, physiotherapy, chiropractic, mental health, counseling, cosmetics, beauty, hair care, personal grooming, personal assistance, fitness, personal training, veterinary, household, housekeeping, cleaning, food preparation, food service, childcare, government infrastructure, government services, legal, financial, banking, accounting, business, consulting, drawing, drafting, writing, technical writing, word processing, typing, secretarial, money management, real estate, educational, tutoring, development, maintenance, support, planning, funeral planning, software development, software maintenance, software support, product support, construction, surveying, gardening, lawn care, household maintenance, sanitation, architecture, transportation, lodging, security, police, fire, emergency, ambulance, entertainment, companionship, travel and tourism.

The unit of service may include one or more of: a unit of functionality, a unit of time, a unit of service, task, a unit of difficulty, a unit of complexity, a unit of expected result, a unit of actual result, a unit of expected change, a unit of actual change and a bundle or kit relating to any of the above. The bundle or kit may include a service and at least one of: a good or product, a service, a good or product accessory, a service accessory, a complementary good or product, a complementary service, a substitute good or product, a substitute service, an unrelated good or product and an unrelated service. All items in the kit or bundle may be saleable. At least one item in the kit or bundle may be not saleable. The kit or bundle may include of one or more of: a cell phone and cell service, software and support services, software and maintenance services, software and development services, Internet service and modem, vehicle cleaning and maintenance services, food and food service, dry cleaning and tailor service, digital video recorder and subscription service, satellite entertainment equipment and subscription service, movie admission and food, gym membership and personal training services, life insurance and property insurance, wash, cut and blow dry hair care, local and long distance telephone service plans, an automobile and automotive maintenance services, garden planting or landscaping services and garden maintenance services and any other related or unrelated services and goods, products and/or services.

The lowest common level of abstraction may be the stock keeping unit level or a level of abstraction above or below the stock keeping unit level. The lowest common level of abstraction may be the bill of materials level or a level of abstraction above or below the bill of materials level. The lowest common level of abstraction may be the parts level or a level of abstraction above or below the parts level. The lowest common level of abstraction may be the components level or a level of abstraction above or below the components level. The lowest common level of abstraction may be a unit of functionality or above or below a unit of functionality. The lowest common level of abstraction may be a unit of time, such as hours, or a unit of time longer or shorter than hours. The lowest common level of abstraction may be weeks-on-hand, days-on-hand or any other unit of time-on-hand.

The lowest common level of abstraction may be a unit of a good and/or product that is held or owned in a manner selected from the group consisting of: leased, rented, time-shared, bartered and licensed. The lowest common level of abstraction may be a unit of a service that is held or used in a manner selected from the group consisting of: leased, rented, time-shared, bartered and licensed. A lowest common level of abstraction may be a level of abstraction that is higher than the actual lowest common level of abstraction. A lowest common level of abstraction may be a level of abstraction that is defined by a user, system and/or decision maker. A lowest common level of abstraction may be a level of abstraction that is defined by a user, system and/or decision maker, and higher than the actual lowest common level of abstraction.

The lowest common level of abstraction may be multidimensional, and may consist of units along one or more dimensions. The dimensions may be one or more of: stock keeping unit, bill of materials, parts, components, time, unit of time, unit of functionality, goods, products, services, geography, geographic region, geographical unit, manufacturing unit, supply unit, demand unit, quality, quantity, process, process involvement, travel-miles, market share, market penetration, any unit of good, any unit of product and any unit of service. The lowest common level of abstraction may be a unit of time combined with at least one other unit selected from the following group: good, product, service, stock keeping unit, bill of materials, parts, components and time. The lowest common level of abstraction may be a unit of a good combined with at least one other unit selected from the group consisting of: good, product, service, stock keeping unit, bill of materials, parts, components and time. The lowest common level of abstraction may be a unit of a product combined with at least one other unit selected from the following: good, product, service, stock keeping unit, bill of materials, parts, components and time. The lowest common level of abstraction may be a unit of a service combined with at least one other unit selected from the following: good, product, service, stock keeping unit, bill of materials, parts, components and time. The lowest common level of abstraction may be stock keeping units per week per manufacturing plant. The lowest common level of abstraction may be products per day per distribution channel. The lowest common level of abstraction may be products per day per distribution channel per country. The lowest common level of abstraction may be one or more of cost per passenger mile, service hours per day per worker, change in market share per advertising campaign cost and stock keeping units per week.

The lowest common level of abstraction may change. A given lowest common level of abstraction may change. The lowest common level of abstraction may change over time. A given lowest common level of abstraction may change over time. The lowest common level of abstraction may change by process. A given lowest common level of abstraction may change by process. The lowest common level of abstraction or a given lowest common level of abstraction may change in response to one or more of the following: time, process, internal event, external event, internal condition, external condition, information, input from a user, system and/or decision maker, and user, system and/or decision maker preferences.

The method or system may account for goods, products and/or services at all levels of abstraction, at different levels of abstraction and/or at user specified levels of abstraction, and may account for any and/or all of these simultaneously. The levels of abstraction may be along, from or of different dimensions. One level of abstraction may be a unit of a good and/or product and another level of abstraction may be a bundle or kit that includes at least a unit of product and at least one other item. The other item may be a good, product and/or service. One level of abstraction may be some unit of a service, and another level of abstraction may be a bundle or kit that includes at least a unit of service and at least one other item. One level of abstraction may be a stock keeping unit and another may be a bundle or kit that includes at least the stock keeping unit and at least one other item. One level of abstraction may be above or below a stock keeping unit and another may be a bundle or kit that includes at least the item above or below the stock keeping unit and at least one other item. One level of abstraction may be a bill of materials and another may be a bundle or kit that includes at least the bill of materials and at least one other item. One level of abstraction may be above or below a bill of materials and another may be a bundle or kit that includes at least the item above or below the bill of materials and at least one other item. One level of abstraction may be a project and another may be a bundle or kit that includes at least the project and at least one other item. One level of abstraction may be above or below a project and another may be a bundle or kit that includes at least the item above or below the project and at least one other item. One level of abstraction may be a task and another may be a bundle or kit that includes at least the task and at least one other item. One level of abstraction may be above or below a task and another may be a bundle or kit that includes at least the item above or below the task and at least one other item. The other item may be a good, product and/or service. There may be additional levels of abstraction. The levels of abstraction may be along different dimensions.

All items in a kit may be saleable. At least one item in a kit may be not saleable. All items in a bundle may be saleable. At least one item in a bundle may be not saleable.

The methods above may further include a step of linking, synchronizing, integrating, aggregating and/or aligning at least two units, plans, functions, processes and/or other subsets of an enterprise, that includes characterizing the units, plans, functions, processes and/or other subsets of an enterprise in terms of a lowest common level of abstraction or a least common denominator variable that is common to the units, plans, functions, processes and/or other subsets of an enterprise to be linked, synchronized, integrated, aggregated and/or aligned. The method may account for units, plans, functions, processes and/or other subsets of an enterprise at all levels of abstraction, at different levels of abstraction, at specified levels of abstraction and/or at user, system and/or decision maker-specified levels of abstraction. The units, plans, functions, processes, other subsets of an enterprise and/or levels of abstraction may be any of the following: enterprise, division, subsidiary, affiliate, business unit, office, branch, department, group, sub-group, project team, team, geographically-defined unit, employee, contractor, agent, analyst, consultant and the like. The lowest common level of abstraction may be multidimensional. Multiple pairs of units, plans, functions, processes and/or other subsets of an enterprise may be linked, synchronized, integrated, aggregated and/or aligned simultaneously or in sequence. The multiple pairs may be all possible pairs or fewer than all possible pairs.

The enterprise may be characterized as having one or more of the following functions: retail, wholesale, manufacturing, service provision, research, development, distribution, sales, advertising, utility, agriculture, entertainment, polling, surveying, pharmaceutical, biotechnology, research, development, financial services, transportation, insurance, medical service, licensing and any combination of the foregoing.

The level of abstraction for a unit, plan, function, process and/or other subset of an enterprise may be selected from the group consisting of: enterprise, division, subsidiary, affiliate, business unit, office, branch, department, group, sub-group, project team, team, geographically-defined unit, employee, contractor, agent, analyst, consultant and the like.

In a sales representative organization, the lowest common level of abstraction may be selected from the group consisting of: margin per product sold, price per product, time, geographic unit, total products sold, change in revenue, change in market share and change in market penetration. The dimension(s) of the lowest common level of abstraction may be selected from the group consisting of: margin per product sold, price per product, time, geographic unit, total products sold, change in revenue, change in market share and change in market penetration. The relevant units, plans, functions, processes and/or other subsets of an enterprise may be selected from the group consisting of: demand, supply, and finance department. At least two relevant units, plans, functions, processes and/or other subsets of an enterprise may be selected.

In an advertising business, the lowest common level of abstraction may be selected from the group consisting of: cost-per-thousand impressions, hours worked, geographic unit, geographic region, change in revenue, change in market share and change in market penetration. The lowest common level of abstraction may be selected from the group consisting of: cost-per-thousand impressions, hours worked, geographic unit, geographic region, change in revenue, change in market share and change in market penetration. The advertising business may use media channels selected from the group consisting of: television, radio, Internet, email, banner ads, pop-up ads, text messaging, SMS messaging, mobile platforms, print, newspapers, magazines, billboards, signs, advertisements placed on vehicles, video displays, video games, movies, television programs and any other media in which one can advertise now or in the future. The relevant units, plans, functions, processes and/or other subsets of an enterprise may be selected from the group consisting of: procurement, human resources and finance. At least two relevant units, plans, functions, processes and/or other subsets of an enterprise may be selected.

The enterprise may be involved with a good, product and/or service which may spoil, age or become obsolete, and the lowest common level of abstraction may be selected from the group consisting of: a freshness measure, lifetime, half-life, energy cost, heating cost, cooling cost, geographic region and percentage alive. The enterprise may be selected from the group consisting of: restaurant, grocery store, bar, food and/or beverage distributor, food and/or beverage wholesaler, food and/or beverage manufacturer, food and/or beverage retailer, laboratory, pharmaceutical company, drug manufacturer, pharmacy, pet retailer, animal transportation, convenience store, consumer goods vendor and clothing retailer. The good or product may be selected from the group consisting of: foodstuff, beverage, chocolate, candy, computer hardware, electronics, medical supplies, drugs, a liquid gas, a compressed gas such as oxygen, nitrogen, helium, propane, or natural gas, animal, living organisms, viruses, musical instruments, flora and fauna. A condition relating to the good or product may require regulation or monitoring, the condition may be selected from the group consisting of: temperature, humidity, vibration level, pressure, oxygen-level, water-level and travel time. The service may be selected from the group consisting of: promotion by a celebrity, promotion of a temporary event, food service, food preparation and development. The relevant units, plans, functions, processes and/or other subsets of an enterprise may be selected from the group consisting of: distribution, supply, operations and marketing. At least two relevant units, plans, functions, processes and/or other subsets of an enterprise may be selected.

The enterprise may be an electricity or energy distribution utility and the lowest common level of abstraction or dimension of the lowest common level of abstraction may be selected from the group consisting of: kilowatt hours, kilowatt hours transmitted, margin per kilowatt hour, cycles, geographic region, day, week, quality of electricity and market share. The relevant units, plans, functions, processes and/or other subsets of an enterprise may be selected from the group consisting of: engineering, supply, distribution, and operations. At least two relevant units, plans, functions, processes and/or other subsets of an enterprise may be selected.

The enterprise may be an agricultural business and the lowest common level of abstraction or dimension of the lowest common level of abstraction may be: energy cost, pounds of feed per pounds of meat, pounds of feed per pound of product, pounds of feed per gallon of output, time, input measure per unit of output measure and fee per hour of service. The animal stock may be selected from the group consisting of: cows, cattle, horses, pigs, sheep, lamb, deer, ostrich, bees, chickens, roosters, ducks, other poultry, other foul, rabbits and fish. The crop may be selected from the group consisting of: corn, wheat, rice, sunflower seeds, beans, celery, rhubarb, bananas, oranges, tomatoes, strawberries, peaches, cherries, blue berries, raspberries, peanuts, walnuts, cashews, other nuts, other fruits, other vegetables and other grains. The product produced may be selected from the group consisting of: corn, wheat, rice, honey, meat, eggs, canola oil, vegetable oil, fruits, vegetables, nuts and grains. The service may be selected from the group consisting of: hunting, fishing, ranch tourism and horseback riding. The relevant units, plans, functions, processes and/or other subsets of an enterprise may be selected from the group consisting of: human resources, supply-chain, quality control, finance department, distribution, and logistics. At least two relevant units, plans, functions, processes and/or other subsets of an enterprise may be selected.

The enterprise may be a transportation business and the lowest common level of abstraction or dimension(s) of the lowest common level of abstraction may be selected from the group consisting of: cost per passenger mile, revenue per passenger mile, profit per passenger mile, on-time trips, weight per distance, spatial dimensions, weight, volume, density, energy consumption, cost, time, equipment depreciation, distance and arrival time. The mode of transportation may be selected from the group consisting of: aircraft, airplane, helicopter, airship, blimp, rail, train, trolley, street car, water, sea, ship, boat, submarine, hovercraft, land, road, truck, car, motorcycle, bicycle, segway, all terrain vehicle, snow mobile and any other mode of transportation. The target of transportation may be selected from the group consisting of: humans, passengers, animals, food products, cargo, freight and merchandise purchased over the Internet. The relevant units, plans, functions, processes and/or other subsets of an enterprise may be selected from the group consisting of: demand, logistics, compliance and quality control. At least two relevant units, plans, functions, processes and/or other subsets of an enterprise may be selected.

The enterprise may be an insurance business and the lowest common level of abstraction or dimensions(s) of the lowest common level of abstraction may be selected from the group consisting of: actuarial risk, cost per person insured, cost per item ensured, cost per business insured and margin per insurance policy. The valuable, item, object and/or commodity insured may be selected from the group consisting of: human life, animal life, other life, real property, a building, a voice, part of a body, musical instrument, jewelry, the contents of a home, electronics, a business, a client-base, a car, truck, motorcycle, plane, helicopter, boat, ship, bicycle, other vehicle, shipment, cargo and baggage. The insurance may cover events such as fire, natural disaster, flood, earthquake, tornado, act of war, act of terror, fraud, theft and expropriation, trip cancellation and healthcare events. The relevant units, plans, functions, processes and/or other subsets of an enterprise may be selected from the group consisting of: finance, distribution and compliance. At least two relevant units, plans, functions, processes and/or other subsets of an enterprise may be selected.

The enterprise may be a medical service provider and the lowest common level of abstraction or dimension(s) of the lowest common level of abstraction may be selected from the group consisting of: units of treatment, cost of treatment, doctor hours, nurse hours, margin per procedure, time, geographic region and risk. The relevant units, plans, functions, processes and/or other subsets of an enterprise may be selected from the group consisting of: human resources, recruitment, quality control, operations and finance. At least two relevant units, plans, functions, processes and/or other subsets of an enterprise may be selected.

The enterprise may be an entertainment business and the lowest common level of abstraction or dimensions(s) of the lowest common level of abstraction may be selected from the group consisting of: box office sales, copies sold, return on investment, time, geographic location, tables filled, tickets sold, consumer reaction and ratings. The relevant units, plans, functions, processes and/or other subsets of an enterprise may be selected from the group consisting of: development, recruitment, research, compliance and accounting. At least two relevant units, plans, functions, processes and/or other subsets of an enterprise may be selected.

The enterprise may be a polling and/or surveying business and the lowest common level of abstraction or dimension(s) of the lowest common level of abstraction may be selected from the group consisting of: number of people polled, hours, number of questions, design hours per question, location, achieved results and any combination of any of the foregoing. The relevant units, plans, functions, processes and/or other subsets of an enterprise may be selected from the group consisting of: human resources, recruiting, logistics and quality control. At least two relevant units, plans, functions, processes and/or other subsets of an enterprise may be selected.

The enterprise may be a pharmaceutical and/or biotechnology business and the lowest common level of abstraction or dimension(s) of the lowest common level of abstraction may be selected from the group consisting of: margin, stock keeping units, return on investment, market share, unit of disease, time, location, occurrence per population and saturation. The relevant units, plans, functions, processes and/or other subsets of an enterprise may be selected from the group consisting of: research, development, demand, logistics, compliance, distribution and quality control. At least two relevant units, plans, functions, processes and/or other subsets of an enterprise may be selected.

The enterprise may be a research and development enterprise and the lowest common level of abstraction or dimensions(s) of the lowest common level of abstraction may be selected from the group consisting of: return on investment, rate of commercialization, geographic classification, time series, risk to return ratios and risk. The relevant units, plans, functions, processes and/or other subsets of an enterprise may be selected from the group consisting of: research, development, engineering, finance and human resources. At least two relevant units, plans, functions, processes and/or other subsets of an enterprise may be selected.

The enterprise may be a financial services company and the lowest common level of abstraction or dimension(s) of the lowest common level of abstraction may be selected from the group consisting of: units sold, dollars under management, customer satisfaction, volume, time, region and return. The relevant units, plans, functions, processes and/or other subsets of an enterprise may be selected from the group consisting of: human resources, demand forecast, sales, sales team, research and lobbying. At least two relevant units, plans, functions, processes and/or other subsets of an enterprise may be selected.

The enterprise may be a retail enterprise and the lowest common level of abstraction or dimension(s) of the lowest common level of abstraction may be selected from the group consisting of: stock keeping units, pallets, lots, truck-loads, margin, shelf-space, weeks, store location, plant location, distribution facility location and display size. The relevant units, plans, functions, processes and/or other subsets of an enterprise may be selected from the group consisting of: production, marketing, promotional, promotional project team, distribution, operations and sales. At least two relevant units, plans, functions, processes and/or other subsets of an enterprise may be selected.

The enterprise may be a service provider and the lowest common level of abstraction or dimension(s) of the lowest common level of abstraction may be selected from the group consisting of: service hours provided at a certain location, workers, hours, network bandwidth and achieved results. The relevant units, plans, functions, processes and/or other subsets of an enterprise may be selected from the group consisting of: human resources, recruitment, promotion, operations and finance. At least two relevant units, plans, functions, processes and/or other subsets of an enterprise may be selected. The service provider may be a telephone company. The telephone company may run a long distance promotion. The system may allow the telephone company to allocate or otherwise ensure network bandwidth is adequate and that there are enough customer service representatives to respond to customer queries and complaints.

The enterprise may be a wholesale manufacturing enterprise and the lowest common level of abstraction or dimension(s) of the lowest common level of abstraction may be selected from the group consisting of: components of the product produced, parts, bill of materials, raw materials and sub-assemblies. The relevant units, plans, functions, processes and/or other subsets of an enterprise may be selected from the group consisting of: procurement, production, inventory, distribution and demand forecast. At least two relevant units, plans, functions, processes and/or other subsets of an enterprise may be selected.

The enterprise may be a manufacturing enterprise and the lowest common level of abstraction or dimension(s) of the lowest common level of abstraction may be selected from the group consisting of: bill of materials, unit of raw material, location of production, date of production and lots produced. The relevant units, plans, functions, processes and/or other subsets of an enterprise may be selected from the group consisting of: financial department and supply-chain function. At least two relevant units, plans, functions, processes and/or other subsets of an enterprise may be selected.

The enterprise may be characterized as a consumer goods retailing enterprise and the lowest common level of abstraction or dimension(s) of the lowest common level of abstraction may be selected from the group consisting of: pallets, bulk lots, stock keeping units, source, time available, transportation time and location of demand. The relevant units, plans, functions, processes and/or other subsets of an enterprise may be selected from the group consisting of: production plan, sales team, marketing plan and distribution. At least two relevant units, plans, functions, processes and/or other subsets of an enterprise may be selected. The system may enable verification and/or determination that a production plan and distribution channels are adequate to meet the requirements of a marketing plan.

The enterprise may be characterized as a distribution enterprise and the lowest common level of abstraction or dimension(s) of the lowest common level of abstraction may be selected from the group consisting of: stock keeping units, intermodal containers, pallets, transportation time, source location, destination location and lead-time. The relevant units, plans, functions, processes and/or other subsets of an enterprise may be selected from the group consisting of: procurement department and demand-forecast plan. At least two relevant units, plans, functions, processes and/or other subsets of an enterprise may be selected.

A method or system disclosed herein may include placing an element, object, item and/or idea into a hierarchy or structure based on its characteristics, such as its characteristics relative to any other element, object, item and/or idea in the hierarchy or structure, or based on its position in at least one other hierarchy or structure. At least one element, object, item and/or idea may be common to each pair of hierarchies or structures. The hierarchies or structures may be linked.

The other hierarchies or structures may be a subset of all available hierarchies or structures of which the element, object, item and/or idea is a part. The other hierarchies or structures may be a user, system and/or decision maker-defined subset of all available hierarchies and/or structures of which the element, object, item and/or idea may be a part. A user, system and/or decision maker may define the hierarchy and/or structure subset with dynamic generation of alternative hierarchies and/or structures. The other hierarchies and/or structures may be all available hierarchies and/or structures of which the element, object, item and/or idea may be a part.

The element, object, item and/or idea may be selected from the group consisting of: an element, an object, an item, an idea, a function, a measure, an enterprise-related element, an enterprise-related object, an enterprise-related item, an enterprise-related idea, an enterprise-related function, an enterprise-related measure, a business-related element, a business-related object, a business-related item, a business-related idea, a business-related function and a business-related measure. The element, object, item, and/or idea may be selected from the group consisting of: analyst name, analyst identification, product name, product identification, actual measures, forecasted measures, plans, minimum lot size, weeks on-hand, plant name, plant location, six week moving average, percent change, year-to-date value, element of a computer program and function of a computer program.

The hierarchy and/or structure may be selected from the group consisting of: products sorted by type, products sorted by name, products sorted by volume sold, products sorted by assigned analyst, analyst names in alphabetical order, analysts sorted by region, analysts ordered by forecast accuracy, analysts sorted by length of employment, analysts sorted by assigned plant, plants organized by region, plant names in alphabetical order, plants sorted by volume produced, moving averages sorted by time period, moving averages sorted by value, moving averages sorted by variance, list of mathematical and statistical measures, mathematical and statistical measures sorted by type, mathematical and statistical measures sorted by significance, mathematical and statistical measures ordered by overall frequency of use and mathematical and statistical measures ordered by frequency of use by each analyst.

A graphical user interface may be provided for displaying any element, object, item and/or idea of a hierarchy and/or structure relative to any other element, object, item and/or idea of the hierarchy and/or structure. The elements, objects, items and/or ideas to be displayed may be selected by a user. A user, system and/or decision maker may define the hierarchy and/or structure subsets using dynamic generation of alternative views of the hierarchies and/or structures. The method of display may be a directed graph. The directed graph may represent a plurality of views of the hierarchy and/or structure. The user definition of the hierarchy and/or structure may impact the directed graph.

An analytic engine for analyzing or modifying data may be associated with the hierarchy and/or structure. The analytic engine may analyze or modify data that is relevant to the various units, plans, functions, processes and/or subsets of an enterprise.

The analytic engine may include a calculator. The calculator or analytic engine may apply one or more functions to the data, to a subset of the data, to a subset of a subset of the data, to a user-defined subset of the data or to various combinations of any of the foregoing. Two or more functions may be applied with the same weights or with different weights. Certain of the functions may be applied with the same weights and certain of the functions may be applied with different weights. The functions may be applied in series, in parallel, in an over-lapping manner or simultaneously to the data, to a subset of the data, to a subset of a subset of the subset of the data, to a user-defined subset of the data or to various combinations of any of the foregoing. The application may be to a combination of the same and different parts of the data, subset of the data, subset of a subset of the data and/or user-defined subset of the data. The data may include decisions and/or decision objects.

The functions applied by the analytic engine may be logical functions including AND, IF( ), IS, NOT, OR, XOR and any other function that may be resolved to a binary conclusion. The functions applied by the analytic engine may include mathematical functions such as: ABS( ), CEILING( ), EXP( ), LOG( ), LN( ), MOD( ), MULTINOMIAL( ), POWER( ), RAND, ROUND( ), ROUNDDOWN( ), ROUNDUP( ), SIGN( ), SQRT( ), SUM( ), SUMPRODUCT( ), SUMSQ( ), SUMX2MY2( ) and TRUNC( ). The functions applied by the analytic engine may include statistical functions such as: AVERAGE( ), CORREL( ) COUNT( ) COVAR( ) DEVSQ( ), FORECAST( ) GAMMADIST( ), GAMMAINV ( ), GEOMEAN( ) INTERCEPT( ) LARGE( ), MAX( ) MEDIAN( ), MID( ), MIN( ) MODE( ), NORMSDIST, NORMSINV, NTILE( ), PERCENTRANK( ) RANK( ) RANKASC( ) REPEATABLERAND, RSQ( ), SLOPE( ), SMALL( ) STANDARDIZE( ), STDEV( ), STDEVP( ), VAR( ) and VARP( ). The functions applied by the analytic engine may include single member functions such as: ElementIn( ), FirstOf( ), LastOf( ), LastValue( ), MapName( ), MemberAlias( ), MemberIn( ), MemberKey( ), MemberKeyCounto, MemberName( ), MemberQualifiedName( ), NextOf( ), NextsOf( ), NthOf( ), Parameter( ), ParentOf( ), ParentOfByHierarchy( ), ParentsOf( ), PriorOf( ) and PriorsOf( ). The functions applied by the analytic engine may include financial functions such as: FV( ), IRR( ) and NPV( ). The functions applied by the analytic engine may include constant functions such as: AttributeValue and CellAddress( ). The functions applied by the analytic engine may include member list functions such as: AncestorsOf( ), Between( ), ChildrenOf( ), DescendantsOf( ), ElementCount( ), IndexofFirstValue( ), IndexofLarge( ), IndexofLastValue( ), IndexofMax( ), IndexofMin( ), IndexofSmall( ), LeavesOf( ), Level( ), MemberCount( ), ParentsOf( ), PriorsOf( ), Reverse( ) and RootsOf( ). The functions applied by the analytic engine may include Boolean functions such as: FIND( ), FALSE, NULL and TRUE. The functions applied by the analytic engine may include data functions such as: DATETOJULIAN( ), DATEVALUE( ), DATE, DAY( ), DAYS( ), EDAY( ), JULIANTODATE( ), MONTH( ), TODAY, WEEKDAY( ) and YEAR( ). The function applied by the analytic engine may include string functions such as: CONCATENATE( ), DOUBLETOSTRING( ), INTTOSTRING( ), LOWER( ), STRINGTODOUBLE( ), STRINGTOINT( ), STRINGTOMEMBER( ) and UPPER( ). The functions applied by the analytic engine may include calculator functions such as: add, apply, average, clear, constant, divide, growth, maximum, minimum, multiply, prorate, slope and subtract.

The analytic engine may calculate demand or generate forecasts. The forecasts may be based on historical data and/or user-provided data, and may be based on an analytical model.

The analytic engine may allow for the specification, such as by a user, system and/or decision maker, of at least one parameter selected from the group consisting of: function, logical function, mathematical function, statistical function, single member function, financial function, constant function, member list function, Boolean function, date function, string function, a calculator function, any parameter of any of the foregoing functions, any variable value of any of the foregoing functions, rounding rules, specification of the data set, specification of the subset of the data set, analyst name, analyst identifier, how the function or process is to be applied, series application, parallel application, simultaneous application, over-lapping application, any other parameter, any other variable value, any weighting of any function, any weighting of any parameter and any weighting of any variable value.

The specification of at least one parameter may be through a graphical user interface. The graphical user interface may contain at least one field for specifying the parameter. The graphical user interface may contain at least one element and/or function from the group consisting of: apply, undo, preview application, cancel, delete, new, modify, save and print. The parameter or a variable value of the parameter may be defined by a user, system and/or decision maker. The parameter or a variable value of the parameter or weighting of the parameter may be automatically defined, defined by a user, system and/or decision maker, defined by a natural law, industry practice, logic or historical data.

The analytic engine, method, system and/or process may calculate, generate, estimate and/or forecast one or more of supply, dependent supply, independent supply, demand, dependent demand, independent demand, a measure or metric, a dependent metric or measure, an independent metric or measure, and/or forecasts based upon historical data, user-provided data, an analytical model, method and/or system.

A good, product and/or service may have or be characterized by an independent or dependent signal of demand, supply, or any other measure or metric for the good, product and/or service. A dependent signal may be derived from an independent signal or from another dependent signal that eventually derives from an independent signal. An independent signal may be a signal based on consumer preferences and market forces. A dependent signal for an item may arise when the item is a component or part of a good, product, service, bundle or kit for which an independent signal exists or for which a dependent signal exists that eventually derives from an independent signal. For example, a video game console and a video game may be sold together or independently. There may be an independent demand for each of the console, game and bundle of the console and game. There may also be a dependent demand for each of the console and game derived from the independent demand for the bundle of the console and game.

The signal may be for the good, product and/or service outside a bundle or kit, or as part of a bundle or kit. The signal may be based on the independent demand signal for the bundle or kit of which the good, product and/or service is a part. The good, product and/or service may be saleable or non-saleable. If non-saleable, the good, product and/or service may have a local independent signal as a result of its inclusion in one or more bundles and/or kits.

An allocation engine, function, method and/or system may be associated with the method or system, enterprise planning method or system and/or the method or system for placing an element, object, item, and/or idea into a hierarchy and/or structure. The allocation engine, function, method and/or system may be associated with the analytic engine, the intelligent decision engine and/or the decision process. The allocation engine, function, method and/or system may be associated with or include other engines, analytic tools, processes, methods and/or systems.

The allocation engine may allocate units of a good, product, service, resource, signal and the like to a level of abstraction below or above the lowest common level of abstraction or an arbitrary level of abstraction. The allocation, or the method, process, system, parameters, algorithms and/or logic thereof, may be defined by a user, system, decision maker and/or method. The signal may include: a demand signal, supply signal, procurement signal, distribution signal and/or any other internal or external signal or information flow within an enterprise. The levels of abstraction may be specified by a user, decision maker, system, method and/or model.

A rule engine, function, method or system may execute rules. The rules may be associated with the planning method or system, the method or system for placing an element, object, item and/or idea into a hierarchy and/or structure, the analytic engine, the comparison engine, the decision process, an analytic tool or any other engines, processes, systems or methods as described herein, or that may be employed with the engines, processes, systems or methods as described herein.

A rule may be specific to any level of abstraction, hierarchy, structure, level of a hierarchy and/or structure, parameter, group of parameters and/or any other aspect of a system, method or object within a system and/or method. A rule may alter or otherwise modify a function, element, process, system, method and/or procedure, such as in response to an event or condition. The event or condition may be external or internal. A rule may affect the availability of a function, element, process, system, method and/or procedure such as by making the function, element, process, system, method and/or procedure available, unavailable or conditionally available in response to an event or condition. The event or condition may be user, system or decision maker-defined or specified by a model. The event or condition may be a constraint, such as a real world constraint. The real world constraint may include: production time of a good, availability of a raw material, availability of a resource, availability of a production input, lead time of a facility, conversion time of a facility, turn-over time of a facility and transportation time.

A comparison engine, function, method and/or system may perform a comparison. The comparison engine, function, method and/or system may be associated with the enterprise planning method or system, or with a method or system for placing an element, object, item and/or idea into a hierarchy and/or structure. The comparison engine, function, method and/or system may be associated with the analytic engine, the intelligent decision engine and/or the decision process. The comparison engine, function, method and/or system may be associated with or include other engines, processes, systems and/or methods.

The comparison may be among data or subsets of data, such as a subset of actual data, a partial subset of actual data, a subset of forecasted data, a partial subset of forecasted data, actual data from a certain time period, forecasted data from a certain time period, actual data from a certain region, forecasted data from a certain region, an entire data set, decisions, prospective decisions, proposed decisions, executed decisions, implemented decisions, decision objects, prospective decision objects, proposed decision objects, executed decision objects and implemented decision objects. The subsets of data may include all data available to the comparison engine. A comparison may be between any two or more of a forecasted values or set of values or plans and/or an actual value or set of values.

A comparison may present, show and/or analyze an actual result against an expected result. A comparison may allow a user, system and/or decision maker to observe, determine and/or learn behaviors and/or relationships, such as cause and effect behaviors and/or relationships. A comparison may allow a user, system and/or decision maker to observe, determine and/or learn which changes, proposed changes, decisions, decision objects, prospective decisions, prospective decision objects, proposed decisions, and/or proposed decision objects may correct and/or not correct a given problem, condition or situation. The comparison may be outputted, displayed, printed or otherwise provided as a report or summary, and may be in a graphical format, such as a graphical format defined by a user, system, decision maker and/or model. The graphical format may be automatically defined by a model and/or system.

The report or summary may include a chart or graph such as: 3D, vertical bar, horizontal bar, vertical area, horizontal area, vertical line, horizontal line, pie, radar, histogram, spectral map, pie-bar, scatter, polar, stock and/or bubble. The 3D chart or graph may be one or more of: bar, pyramid, octagon, floating cubes, floating pyramids, area series, ribbon series, area group, ribbon group, surface, surface sides and surface honeycomb. The vertical bar chart or graph may be one or more of: side-by-side, stacked, side-by-side dual axis, stacked dual axis, side-by-side bipolar, stacked bipolar and percentage. The horizontal bar chart or graph may be one or more of: side-by-side, stacked, side-by-side dual axis, stacked dual axis, side-by-side bipolar, stacked bipolar and percentage. The vertical area chart or graph may be one or more of: absolute, stacked, absolute bipolar, stacked bipolar and percentage. The horizontal area chart or graph may be one or more of: absolute, stacked, absolute bipolar, stacked bipolar and percentage. The vertical line chart or graph may be one or more of: absolute, stacked, absolute dual axis, stacked dual axis, absolute bipolar, stacked bipolar and percentage. The horizontal line chart or graph may be one or more of: absolute, stacked, absolute dual axis, stacked dual axis, absolute bipolar, stacked bipolar and percentage. The pie chart or graph may be one or more of: ring, multiple, ring multiple, multiple proportional and ring multiple proportional. The radar chart or graph may be one or more of: line, area and line dual axis. The histogram chart or graph may be one or more of: vertical and horizontal. The scatter chart or graph may be one or more of: dual, labels and labels dual. The stock chart or graph may be one or more of: candle, high/low, high/low dual axis, high/low bipolar, high/low close, high/low close dual axis, high/low close bipolar, high/low candle, high/low candle volume, high/low open/close, high/low open/close dual axis, high/low open/close bipolar, high/low volume, open/close volume, candle volume and high/low close volume. The bubble chart or graph may be one or more of: chart, chart with labels, dual axis chart and dual axis with labels.

A comparison may use, employ or include statistical and mathematical measures, functions, values, algorithms and analytics, including for example any of the functions noted above. The statistical and mathematical measures, functions, values, algorithms and analytics may be applied to actual data, forecasted data or results of another comparison.

A feedback engine, function, method and/or system may provide feedback. A feedback engine, function, method and/or system may be associated with the enterprise planning method or system or with a method or system for placing an element, object, item and/or idea into a hierarchy and/or structure. A feedback engine, function, method and/or system may be associated with the analytic engine, the intelligent decision engine and/or the decision process. A feedback engine, function, method and/or system may be associated with or include other engines, processes, analytic tools, systems and/or methods.

A feedback engine may communicate the output of the comparison engine, and may do so automatically. A feedback engine may communicate using one or more of: email, voicemail, telephone, text message, on-screen, audio, alert, vibration and any other means of communication. A feedback engine may provide suggestions and/or recommendations in relation to future actions, inputs, forecasts and/or assumptions. The feedback may allow improved or increased accuracy of forecasted data or plans. The feedback may be provided at set intervals and/or at user-defined intervals. The interval may be one or more of: annually, monthly, weekly, daily, hourly, any unit of time, continuously or in real-time.

The feedback may be provided in the form of an alert, or in connection with an alert or the alert function.

An interface, which may be or include a graphical user interface, a work environment or a template, may be associated with one or more of the enterprise planning method or system, the method or system for placing an element, object, item and/or idea into a hierarchy and/or structure or with any of the analytic engine, the comparison engine, the feedback engine, analytic tools, the intelligent decision engine, the decision process or any other engines, processes, systems and/or methods that are included in, associated with or external to the system.

The elements, components and/or layout of the interface may be changeable, modifiable, adaptable and/or customizable. The change, modification, adaptation and/or customization may be determined manually, automatically or otherwise, by a model, system, data, parameters, variable values or in response to an input, such as a user input.

In an interface, or more generally any of the methods or systems described above, a process may replace data values, such as data in a data grid, with other values, such as a symbol, text, number or other value that may be more easily recognizable, processed or understood by a user than the data value that was replaced. The symbol, text, number or other value may be more intuitive to the user than the certain value replaced, and may be of a different color, size or font. For example, the entries in a set of forecasted data may be relabeled as “hit” or “miss” based on how close each value is to an actual value.

An alert or alert function may be associated with one or more of the enterprise planning method or system, the method or system for placing an element, object, item and/or idea into a hierarchy and/or structure, or with any of the analytic engine, the comparison engine, the feedback engine, the intelligent decision engine, the decision process or any other engines, processes, systems and/or methods that are included in, associated with or external to the system.

An alert or alert function may be activated in response to an event or condition. The event or condition may be internal or external, may be user defined and/or may be specified by a model and/or system. The event or condition may be a certain value or result being outside or inside a range. The event or condition may be a certain output of the comparison engine, feedback engine, other engine or analytic tool, such as an output specified by a user, system and/or decision maker. The alert or alert function may be directed at one or more individuals, groups and/or entities including one or more of: supervisor, manager, enterprise, division, subsidiary, affiliate, business unit, office, branch, department, group, sub-group, project team, team, geographically-defined unit, employee, contractor, agent, analyst, consultant and the like. The alert or alert function may communicate in one or more of the following manners: email, voicemail, telephone, text message, SMS, on-screen, a symbol, an icon, window, audio, alert, alarm, vibration, smell, taste and/or any other means of communication. An alert may be private or public. One user, system and/or decision maker can create an alert for itself and/or for another user, system and/or decision maker. The other user, system and/or decision maker may or may not know whether or not an alert was also provided to the user, system and/or decision maker that created the alert.

In an embodiment, the alert or alert function may generate an alert to a supervisor when an analyst inputs a forecast value that is outside a specified range, or that differs from historical data by more than a specified amount.

A prioritization engine may prioritize or identify tasks, such as time sensitive tasks or other items that require attention. A prioritization engine may be associated with one or more of the enterprise planning method or system, the method for placing an element, object, item and/or idea into a hierarchy and/or structure, or with any of the analytic engine, the comparison engine, the feedback engine, the intelligent decision engine, the decision process or any other engines, processes, analytic tools, systems and/or methods that are included in, associated with, or external to a method or system.

The tasks may be prioritized for a user, system and/or decision maker, or identified for a user, system and/or decision maker. A prioritization engine may modify a work environment or graphical user interface. A prioritization engine may function based on preferences, profiles and/or templates selected or defined by a user, system, decision maker, model, algorithm, template, profile, internal event, internal condition, external event and/or external condition. The preferences, profiles and/or templates may be connected to a class or type of user, system and/or decision maker, or connected to a particular user, system and/or decision maker.

The user, system and/or decision maker may be selected from the group consisting of: a manager, chief executive officer, chief technology officer, chief financial officer, chief information officer, directors, or any other executive, analyst, technician, manager, board member, or other individual who may make decisions or set priorities within an entity. A user may be an analyst. The preferences, profiles and/or templates of the analyst may require, suggest, demand and/or recommend an on-screen dashboard or report displaying all stock keeping units for which the accuracy of an associated forecast is outside a specified range.

The prioritization engine may generate one or more dashboards, reports, charts, alarms and/or alerts. The prioritization engine may inform the feedback engine. The prioritization engine may determine the task for which it is most efficient or optimal to work on next.

An analytic workbench may be provided for analysis and/or control of analysis, analytic processes and/or analytic engines.

A multi-dimensional modeling system may also be included. The multi-dimensional model may be applied to data retrieved from one or more data sources to generate model-driven data for the business units, processes, plans and functions. Values for a set of metrics for the units, processes, plans and functions may be user-entered or calculated based upon the model-driven data. The model-driven data and the metrics data may be output to a user. A user may make changes to the model-driven data to simulate “what-if” scenarios. The ability to provide user-entered values and force the multi-dimensional model to drive the recalculation of the model-driven data and the metrics based upon the user-entered values enables a user to run hypothetical “what-if” planning scenarios for the business units, processes, plans and functions. The user may enter hypothetical values or assumptions for the business units, processes, plans and functions and observe the impact of the changes on other information related to the business units, processes, plans and functions and on the performance of the business units, processes, plans and functions (as measured by a set of one or more business metrics). The user-entered values entered by a user may represent changes to plans or forecasts for a particular business units, processes, plans and functions. The recalculated model-driven values and the recalculated metrics represent the expected impact of the changes on the business units, processes, plans and functions. Further information related to “what-if” scenarios and functionality is provided in U.S. Provisional Application No. 60/589,491 filed Jul. 19, 2004 (Attorney Docket No. 22304-000400US), the entire contents of which are incorporated herein by reference for all purposes.

The systems and methods described herein may be provided as modular software including reusable code that embodies each of the engines and/or processes described above. The modular software may be designed around common work flows and/or scenarios to more conveniently configure the systems and methods to particular applications.

There may be more than one method or system. Any method or system may be a model or process. In certain cases, a method may be implemented using a system and a system may be implemented or based on a system.

The method or system may be implemented, in whole or in part, using or in connection with a software application, that may include a graphical user interface. The software may run on a computer, server, handheld or other device and may be used in connection with a network or on a standalone basis. The software may include functionality and the graphical user interface may include screens regarding header data, master data, such as properties of a product, demand, supply, impact, values, a dimension hierarchy, various hierarchies, a calculator, data, cells with data, tables with rows and columns, charts, graphs, collaboration, templates, scenarios, administration, administrative functions, preferences, attributes, rules and the like, and various combinations of the foregoing.

As used herein, the term “decision” is intended to refer to a decision, decision object, prospective decision, prospective decision object, proposed decision, proposed decision object, executed decision, executed decision object, implemented decision, implemented decision object and/or decision process, along with any data or other information related thereto, or any combinations of the above, that might embody a decision at any stage of resolution in any form, such as a data variable, software object, or any other tangible or intangible representation of any of the foregoing, unless another meaning is specifically provided or otherwise required by the context thereof.

A “decision process” or “decision object” can be any function, process, model, system or method relating to or defining and/or describing a decision, including abstract or conceptual models therefore as well as concrete realizations in software or other tangible or computer executable form, along with any combinations of any of the foregoing and/or any data or other information relating thereto, unless another meaning is specifically provided or otherwise required by the context thereof.

A “unit” may include a plan, function, process and/or other subset of an enterprise. A “plan” may include a unit, function, process and/or other subset of an enterprise. A “function” may include a unit, plan, process and/or other subset of an enterprise. A process may include unit, plan function and/or other subset of an enterprise.

As used herein, the term “data facility” is intended to have the broadest possible meaning consistent with these terms, and shall include a database, a plurality of databases, a repository information manager, a queue, a message service, a repository, a data facility, a data storage facility, a data provider, a website, a server, a computer, a computer storage facility, a CD, a DVD, a mobile storage facility, a central storage facility, a hard disk, a multiple coordinating data storage facilities, RAM, ROM, flash memory, a memory card, a temporary memory facility, a permanent memory facility, magnetic tape, a locally connected computing facility, a remotely connected computing facility, a wireless facility, a wired facility, a mobile facility, a central facility, a web browser, a client, a laptop, a personal digital assistant (“PDA”), a telephone, a cellular phone, a mobile phone, an information platform, an analysis facility, a processing facility, a business enterprise system or other facility where data is handled or other facility provided to store data or other information, as well as any files or file types for maintaining structured or unstructured data used in any of the above systems, or any streaming, messaged, event driven, or otherwise sourced data and any combinations of the foregoing, unless a specific meaning is otherwise indicated or the context of the phrase requires otherwise.

As used herein, the term “data” is intended to have the broadest possible meaning, and to refer to any and all data in any form that might be stored in or transferred to, from, or through a data facility, or exist in any other tangible form, along with metadata and/or descriptive information and other data relating thereto, unless another meaning is specifically provided or otherwise required by the context thereof.

All patents, patent applications and other documents referenced herein are hereby incorporated by reference.

### BRIEF DESCRIPTION OF THE FIGURES

FIG. 1 depicts the various inputs to and outputs from a decision and/or decision maker.

FIG. 2 depicts various decisions embodied in decision objects which may be stored as data.

FIG. 3 depicts a decision or a decision maker as a plurality of decision processes which may include decision objects.

FIG. 4 depicts several decisions or decision makers in an enterprise.

FIG. 5 is a simplified high-level flow chart depicting an enterprise planning method.

FIG. 6 depicts the lowest common level of abstraction for various subsets of an enterprise.

FIG. 7 depicts the synchronization of a plurality of decisions and/or decision makers via one or more lowest common levels of abstraction.

FIG. 8 depicts a unit, plan, function, process or other subset of an enterprise as a plurality of decisions and/or decision makers.

FIG. 9 is a simplified high-level schematic diagram which represents an enterprise in terms of units, plans, functions, processes, other subsets or other abstractions of an enterprise synchronized via one or more lowest common levels of abstraction.

FIG. 10 is a simplified high-level schematic diagram which represents an enterprise in terms of the various methods, systems, models, analytic tools, networks, data facilities and devices of which it may be composed.

FIG. 11 is a flow diagram showing the logical linking of three decision processes.

FIG. 12 is a simplified high-level flow chart depicting a decision process.

FIG. 13 is a simplified high-level schematic diagram depicting a hierarchy of decision processes.

FIG. 14 is a simplified high-level flow chart depicting a decision process including a list of certain attributes.

FIG. 15 depicts the relationship between a decision object and a data facility.

FIG. 16 depicts the relationship between a decision object and attributes and a data facility.

FIG. 17 is a simplified high-level schematic diagram illustrating that a decision process may consist of plurality of decision types with a plurality of decision objects.

FIG. 18 is a simplified high-level schematic diagram illustrating that a hierarchy of decisions in a decision process may consist of plurality of decision types with a plurality of decision objects.

FIG. 19 depicts interrelated decision processes.

FIG. 20 depicts a decision as associated with one or more hierarchies of data.

FIG. 21 depicts a decision consisting of a plurality of decisions.

FIG. 22 depicts a decision process consisting of a plurality of decisions.

FIG. 23 depicts a decision involving one or more levels of abstraction within a hierarchy of levels of abstraction.

FIG. 24 depicts the viewing of past and current decisions of various types.

FIG. 25 depicts the viewing of past and current decisions of various types which are stored and maintained as data.

FIG. 26 depicts a decision object associated with various subsets and users of an enterprise hierarchy.

FIG. 27 depicts the addition of data to a decision object by a user.

FIG. 28 depicts the modification of a decision object by a user.

FIG. 29 depicts the implementation of a decision object by a user.

FIG. 30 depicts the implementation of a decision object by a user.

FIG. 31 is a simplified high-level schematic diagram illustrating that users may be within the same or different levels of an enterprise hierarchy.

FIG. 32 is a simplified high-level schematic diagram illustrating that users may be within the same or different parts of an enterprise hierarchy.

FIG. 33 depicts a decision object associated with various subsets and users of an enterprise hierarchy where the association process is driven by one or more methods.

FIG. 34 depicts a decision object associated with various subsets and users of an enterprise hierarchy where the association process is driven by one or more systems.

FIG. 35 depicts a decision object associated with various subsets and users of an enterprise hierarchy where the association process is driven by one or more users.

FIG. 36 depicts a decision object associated with various subsets and users of an enterprise hierarchy where the association process is driven by a plurality of users.

FIG. 37 depicts the presentation of a decision object to one or more levels of an enterprise, parts of an enterprise hierarchy, users, systems and/or decision makers.

FIG. 38 depicts the association of a decision object to one or more levels of an enterprise, parts of an enterprise hierarchy, users, systems and/or decision makers.

FIG. 39 depicts the presentation of a modified decision object to one or more levels of an enterprise, parts of an enterprise hierarchy, users, systems and/or decision makers.

FIG. 40 depicts the association of a modified decision object to one or more levels of an enterprise, parts of an enterprise hierarchy, users, systems and/or decision makers.

FIG. 41 depicts the various types of decision objects.

FIG. 42 depicts the various types of modified decision objects.

FIG. 43 depicts the relationships between decision objects and the various types of modified decision objects.

FIG. 44 depicts a decision to implement a decision in one or more units, plans, functions, processes or other subsets of an enterprise.

FIG. 45 depicts an intelligent decision engine which may analyze or be applied to one or more decision objects.

FIG. 46 is a simplified high-level flow chart certain representing certain aspects of the intelligent decision engine.

FIG. 47 depicts an intelligent decision engine breaking a decision object into more than one decision.

FIG. 48 depicts an intelligent decision engine associating a decision object with one or more decisions which may create another decision object.

FIG. 49 depicts an intelligent decision engine which may aggregate one or more decision objects.

FIG. 50 depicts an intelligent decision engine which may suggest or emphasize relatedness between two or more decisions.

FIG. 51 is a simplified high-level schematic diagram representing certain aspects of the intelligent decision engine.

FIG. 52 depicts an intelligent decision engine which may identify additional information to be requested in connection with a decision.

FIG. 53 depicts an intelligent decision engine which may identify missing information in connection with a decision.

FIG. 54 depicts an intelligent decision engine which may pose one or more questions in connection with a decision.

FIG. 55 depicts an intelligent decision engine which may suggest actions to be taken, recommend one or more courses of action and/or provide advice, in connection with a decision.

FIG. 56 depicts the various methods, systems, processes and information which may be utilized by the intelligent decision engine.

FIG. 57 depicts a decision collaboration engine which may present a decision to two or more levels of an enterprise hierarchy, parts of an enterprise hierarchy, users, systems and/or decision makers.

FIG. 58 depicts a decision collaboration engine which may associate a decision with two or more levels of an enterprise hierarchy, parts of an enterprise hierarchy, users, systems and/or decision makers.

FIG. 59 depicts the relationship between a decision collaboration engine and various elements of an enterprise, including a decision object.

FIG. 60 depicts the relationship between a decision collaboration engine and various elements of an enterprise, including a modified decision object.

FIG. 61 depicts the relationship between a decision collaboration engine and various elements of an enterprise.

FIG. 62 depicts the relationship between a decision collaboration engine and various elements of an enterprise, including a decision object, as an iterative process.

FIG. 63 depicts the relationship between a decision collaboration engine and various elements of an enterprise, including a modified decision object, as an iterative process.

FIG. 64 depicts the relationship between a decision collaboration engine and various elements of an enterprise, as an iterative process.

FIG. 65 depicts the relationship between a decision collaboration engine and various elements of an enterprise, including a decision object, involving an intelligent decision engine.

FIG. 66 depicts the relationship between a decision collaboration engine and various elements of an enterprise, including a modified decision object, involving an intelligent decision engine.

FIG. 67 depicts the relationship between a decision collaboration engine and various elements of an enterprise, involving an intelligent decision engine.

FIG. 68 depicts the relationship between a decision collaboration engine and various elements of an enterprise, including a decision object, as an iterative process, involving an intelligent decision engine.

FIG. 69 depicts the relationship between a decision collaboration engine and various elements of an enterprise, including a modified decision object, as an iterative process, involving an intelligent decision engine.

FIG. 70 depicts the relationship between a decision collaboration engine and various elements of an enterprise, as an iterative process, involving an intelligent decision engine.

FIG. 71 illustrates that the decision collaboration engine may work with all or a subset of the decisions of an enterprise.

FIG. 72 depicts a possible progression of a decision object through an enterprise.

FIG. 73 depicts a possible progression of a decision object through an enterprise, involving an approval chain.

FIG. 74 is a simplified high-level schematic diagram which illustrates the various information flows involving a decision object.

FIG. 75 is a simplified high-level schematic diagram which illustrates the various information flows involving a modified decision object.

FIG. 76 depicts a possibility for implementation of a proposed decision, involving a decision implementation engine.

FIG. 77 depicts a decision implementation engine targeting various units, plans, functions and processes of an enterprise.

FIG. 78 depicts a decision implementation engine targeting various elements of an enterprise.

FIG. 79 depicts a decision implementation engine targeting various units, plans, functions and processes of a subset of an enterprise.

FIG. 80 depicts a decision implementation engine targeting various elements of a subset of an enterprise.

FIG. 81 depicts a decision implementation engine which may write an array of values to various systems.

FIG. 82 depicts a decision implementation engine targeting various elements of an enterprise though a plurality of means of communication.

FIG. 83 depicts a decision implementation engine targeting various elements of an enterprise though a plurality of means of communication.

FIG. 84 depicts a decision implementation engine targeting various units, plans, functions and processes of a subset of an enterprise though a plurality of means of communication.

FIG. 85 depicts a decision implementation engine targeting various elements of a subset of an enterprise though a plurality of means of communication.

FIG. 86 depicts the periodic updating of various elements of an enterprise.

FIG. 87 depicts a hierarchy of certain units of time.

FIG. 88 depicts the transitions from forecasted to historical data over time.

FIG. 89 depicts the mapping of a time series to a calendar.

FIG. 90 depicts the mapping of a time series to a financial calendar.

FIG. 91 depicts the mapping of a time series to a clock.

FIG. 92 depicts the mapping of a time series to various processes.

FIG. 93 depicts a decision tracking facility.

FIG. 94 depicts a decision tracking facility emphasizing decisions at a particular point in time.

FIG. 95 depicts a decision tracking facility in connection with a plurality of decisions.

FIG. 96 is a simplified high-level schematic diagram which illustrates the various information flows involving a decision tracking facility.

FIG. 97 depicts a decision tracking facility associated with various elements of an enterprise.

FIG. 98 depicts a decision tracking facility which allows for revisiting a decision in context.

FIG. 99 depicts the various dimensions of a plurality of decision objects.

FIG. 100 depicts the various dimensions of a plurality of decision objects in connection with the decision tracking facility.

FIG. 101 depicts certain decision objects in a range of a dimension.

FIG. 102 depicts certain decision objects at a point in two dimensions.

FIG. 103 depicts a simple approval chain.

FIG. 104 depicts a simple approval chain.

FIG. 105 depicts a decision tracking facility that may provide simulations, modeling and analysis of a decision under historical and/or hypothetical conditions.

FIG. 106 depicts the first part of an embodiment of the planning process.

FIG. 107 depicts the second part of an embodiment of the planning process.

FIG. 108 depicts the third part of an embodiment of the planning process.

FIG. 109 depicts the fourth part of an embodiment of the planning process.

FIG. 110 depicts an enterprise as units.

FIG. 111 depicts an enterprise as plans.

FIG. 112 depicts an enterprise as functions.

FIG. 113 depicts an enterprise as processes.

FIG. 114 depicts the relationship between an enterprise and the various units, plans, functions and processes of an enterprise.

FIG. 115 depicts the relationship between an enterprise and the various units, plans, functions and processes of an enterprise, at various levels of abstraction.

FIG. 116 is a simplified high-level flow chart depicting an enterprise planning method, involving units.

FIG. 117 is a simplified high-level flow chart depicting an enterprise planning method, involving plans.

FIG. 118 is a simplified high-level flow chart depicting an enterprise planning method, involving functions.

FIG. 119 is a simplified high-level flow chart depicting an enterprise planning method, involving processes.

FIG. 120 depicts an enterprise planning method at various levels of abstraction.

FIG. 121 depicts the relationship between an enterprise planning method and a decision process.

FIG. 122 depicts an enterprise planning method which may create new data and/or attributes.

FIG. 123 depicts an enterprise planning method which may modify data and/or attributes.

FIG. 124 depicts the relationship between an enterprise planning method and any one or more engines, systems, models, facilities, methods, levels, users, decision makers, units, plans, analytic tools, functions and/or processes.

FIG. 125 depicts the periodic updating of various elements of an enterprise planning method.

FIG. 126 depicts the periodic updating of various elements of an enterprise planning method, at various levels of abstraction.

FIG. 127 depicts the lowest common level of abstraction for various subsets of an enterprise.

FIG. 128 depicts various kits and/or bundles, with saleable and/or non-saleable elements.

FIG. 129 depicts various kits and/or bundles, with saleable and/or non-saleable elements.

FIG. 130 depicts various kits and/or bundles of kits and/or bundles, with saleable and/or non-saleable elements.

FIG. 131 depicts various kits and/or bundles including goods and/or products, at various levels of abstraction.

FIG. 132 depicts various kits and/or bundles including services, at various levels of abstraction.

FIG. 133 depicts a lowest common level of abstraction in two dimensions.

FIG. 134 depicts a lowest common level of abstraction in three dimensions.

FIG. 135 depicts a change in the lowest common level of abstraction in response to an event and/or condition.

FIG. 136 depicts a unit, plan, function, process or other subset of an enterprise as a plurality of decision processes.

FIG. 137 depicts a unit, plan, function, process or other subset of an enterprise as a plurality of decision objects.

FIG. 138 depicts a unit, plan, function, process or other subset of an enterprise as a plurality of enterprise planning methods.

FIG. 139 depicts a unit, plan, function, process or other subset of an enterprise as a plurality of units, plans, functions, processes or other subsets of an enterprise.

FIG. 140 depicts a lowest common level of abstraction synchronizing, aligning, linking and integrating two or more units, plans, functions, processes or other subsets of an enterprise.

FIG. 141 depicts a lowest common level of abstraction synchronizing, aligning, linking and integrating two or more units, plans, functions, processes or other subsets of an enterprise.

FIG. 142 depicts a plurality of lowest common levels of abstraction synchronizing, aligning, linking and integrating two or more units, plans, functions, processes or other subsets of an enterprise.

FIG. 143 depicts a plurality of lowest common levels of abstraction synchronizing, aligning, linking and integrating two or more units, plans, functions, processes or other subsets of an enterprise, at various levels of abstraction.

FIG. 144 depicts a plurality of lowest common levels of abstraction synchronizing, aligning, linking and integrating two or more units, plans, functions, processes or other subsets of an enterprise, at various levels of abstraction.

FIG. 145 depicts an enterprise planning method for a sales representative organization.

FIG. 146 depicts an enterprise planning method for an advertising business.

FIG. 147 depicts an enterprise planning method for a food distributor.

FIG. 148 depicts an enterprise planning method for an energy distribution utility.

FIG. 149 depicts an enterprise planning method for a cattle ranch.

FIG. 150 depicts an enterprise planning method for a cargo business.

FIG. 151 depicts an enterprise planning method for an insurance business.

FIG. 152 depicts an enterprise planning method for a medical service provider.

FIG. 153 depicts an enterprise planning method for an entertainment business.

FIG. 154 depicts an enterprise planning method for a polling firm.

FIG. 155 depicts an enterprise planning method for a biotechnology firm.

FIG. 156 depicts an enterprise planning method for a research and development enterprise.

FIG. 157 depicts an enterprise planning method for a financial services company.

FIG. 158 depicts an enterprise planning method for a retail enterprise.

FIG. 159 depicts an enterprise planning method for a service provider.

FIG. 160 depicts an enterprise planning method for a wholesale manufacturing enterprise.

FIG. 161 depicts an enterprise planning method for a manufacturing enterprise.

FIG. 162 depicts an enterprise planning method for a consumer goods retailing business.

FIG. 163 depicts an enterprise planning method for a distribution enterprise.

FIG. 164 depicts a graphical user interface, including dependent and independent demand.

FIG. 165 depicts a graphical user interface, including a workbench.

FIG. 166 depicts a graphical user interface, including a hierarchy.

FIG. 167 depicts a graphical user interface, including a hierarchy.

FIG. 168 depicts a graphical user interface, including a hierarchy.

FIG. 169 depicts a graphical user interface, including a hierarchy.

FIG. 170 depicts a graphical user interface, including a calculator.

FIG. 171 depicts a graphical user interface, including a demand tab.

FIG. 172 depicts a graphical user interface, including a master tab.

FIG. 173 depicts a graphical user interface, including a supply tab.

FIG. 174 depicts a graphical user interface, including a supply tab.

FIG. 175 depicts a graphical user interface, including a supply tab.

FIG. 176 depicts a graphical user interface, including a supply tab.

FIG. 177 depicts a graphical user interface, including a supply tab.

FIG. 178 depicts a graphical user interface, including an impact tab.

FIG. 179 depicts a graphical user interface, including a values tab.

FIG. 180 depicts a graphical user interface, including a header tab.

FIG. 181 depicts a graphical user interface, including a navigation menu.

FIG. 182 depicts a graphical user interface, including a navigation menu.

FIG. 183 depicts a graphical user interface, including a navigation menu.

FIG. 184 depicts a graphical user interface, including a navigation menu.

FIG. 185 depicts a graphical user interface, including a navigation menu.

FIG. 186 depicts a graphical user interface, including a navigation menu.

FIG. 187 depicts a graphical user interface, including a navigation menu.

FIG. 188 depicts a graphical user interface, including a navigation menu.

FIG. 189 depicts a graphical user interface, including a navigation menu.

FIG. 190 depicts a graphical user interface, including a navigation menu.

FIG. 191 depicts a graphical user interface, including a navigation menu.

FIG. 192 depicts a graphical user interface, including a dimension hierarchy.

FIG. 193 depicts a graphical user interface, including elements and/or attributes.

FIG. 194 depicts a graphical user interface, including a rule.

FIG. 195 depicts a graphical user interface, including a graph.

FIG. 196 depicts a graphical user interface, including notes.

FIG. 197 depicts a graphical user interface, including a graph and cells.

FIG. 198 depicts a graphical user interface, further drilling down on an element.

### DETAILED DESCRIPTION

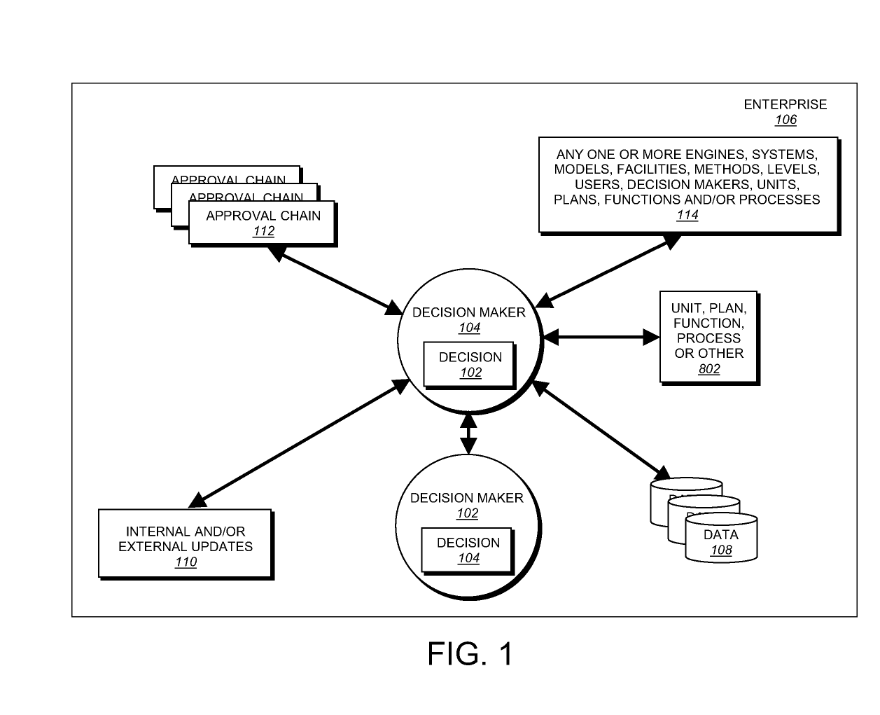

FIG. 1 depicts the various inputs to and outputs from a decision 102 that is made by a decision maker 104. The decision 102 may be any kind of decision that may be related to the goals, objectives, plans, processes, actions or conduct of an enterprise 106. The decision 102 may be related to any unit, person, plan, function, process, other aspect of the enterprise 106 or any course of action of any subset of the enterprise 106 at any level of a hierarchy that represents part of the enterprise 106. The decision maker 104 may be a unit, department, planner, process, function, person, user, system or any other element of an enterprise 106 that can make a decision 102. An enterprise 106 may be involved in a plurality of decisions 102 and have a plurality of decision makers 104. For example, an enterprise 106 may need to decide the quantity to be purchased of a certain component for one of its products. In this case the decision maker 104 may be an analyst on the procurement team or an automated supply-chain system. As another example, an enterprise 106 may need to determine whether or not to run a promotion in a certain region. In this case the decision maker 104 may be a promotions planning team or manager or the decision 102 may be made by multiple decision makers in the marketing, demand forecast and supply chain management departments.

Each decision 102 relates to the goals of the decision maker 104, which in turn may be related in some way, directly, or indirectly, to the overall goals and objectives of an enterprise 106. Each decision 102 may be based on, and each decision maker 104 may base its decisions 102 on, facts, or data 108, that characterize aspects of the enterprise 106 and the outside world that are relevant to the decision 102. An enterprise 106 may store or maintain such data 108 in one or more data facilities 108 or access data facilities 108 external to the enterprise 106 or maintained externally on behalf of the enterprise 106. For example, the enterprise 106 may maintain data 108 in databases relating to products, sales, manufacturing, supply, human resources, budgets, accounts, promotions, and the like. Each decision 102 may also be based on a decision maker's forecasts about the impacts that various actions will have, in particular on whether the actions are likely to allow the decision maker to achieve his or her goals. In the first example, in order to determine the quantity of a component to be purchased, the decision 102 may be based on, or the decision maker 104 may base its decision 102 on, in whole or in part, data 108 relating to the historical and forecasted demand for the product of which the component is a part and data 108 relating to the scarcity of the component and lead-time required for delivery. In the second example, in order to determine which promotion to run in which region, the decision 102 may be based on, or the decision maker 104 may base its decision 102 on, in whole or in part, data 108 related to the effects and impact of past promotions in relevant regions, data 108 related to the forecasted effects and impact of the proposed promotions in the relevant regions, data 108 related to the supply and distribution functions of the enterprise to ensure that adequate products and service providers will be on-hand to meet the increased demand of the promotion and data 108 characterizing the impact similar promotions have had on the other subsets of the enterprise.

In order to ensure that high-quality decisions 102 are made, an enterprise 106 and its decision makers 104 may base their decisions 102 on current data 108 and other information. In order to ensure data 108 and other information is current an enterprise 106, decision maker, systems, methods, models and the like may refresh the data 108 and information based on internal and/or external updates 110. An update 110 may be from sources internal to an enterprise 106 or based on information external to an enterprise 106 or maintained or compiled externally on behalf of an enterprise 106. External information may relate to market conditions, decisions made outside the enterprise 106, or the like.

Decisions 102 often take place, and decision makers 104 often function, within a hierarchy or chain of command, approval, or authority. Decisions 102 and decision makers 104 often rely on input from others in the approval chain 112, including from decisions 102 and decision makers 104 that may be below, above or at the same level as a given decision maker 104 in an approval chain 112. In the first example, in order to approve the quantity of a component to be purchased a decision maker 104 may require approval from a procurement supervisor and from an engineering manager, to ensure that the decision is sound and that the product requires the component in the quantities assumed. In the second example, the decision 102 may require a supervisory approval before finalizing a promotion plan, but in order to receive approval, a media buyer, who reports to the decision maker 104 may have to ensure that adequate magazine advertising space will be available.

A decision 102 or decision maker 104 may wish to account for the interactive effect of other decisions and decision makers 104 of an enterprise or other decisions 102 and decision makers 104 that are external to an enterprise 106, as well as other data and events that occur in or to an enterprise 106. A decision 102 or decision maker 104 may also utilize the wide variety of aids or decision tools 114 that assist in decision-making, including certain embodiments of the present invention. These decision tools 114 may include any one or more analytical tools, forecasting tools, statistical, technical, scientific or econometric models, statistical process management tools, other management tools, quality control tools, engines, systems, models, facilities, methods, functions and/or processes. For example, an analyst might forecast demand for a product during the twenty-seventh week of the year based on an equation that factors in the sales of the product during the twenty-sixth and twenty-seventh weeks of the previous year and the twenty-sixth week of the current year. As depicted in FIG. 1 the interactions between the decision 102 or decision maker 104 and the data facilities 108, the internal and/or external updates 110, the other decisions 102 and/or decision makers 104, the approval chain 112 and various decision tools 114 can be two-way interactions, with a decision 102 affecting an input, and vice versa.

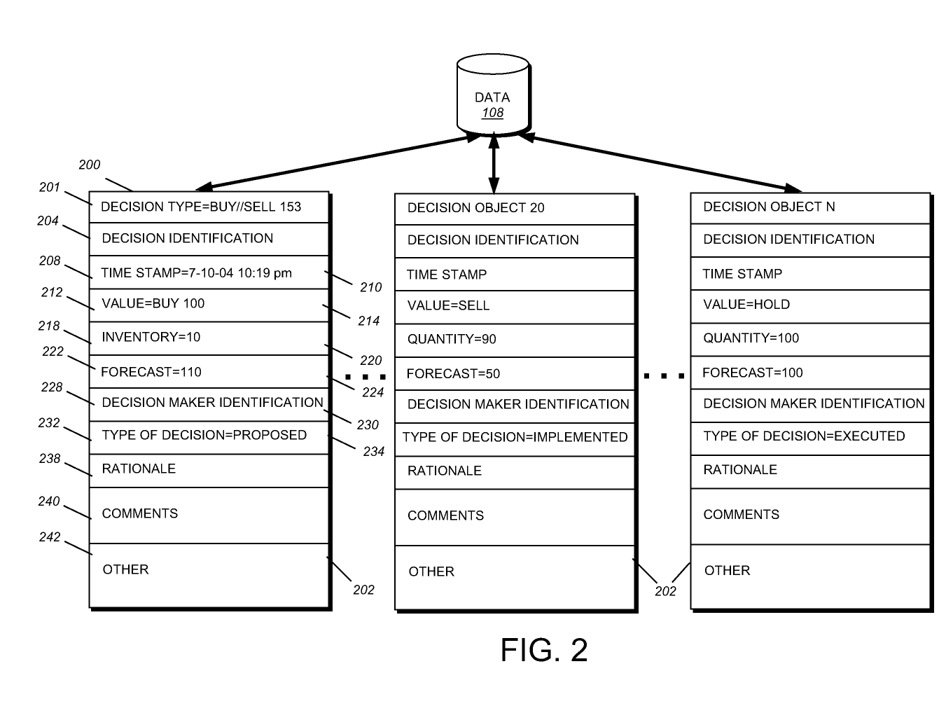

Referring to FIG. 2, a decision object 202 may be created to assist the enterprise 106 in making decisions 102 at all levels of the enterprise 106. FIG. 2 depicts various types of decisions embodied in decision objects 202 that may be stored or maintained in a data facility 108 of an enterprise 106. A decision object 202 may correspond to a decision type 200, which may be any type of decision that takes place in an enterprise 106, such as a decision 102 to buy or sell an item, a decision to hold an item, a decision to reduce or increase inventory, a decision to change prices for an item, a decision to manufacture an item, a decision to delay or cancel an order, a decision to add, keep or delete items from a category of products, a decision to add, keep or subtract a resource, a decision to reduce personnel, a decision to initiate a service, or any other type of decision. A decision type 200 can be assigned a range of attributes that logically relate to the type of decision 102. For example, a decision type 200 can be given a name 201, such as “buy/sell 153” 201 for a decision relating to buying or selling item number one hundred fifty-three in a product hierarchy of the enterprise 106. A decision type 200 can identify the attributes or classes of attributes that are relevant to that decision type 200. For example, a decision type 200 might identify a time stamp 208, a value 212, such as to represent the decision made and a related quantity, an item of data about the current state of an aspect of the enterprise 106, such as an inventory level 218 or other numerical value relevant to the decision, a forecast 222 or other data 108, such as data 108 used by the decision maker 104 as an input to the decision 102, an identifier 228 for the decision maker 104, an identifier 232 as to the finality of the decision, such as whether the decision is a prospective decision, a proposed decision or a final decision, a rationale 238, comments 240, and other attributes 242. Thus, the decision type 200 may catalog all of the variables or attributes that are relevant as inputs and outputs of a type of decision 102, or that characterize the decision, for any aspect of any hierarchy of an enterprise 106.

Once a decision type 200 has been identified, a particular decision 102 (or prospective or proposed decision) can be stored as a decision object 202, such as in a file, table or similar facility of a data facility 108 of the enterprise 106. As a decision 102 is made, the values of the various attributes of the decision type 200 can be completed and stored in the decision object 202, such as the time 210 of the decision, or when it was created, accessed or modified, the value, action or nature of the decision, such as a decision to buy one hundred units 214, a value for data 108, such as ten units in current inventory 220 or other numerical value required for the decision type 200, a value 224 representing a forecast 222 or other input, such as any input that was obtained from a decision tool 114, and a value 234, such as “prospective,” “proposed,” or “final” representing the relative finality of the decision. The example of FIG. 2 is one of a host of different decision types 200 that can allow decisions to be stored as decision objects 202 that can be stored in data facilities 108 of an enterprise 106 to facilitate better decisions 102 by decision makers 104 in the enterprise 106 as more particularly described in this disclosure. In fact, any decision 102 of an enterprise 106 can be characterized as a decision type 200 and stored in a decision object 202.

Decision types 200 and decision objects 202 can be used by an enterprise 106 in a wide variety of ways to improve decision-making and planning. For example, before a decision 102 is made, an enterprise 106 may use a decision type 200 to define the attributes of a decision that a decision maker 104 is required to consider, so that decisions 102 of a given type are made consistently by decision makers 104 and planners throughout an enterprise. A decision object 202 or decision type 200 also allows the enterprise 106 to store the attributes of prospective decisions, so that a decision maker 104 can explore the impact of various prospective decisions before proposing a decision for approval. Decision types 200 and decision objects 202 also allow the enterprise 106 to create approval processes, where a decision maker 104 responsible for approving a decision 102 that is proposed by another decision maker 104 can view a proposed decision 102, the attributes of the decision 102 as stored in the decision object 202, the values of the inputs of the decision 102 stored in the decision object 202, and the possible impact of the decision 102, such as on other aspects of the enterprise 106. Storing prospective or proposed decisions 102 as decision objects 202 also facilitates forecasting, by allowing a decision maker 104 or member of an approval chain to consider the impacts of various decisions (and to compare the relative impacts of various prospective or proposed decisions), using various models, including models of other processes or plans of the enterprise 106 that depend on the decision 102, as well as the forecasted impact of the decision 102 based on various forecasting models, such as analytical models that can take their inputs from the values of the attributes of a decision type 200 as stored in a decision object 202. Decision objects 202 also allow decision makers 104 who are responsible for approving a number of different proposed decisions 102 to review all of those decisions rapidly and in context, so that the potential interactive effects of the proposed decisions 102 stored in the various decision objects 202 can be considered, in their respective contexts, before some or all of the proposed decisions 102 are approved.

Decision types 200 and decision objects 202 can also be used by an enterprise 106 for post-decision analysis. For example, decisions 102 that result in negative outcomes can be reviewed to determine what caused the decision to be faulty, such as whether the decision failed to use correct data 108, failed to respond to an internal or external update, resulted from an incorrect forecasting model, failed to use proper input variables, failed to obtain appropriate approvals, or was a failure of judgment. In some cases a decision 102 may be correct in its own context, based on the assigned goals of the decision maker 104, but may have a negative impact unknown to the decision maker 104. Storing decisions 102 as decision objects 202 makes it possible to store decisions along with the entire context, so that the reasons for past mistakes can be analyzed accurately. Post-decision analysis of decision objects 202 can be used for a variety of purposes, such as training new personnel by describing and classifying good and bad past decisions, identifying trends in the impacts of past decisions, such as to update forecasting models, identifying unforeseen impacts of past decisions on other aspects of an enterprise, identifying the effects of compensation models on decisions, identifying logical connections between decisions 102 and other aspects of an enterprise, and evaluating and rewarding performance of decision makers 104. As attributes of past decisions 102 are better understood, decision types 200 can be updated, as can decision processes 300, compensation models and approval chains.

In the example of FIG. 2, the decision type 200 is for a decision 102 to buy or sell a particular component, component number one hundred fifty-three in the component hierarchy of an enterprise 106. The decision object 202 captures the decision 102. For example, the decision maker 104, here a buyer, decides to buy the component. At the time of the decision (Jul. 10, 2004 at 10:19 p.m.), the decision maker 104 might check a decision tool 114 and see that the forecast demand for item one-hundred fifty three is one-hundred ten, so the forecast value one-hundred ten 224 is stored in the forecast attribute 222 of the decision object 202 of the decision 102. The buyer might then check current inventory, such as by checking an inventory database 108 of the enterprise 106 and determine that current inventory is ten 220, after which the value ten 220 can be stored with the inventory attribute 218 of the decision object 202. Seeing that the forecast demand value 222, 224 exceeds the current inventory 218, 220, the buyer can decide to buy one hundred units 212, 214 to cause inventory to meet demand. The buyer can store the rationale 238 with the decision object 202, such as “purchased units to meet demand based current inventory and demand forecast from decision tool.” Cataloging and storing the attributes of decisions in decision objects 202 that correspond to decision types 200 facilitates improved decisions 102 by decision makers 104 of the enterprise 106. For example, if the decision object 202 for the decision 102 made in FIG. 2 is stored as a proposed decision, then another buyer can see that the decision maker 104 proposes to bring inventory to a level that meets the forecasted demand, allowing the second buyer to wait until the decision is final before ordering more of the item. Similarly, an executive of the enterprise can review the proposed decision in view of other factors, such as knowledge that the forecast demand is likely to be inaccurate, because another department is engaging in actions that will increase the demand forecast, such as price reductions. Also, decision objects 202 allow managers to revisit decisions and review them in the context in which they were made, including viewing the relevant inputs to the decision, to assist in improving the decision-making skills of their employees. For example, a manager can identify the decision 102 and the decision maker 104 and can revisit the decision object 202 later, in context, along with the stored rationale 238. For example, the rationale might have been that the decision maker 104 knew that there was a promotion planned for promoting the product, so the decision maker 104 may have forecasted increased demand in the region, meaning the decision maker 104 decides to buy more components and build more products. The promotion might be planned for some time in the future, but other data might suggest that the price of the component will rise in the future, so it may make sense to stock up now. When the decision 102 appears to have been erroneous, a manager can revisit the decision object 202 and review the rationale 238. For example, the manager might find that although inventory is now too high because of the decision maker's decision to buy, the high inventory resulted from the fact that the planned promotion was not run, not from a poor decision by the decision maker 104. Thus, decision objects 202 facilitate decision analysis, both before and after decisions are made.

Decision objects 202 also facilitate continuous planning on the part of the enterprise, with each decision 102 being stored and rapidly propagated through the enterprise 106, so that other decisions 102 that depend on a particular decision 102 rapidly reflect the effects of the first decision 102. Certain attributes and benefits of continuous planning are discussed elsewhere in this disclosure.

For each decision type 200 of an enterprise 106, the various attributes of the decision type 200 catalog the one or more variables that are relevant to the decision in a plurality of decision objects.

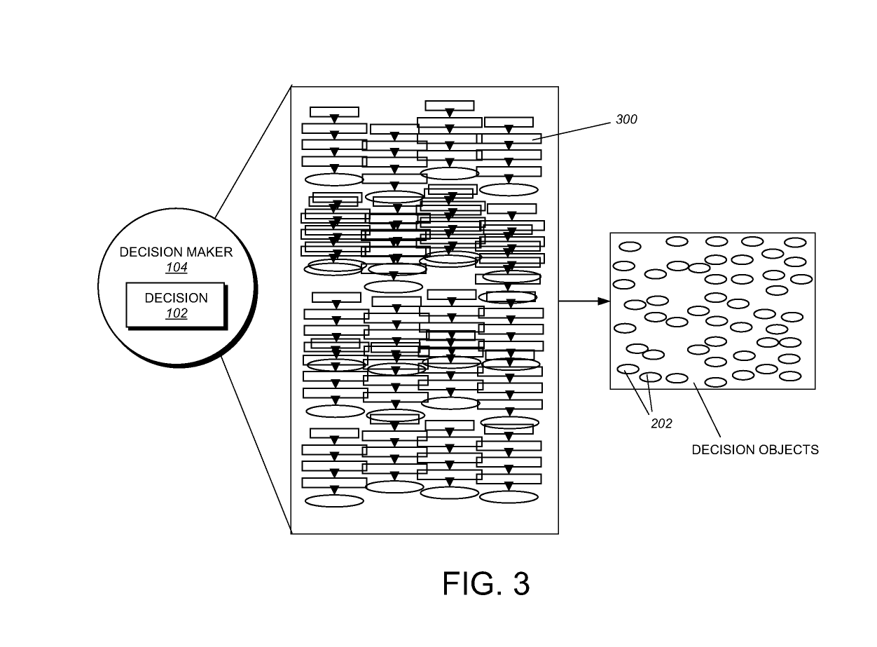

Referring to FIG. 3, the decisions of an enterprise 106 may reside in a host of decision processes 300, each of which is comprised of multiple decisions 102. FIG. 3 depicts decisions 102 and decision makers 104 operating in a plurality of decision processes 300 that result in decision objects 202 that represent prospective, proposed and final decisions. The decision processes 300 may take place in all levels of an enterprise and may relate to one or more hierarchies of the enterprise, such as an organizational hierarchy, a product hierarchy, a management hierarchy, a personnel hierarchy, an approval chain, a decision process, a service hierarchy, or a hierarchy relating to a plan, a unit, a division or a function of the enterprise. As compared to the simple decision 102 captured in the decision object 202 in the example of FIG. 2, the real decisions 102 of an enterprise 106 are numerous, complex, and interrelated. The decisions 102 happen on a continuous basis and are made by different decision makers 104, who plan and make decisions according to different goals and objectives and over different time horizons. For example, the decision of a sales person to sell an item at a reduced price may result in changes in inventory (as goods are sold), which impacts the decisions of the supply chain manager (who is responsible for keeping items in stock), which affects the decisions of a product market manager (who is responsible for determine whether to raise or lower the published prices for an item). Not only are the decision processes 300 interrelated, in that one decision 102 affects many other decisions 102, but each decision process 300 may be governed by specific inputs, data 108, decision tools 114, goals and objectives that vary from the inputs, data 108, decision tools 114 and goals and objectives of other decision processes 300. For example, the goal of the sale person may be to maximize total revenue in order to maximize commissions, and the sales person's data 108 and tools 112 may be limited to knowing what items are available, what customers might be interested in the item and at what price the sales person is allowed to offer the items. Meanwhile, the goal of the supply chain manager may be to reduce the average number of weeks of inventory on hand of an item, and the supply chain manager may only have access to a forecast of demand from a decision tool 114 that is based on the demand for the product from a previous period. Similarly, a marketing manager may have a goal of maximizing market share, and the marketing manager may only have access to a forecast of demand from a decision tool 114 (which might be a different decision tool 114 from the one used by the supply chain manager) as well as data about the cost of the product and the list price for the product. Meanwhile, an executive responsible for the product line might be seeking to maximize margin dollars for the product line, and an executive responsible for the entire enterprise 106 may be seeking to maximize profits for all product lines of the entire enterprise. Needless to say, when the differences in the data 108, tools 114, goals and objectives of the different decisions makers 104 are added to the effects that one decision has on another, there is a high likelihood of decisions being made that diverge from the decisions that would be made if all decision makers 104 had consistent data 108, tools 114, goals and objectives and if all decision makers 104 were sensitized to the effects that their decisions had on the other decision makers 104 and the enterprise 106 as a whole.

Decision objects 202 allow proposed and actual decisions 102 to be stored and propagated around an enterprise 106, such as for review by decision makers 104 who are making other decisions 102. Storing the rationale for a decision 102 allows another decision maker 104 or reviewer to identify faults in the rationale (such as if the rationale is based on a planned promotion that will not in fact be conducted), so that a decision can be rejected or reversed before too much damage is done. Over time, as the impacts of proposed decisions are identified to decision makers 104 and as decisions that have negative impacts are rejected, decision makers 104 can learn to make decisions that have positive, rather than negative, impact on the other aspects of the enterprise. Also, managers can adjust the goals, compensation schemes and decision processes 300 of their employees, so that decisions more accurately reflect the goals of the enterprise as a whole. The overall effect can be to continually improve the decisions 102 of the enterprise 106.

It is often the case that an enterprise 106 contains many disparate, or at best partially coordinated, decision makers 104 making decisions 102 for the enterprise 106. Some enterprises 106 endeavor to manually coordinate the various decision makers 104, but as discussed above, an enterprise 106 may have to make many decisions, each of which can be very complicated. At best the decisions 102 may be based on a subset of the relevant information. As a result, the attempts at manual coordination of decision makers 104 can fail and result in poor decisions 102 that may conflict with the goals and objectives of the enterprise 106. In addition, the attempts at manual coordination and integration are time consuming and labor intensive, resulting in increased transaction costs and diminished enterprise resources.

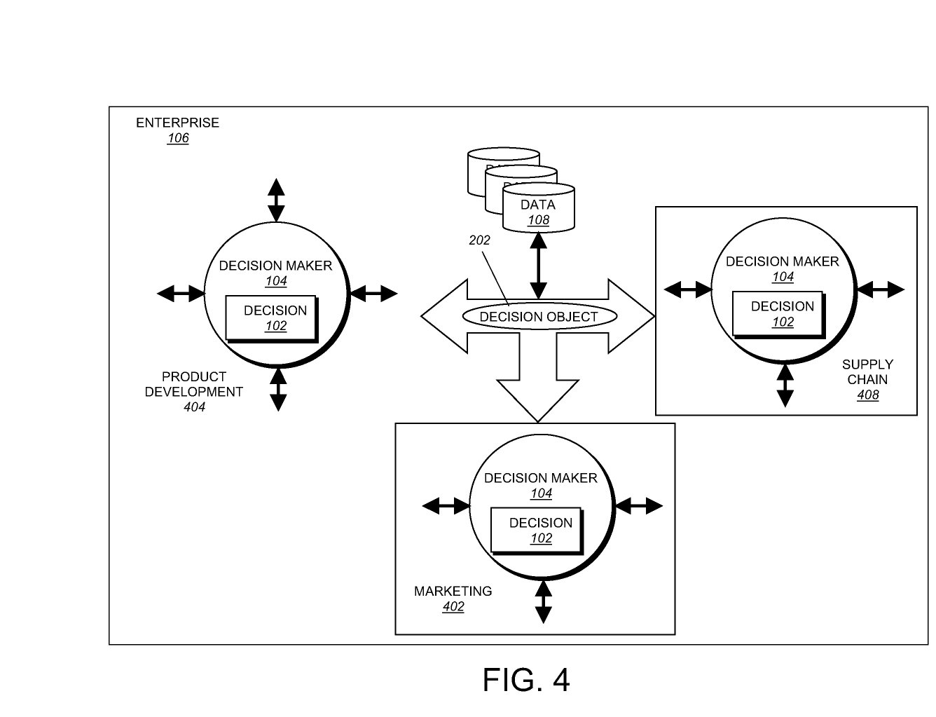

For example, referring to FIG. 4, the marketing department 402 of an enterprise 106 may choose a new product for promotion that was featured in the monthly bulletin sent out by the product development department 404 of the enterprise 106. Several days after the bulletin went out, the product development department 404 may have decided to halt development of the product selected for promotion by the marketing department 402. By the end of the week the marketing team 402 may have finished planning the promotion based on the information in the bulletin, and the ads may have begun to run. A week may have passed before a manager in the product development department 404 noticed one of the ads in a newspaper and contacted the marketing team 402. If the marketing team 402 and product development department 404 had been integrated through an enterprise planning method and the decision had been embodied in a decision object, sent out in a timely manner for approval by all relevant parts of the enterprise 106, the situation could have been avoided. The monthly bulletin was not current enough. Organizations often introduce regular meetings, reports, communication processes and approval chains to address the problems of asymmetric information in an enterprise 106. Unfortunately, while efforts at coordination can work to some extent, often the decision makers 104 who make decisions 102 are not as closely connected as in the simple example of a product development department 404 and marketing department 402 that work on the same product. For example, the supply chain side of an enterprise 106, the marketing department 402 and the sales organization may only have relatively infrequent contact. Even within a department employees may have relatively infrequent contact if their jobs do not permit frequent meetings or internal communications. These types of disconnects are further compounded in large or international organizations where various decision makers may be distributed around the world, speak different languages and operate on schedules with very little overlap in the work-day.

Referring to FIG. 4, the creation of a decision object 202 can facilitate coordination of different aspects of an enterprise 106. A decision object 202 can draw values for data from a common data facility 108, so that all aspects of the enterprise use the same, fresh data before making decisions of the decision type 200 for a particular decision object 202. The decision object 202 can be communicated among departments, such as the marketing department 402, product development department 404 and supply chain department 408 of FIG. 4, or any other units, departments, groups, teams, persons, or other aspects of an enterprise 106. By assigning appropriate attributes to a decision type 200, the decision object 202 can be populated with appropriate data 108 from the best data facilities 108 of the enterprise 106, can take into account the goals of the enterprise, can take into account the preferred decision processes 300, as well as internal and external updates, and can be based on preferred forecasting methods. By placing the decision object 202 into the appropriate decision processes 300, the decision object 202 can be employed with the assurance that the various aspects of the enterprise 106 are making coordinated decisions that support higher-level goals of the enterprise 106.

Once an enterprise 106 defines decisions 102 according to decision types 200 and captures decisions as decision objects 202 for storing, manipulation, approvals, review and the like, other challenges remain. One challenge that remains for an enterprise 106 is that different aspects of the enterprise 106 employ widely varying decisions 102, tools 114 and types of data 108 to accomplish varying goals and objectives. As a result, even if decisions are classified well, stored in a well-updated common repository, and communicated effectively, differences in how the different aspects of the enterprise 106 view data 108 and differences in their respective goals and objectives can result in conflicts, even if each unit or department makes good decisions according to its own terms. Accordingly, a need exists to more effectively link the decisions 102 and decision processes 300 of the various units, divisions, functions, decision makers 104, plans, processes and other aspects of an enterprise 106 to the highest-level objectives of the enterprise 106.

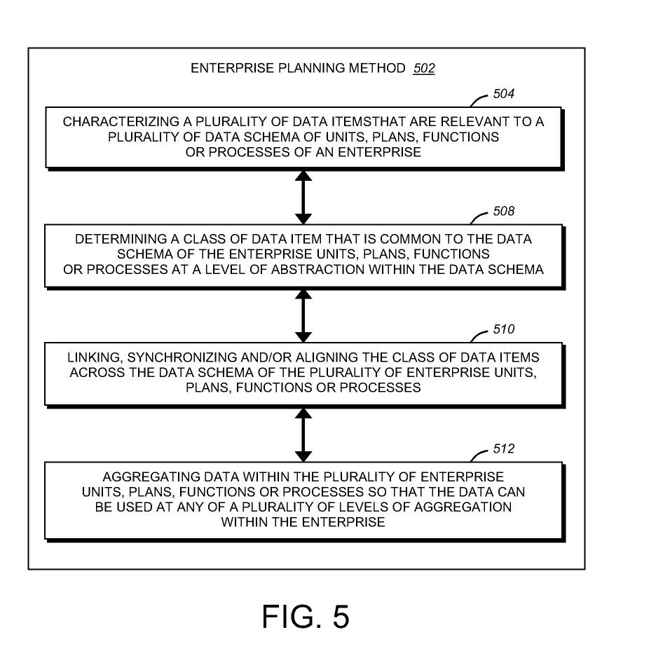

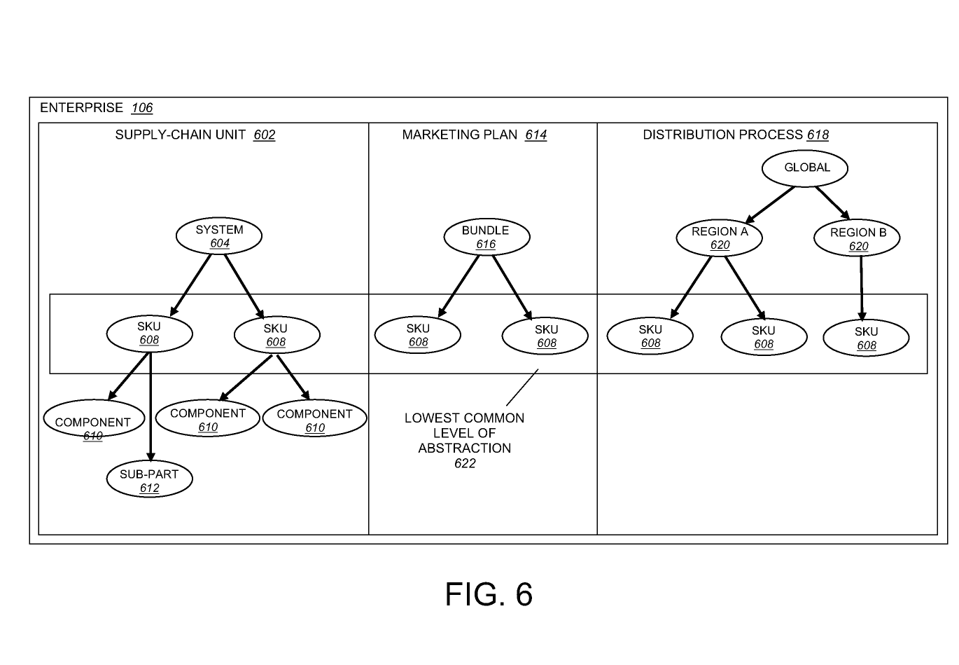

FIG. 5 is a simplified high-level flow chart 500 depicting the various steps of an enterprise planning method 502 that assists in more effectively connecting the many various decisions 102 of an enterprise 106 to the high-level plans of the enterprise 106. In the first step 502 of the method a plurality of the data items and schema that are relevant to the decisions or planning of the units, plans, functions and/or processes of an enterprise 106 are characterized. For example, the data schema of an aspect of an enterprise 106 may be characterized in data fields that are organized into various hierarchies, such as hierarchies related to products, services, personnel, resources, authority, geography, or the like. For example, as depicted in FIG. 6, a unit of an enterprise 106 may be a supply-chain unit 602 and the data schema may be a list of, and the hierarchical relationship between, the various systems 604, stock keeping units 608, components 610, and sub-parts 612 that relate to the products or components for which the supply chain unit 602 is responsible for procurement. Similarly, the data schema of a plan of an enterprise 106 may include data related to timelines, products and delivery dates. For example, as depicted in FIG. 6, the plan may be a marketing plan 614, and the data schema may be a list of, and the hierarchical relationship between, the various product bundles 616 that are composed of stock keeping units 608. The data schema of a function of an enterprise 106 may include data fields for specifying the subset of the enterprise 106 to be acted upon, the objectives of the function and the effects the application of the function may have on other parts of the enterprise 106. The data schema of a process of an enterprise 106 may include data related to the steps in the process, the order of the steps in the process, the aspects of the enterprise 106 that are impacted by the process, and a list of interrelated plans and functions. For example, as depicted in FIG. 6, the process may be a distribution process 618, and the data schema may include a hierarchy of the various regions 620 to which various stock-keeping units 608 are to be distributed. In any enterprise 106, a host of different hierarchies and data schema are possible, which may be organized into relational or object-oriented databases, organizational charts, approval chains, decision processes, trees, such as decision trees, graphs, such as directed graphs, flow diagrams, Venn diagrams, and other representations of hierarchies of data. However, for any given enterprise 106, a few types of data are likely to be used in many different aspects of the enterprise 106, such as data relating to products, costs, prices, and timeliness.

Referring again to FIG. 5, in the second step of the method 504 a class of data item that is common to the data schema of one or more enterprise units, plans, functions and/or processes is determined. Referring to FIG. 6, this common class of data item can be conceptualized as the lowest common level of abstraction 622 of the one or more enterprise units, plans, functions and/or processes. For example, as depicted in FIG. 6, the lowest common level of abstraction 622 may be stock-keeping units, or SKUs, 608. Stock keeping units 608 are common to the supply-chain unit 602, marketing plan 614 and distribution process 618. That is, while the supply chain unit 602, marketing plan 614 and distribution process 618 have different goals and objectives, decision tools 114 and decision processes 300, each of them uses a stock-keeping unit 608 as a fundamental component of its decisions. Thus, the stock-keeping unit 608 is a candidate for linking, synchronizing, integrating, aggregating and/or aligning the decisions 102 and data 108 of the various enterprise units, plans, functions and processes that use the stock keeping unit 608 in their respective data schema.

Referring again to FIG. 5, the third step 508 involves logically linking the common class of data items across the data schema of the plurality of enterprise units, plans, functions and/or processes. That is, two decisions 102, processes 300 or plans, residing in two different parts of the enterprise 300, may be logically linked to each other, so that changes in a data item that are relevant to one unit, plan, function or process can be shown automatically in the other enterprise units, plans, functions and/or processes that use the common class of data items. In the example depicted in FIG. 6, the level of stock keeping units 608 may be used to link, synchronize, integrate, aggregate and/or align the data across the supply-chain unit 602, marketing plan 614, and distribution process 618. This linking, synchronizing, integrating, aggregating and/or aligning may allow a given decision maker 104 of the unit, plan or function of the enterprise 106 to benefit from the information of the other decision makers 104 of the enterprise 106, such as the supply-chain unit 602, marketing plan 614, and distribution process 618 depicted in FIG. 6, but including any other aspects of the enterprise 106. This logical linking may also allow for the decision makers 104 to coordinate their efforts in the absence of meetings or other direct coordination efforts. Each decision maker 104 is simply presented with fresh information and data 108 in decision objects 202 that account for the actions or proposed actions of the other decision makers 104 in the logically linked. For example, a marketing manager can see what the supply chain manager proposes to have in inventory for a given SKU as of a given date, and the supply chain manager can see when and if the marketing manager proposes to conduct a promotion on a particular SKU. The linking may be based on know relationships, historical data, forecasted data, projections, plans, expected relationships and the like.

In addition to allowing a decision maker 104 in one decision process 300 to see the impact of a decision in a linked process 300, logically linking two processes 300 according to a common class of data items also results in the synchronization of enterprise plans, so that when the enterprise aggregates data from various plans, the data are consistent, and the overall enterprise plans accurately reflect the collective results of various decision processes 300. Thus, data for various processes 300 are linked, synchronized, integrated, aggregated and/or aligned so that the data can be used at any of a plurality of levels of aggregation within the enterprise. In the example depicted in FIG. 6, at a high level of aggregation the chief financial officer and several vice-presidents of an enterprise may want to predict profits for the next quarter. Thus, executives at the tope of any of the linked processes 300 can view the processes consistently at various levels of abstraction.

The linking of processes 300 by common data items allows decision makers 104 to automatically view the effects of proposed or final decisions as the decisions are made by decision makers 104 from other parts of the enterprise 106. In addition, the linking allows decision makers 104 to see the effects of data 108, such as data 108 changes based on changes in the world as reflected by external updates. Any change is automatically propagated through the enterprise 106 to all parts of the enterprise 106 that use the class of data that is changed. Not only can the impact of a single decision 102 be analyzed by being linked to other decisions 102, a decision maker 104 can view the impact of any proposed decision throughout various domains of the enterprise 106. Thus, for example, a decision to offer a promotion can be logically linked to a sales forecast (which would go up based on an increase in forecast demand for a product—a variable that is shared with the promotion planning process) and to a demand plan (which would forecast a need for increased inventory based on the increased sales forecast based the shared demand variable). A decision to hire an employee could be logically linked to a sales forecast (which may share the variable headcount with the hiring process and which may logically link anticipated sales to the number of sales people). The logical linking of different processes 300 is supported by the linking of data in data facilities 108 of the enterprise. The same data 108 may be aggregated or manipulated according to the logical linking to produce data according to the shared data schema of various processes 300 of the enterprise 106. For example, demand for a product may be calculated based on the sum of demand for the product as a standalone product and demand for the product in a bundle with another product. A promotion for the bundle based on the forecast demand can be logically linked to demand for the product as a whole by taking total demand and subtracting out the standalone demand to arrive at the bundle demand. Meanwhile, a supply chain manager may only care about total demand, because the supply chain manager has to order the product and does not care whether it ends up in a bundle or not. In other cases the supply chain manager might need to know which products are bundled and which are not, so that changes can be made at the manufacturer (such as labeling changes). In such as case, the logical linking between bundle demand and standalone demand remains the same, but the supply chain manager may choose to operate using data at a different level of the hierarchy.

Using the enterprise planning method 502 with stock keeping units as the lowest common level of abstraction 622 the executives will be able to forecast high-level enterprise performance metrics, such as profits from the SKU 608. The data 108 from the supply-chain unit 602 can be used to predict the available supply of a stock-keeping unit 608 for the next quarter and the cost of getting the SKU 608 manufactured and transported to customers. The data 108 from the marketing plan 614 can be used to forecast changes in demand for certain stock keeping units 608 in response to pricing changes, placement of advertisements, product changes in the SKU 608, and promotional activities, as well as the costs of promoting the stock keeping unit 608. The data 108 from the distribution process 618 can be used to predict the quantities of the stock keeping unit 608 that will be sold during the quarter, as well as the effects of commissions, volume discounts, rebate programs and the like. Thus, using the lowest common level of abstraction, the executives using the enterprise planning method can aggregate the information from the various data facilities 108 of the different departments and make a prediction as to the profit that will arise from the SKU and any other SKUs that will be offered by the enterprise.

As discussed above, FIG. 6 depicts the lowest common level of abstraction 622 for various subsets of an enterprise 106. In FIG. 6, this includes a supply-chain unit 602, a marketing plan 614 and a distribution process 618. In this example, the lowest common level of abstraction 622 is the stock keeping unit level 608. The lowest common level of abstraction 622 may also be multidimensional, for example, stock keeping units per region or stock keeping units per region per day. In the example, the additional dimensions would allow the executives to predict profits by day, which may allow the enterprise planning method 502 to take into account information and data 108 that is external to the enterprise 106 but may be relevant to one or more decision processes 300. For example, if the stock-keeping units 608 corresponded to merchandise related to various sports teams, the enterprise would be able to update its forecasts based on which teams were winning in which regions. These additional dimensions may improve the quality and resolution of the decisions 102 of an enterprise 106. However, if the extra dimensions are not needed their inclusion may just complicate and increase the costs of the enterprise planning method 502.

In addition to use of the linked, synchronized, integrated, aggregated and/or aligned data by the executives, decision makers 104 in each of the units, plans, functions and/or processes to be linked, synchronized, integrated, aggregated and/or aligned can benefit. For example, the managers in the supply-chain unit 602 can see proposed marketing plans and adjust supply accordingly. The managers of the distribution unit can see the proposed marketing plans and supply-chain forecasts and adjust distribution capacity accordingly. The marketing plan 614 decision makers 104 can then see that the enterprise 106 has sufficient resources on hand to support their decisions 102 before they implement the marketing plan. The benefits of the method 502 will be discussed more particularly in connection with certain other embodiments disclosed herein.

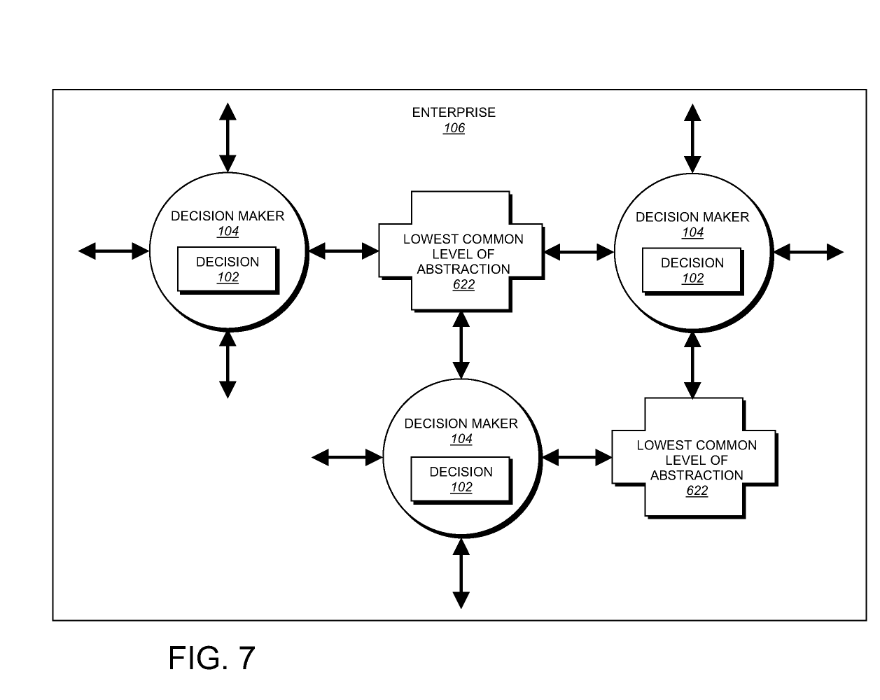

FIG. 7 depicts the application of the enterprise planning method 502 to various decisions 102 and decision makers 104 of an enterprise 106. The enterprise planning method 502 can be used to link, synchronize, integrate, aggregate and/or align one or more decisions 102 and decision makers 104 using one or more lowest common levels of abstraction 622. Referring back to FIG. 4., if the marketing team and production department had been integrated through an enterprise planning method and the decision had been embodied in a decision object 202, automatically sent out for approval by all relevant parts of the enterprise 106, the situation could have been avoided. In embodiments, the lowest common level of abstraction 622 may be products by stage of development or simply products. The marketing team would have seen that the production department cancelled the product and they could have changed their marketing plan accordingly. Alternatively, the production department could have seen the marketing team's demand forecast information and data 108 in response to the promotion, causing them to revisit their decision 102. The production department could have revisited the assumptions specified in the relevant decision object 202 and realized that the demand forecast was incorrect. With the updated demand forecast, accounting for the promotion, it may have been wise sense to move forward with production of the product.

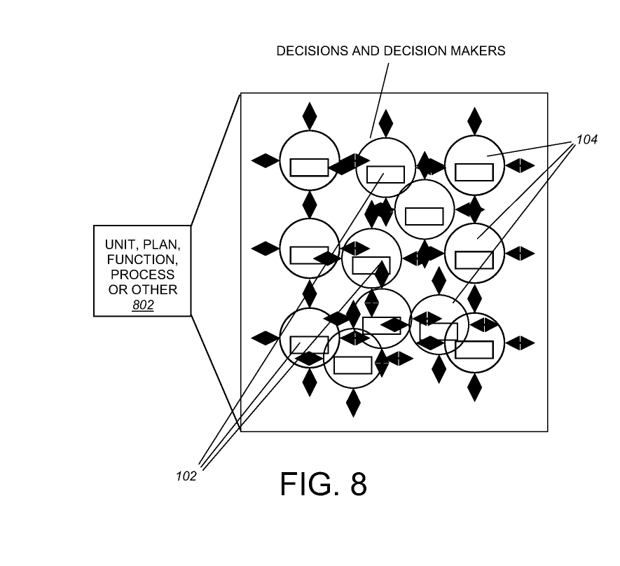

Referring to FIG. 8, an enterprise 106 can be composed of various units, plans, functions, processes or other subsets 802. FIG. 8 depicts a unit, plan, function, process or other subset of an enterprise 802 as a plurality of decisions 102 and/or decision makers 104. The decisions 102 and decision makers 104 of a unit, plan, function, process or other subset of an enterprise 802 may be interrelated, may have an order or hierarchy, and/or may work together or be decided in series or parallel. The various decision makers 104 make decisions 102 based on the information and data 108 available to them at the time of the decision 102 and the goals and objectives of the enterprise 106 as perceived by the decision maker 104. For example, the unit, plan, function, process or other subset of an enterprise 802 may be the product development unit. The decision makers 104 may be inventors, managers, administrative assistants and members of the unit responsible for the profitability of the products. The decisions 102 may involve deciding on the types of products to produce, the types of products which can be produced given the technology of the enterprise, the types of technologies to purchase and the direction of the market and demand.

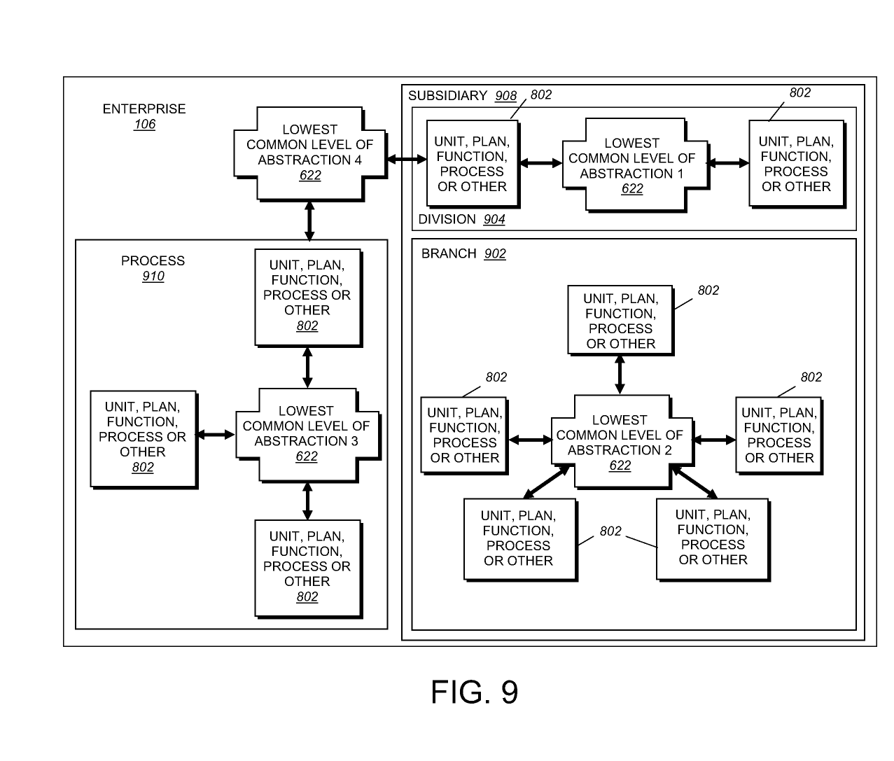

FIG. 9 is a simplified high-level schematic diagram which represents an enterprise 106 in terms of units, plans, functions, processes and/or other subsets of an enterprise 802. The units, plans, functions, processes and/or other subsets of an enterprise 802 may be linked, synchronized, integrated, aggregated and/or aligned using one or more lowest common levels of abstraction 622. Several units, plans, functions, processes and/or other subsets of an enterprise 802 may be linked, synchronized, integrated, aggregated and/or aligned through a lowest common level of abstraction 622. These linked, synchronized, integrated, aggregated and/or aligned units, plans, functions, processes and/or other subsets of an enterprise 802 may then be linked, synchronized, integrated, aggregated and/or aligned with other units, plans, functions, processes and/or other subsets of the enterprise 802 using another lowest common level of abstraction 622 which is common to at least one of the linked, synchronized, integrated, aggregated and/or aligned units, plans, functions, processes and/or other subsets of an enterprise 802 and the one or more units, plans, functions, processes and/or other subsets of an enterprise 802 to which they are to be linked, synchronized, integrated, aggregated and/or aligned. The various units, plans, functions, processes and/or other subsets of an enterprise 802, whether or not linked, may form various levels of an enterprise 106, such as a subsidiary, affiliate, division, branch, team or other unit, plan, function, process and/or other subset of an enterprise 802.

For example, in one embodiment, the enterprise 106 could be a financial institution such as a bank. A lowest common level of abstraction 622 may be customers per region which may link, synchronize, integrate, aggregate and/or align five units, plans, functions, processes and/or other subsets of an enterprise 802 to form a branch 902. Two units, plans, functions, processes and/or other subsets of an enterprise 802 may be linked by the lowest common level of abstraction 622 of profit per customer per region to form a division 904. One of the units, plans, functions, processes and/or other subsets of an enterprise 802 of the branch 902 may also incorporate profit per customer per region as a level of abstraction, thus, allowing the enterprise planning method 502 to link, synchronize, integrate, aggregate and/or align it with the units, plans, functions, processes and/or other subsets of an enterprise 802 of the division 904. The division 904 and the branch 902 together may form a subsidiary 908, another level of abstraction of the enterprise 106. Several other units, plans, functions, processes and/or other subsets of an enterprise 802 may be linked, synchronized, integrated, aggregated and/or aligned through the lowest common level of abstraction 622 of subset of enterprise acted upon to form a process 910. The process may be linked, synchronized, integrated, aggregated and/or aligned to a unit, plan, function, process and/or other subset of an enterprise 802 of the division 904 through a lowest common level of abstraction 622 which may be processes of the division.

It may often be the case that various units, plans, functions, processes and/or other subsets of an enterprise 802 which have similar goals or functions are more easily linked, synchronized, integrated, aggregated and/or aligned than units, plans, functions, processes and/or other subsets of an enterprise 802 which have widely varying goals or functions. Through the process of linked, synchronized, integrated, aggregated and/or aligned the linked, synchronized, integrated, aggregated and/or aligned groups of units, plans, functions, processes and/or other subsets of an enterprise 802 an enterprise wide enterprise planning method may be implemented.

An enterprise may contain a plurality of, network or standalone, computer, laptops, machines and devices. An enterprise may contain one or more networks and/or one or more data facilities 108. An enterprise may be linked to data 108, the Internet, external resources or other items via a network or other means. An enterprise may also contain one or more analytical tools 114, intelligent decision engines 4502, decision collaboration engines 5702, implementation engines 7602, decision tracking facilities 9302 and/or enterprise planning methods 12000.

An enterprise may contain a dimension hierarchy function 1002. The dimension hierarchy function 1002 may allow for the placement of an element, object, item, idea and/or any subset of an enterprise 4412 in one or more hierarchies or structures. The placement may be defined by a user 2608, system 2610 and/or decision maker 104 and/or may be based on the characteristics, relationships and/or interactions of the elements, objects, items, ideas and/or any subsets of an enterprise 4412. The dimension hierarchy function 1002 may display any hierarchy or structure using a graphical user interface. A graphical user interface associated with the dimension hierarchy function 1002 may allow a user 2608, system 2610 and/or decision maker 104 to place elements, objects, items, ideas and/or any subsets of an enterprise 4412 into different hierarchies and structures. For example, an element “plantID004” which is the identifier for a manufacturing plant of the enterprise may belong to a hierarchy of plants organized by region and a hierarchy of plants organized by the analysts assigned to monitor the plant.

An analytic engine 1004 may apply one or more functions to the data 108 or a subset of the data 108. The functions may be applied with the same of different weights and to different subsets of the data 108. The application of the analytic engine 1004 may be initiated or controlled by a user 2608, system 2610 and/or decision maker 104 and/or may be based on the characteristics, relationships and/or interactions of the elements, objects, items, ideas and/or any subsets of an enterprise 4412. For example, the analytic engine 1004 may function as a calculator and multiply all values selected by the user 2608 by a number specified by the user. The analytic engine 1004 may also calculate, estimate, generate, and/or forecast values or a series of values, based on historical or forecast data 108 and/or methods, models, algorithms, systems 2610 and the like.

An allocation engine 1008 may allow for the allocation of goods, products, services, resources, capacity, and the like below the lowest common level of abstraction 622 or an arbitrary level of abstraction. An allocation engine 1008 may function based on parameters, logic, algorithms, and the like. For example, the lowest common level of abstraction may be product per plant per region. The allocation engine 1008 may allow for allocation of production requirements among the individual workers in a plant, based on their past work performance.

A rule engine 1010 may execute rules specified by a user 2608, system 2610, decision maker 104, system architect, and/or any subset of an enterprise 4412. A rule engine 1010 may act based on natural, enterprise-related, and/or user-defined, system-defined and/or decision maker-defined conditions, constraints and/or restrictions. For example, production at a certain factory may require a lead time of three weeks. An analyst may be blocked from requesting output from this factory during this three week period.

A comparison engine 1012 may perform comparisons involving the data 108, one or more subsets of the data 108 and/or other subsets of an enterprise 4412. A comparison engine 1012 may allow for the comparison of actual and expected or forecasted results. A comparison engine 1012 may also allow for the comparison of various forecasts. The comparison engine 1012 may utilize statistical or mathematical analytics, systems 2610, methods and/or models. A comparison engine 1012 may generate a report or summary that may include charts and/or graphs. For example, a comparison engine 1012 may compare various demand forecasts and emphasize differences and the likely effects of the differences in those forecasts. In this manner, the comparison engine may present the variance or variations between different versions of a decision, such as a prospective, proposed, executed and/or implemented decision. A comparison engine 1012 may also compare the performance of various analysts over time.

A feedback engine 1014 may provide suggestions, recommendations and/or advice in connection with prospective, proposed, executed and/or implemented decisions, assumptions, data, weightings, methods and the like. A feedback engine 1014 may provide feedback at set intervals such as weekly, daily, hourly or in real-time. A feedback engine 1014 may allow for improved forecast accuracy by notifying the decision maker 104 of any new information in real time and providing an iterative feedback process as decisions 102 are being made. A feedback engine 1014 may interact with an alert function 1016 to provide alerts. Feedback may be provided in the form of an alert. An alert may be in response to an internal or external event of condition. An alert may directed at one or a plurality of users 2608, systems 2610, decision makers 104 and/or subsets of an enterprise 4412. An alert may be provided using a protocol, a database protocol, an Internet protocol, a computer language, code, email, voicemail, telephone, text message, SMS, on-screen, a symbol, an icon, window, audio, alert, alarm, vibration, smell, taste and/or any other means of communication. An alert may be private or public. A user 2608, system 2610, decision maker 104 and/or subset of an enterprise 4412 may provide alerts to one or more other users 2608, systems 2610, decisions makers 104 and/or subsets of an enterprise 4412. There may be rules regarding the subsets of an enterprise 4412 that may provide alerts to a certain other subset or subsets of an enterprise 4412. For example, a supervisor may create many alerts monitoring the inventory levels of certain products. The supervisor may share or assign certain of these alerts to certain analysts. When the inventory for a given product falls below a certain level the analyst will be alerted to the situation. The supervisor will also be alerted to the situation. Depending on the type of alert set by the supervisor, the analyst may or may not know that the supervisor also received the alert as well. If the analyst does know that the supervisor received the alert as well, he may be add a comment to the relevant decision explaining the situation, the steps being taken and then the problem will likely be resolved. The supervisor can quickly review this and will be fully apprised of the situation without directly contacting the analyst. In this example, it may be that analysts to not have the ability to set alerts for their supervisors but do have the ability to set alerts for themselves and other analysts. The analysts may set alerts themselves and each other that are triggered before those set by the supervisor. In this manner the analysts may corrected or address potential problems before they rise to the level at which the supervisor is notified.

A prioritization engine 1018 may prioritize or identify tasks that require attention and may place them in order of priority. A prioritization engine 1018 may function based on algorithms, data 108, artificial intelligence and/or preferences, profiles and/or templates specified by users 2608, systems 2610 and/or decision makers 104. A prioritization engine 1018 may determine the task that it is most efficient to work on next. A prioritization engine 1018 may provide one or more reports, charts alarms and/or dashboards. For example, at the start of a work day a supervisor may be presented with several alerts, proposed decisions 102 and other information requiring attention. The prioritization engine 1018 may order, or offer suggestions for the order in which to deal with, the various tasks. The prioritization engine 1018, following a preference in the supervisor's profile that alerts are to be addressed before proposed decisions, may present the alerts before the proposed decisions. The prioritization engine 1018 may determine which alerts are most critical by examining the difference between the value of the metrics relevant to the alert and the value at which the alert was to be triggered. The prioritization engine 1018 may also consider how vital, or closely connected, the metric is to the health of the enterprise. The prioritization engine 1018 may then order the proposed decision objects 4102 in order of the time zone impacted by the decision 102. Decisions 102 impacting time zones nearing the end of the business day will be presented to the supervisor first.

An analytic workbench 1020 may aid in the analysis and support the various analytical tools 114. The systems and/or methods may use one or more orthogonal dimensions 1022 in order to consolidate various metrics, measures and/or functions. An orthogonal dimension 1022 is generally a set of instructions specifying how to link a set of metrics, measures, and/or functions together over a range, how to map a set of metrics, measures, and/or functions to one another, and/or how to integrate a set of metrics, measures, and/or functions. The set of metrics, measures, and/or functions may be any two or more metrics, measures, and/or functions. The set of metrics, measures, and/or functions may also be a single metric, measure, and/or function over a range.

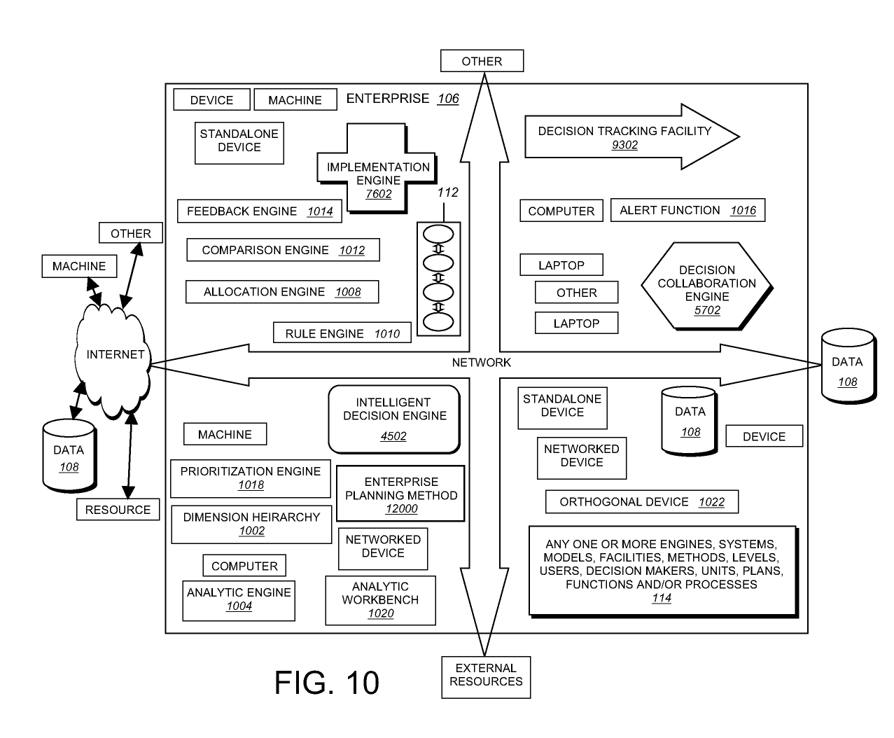

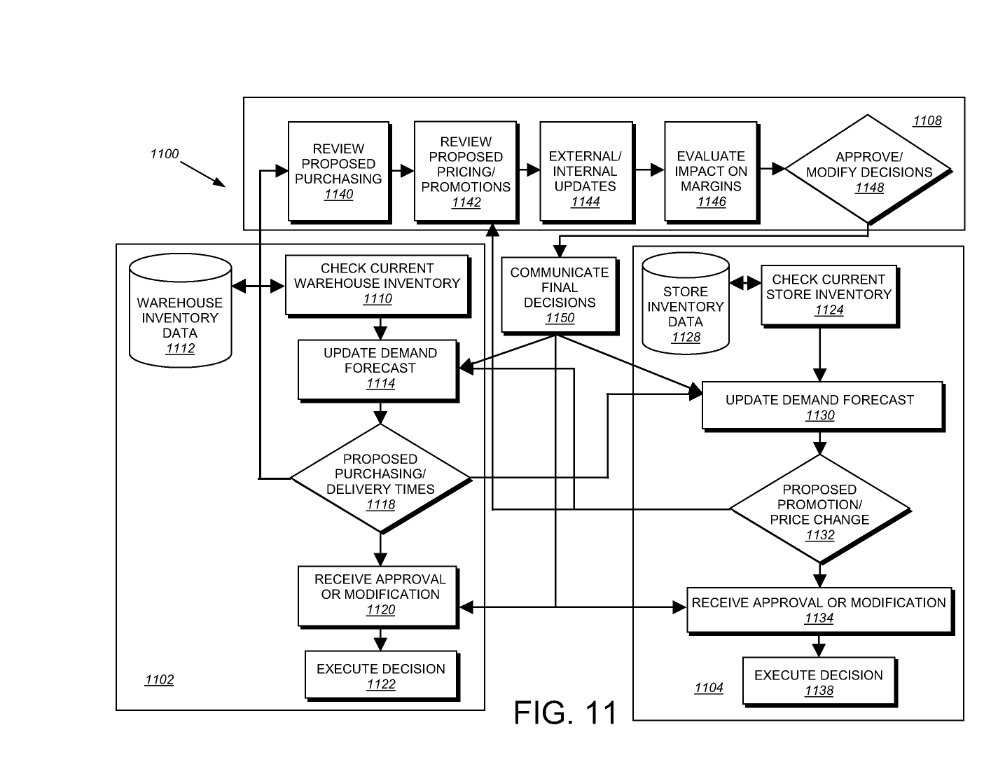

Referring to FIG. 11, a flow diagram 1100 shows the logical linking of three decision processes 1102, 1104 and 1108. The decision process 1102 is a simple purchasing decision process 1102 for purchasing inventory of a product, such as from a vendor, contract manufacturer, raw material supplier or the like. The decision process 1104 is a simple marketing decision process for determining whether to change the price of a product or to run a promotion for the product. The decision process 1108 is an approval process 1108, such as for an executive who is responsible for the performance of the product that is the subject of the purchasing decision process 1102 and the marketing decision process 1104. Any of these decision processes can have the characteristics of decision processes 300 made up of decisions 102 with decision attributes, decision types 200 and decision objects 202 as described above, and may further include various other inputs, updates, approvals, prospective and proposed decisions and the like such as exist in more complex processes in enterprises 106. However, as in FIG. 11, such more complex decision processes 300 can be logically linked as those in FIG. 11. In FIG. 11, the purchasing decision process 1102 can start when an analyst for a purchasing department checks current inventory levels for the product at a step 1110, which can take place, for example, by querying warehouse inventory data 1112, which may be stored in a data facility 108 of the enterprise (which might be updated from an external system or which might be shared with the warehouse, and which might be any kind of data facility 108). In embodiments a software application running on the analysts desktop may include a field or cell that automatically displays current inventory data from the warehouse. Next, the analyst can update the forecast demand for the product at a step 1114. The analyst may have various tools for updating the demand forecast, such as analytical forecasting tools that are based on historical demand. In the embodiment of FIG. 11, the demand forecast includes input from the marketing department, such as to include any proposed decisions made by the marketing decisions about the pricing or promotion of the product. Thus, the analyst can include the potential impact of a proposed price change or promotion on the forecast demand, either based on the analyst's knowledge, based on forecasting tools, or a combination of those. Having forecast demand for the product, such as for a given time period, the analyst can compare that demand to current inventory, to determine whether current inventory is sufficient to meet demand. Next, at a step 1118, the analyst in the purchasing department can propose a plan for purchasing more of the product and for transportation of the product to distribution centers or stores. If inventory is sufficient, the analyst may simply indicate that no additional purchases are planned for the time being, so that the currently anticipated plans for transportation to distribution centers and stores will remain in place. In embodiments the analyst may have a software application on the desktop that includes not only forecasting tools, but also information that assists in planning and executing purchasing decisions. For example, a software application may include a table with a set of rows for a product and set of columns, each of which represents a purchasing period, such as a day, week, month or quarter. The cells in the columns may include quantities and prices for actual past purchases as well as prospective or proposed future purchases. The rows may represent alternative suppliers for the product. The cells may include facilities for highlighting or calculating other aspects of purchasing decisions, such as a calculator for automatically incorporating negotiated volume discounts into the prices that are displayed and a facility for indicating lead times required for the vendor, so that only purchases that are possible given the quoted lead times can be entered as proposed decisions without generating an alert. The system can generate various alerts, such as if the analyst enters a blocked transaction, a transaction that exceeds purchasing authority, a transaction that violates a policy or procedure, a transaction that exceeds certain boundaries relative to previous years, or the like. A software application can also allow the analyst to generate various prospective decisions and view the potential impacts, such as on total purchasing costs, future inventory levels and the like. The software application can allow the analyst to store such prospective decisions 102 as decision objects 202. In embodiments the analyst may view and consider the impact of a decision on various metrics, such as metrics used to evaluate the analyst's performance, such as the number of days that inventory remains in the factory, the total cost of inventory, or the like.

Having taken into account current inventory levels, the input of forecasting tools, constraints, such as what products can be purchased from various vendors at what prices, and input about the forecast demand, and the expected impact on various metrics, at a step 1118 the analyst can propose a purchasing decision and associated delivery times.

In parallel with the purchasing process 1102, a marketing department employee, such as an analyst for analyzing pricing and promotion decisions, can be engaged in a marketing decision process 11104. At a step 1124 the marketing analyst may check current inventories of the product in stores, such as by accessing a store inventory data facility 1128, which can be any type of data facility as described above. Having determined inventory of the product, the analyst may, at a step 1130, update the planned inventory for the stores. In various embodiments, as with the purchasing plan, the analyst may have a software application on the desktop that assists in forecasting future levels of inventory of products, based on forecasted sales of the products, such as on a store-by-store or region-by-region basis. The analyst may refer to various forecasting tools, such as analytical engines and models, for forecasting sales, such as based on prospective promotions and pricing changes under consideration by the analyst. The analyst can take into account actual past sales and various models for future sales, including models of consumer behavior. The analyst can model various prospective decisions and compare the impacts on various metrics, such as total revenues, total time that the product remains on shelves, market share and the like. Among the various factors used by the analyst, the analyst can consider the planned deliveries of additional product to stores, as proposed by the purchasing analyst in the step 1118 of the purchasing process 1102. In embodiments, the proposed deliveries can be stored as a decision object 202 and delivered to a data facility 108 for write access by the purchasing analyst and read access by the marketing analyst, such as to appear in a cell or as a factor in an equation that generates a cell in a user interface for a software application that appears on the desktop of the marketing analyst. The analyst may then consider the impact of the proposed inventory deliveries on whether to change prices or offer promotions, in order to optimize the metrics used by the analyst, such as to maximize market share, maximize revenue or the like. The analyst can then choose among various prospective decisions and, at a step 1132, propose a decision 102, which can be stored as a decision object 202, such as to be written to a data facility 108 for write access by the marketing analyst and read access by the purchasing manager to assist in the step 1114 of the decision process 1102. It can be observed that the purchasing decision process 1102 and the marketing decision process 1104 are logically linked in an interdependent way, with the purchasing decision process 1102 taking the proposed marketing pricing and promotion decision 1132 as an input to the updating step 1114 and the marketing decision process 1104 taking the proposed purchasing/delivery decision 1118 as an input to the updating of the store inventory plan at the step 1130. It should be noted that the logical linking is effected by each department having access to the same data facility 108, where proposed decisions 102 of each group are stored as decision objects 202 that can be accessed as data 108 by the other group. The linking does not require separate communication but occurs continuously as proposed decisions results in updates of the data 108 that reside in cells or similar facilities of the analysts in the respective groups. Over time, changes in a proposed decision in one of the processes 1102, 1104 may result in changes in the proposed decision that results from the other process 1102, 1104; however, such changes may allow the processes 1102, 1104 to iterate toward an equilibrium where the proposed plans of the respective groups do not induce changes in the proposed plans of the other. Thus, in embodiments the logical linking of the decision processes and the sharing of decision objects may result in arriving at consistent decisions where inconsistent decisions prevailed absent the logical linking. In embodiments other decision processes may be similarly linked, so that three or more decision processes are linked through the sharing of decision objects, and equilibrium can be reached for a larger subset of the enterprise 106.

In certain embodiments an enterprise 106 may find that decisions of the decision processes 1102, 1104 do not arrive at equilibrium, or that they arrive at an equilibrium that is optimal in view of the sub-goals of the respective processes 1102, 1104, but not optimal with respect to higher-level goals, such as the goals of the enterprise as a whole. Thus, an approval process 1108 may review proposed decisions of the other processes 1102, 1104. The approval process 1108 may view the proposed decisions 1118, 1132 of the decision processes 1102, such as by viewing the decision objects 202 created in connection with those decision processes as stored in a data facility 108, which may be the same data facility to which the various processes 1102, 1104 have access in order to achieve logical linking of the processes. Thus, by accessing a data facility 108 (or by receiving a communication), an executive who is responsible for a product line can, at a step 1140, review the proposed purchasing decision that was made at the step 1118 (including the decision object 202 that captures the context of the decision, including the factual basis for the decision, the output of any forecasts, and the rationale for the decision, among other data). The executive can similarly access a data facility 108 to view a decision object 202 that reflects the pricing/promotion decision proposed by the marketing analyst at the step 1132 (again optionally including the factual context of the decision, the output of forecasts and models, a comparison to alternative prospective decisions, the impact of the inventory decision, the rationale, and other attributes that are stored in the decision object 202). In embodiments, the executive may not be required to initiate a query to the data facilities 108, as a software application running on the desktop of the executive may, for example, automatically populate the cells of a model running on the desktop with the data from the decision objects 202 from the proposed decisions 1118, 1132. Thus, one advantage of the logical linking of decision processes and the storing of decision objects that arise in the decision processes is that the executive can see the exact proposed decisions that are proposed by the analysts, without the decisions being filtered by a middle manager. The view is also simultaneous, so that executive can consider the cross-impacts of various decisions, rather than viewing each decision outside the context of other decisions. The executive may, at a step 1144, consider various internal or external updates, such as updates about other actual or proposed decisions of the enterprise 106. For example, an executive might learn that the research and development or engineering department has identified a new product that will cost less and provide more benefits than the current product, so that it makes sense to get rid of current inventories quickly before the product is obsolete, or the quality control or legal departments may have identified a product liability issue with respect to the product, so that the product must be recalled, or the high-level executives or board may have emphasized that achieving maximum market share is more important than short-term profits for this quarter, or vice versa.

Having reviewed proposed decisions at the steps 1140, 1142 and considered external and internal updates to data, the executive may, at a step 1146, evaluate the impact of the proposed decisions, such as the impact on product margins, total margin dollars for the product line, or other metrics. (It should be recognized that higher-level approval processes might consider the impact of various product-line decisions on other product lines, which may be similarly considered based on logically linked decision processes for the various product lines). The impact may be considered in light of the executive's judgment and experience, which may, in embodiments, be augmented by various analytical tools, such as tools that show the impact of various combinations of proposed decisions 1118, 1132 (and combinations with other decisions). As with the processes 1102, 1104, the executive may have software tools running on the desktop (or reports from tools run by employees who report to the executive) that assist in forecasting the impact of various effects, such as engines for forecasting demand, supply, sensitivity to price changes and promotions, effects on other aspects of the enterprise, and the like. Having considered the impacts, the executive may, at a step 1148, approve or modify the decisions that were proposed and, at a step 1150 communicate the decisions to the decision processes 1102, 1104. In embodiments the communication may take place by having the executive modify a decision object 202 and mark it as “approved,” then store it in the data facility 108 where the decisions reside for access by the processes 1102, 1104 and 1108. Thus, an executive may communicate approval for one decision by approving that decision 102 in an approved decision object 202 (rendering it a “final” decision), which may then be reflected as updated data to all of the processes 1102, 1104 and 1108, such as for access by the respective departments at the steps 1114 and 1130. In some cases, the executive may change approve one decision and not act on the other, which may result in a shift in the equilibrium based on changes that result in the other process 1102, 1104 for which the decision was not yet approved. Once decisions are approved at the step 1148 and communicated at the step 1150 (such as by writing them as decision objects 202 to a data facility), the decision process 1102 can receive approval at a step 1120 and execute the decision at a step 1122 and the decision process 1104 can receive approval at the step 1134 and execute the decision at the step 1138. The resulting decisions thus result from each department considering its own metrics, considering the impact of proposed decisions by other departments, and receiving approval from executives who have considered the impact of other factors on the impact of the proposed decision, all enabled by the logical linking of the decision processes and the storing of decision objects 202 that store the relevant data for the decisions, namely common set of data that is relevant to the different linked decision processes.

It should be noted that certain values and/or measures may be weighted more or less heavily than others in the estimation or forecasting of a value or measure. For example, if eighty percent of the demand for a certain good is know to come from a certain region, then if historical data is used to predict future demand, the historical demand data from that region may be weighted more heavily than the historical demand data from other regions.

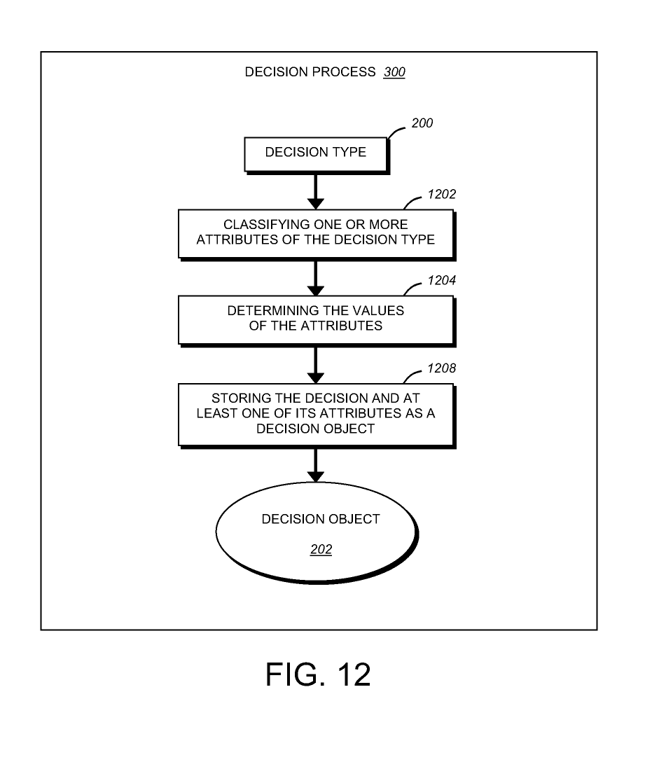

FIG. 12 is a simplified high-level flow chart depicting high-level steps of a process 1200 that results in a decision object 202. The first step 1201 in the process 1200 is to identify the type of decision 200. Referring to FIG. 2, a decision type 200 may be any type of decision 102 that takes place in an enterprise 106, such as a decision 102 to buy or sell an item, a decision 102 to hold an item, a decision 102 to reduce or increase inventory, a decision 102 to change prices for an item, a decision 102 to manufacture an item, a decision 102 to delay or cancel an order, a decision 102 to reduce personnel, a decision 102 to initiate a service, or any other decision 102. The second step 1202 of the process 1200 involves classifying one or more attributes of the decision 102. Certain attributes of a decision 102 can be a name 201, a time stamp 208, a value 212 representing the decision made and a related quantity, an item of data about the current state of an aspect of the enterprise 106, such as an inventory level 218 or other numerical value relevant to the decision, a forecast 222 or other data 108, such as data 108 used by the decision maker 104 as an input to the decision 102, an identifier 228 for the decision maker 104, an identifier 232 as to the finality of the decision, such as whether the decision 102 is a proposed decision or a final decision, a rationale 238, comments 240, and other attributes 242.

The third step 1204 of the process 1200 involves determining the values of the attributes. Referring back to example described in connection with FIG. 2, the forecast demand 222, 224 attribute of the decision 102 had a value of 110 units. This value was determined by consulting the various demand forecasting tools of the enterprise or by accessing updated raw data 108 from a third party service provider and performing analyses on the data 108. The current inventory attribute 218, 220 had a value of 10, which was determined by accessing supply-chain data linked using a lowest common level of abstraction of units of product per week. The value of the attribute representing the decision made 212 was to buy 100 units of the product. The value of this attribute reflected the decision of the decision maker based on the information and data 108 available to the decision maker, such information and data 108 embodied in the decision object. As depicted in FIG. 2, the rationale for the decision 102 may be a rationale such as “purchased units to meet demand based current inventory and demand forecast from decision tool.” Of course, the decision type 200 can relate to any decision of the enterprise 106, about any aspect of the enterprise 106, such as a decision process 300, a plan, a function, a person, a unit, a product, a service, a project, a team, a hierarchy, a brand, or the like. Any decision that can be characterized in a systematic way can be characterized according to its decision type and related attributes, including the variables that serve as inputs to the decision.

The fourth step 1208 of the process 1200 involves storing the decision 102 and at least one of its attributes, optionally including the value or values of one or more attribute, as a decision object 202. The decision 102 and its attributes may be stored and maintained as data 108 in a data facility 108. The data 108 can then be made available to other subsets of the enterprise or used for other purposes, such as renting to third parties. The decision process 300 results in the creation or modification of a decision object 202.

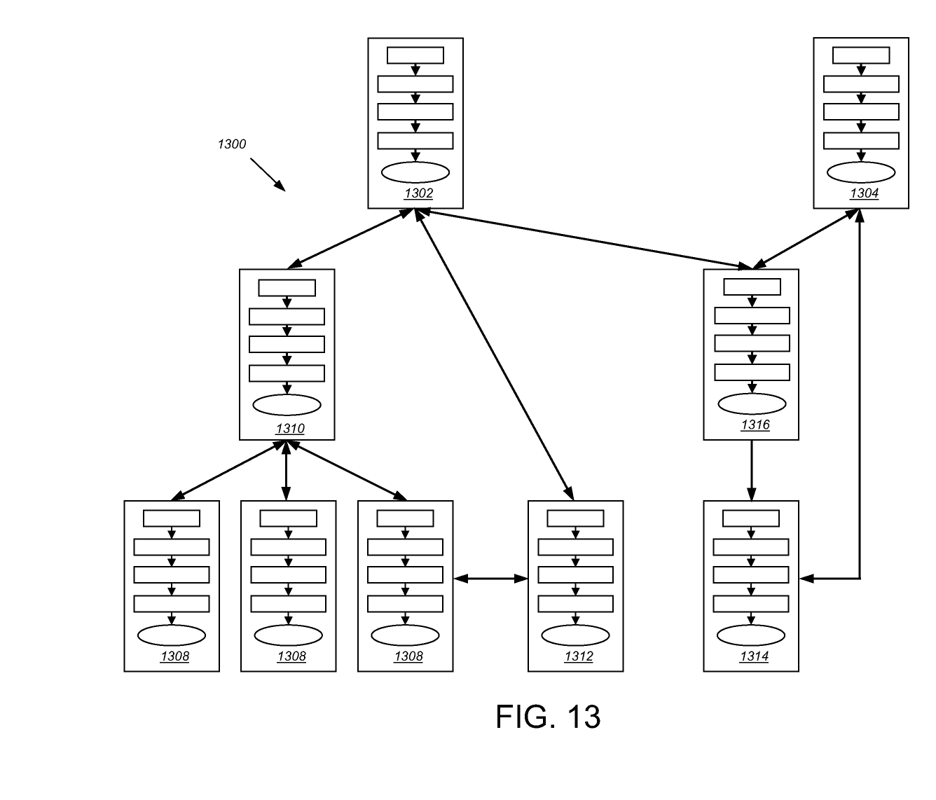

FIG. 13 is a simplified high-level schematic diagram depicting a hierarchy 1300 of decision processes 300. The hierarchy may reside in or be relevant to any one or more units, plans, functions, processes and/or other aspects of an enterprise 802. The hierarchy may reside in or be relevant to any one or more levels of abstraction of the company, such as an affiliate, subsidiary, division, branch, team, employee or consultant. For example, the hierarchy could relate to the valuation department of a hedge fund. The decision processes 300 at the top level of the hierarchy could be those of partners of the fund. For example, decision process 1302 could be that of the partner responsible for technology investments and the decision process 1304 could be that of the partner responsible for managing the debt level of the fund's investments. Several analysts may be responsible for assessing the potential of technology companies based on earnings metrics. The decision processes 300 for these analysts may be at a lower level of the decision hierarchy 1308. The decision objects 202 resulting from these lower level earnings-based decision processes 1308 may travel up the approval chain to a mid-level manager specializing in earnings-based evaluations. The mid-level manager may be involved in a decision process 1310 that assesses the decisions proposed by the analysts 1308, sending the promising decisions 102 to the partner responsible for technology investments. Another analyst may use a decision process 1312 based on development metrics for technology companies. This analyst may require certain earnings information or data 108 from one or more of the analysts using earnings metrics 1308. The decision process of the development analyst 1312 may interact directly with the decision process 1302 of the partner responsible for technology investments. Another analyst may base her decision process 1314 on debt metrics of the various companies. Her proposed decisions 102 may be stored as decision objects 202 and sent to her supervisor 1316. Her supervisor may then evaluate the proposed decisions 102 and send the most feasible ones to the partner responsible for managing debt 1304 for review. The decision processes of the partners 1302, 1304 may involve analysis of all the information presented to them, with the goal of selecting investments. It may be the case that the partners may interact with the managers or analysts in order to determine additional information or to question certain assumptions of the decision objects 102 made during the decision processes 300.

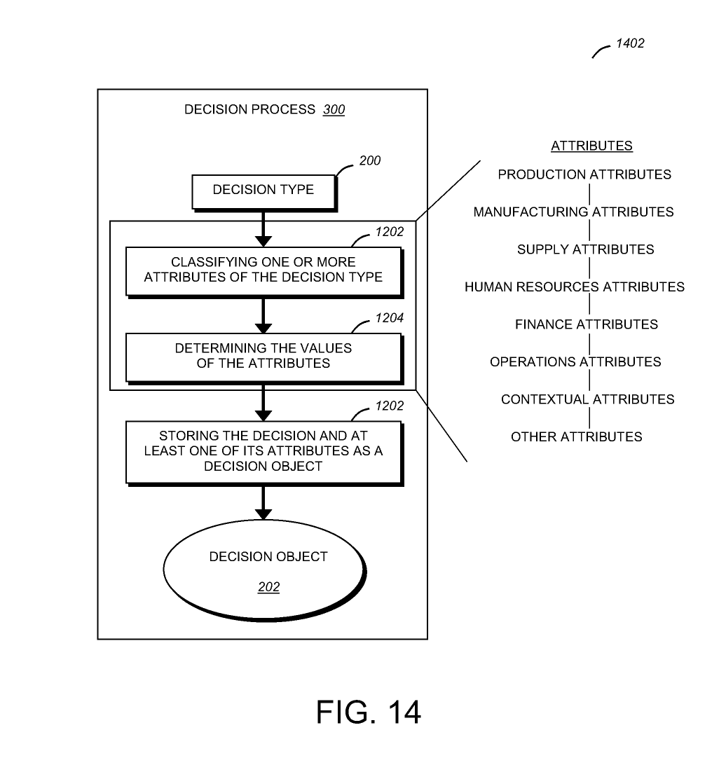

FIG. 14 is a simplified high-level flow chart depicting a process 1400 for arriving at a decision object with respect to a decision that has certain attributes 1402. As discussed in connection with FIG. 12, the second step 1202 of a process 1200 involved classifying one or more attributes 1402 of the decision 102 and the third step 1204 involved determining the values of the attributes 1402. In addition to the attributes 1402 described above, attributes 1402 may also include production attributes, time-related attributes, scheduling attributes, manufacturing attributes, supply attributes, supply-chain attributes, human resources attributes, recruiting attributes, procurement attributes, buying-related attributes, price-related attributes, cost-related attributes, placement-related attributes, branding-related attributes, product-related attributes, purchasing attributes, operations attributes, logistics attributes, product management attributes, research attributes, development attributes, engineering attributes, quality control attributes, program management attributes, inventory attributes, demand attributes, sales attributes, sales and order processing attributes, marketing attributes, channel attributes, distribution attributes, promotion attributes, executive attributes, management attributes, finance attributes, controlling attributes, compliance attributes, accounting attributes, audit attributes, attributes relating to any measurement of any aspect of the decision 102, measures of the decision 104 along several dimensions, measurements, context of the decision 102, hierarchies and/or structures related to the decision 102, the place of a decision 102 in one or more hierarchies and/or structures relating to the decision 102, parameters related to the decision 102, variable values related to the decision 102, weightings related to the decision 102, revenue, cost, margin, profit, volume, share, each change that was made, when each change was made, the user, system, decision maker 104 which made a given change, any noted reasons for a given change, any noted assumptions for a given change, any noted conditions for a given change, each proposed change that was not made, when the change was proposed, when it was decided that the change should not be made, the user, system, decision maker 104 that decided whether or not to make a given change, any noted reasons for a not accepting a given change, any noted assumptions for not accepting a given change and/or any noted conditions for not accepting a given change, a scenario version. The values of attributes 1402 may be expressed as text, numbers or symbols, include detailed descriptions or incorporate working models and/or algorithms. Thus, any decision type 200 of an enterprise 106 can be associated with attributes of that decision type 200 to establish a decision object 202. The decision object 202 can be associated with a decision process 300 that is itself located within a hierarchy 1300 of decision processes 300.

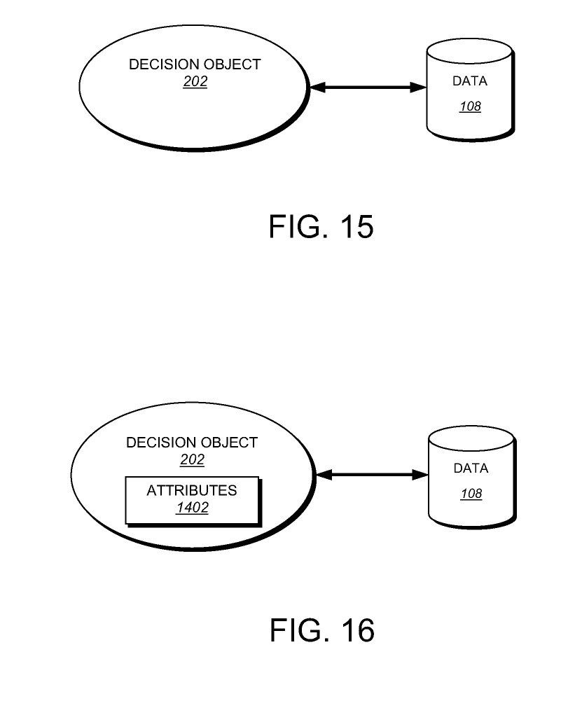

Referring to FIG. 15 a decision object 202 may be stored and maintained as data in a data facility 108. Thus, the decision object 202 and associated data may be made available to various aids and decision tools 114 for analysis and other uses and purposes. For example, a proposed decision object 202 may be made available to the intelligent decision engine, which may then modify the information requested in connection with another decision 102, so that sufficient information will be on hand in connection with the proposed decision object 202. The data 108 can be shared with the units, plans, functions, processes, and/or other subsets of the enterprise 802. For example, the data 108 embodiment of a proposed decision object 202 regarding product pricing may be made available to the demand forecast unit, which may then determine the impact the price change will likely have on demand. The data 108 may be updated internally and externally 110 and ported to other systems or sold or rented to third parties. For example, employees in a credit department of a company may update their data facility 108 in real-time to reflect balance changes in customer accounts. The data facility 108 may also incorporate information from a credit agency that may track the other transactions of a particular customer. The company may enter into an arrangement to share its credit data 108, in real-time, with the credit agency. It may be the case that the data 108 is encrypted for security.

Changes or updates to the data 108 and data facility 108, such as from scheduled updates or from the interactions with other users and/or decision makers 104, may impact a decision object 202. A decision object 202 may contain one or more parameters or algorithms. For example, a decision object 202 may contain a decision that if supply of a certain component falls below a specified level the system is to automatically order fifteen more units of the component. In order for this type of decision 102 to work the data 108 on which the decision 102 is based must be updated and be associated with the decision object 202.

FIG. 16 shows that the attributes 1402 of a decision type 200 are embodied in the decision object 202 or decision objects 202 associated with that decision type 200. The attributes 1402 may also be stored and maintained as data 108 in a data facility 108. The attributes 1402 may be updated, modified and embodied in the same manners as a decision object 202.

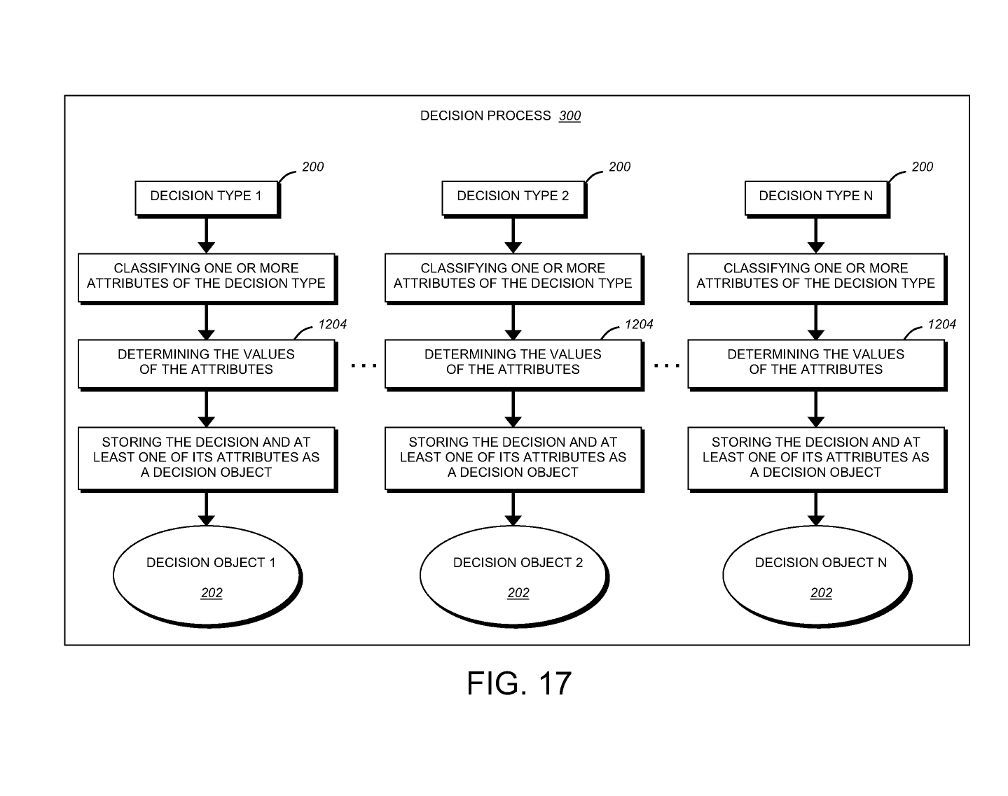

FIG. 17 is a simplified high-level schematic diagram illustrating that a decision process 300 may consist of a plurality of decision processes 300, each with decision types 200 and decision objects 202. For example, the decision process 300 may involve forecasting the profits attributable to a certain product in the next two quarters. This decision process 300 may involve, or be composed of, several other decision processes 300 such as deciding on the price for the product, planning any promotions in connection with the product and determining the demand for the product. These decision processes 300 may be interrelated and each of them 300 may, in turn, involve, or be composed of, several other decision processes 300. For example, the decision to plan a promotion may be broken down into decisions involving selecting the geographic regions in which to run the promotion, choosing the types of media in which to run the promotion, determining promotional pricing and the like.

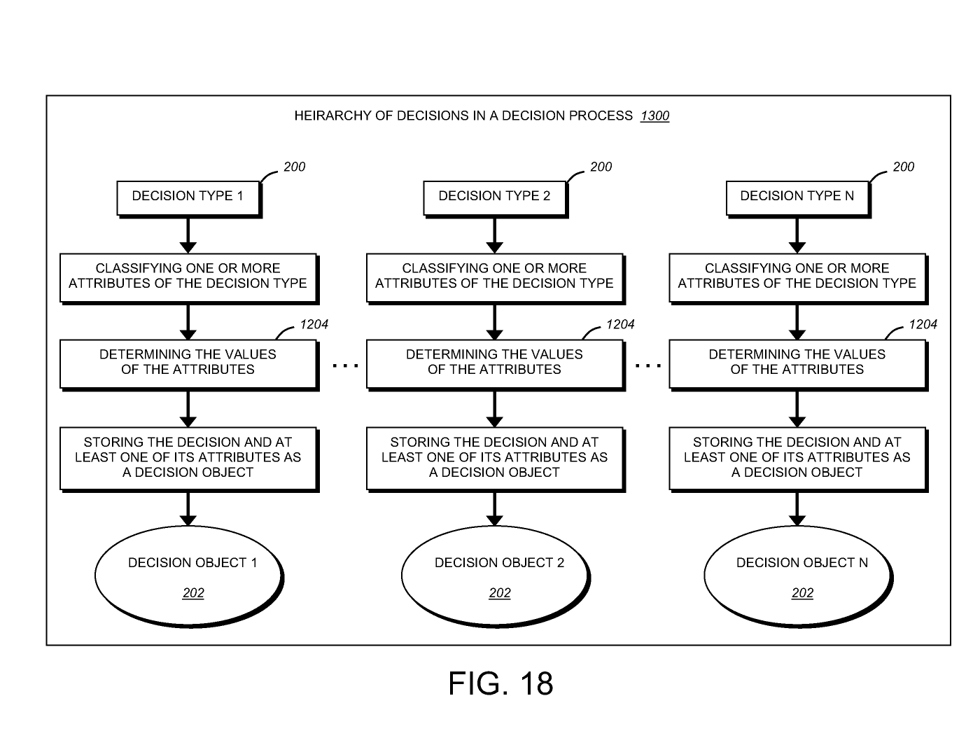

FIG. 18 is a simplified high-level schematic diagram illustrating that a hierarchy 1800 of decisions may consist of a plurality of decision processes 300, each with decision types 200 and decision objects 202. For example, the hierarchy may be similar to that of the valuation department of a hedge fund described in connection with FIG. 13. The decision processes may be those of the various analysts and managers. It may also be the case that the each decision process 3001 through N in FIG. 18 embodies a hierarchy similar to that presented in FIG. 13, with the overall hierarchy of decisions in the decision process 1300 being the selection of investments for each of many different funds.

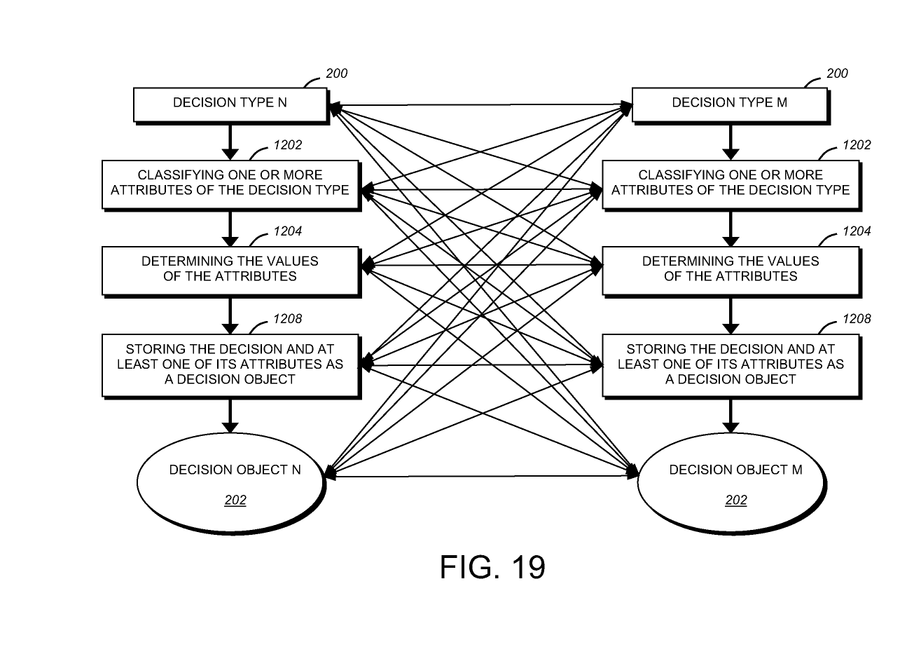

As FIG. 19 depicts, one or more decision types 200 may be interrelated. The interrelatedness may be at the level of an entire decision process 300 for that decision type 200 or at the level of the individual steps of a decision process 300. Decision processes 300 may be interrelated in that one may come after, or may become relevant after, another one has been decided. For example, the decision 102 as to whether a building should be used for residential or commercial space would usually be made before the decision processes 300 to determine the layout, amenities and the like would be relevant. The attributes 1402 recorded in connection with a decision object 202 as classified, determined and stored in steps 1202, 1204 and 1208 of a decision process 300 may depend on the outcome of another decision process or the outcome of a step of another decision process. For example, recording the attribute of “dependent demand” for a product may be useful if a decision 102 is made to also sell the product as part of a kit or bundle. Alternatively, the attribute “dependent demand” may be recorded for the product; however, if the product was only sold on a standalone basis the value of the dependent demand, as determined in step 1204, would be zero. A step of one decision process 300 may be intimately related to a step of another decision process 300. For example, the two decision processes 300 may involve determining the price at which to sell a product and forecasting the demand for that product. The step of determining the value of the attribute “price” 1404 in the first decision process may be interconnected with the step of determining the value of the attribute “forecasted demand” 1404 in the second decision process 300. This may be the case as price and demand are often interrelated, with the amount consumers purchase varying inversely with price.

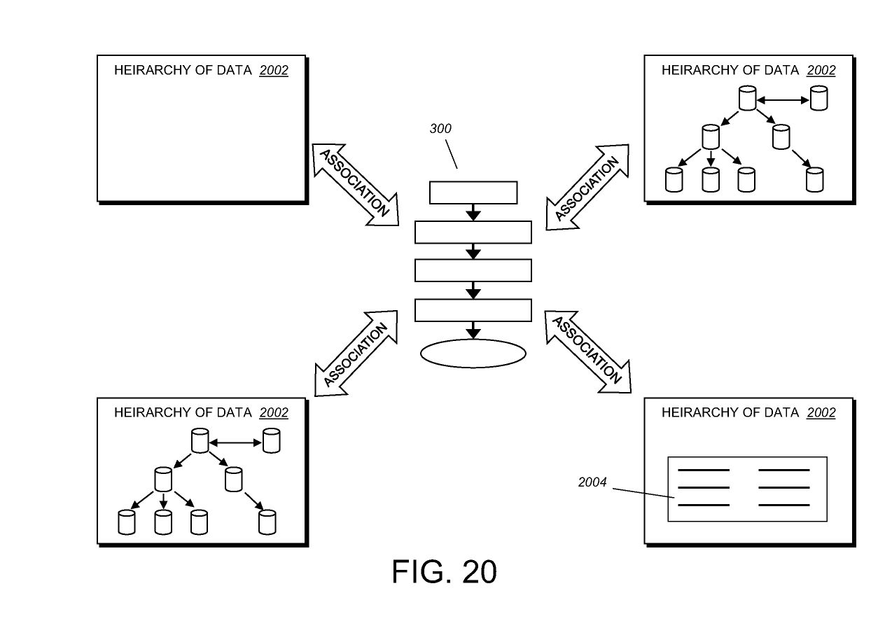

As depicted in FIG. 20 a decision process 300 may be associated with one or more hierarchies of data 2002. A hierarchy of data 2002 may reflect the organization of a group of decision makers 104 or may be organized to reflect various other schema associated with the data. The structure of the hierarchy of data 2002 may reflect the structure of the enterprise 106 or the network and allow for decision makers 104 and users to easily update the values as necessary. For example, data for an aspect of the enterprise 106 may be structured by region, which may easily allow for updates from various regions. The data 108 may also be structured in a hierarchy that reflects the reliability of the data 108 and prevents more reliable data 108 from being mixed with less reliable data 108. A hierarchy of data may relate to a single step of a decision process. A hierarchy may relate to an approval chain for a decision. A hierarchy may relate to physical objects, such as materials that make up components that make up subassemblies that make up products that make up systems. A hierarchy may relate to producers of products, customers for a product, vendors of a component, or other parties outside the enterprise 106. A hierarchy may relate to quality of a product or service, or membership in a particular class of customer, such as a “gold” club for a frequent flyer or purchaser. For example, a hierarchy of product attributes by region may be stored in a data facility in connection with step 1202 and 1204 of a decision process 300 to determine when to bring the product to market. In various embodiments, data hierarchies may consist of Universal Markup Language (UML) models, HTML, SGML or XML or other mark-up language models or schema, object-oriented classes and objects, such as coded in Java, C++ or other object-oriented programming languages, graphics-based hierarchies, such as directed graphs and similar hierarchies, worksheets, spreadsheets and similar facilities that embody mathematical data and/or formulas, including those with nested logic or cross-references, and any other type of data hierarchy as captured by any type of tool for storing or manipulating a data hierarchy. In one preferred embodiment data items represent cells in tables 2004 of relational databases that are stored as files in a data facility 108 with row-column formats. A data item can be stored in a cell of an appropriate table for access and updating by more than one logically linked decision process 300 of a plan, function, process, unit or other aspect of an enterprise 106.

FIG. 21 depicts a decision process 300 that may consist of a plurality of other decision processes 300. For example, the main decision process 300 may involve a hiring decision. The plurality of decision processes 300 may relate to interviewing and rating each of several candidates, as well as determining the compensation that would be required to attract desirable candidates. Any decision process can be broken down into a set of other decision processes, which can ultimately be broken down into individual decisions that can be represented as decision objects 202. In various embodiments, decisions 102 and decision processes 300 may be dependent 2102, where on decision takes the results of another decision as an input variable, independent 2104, or interdependent 2108, where each decision takes as an input variable the output of the other decision.

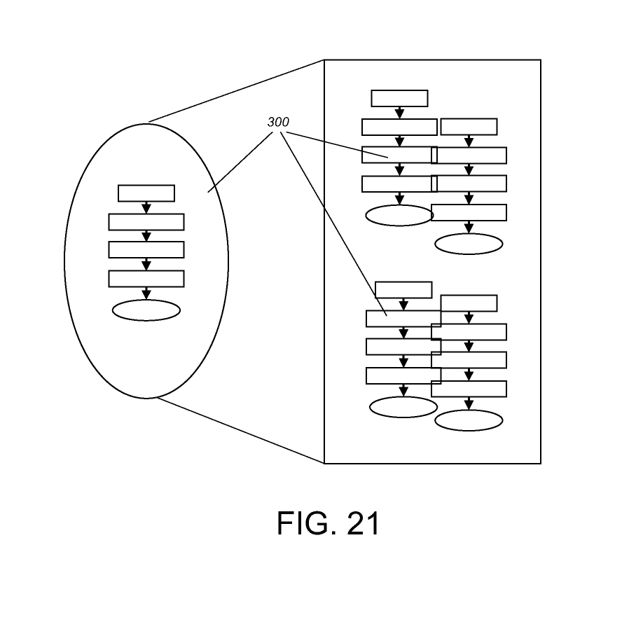

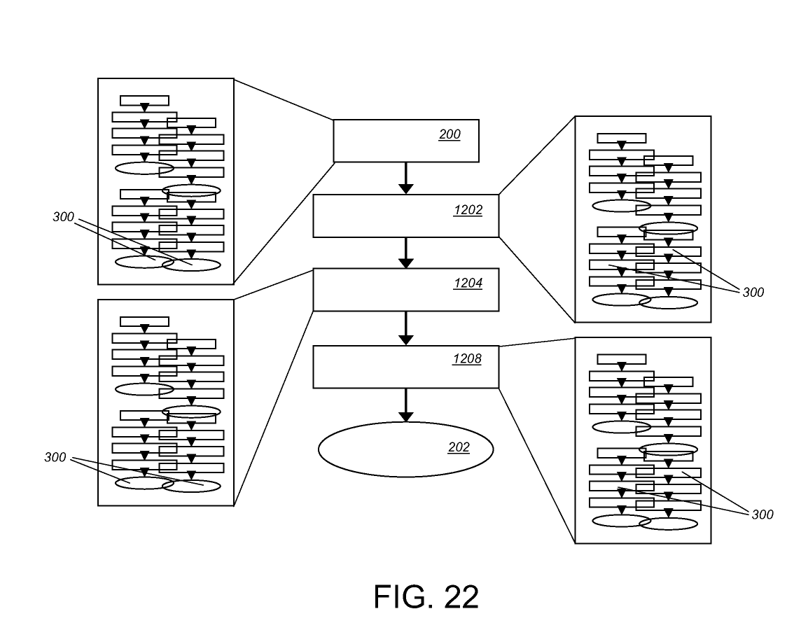

FIG. 22 depicts a decision process 2200 for which one or more steps of the decision process 2200 may consists of, or depend on, one or more other decision processes 300. For example, the decision process 2200 may be similar to the decision process of FIG. 2 that results in deciding on a decision object 202. The outcome of the step 2202 concerning which attributes to include may depend on the information which will be needed later in the process or elsewhere in the enterprise. For example, if products may be sold in multiple regions, then it may be likely that the outcome of step 2202 will be to include a set of attributes corresponding to each region in which the product may be sold. The step of determining the values of the included attributes 2204 may be composed of a series of decision processes 300. For example, in order the determine the value of an attribute, a decision process 300 involving the reliability and weighting of data 108 from various sources may need to be completed. In step 2208 the method of storing the data 108 may be decided in a way to maximize the benefit other decision makers 104 in the enterprise 106 will derive from the data 108. Thus, the decision process 2200 for determining a decision object 202, or any other decision process 300 of an enterprise, can depend on other decision processes, each of which can consists of decisions 102 that are classified as decision types 200 and stored as decision objects 202.

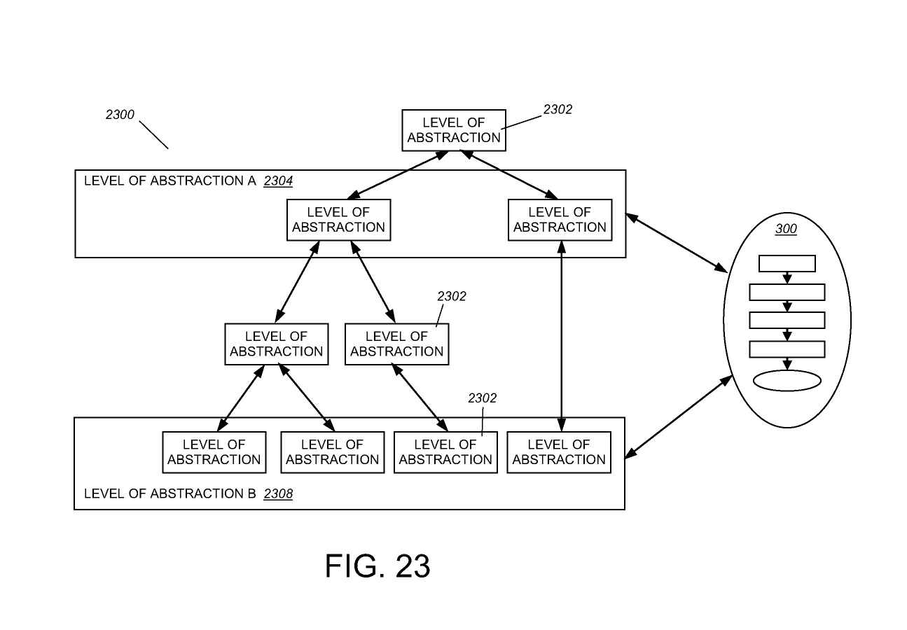

FIG. 23 depicts a decision process 2300 involving one or more levels of abstraction 2302 within a hierarchy of levels of abstraction 2300. The levels of abstraction 2302 may be levels of abstraction of data 108, levels of abstraction of the subsets of the enterprise 106, levels of abstraction of the decision makers 104 and the like. In this embodiment, level of abstraction A 2304 and level of abstraction B 2308 may be related to or impact the decision process 2300. For example, the decision process 2300 may relate to determining profits for the next quarter. Level of abstraction A 2304 may relate to product development and the determination of the price of the products. Level of abstraction B 2308 may relate to production and the cost to produce the product at various levels of quality. The information from these levels of abstraction 2304 and 2308 may inform the decision process 300 allowing finance to estimate the amounts of each product that will be sold at the corresponding price and level of quality, which in turn may allow for the calculation of expected profits for the quarter.

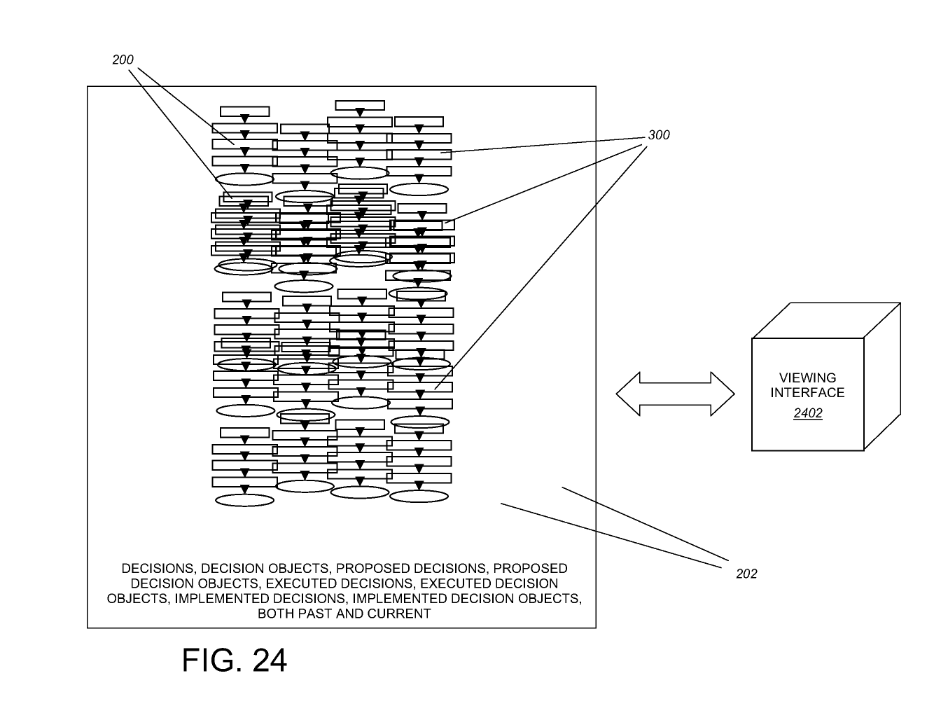

As depicted in FIG. 24, the method and/or system may allow for the viewing, using a viewing interface 2402, of past and current decisions types 200, decision objects 202 and decision processes 300. The decisions types 200, decision objects 202 and decision processes 300 may be proposed, executed or implemented. The viewing interface 2402 may allow for searching, categorization, analysis and the like of the decisions types 200, decision objects 202 and decision processes 300. For example, at the request of a user, the viewing interface 2402 may only display decision objects executed between Jul. 8, 2004 and Jul. 14, 2004. The viewing interface 2402 may also allow for customization of the view and the fields displayed in each view. For example, the viewing interface 2402, at the input of the user, may only display the name 201, rationale and decision maker 104 for the decisions 102. In embodiments the viewing interface may be a graphical user interface for a software application with a table that shows rows and columns, with columns representing different time periods in the past, present and future, rows relating to particular data attributes, (such as product names, locations, quantities, prices, and the like) and cells that reflect data for the attributes as they relate to the time periods. The viewing interface 2402 may include colors, fonts, comment boxes, footnotes, patterns and other graphical, numeric and textual elements for conveying data, such as data relevant to decision attributes of decision types 200, data relevant to forecasting (such as for forecasting tools and analytical tools), data relevant to the impact of decisions, and the like. In embodiments particular tables of data 108 may be selected by navigating in a hierarchy, such as a hierarchy of products, services, accounts, plans, regions, components, stores, sales people, employees, or the like. The selection of the hierarchy can drive the view of the data, while the underlying data (including decision objects 202) can be the same data for various aspects of the enterprise, such as linked processes as described in connection with FIG. 11.

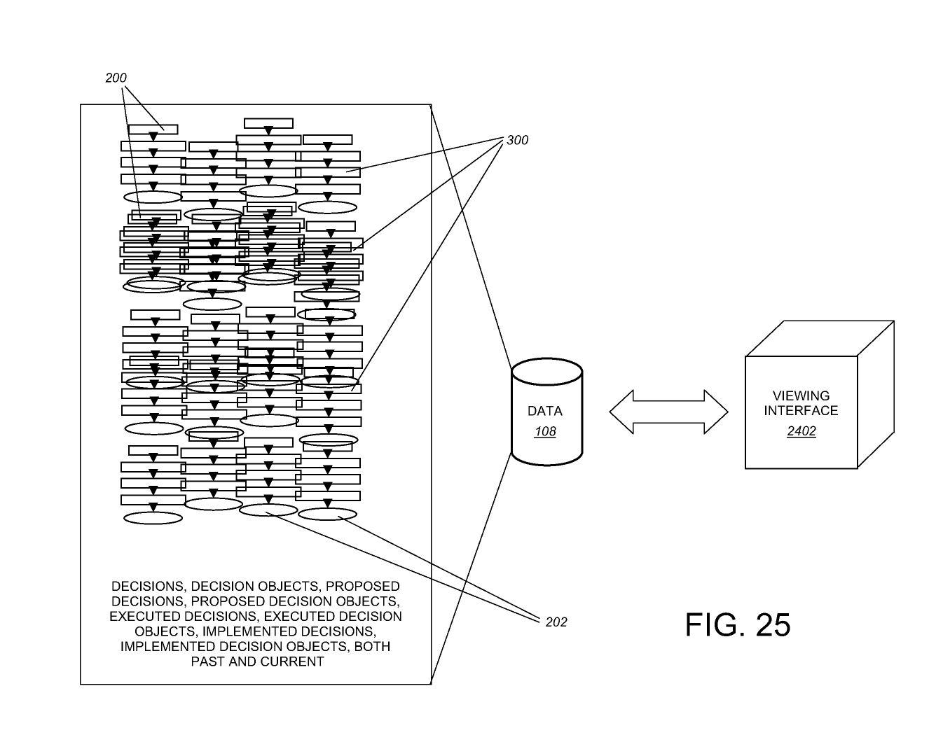

As depicted in FIG. 25, the past and current decisions types 200, decision objects 202 and decision processes 300 may be maintained and stored as data 108 in a data facility 108. The decisions types 200, decision objects 202 and decision processes 300 may be prospective, proposed, final, or executed/implemented. As discussed above, the data 108 may be made available to other subsets of the enterprise 106 or to third parties, with views varying according to the hierarchy or schema of the viewer. The viewing interface 2402 may function in a variety of ways as described in connection with FIG. 24.

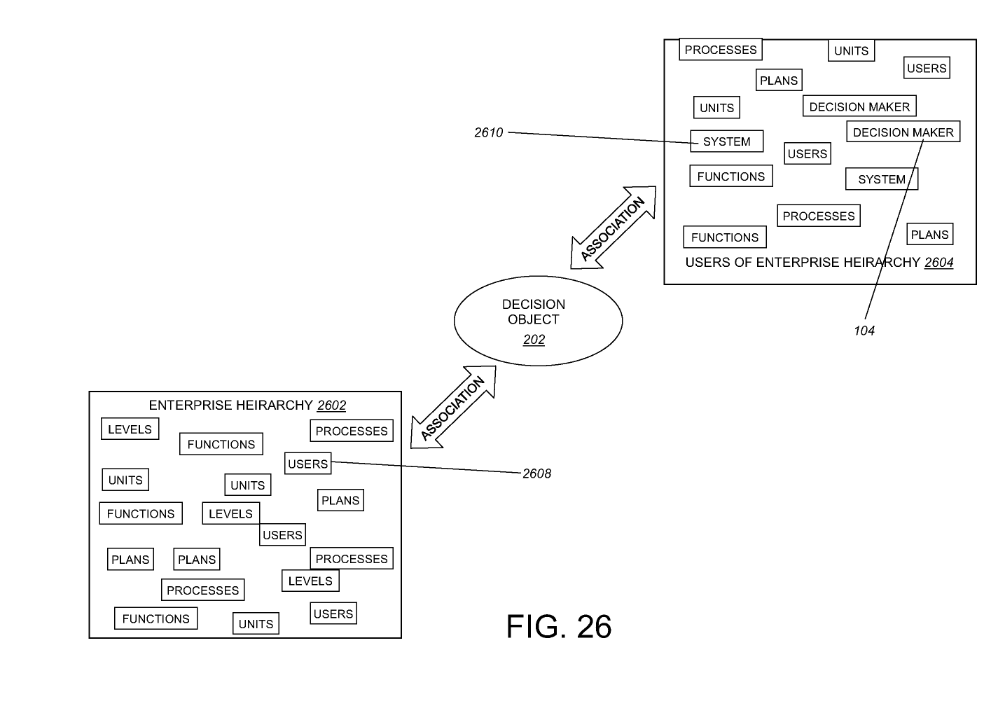

FIG. 26 depicts a decision object 202 associated with various subsets of an enterprise hierarchy 2602 and various users of an enterprise hierarchy 2604. The various subsets of an enterprise hierarchy 2602 may be one or more units, plans, functions, processes, levels, users 2608, decisions 102, decision objects 202 and decision processes 300 or other subsets of an enterprise 106. The various users 2602 of an enterprise hierarchy 2604 may be one or more units, plans, functions, processes, systems 2610, decision makers 2612 or other subsets of an enterprise 106. Users 2608 may include a division, subsidiary, affiliate, business unit, office, branch, department, group, sub-group, project team, team, geographically-defined unit, employee, contractor, agent, analyst, consultant, decision 102, decision object 202 and decision process 300, system 2610, decision maker 2612 or other subset of an enterprise 106.

The system 2610 may be a production system, manufacturing system, supply system, supply-chain system, human resources system, recruiting system, procurement system, buying system, purchasing system, operations system, logistics system, product management system, research system, development system, engineering system, quality control system, program management system, inventory system, demand system, sales system, sales and order processing system, marketing system, channel system, distribution system, promotion system, executives system, management system, finance system, controlling system, compliance system, accounting system, audit system, user 2608, decision maker 104 or other subset of an enterprise 106. The decision maker 104 may be a person, model, computer, user 2608, system 2610 or other subset of an enterprise 106.

The user 2608, system 2610 and/or decision maker 104 may be at a higher, lower or equal level of abstraction with the aspects of the enterprise affected by the decision 102. For example, a user 2608, system 2610 and/or decision maker 104 may be the chief executive officer of an enterprise, a vice president of sales, a secretary, a distribution management system or an assembly line worker.

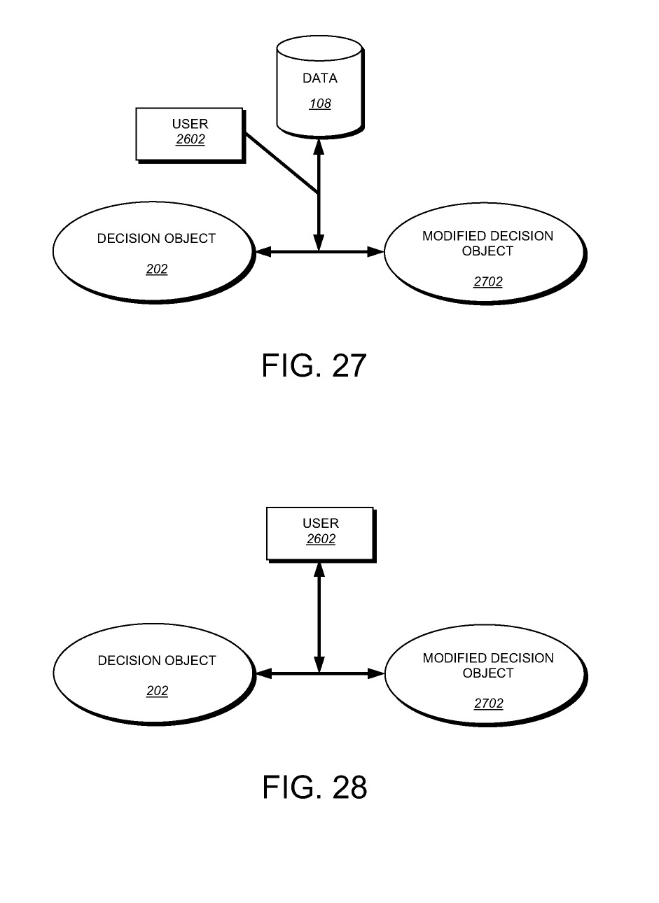

FIG. 27 depicts the addition or subtraction of data 108 which may be stored in a data facility 108 to a decision object 202 by a user 2608 resulting in a modified decision object 2702. The user 2608 may be a decision maker 104 or system 2610. The modification may be an addition or subtraction of attributes 1402 to or from the decision object 202 or a change in the value or values of one or more attributes 1402.

For example, a subset of an enterprise may implement a decision 102 in connection with a promotion for a certain product. The decision 102 may include an updated demand forecast for several related products. This data 108 may be linked or shared with other decision processes 300 and existing decision object 202 resulting in the updating and modification of any related decision processes 300 and decision objects 202. The addition or subtraction of data 108 from the decision object 202 may also change the data 108 embodying the decision object 202 in the data facility 108 in which it is stored or maintained.

FIG. 28 depicts the modification of a decision object 202 by a user 2608 resulting in a modified decision object 2702. The user 2608 may be a decision maker 104 or system 2610. The modification could be the addition or subtraction of data 108 as discussed in reference to FIG. 28. The modification may be directly inputted by a user 2608 resulting in an addition or subtraction of attributes 1402 to or from the decision object 202 or a change in the value or values of one or more attributes 1402. For example, a decision maker 104 may realize that one of her assumptions in connection with a decision 102 was flawed. She may then access the related decision object 202 or decision objects 202, which may be proposed and not yet executed, and may the necessary revisions. The modification of the decision object 202 may change the data 108 embodying the decision object 202 in the data facility 108 in which it is stored or maintained. In embodiments the decision object 202 may be modified by a manager or other executive based on a review or approval process, then stored as a modified decision object 2702.

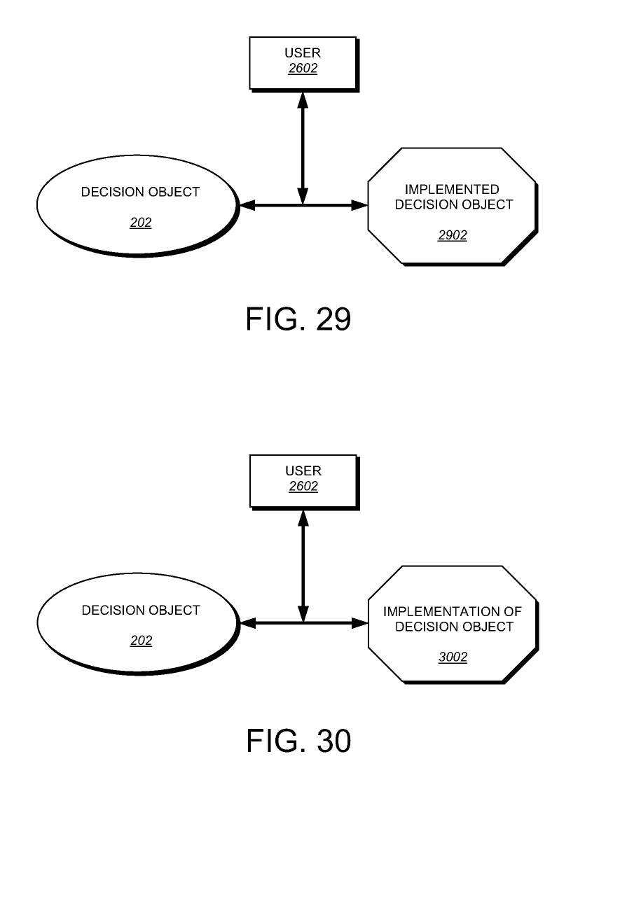

FIG. 29 depicts the implementation of a decision object 202 by a user 2608, which may convert the decision object 202 into an implemented decision object 2902. The user 2608 may be a decision maker 104 or system 2610. The decision object 202 may be manually implemented by the user 2608. For example, if the decision 102 involved the purchase of an item, the user 2608 may order the item, thus implementing the decision. In another example, the decision may involve the separation of a data facility 108 into two data facilities 108 to reflect the regions in which the enterprise 106 operates. The user 2608 may implement the decision by performing the necessary work to separate the databases.

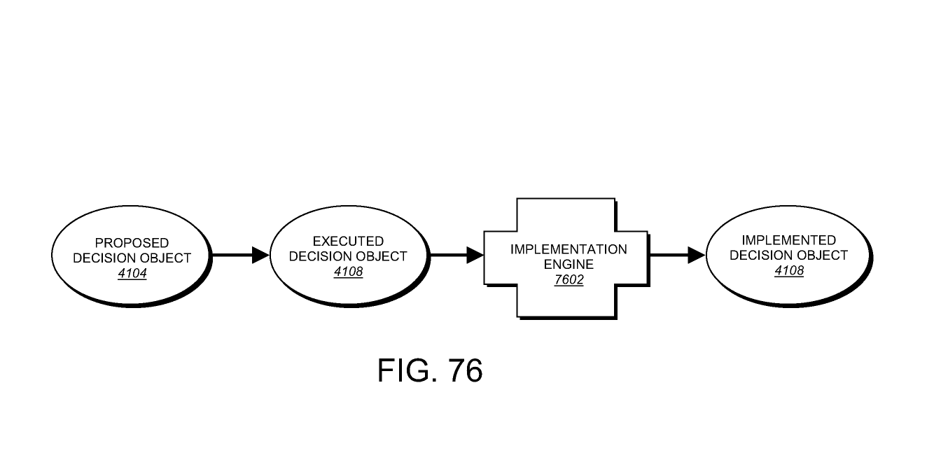

It is often the case that the implementation of a decision object 3002 is too complex for a user 2608 to accomplish alone. In cases such as this, as depicted in FIG. 30, the user 2608 may trigger or command the implementation of the decision object 202. It may be the case that another decision maker 104 or approval chain 112 has made a decision to implement the decision 102. The various systems 2610, decision makers 104, users 2608 and other subsets of the enterprise may aid in the implementation of a decision object 3002. The decision object may be propagated to the relevant subsets of the enterprise 106 and a system 2610 may write the necessary changes to any related data facilities 108. The implementation may be accomplished through the use of an implementation engine, as discussed below in reference to FIG. 76. In embodiments a decision object 202 may be implemented without any affirmative trigger; that is, populating a data facility 108 with a decision object 202 and indicating that the decision object 202 is final or approved may allow a user from another part of the enterprise 106 to carry out a decision process 300 that depends on the decision object 202, such as based on facts associated with the decision object 202, without the user being explicitly aware of the decision or the decision object. For example, the decision object 202 may result in a cell or other viewing interface being populated with data that results from the decision object (such as a demand forecast), without requiring any other communication. Thus, implementation can take place as a result of logical linking, as described in connection with FIG. 11.

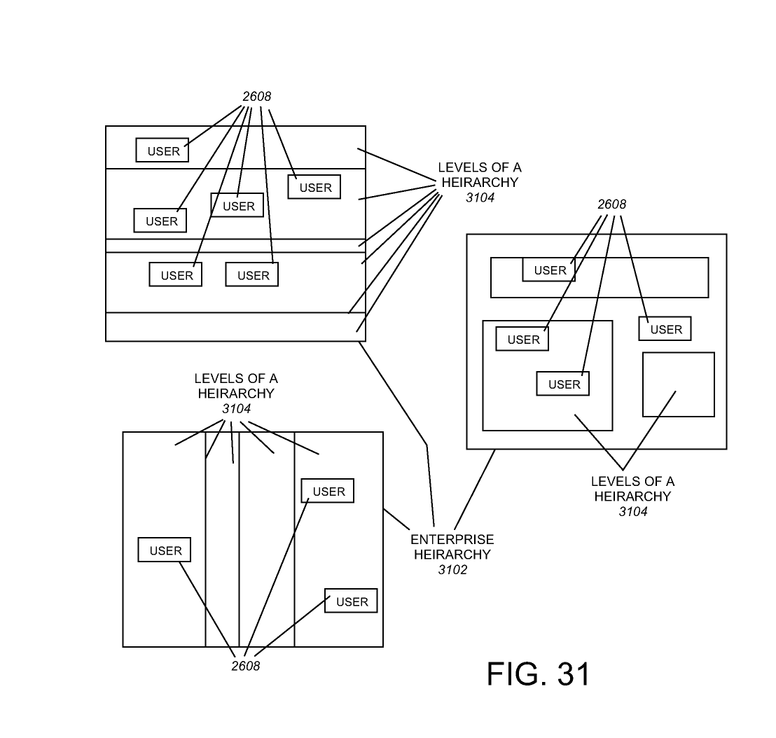

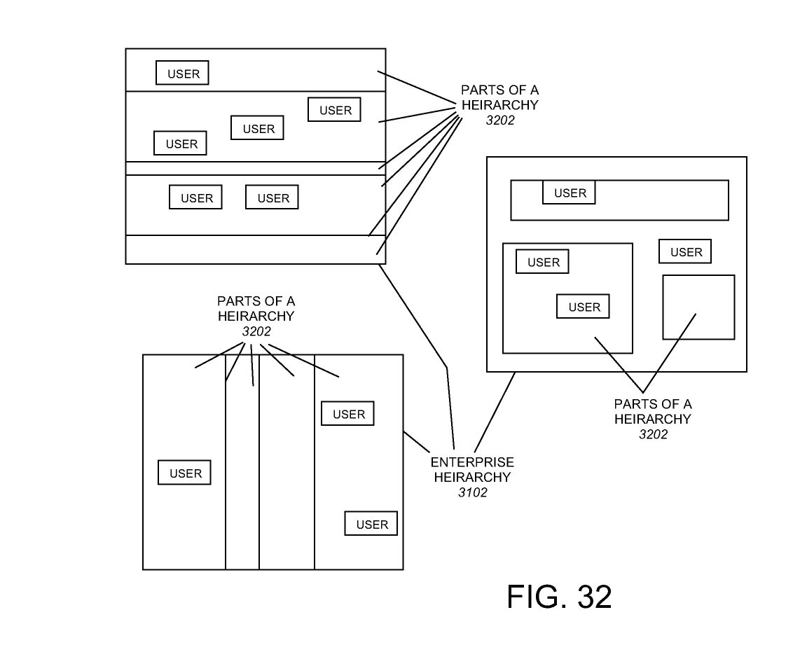

FIGS. 31 and 32 are simplified high-level schematic diagrams illustrating that users 2608 of an enterprise hierarchy 3102 may be within the same or from different levels 3104 or parts 3202 of the enterprise hierarchy 3102. The user 2608 may be a decision maker 104 or system 2610. For example, an enterprise hierarchy 3102 may consist of a level 3104 of managers and a level 3104 of analysts. Both the managers and analysts may access the same elements of an enterprise hierarchy 3102, such as analytic tools 114, data facilities 108 and individuals. An enterprise hierarchy 3202 may also consist of a part 3202 responsible for promotions and another part 3202 responsible for forecasting demand. Both parts 3203 may access the same elements of an enterprise hierarchy 3102, such as analytic tools 114, data facilities 108 and individuals.

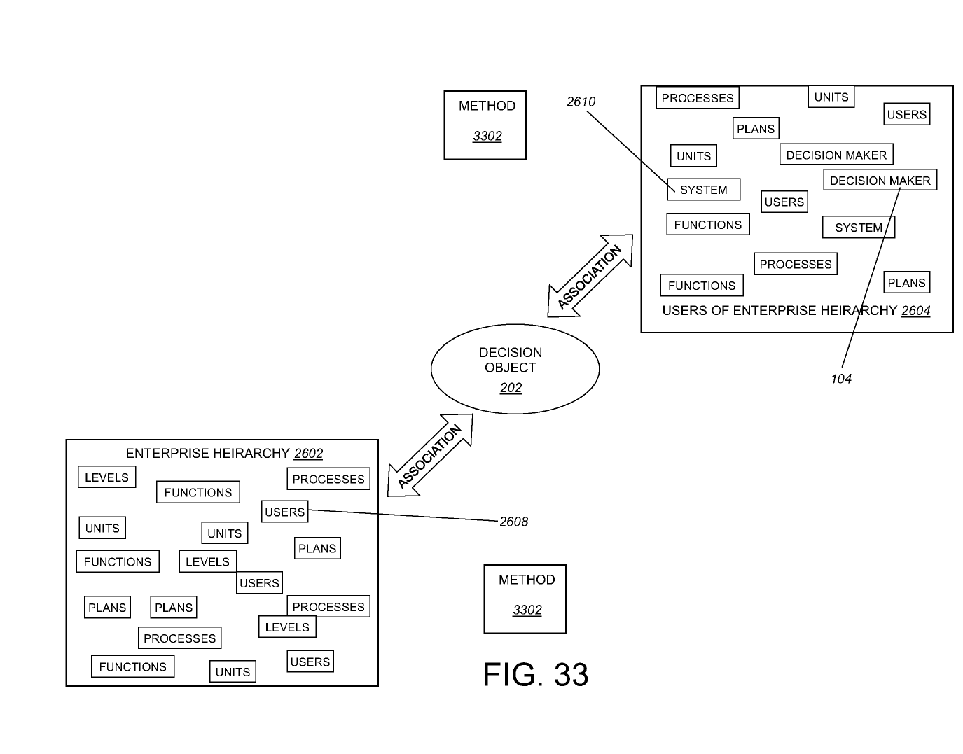

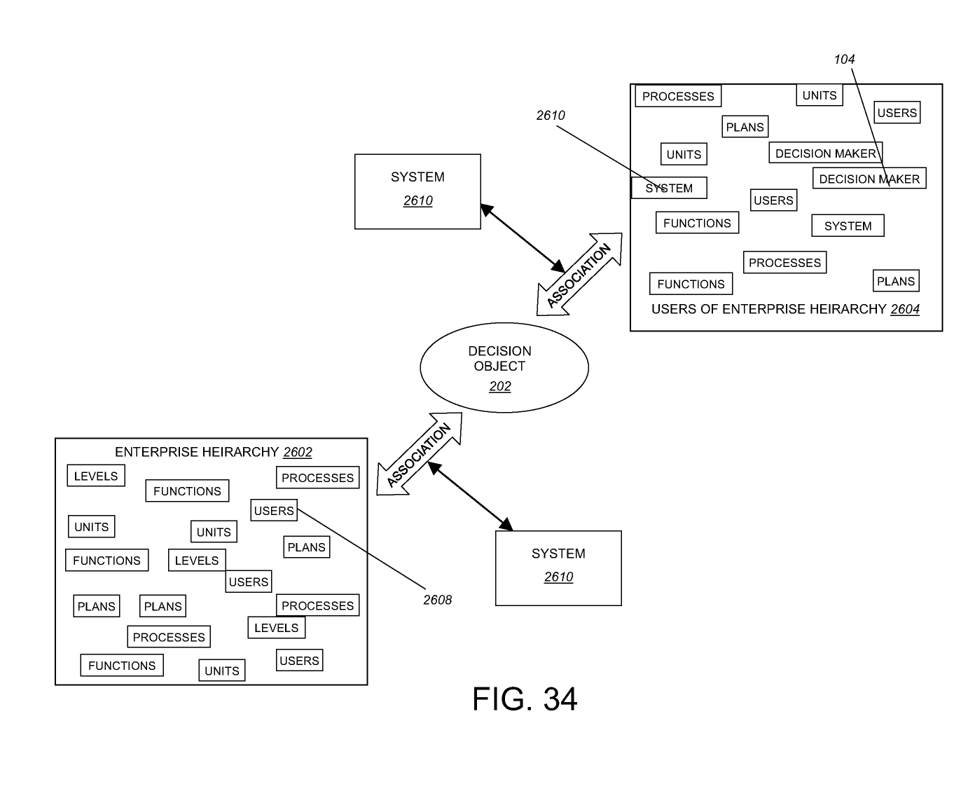

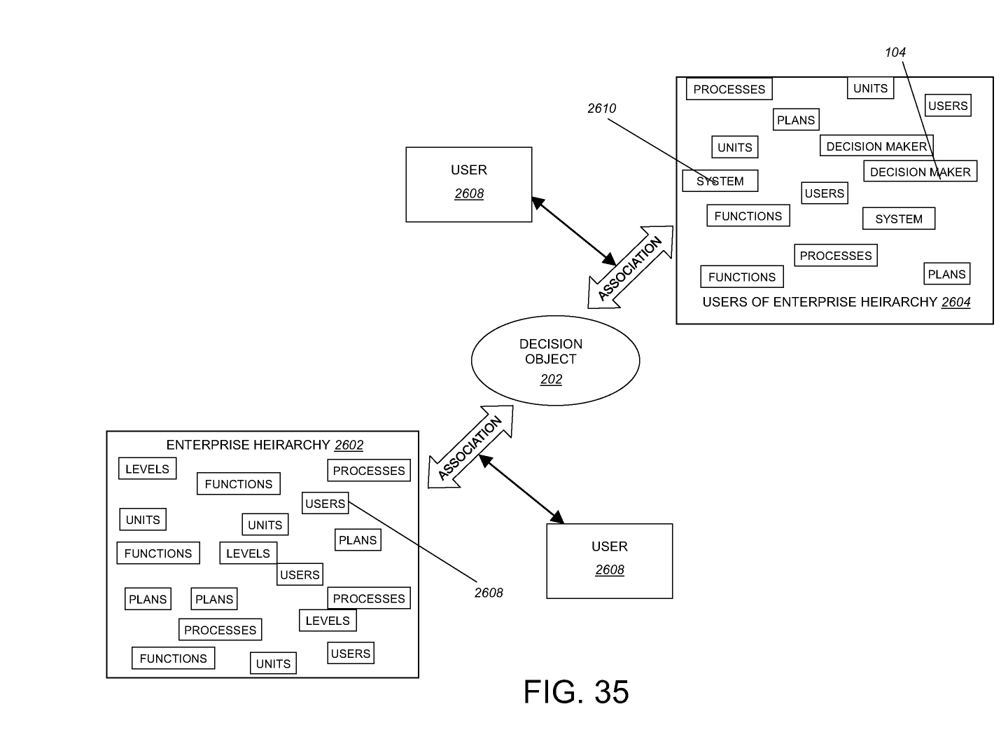

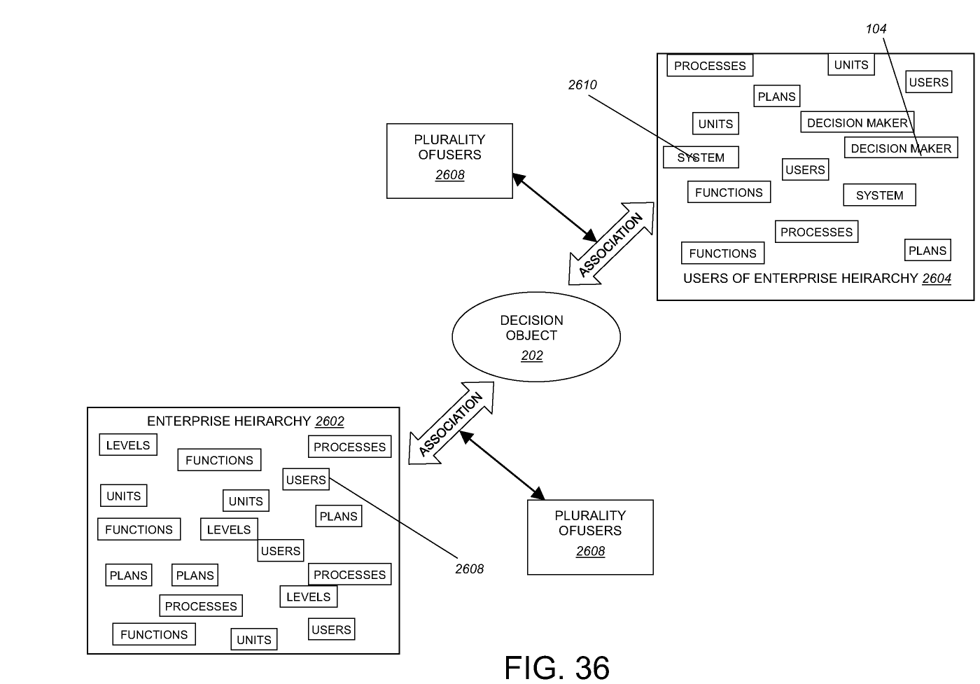

Referring back to FIG. 26, a decision object 202 may be associated with various subsets of an enterprise hierarchy 2602 and various users of an enterprise hierarchy 2604. The association may be driven by a method 3302, as depicted in FIG. 33, a system 3402, as depicted in FIG. 34, a user 2608, as depicted in FIG. 35, or a plurality of users 2608, as depicted in FIG. 36. The association may also be driven by a decision maker 104 or other subset of the enterprise 106. The method may be an enterprise planning method 502. In another example, an approval chain system 2610 can direct a decision object to various decision makers 104 in an enterprise 106 or ensure that certain systems 2610 are involved in a decision process 300. Another system 2610 may examine the attributes of a decision object 202 and determine whether or not they contain supply and demand attributes. If they do, the system 2610 may direct the decision object 202 to the supply chain, sales and finance departments, and may identify specific users 2608, decision makers 104 and other systems 2610 in those departments. Users 2608 modifying or creating a decision object 202 may also send or direct the decision object 202 to another user 2608 or system 2610 for review, approval and/or feedback. In other embodiments decision processes 300 are logically linked, so that decision makers 104 in each respective process 300 receive as inputs the proposed or actual decisions 102 (reflected as decision objects 202, optionally stored in shared data facilities 108) of the decision makers 104 in the other process.

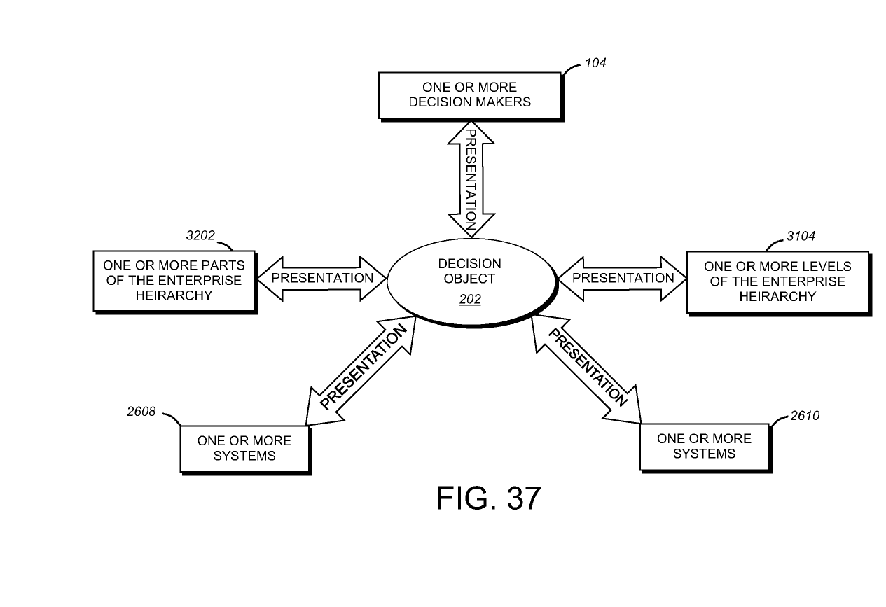

As depicted in FIG. 37, a decision object 202 may be presented, or a decision 102 may be made to present the decision object 202, to one or more decision makers 104, levels of an enterprise hierarchy 3104, systems 2610, users 2608, parts of an enterprise hierarchy 3202 or other subset of an enterprise 106. A decision object 202 may be presented using a viewing interface 2402. The presentation may be a component of a formal review process, as the result of a search performed on a subset of the decision objects 202 of the enterprise 106, or by automatically populating a software tool on the desk top of a user 2608 based on data associated with the decision object 202. The presentation may involve all or only certain attributes 1402 of the decision object 202. For example, upon request, a performance review system 2610 may be presented with all the decisions 102 proposed and executed by a particular employee. Referring back to FIGS. 33 through 36 the presentation can be driven by a method 3302, system 3402, user 2608, plurality of users 2608, decision maker 104 or other subset of the enterprise 106.

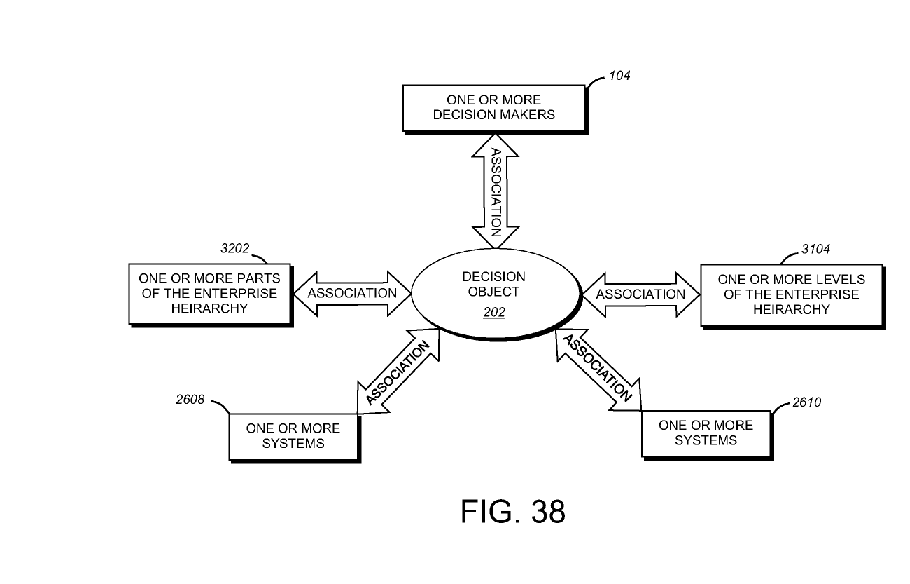

As depicted in FIG. 38, a decision object 202 may be logically associated, or a decision 102 may be made to associate the decision object 202, with one or more decision makers 104, levels of an enterprise hierarchy 3104, systems 2610, users 2608, parts of an enterprise hierarchy 3202 or other subset of an enterprise 106. The logical association may be in connection with a review, approval, feedback, information update or similar process. The decision 102 may become associated with certain systems 2610, methods 3302, such as an enterprise planning method 502, functions, processes and/or other subsets of the enterprise 106. For example, each time a decision object 202 is modified or updated, all the systems 2610 and decision makers 104 associated with the decision object 202 can be notified, or decision objects 202 can be updated and accessed by the software tools used by the various decision makers 104. Decision object 202 associations may also help to create and maintain approval chains for decisions 102 of a similar nature. Referring back to FIGS. 33 through 36 the association can be driven by a method 3302, system 3402, user 2608, plurality of users 2608, decision maker 104 or other subset of the enterprise 106.

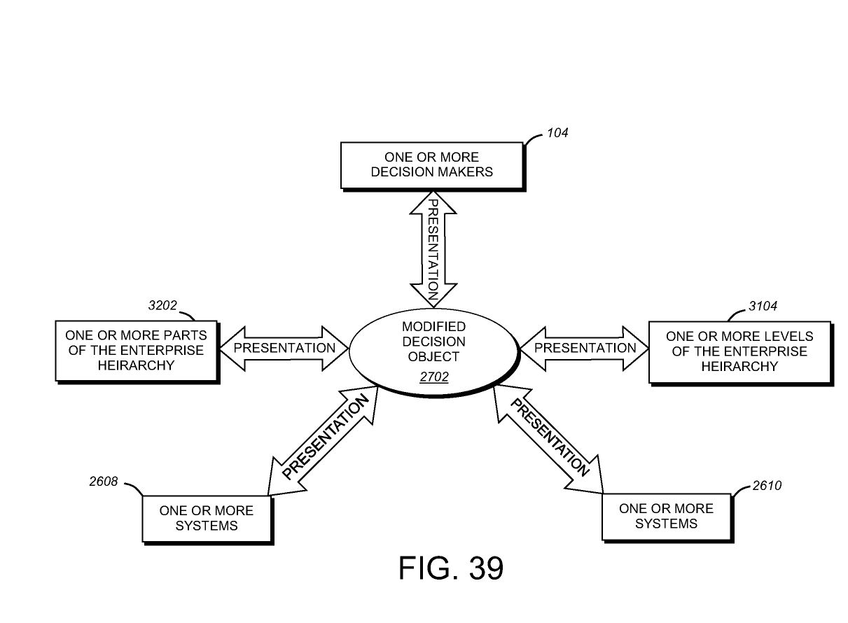

As depicted in FIG. 39, a modified decision object 2702 may be presented, or a decision 102 may be made to present the modified decision object 2702, to one or more decision makers 104, levels of an enterprise hierarchy 3104, systems 2610, users 2608, parts of an enterprise hierarchy 3202 or other subset of an enterprise 106. A modified decision object 2702 may be presented using a viewing interface 2402. The presentation may be a component of a formal review process or as the results of a search performed on a subset of the decision objects 202 of the enterprise 106. The presentation may involve all or only the modified attributes 1402 of the various decision processes 300. For example, upon request, a performance review system 2610 may be presented with each decision 102 modified by a particular employee within a certain time period of its creation. The information may then be used to determine whether or not the employee is second guessing herself. The presentation may also be the result of a modification notification system 2610. In embodiments, each time a decision object 202 is modified, the system 2610 may notify all the decision makers 104 who accessed that decision object 202 or related data in a given period, such as the two (2) months prior to the change, or at any point prior to the change. Referring back to FIGS. 33 through 36 the association can be driven by a method 3302, system 3402, user 2608, plurality of users 2608, decision maker 104 or other subset of the enterprise 106.

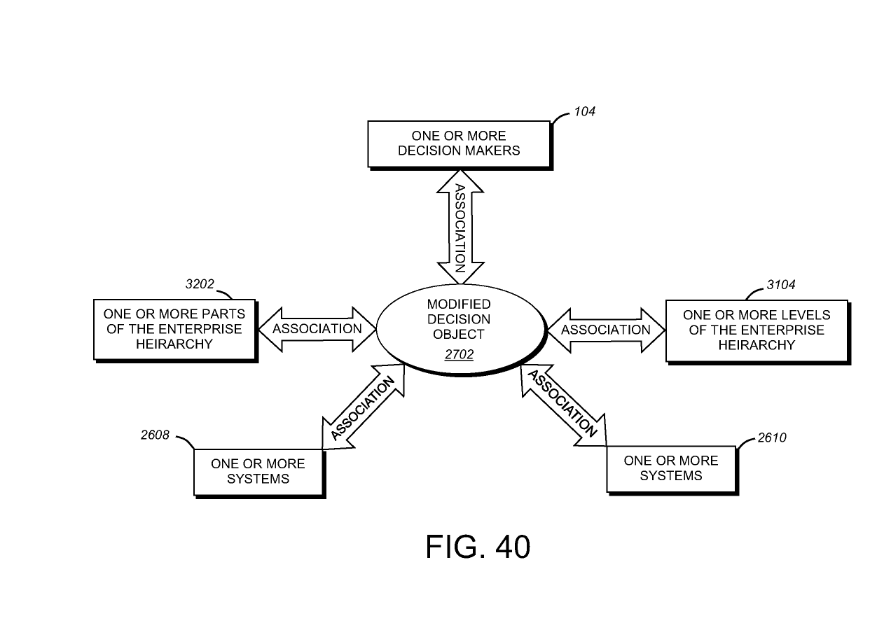

As depicted in FIG. 40, a modified decision object 2702 may be associated, or a decision 102 may be made to associate the modified decision object 2702, with one or more decision makers 104, levels of an enterprise hierarchy 3104, systems 2610, users 2608, parts of an enterprise hierarchy 3202 or other subset of an enterprise 106. The association may be in connection with a review, approval, feedback, information update or similar process. The decision 102 may become associated with certain systems 2610, methods 3302, such as an enterprise planning method 502, functions, processes and/or other subsets of the enterprise 106. For example, if a modification to a decision object 202 is subsequently undone, all the systems 2610 and decision makers 104 associated with the decision object 202 can be notified. Referring back to FIGS. 33 through 36 the association can be driven by a method 3302, system 3402, user 2608, plurality of users 2608, decision maker 104 or other subset of the enterprise 106.

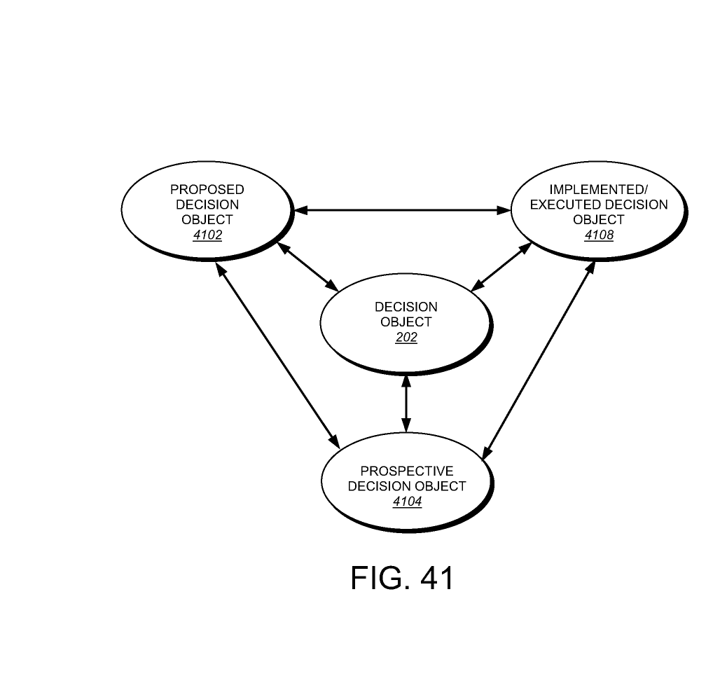

FIG. 41 depicts various relationships between various types of decision objects 202. A decision object 202 may be a proposed decision object 4102, prospective decision object 4104 and/or executed or implemented decision object 4108. Typically, a proposed decision object 4102 is proposed, but has not been executed or implemented, such as because it is waiting for approval or waiting to be triggered by a contingent event. A prospective decision object 4104 is typically one of a range of decision objects that have not been implemented and that are being considered, such as by modeling and comparing the respective impacts of the prospective decision objects 4104. A proposed decision object 4104 may be in the review or pre-approval stages. Once approved a decision may be made to execute a proposed decision object 4102 converting it into an implemented or executed decision object 4104. The executed decision object 4108 may travel throughout the enterprise, with or without the aid of the implementation engine referred to in FIG. 76, notifying various decision makers 104 and modifying relevant data facilities 108. In certain cases it may be possible to reverse the implementation of a decision object, converting it into a prospective 4104 or proposed 4102 decision object. Each of the prospective 4104, proposed 4102, and executed or implemented 4108 decision objects may be converted into or associated with one or more of any type of modified decision object 2702.

For example, an inventory management system 2610 may propose a decision 102 to increase the inventory of a product in response to a certain external event. The system 2610 may send the proposed decision object 4102 to the inventory management team for approval. The inventory management team may review the proposed decision object 4102 and may decide to execute the decision object 202. The executed decision object 4104 may be sent to the subsets of the enterprise 106 with which it is associated for a final review. It may be the case that no modifications are suggested within a day, so the executed decision object 4108 is sent to the implementation engine, referred to in FIG. 76 for implementation. The decision object 202 and the related prospective 4104, proposed 4102, and executed/implemented 4108 decision objects 202 may be stored or maintained as data 108 for review at a later date.

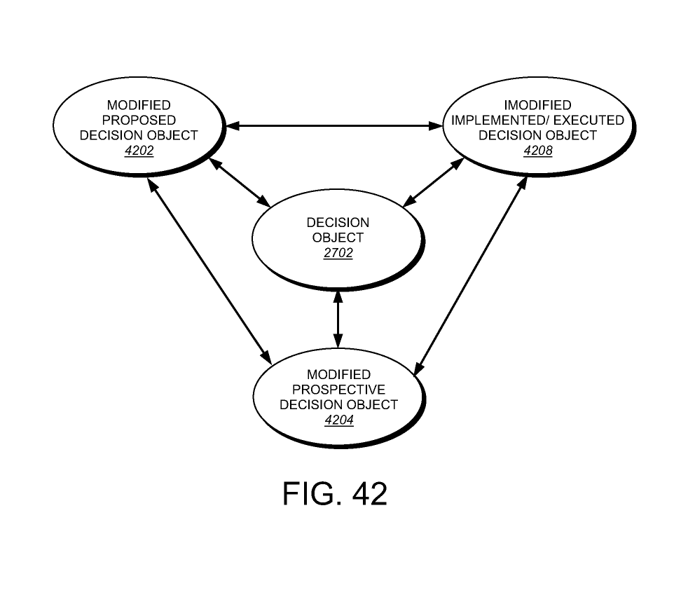

A decision object 202, prospective decision object 4104, proposed decision object 4102, and/or executed/implemented decision object 4108 may be modified. FIG. 42 depicts the various types of modified decision objects such as a modified decision object 2702, a modified proposed decision object 4202, a modified prospective decision object 4204 or a modified implemented/executed decision object 4208. The types of modified decision objects 2703 are analogous to the types of decision objects 202. Typically, a modified proposed decision object 4202 has not been executed or implemented. A modified proposed decision object may have been a proposed decision object 4102 which was modified, a modified proposed decision object 4202 which was further modified or any other type of decision object 202 which may be changed, modified and/or reversed. A modified implemented or executed decision object 4208 may have been an implemented decision object 4108 which was modified, a modified executed decision object 4208 which was implemented or the like. More often than not, whether a decision object 202 is conceptualized as a modified decision object 2702 or a decision object 202 is relative. A modified decision object 2702 may often be redefined as a decision object 202.

For example, a decision maker 104 in the promotion planning unit may propose a decision 102 to run 100 print advertisements in the next month. The decision maker 104 may send this proposed decision object 4102 to the relevant approval chain 112 for review. A promotions executive may reduce the number of advertisements to seventy-five, creating a modified proposed decision object 4202. The modified proposed decision object 4202 may be circulated as a proposed decision object 4102 for further comment. If no comments are received within a specified period, say one day, then the decision 102 may be automatically executed. Before implementation it is possible that a system 2610 may detect an internal inconsistency with the decision 102, for example, an error in the name of a data facility 108 and automatically correct the problem creating a modified executed decision object 4108.

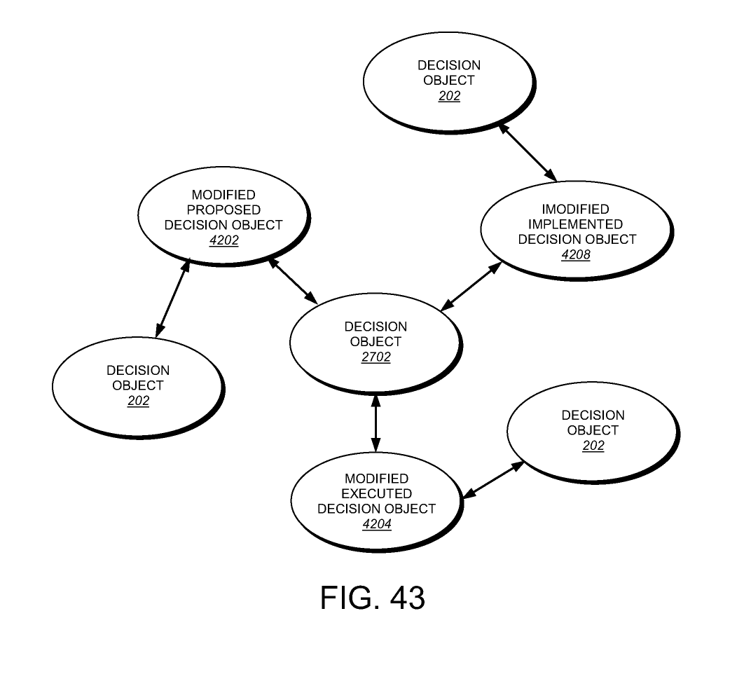

FIG. 43 depicts relationships that may exist between various decision objects 202 and modified decision objects 2702. Any modified decision object 2702 may become a decision object 202 which may be any proposed decision object 4102, prospective decision object 4104 or executed/implemented decision object 4108. Modified decision objects 2702 may share the same properties as decision objects 202. A proposed modified decision object and a modified proposed decision object 4202 may be interchangeable. An executed modified decision object and a modified executed decision object 4208 may be interchangeable. An implemented modified decision object and a modified proposed decision object 4208 may be interchangeable.

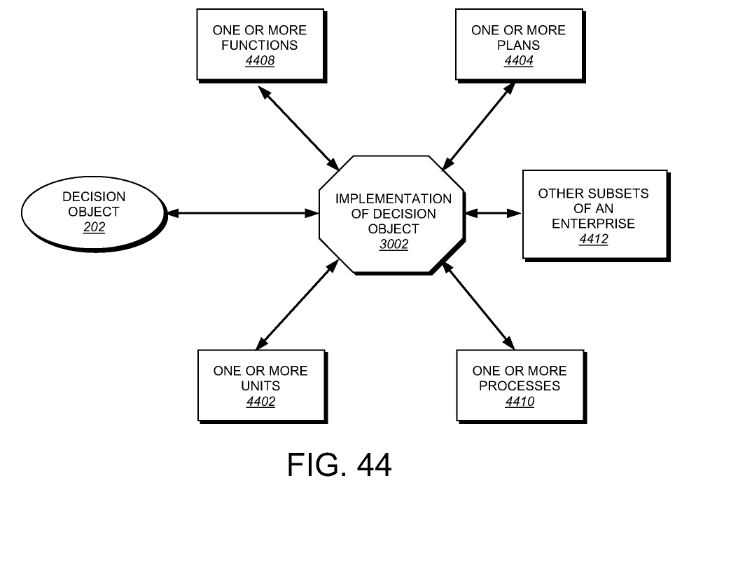

FIG. 44 depicts a decision 102 to implement a decision object 202. As discussed above the decision object may be a proposed, prospective, executed/implemented and/or modified. The decision 102 may be implemented in one or more units 4402, plans 4404, functions 4408, processes 4410 or other subsets of an enterprise 4412. In this manner the implementation of a decision may have far reaching effects throughout an enterprise 106. As such, it may be difficult to reverse the effects of a decision 102 once implemented. For example, a decision 102 may involve the conversion of one currency to another. Once implemented it may be hard to reverse this decision without damage as transaction costs may be occurred exchanging the currency and the market may have changed to the disadvantage of the enterprise 106.

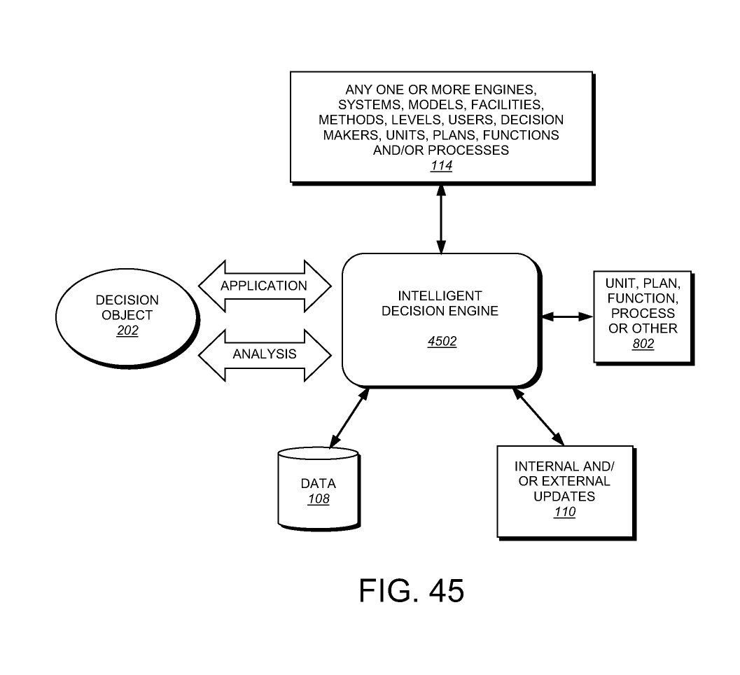

As depicted in FIG. 45 an intelligent decision engine 4502 may be applied to, or may analyze, a decision object 202. An intelligent decision engine 4502 may interact with data 108 and/or data facilities 108, internal and/or external updates 110, units, plans, functions, processes or other subsets of the enterprise 802, or any aids or decision tools 114. An intelligent decision engine 4502 may provide assistance in decision-making and guide decision makers 104 through a decision process 300. An enterprise may have more than one intelligent decision engine 4502.

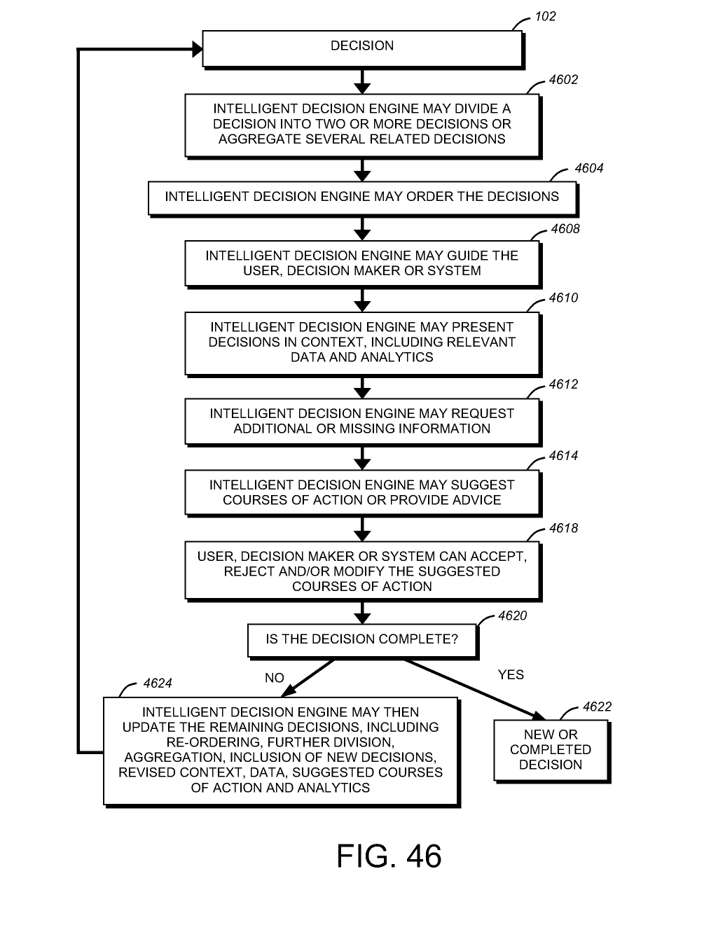

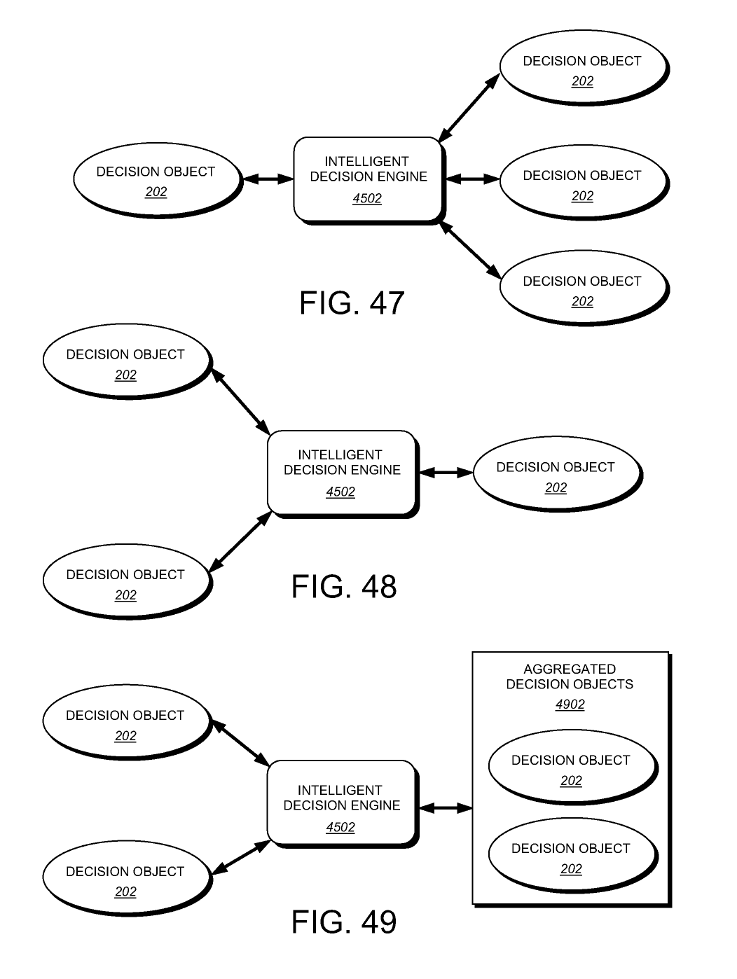

In one embodiment, the intelligent decision engine 4502, may proceed as in the simplified high-level flow chart depicted in FIG. 46. The decision 102 may be proposed, prospective, executed, implemented and/or modified. In embodiments, in a step 4602 the intelligent decision engine 4502 may divide, break, decompose and/or disaggregate a decision 102 into two or more decisions. FIG. 47 shows an intelligent decision engine dividing, breaking, decomposing and/or disaggregating a decision object 202 into more than one decision object 202. As an example, the decision 102 may involve determining which products to offer in the next quarter. The intelligent decision engine 4502 may break this decision into several component decisions 102 such as determining the demand forecast for each product, the cost of distribution for each product, the cost of production for each product, the cross-promotion potential of the products and the like. It may be the case that the intelligent decision engine 4502 only conceptually breaks down a decision object 202 or creates a copy of the original decision object 202, leaving the original decision object 202 intact. This may be helpful when the original decision object 202 relates to one or more subsets of an enterprise 4412. For example, many units, plans, functions, processes and other subsets of the enterprise 802 may use or require aspects of the decision object 202 dealing with the products to be offered during the next quarter. Breaking down the decision object 202 can facilitate logically linking one or more decision processes 300, such as by having them share one or more decision objects 202 that relate to logically linked decisions.

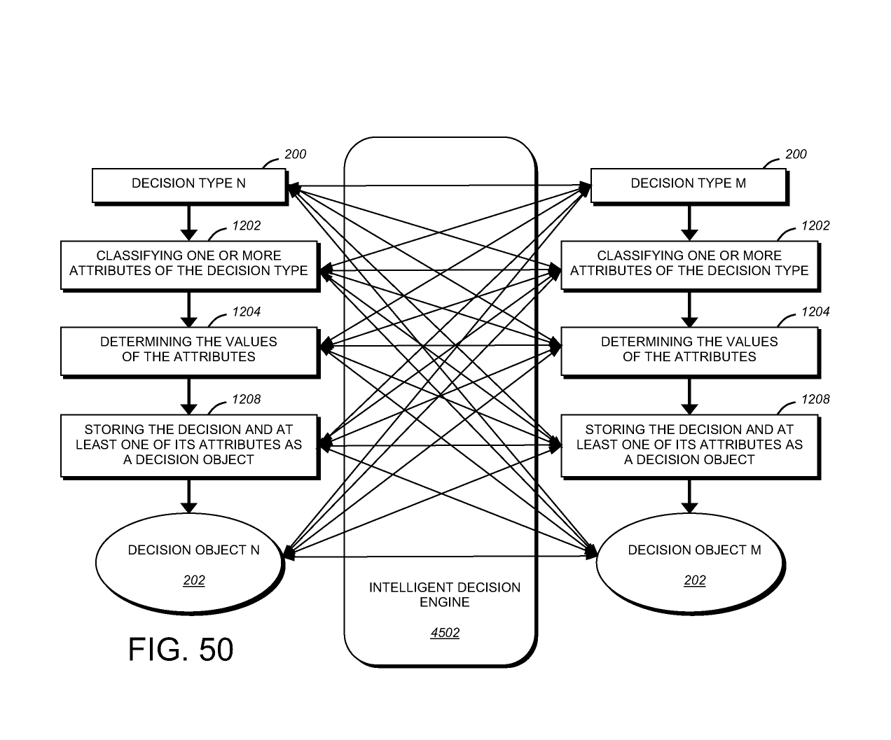

In step 4602 the intelligent decision engine 4502 may also aggregate, link, join and/or associate several related decisions 102. FIG. 48 shows an intelligent decision engine 4502 aggregating, linking, joining and/or associating two or more decision objects 202 to form another decision object 202. One of the aggregated decision objects 202 may be the original decision sent to the intelligent decision engine 4502 by the user 2608 and the other may be a decision object that the intelligent decision engine 4502 determined may be relevant to the original decision 102. For example, the original decision 102 may involve determining the demand for a product. As discussed above, the demand for a product is related to the price of the product. As such the intelligent decision engine 4502 may aggregate the demand decision object 202 with the price decision object. FIG. 49 shows the intelligent decision engine 4502 aggregating, linking, joining and/or associating two or more decision objects 202. In this case a new decision object 202 is not formed, but the decision objects are linked or associated in some manner to form an aggregation of decision objects 4902. The aggregation of decision object 4902 may be acted on in the same manner as a single decision object 202, however, each decision object is distinctly preserved. This may be desirable in cases where the decision objects 202 related to multiple subsets of an enterprise 4412. For example, many units, plans, functions, processes and other subsets of the enterprise 802 may use or require aspects of the decision objects 202 dealing with the products to be offered during the next quarter. As depicted in FIG. 50, the intelligent decision engine 4502 may also aggregate, link, join and/or associate decision processes 300 or certain steps of two or more decision processes. The intelligent decision engine may also suggest or emphasize relatedness between one or more steps of various decision processes 300. One of the decision processes 300 may correspond to the decision 102 sent to the intelligent decision engine 4502 by the decision maker 104. The intelligent decision engine 4502 may identify a step of another decision process 300 of the enterprise 106 that is relevant to the original decision process 300 or to a step of the original decision process 300. For example, the original decision process 300 may involve selecting certain products to be offered during the next quarter. One step of this process involves determining which attributes 1402 of a product are important and embodying those attributes 1402 in a decision object 202. The intelligent decision engine 4502 can, for example, search relevant data facilities 108 and located the relevant step of a similar decision process 300 from a prior year in order to offer suggestions and speed the process for the current quarter. In embodiments, a search facility may search for decision objects 202 that share similar attributes with the decision type 200 of the decision object 202. For example, a decision process 300 to determine the preferred attributes of the product might be linked to a decision process 300 that indicates what attributes are available, such as indicated by a data object that stores attributes of products provided by various vendors.

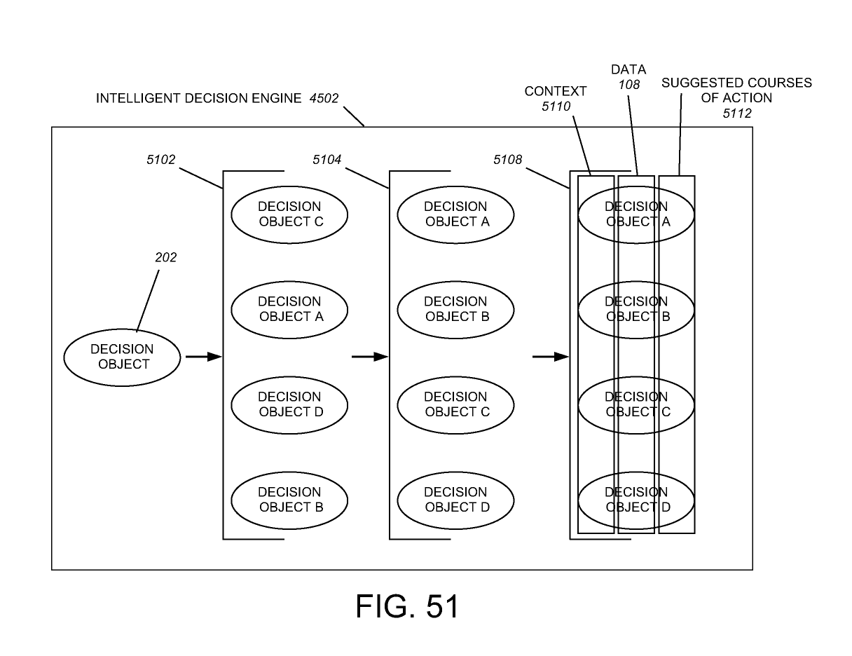

In step 4604, the intelligent decision engine 4502 may order the decisions 102. The decisions 102 may be placed in a logical order, an order that will make the process intuitive to the user 2608 or another order. In step 4608, the intelligent decision engine 4502 may guide the user 2608, system 2610 or decision maker 104 through the decision process 300, including prompts where necessary. In step 4610, the intelligent decision engine 4502 may present the steps and decisions 102 in context, including any relevant data 108 and analytics, such as from various analytical tools 114. FIG. 51 is a simplified high-level schematic diagram representing certain aspects of the intelligent decision engine. Step 5102 may correspond to the situations in any or all of FIGS. 48 to 50. Step 5104 may place the decision objects 202 in a logical order for presentation to the decision maker 104. For example, determining the number and types of products before deciding on accessories or option packages. Step 5108 may involve analysis of the decisions 102. The analysis may draw on the context of the decisions 102, relevant data 108 and may result in suggested courses of action and advice 5112 or may rely on suggested courses of action and advice 5112 from other decisions 102. For example, in order to determine which products to offer next quarter, the context 5110 may involve information about current styles and fashions. Relevant data 108 may concern any intelligence on the products competitors will likely offer next quarter. The intelligent decision engine 4502 may also look to the courses of action suggested in connection with this decision last quarter and may also offer suggestions based on the information and data 108 available.

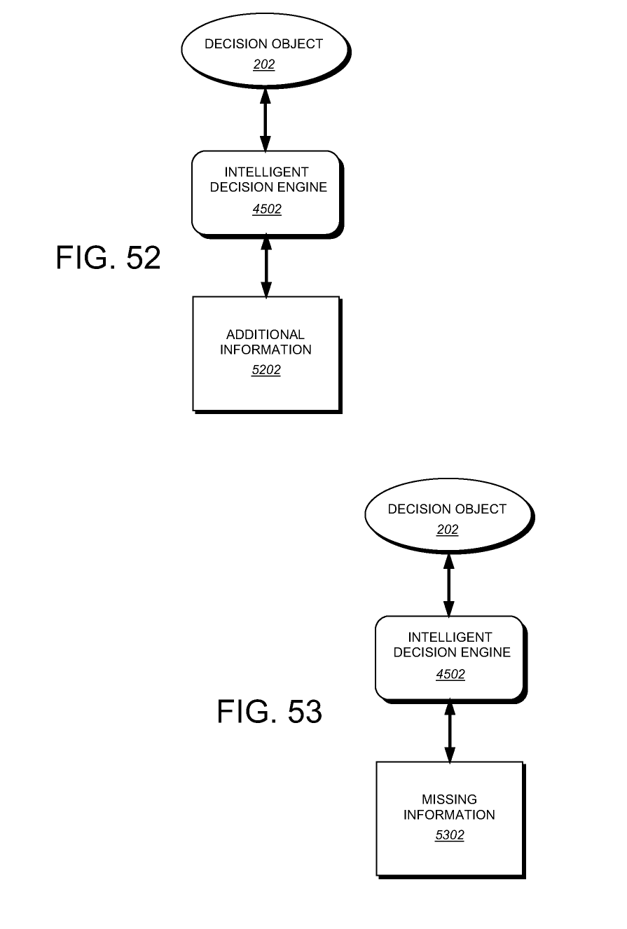

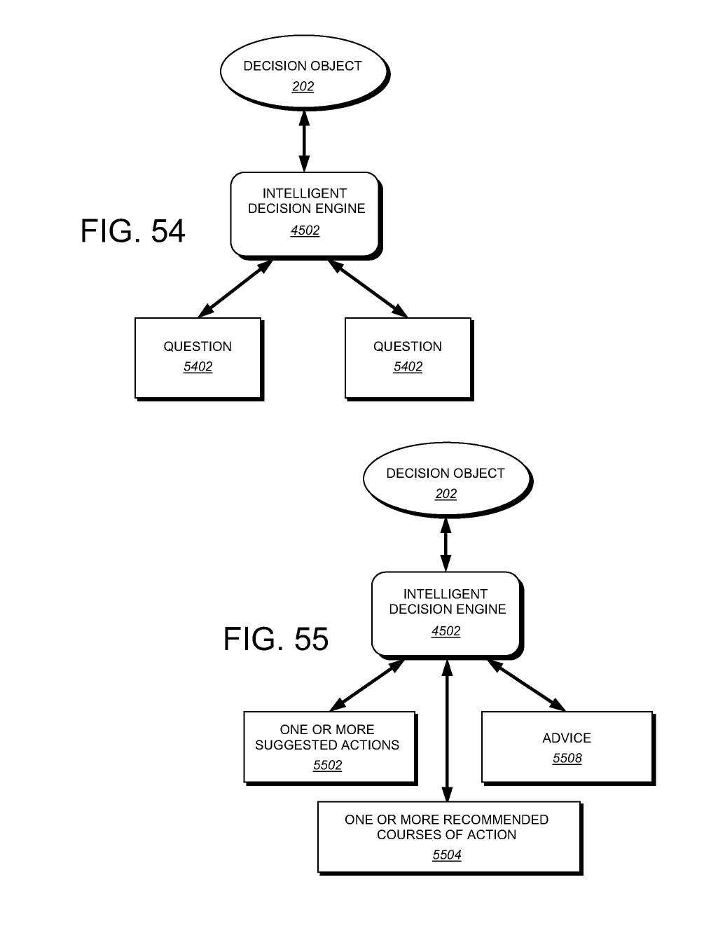

In step 4612, the intelligent decision engine 4502 may request additional or missing information. As depicted in FIG. 52 the intelligent decision engine 4502 may request additional information 5202 in connection with a decision 102. As depicted in FIG. 53 the intelligent decision engine 4502 may determine that certain information is missing 5302 in connection with a decision 102. The additional information 5202 and missing information 5302 may be needed to confirm inconsistent or possibly erroneous information, may be needed to complete the decision process 300, may be helpful to the decision process 300 and the like. As depicted in FIG. 54, the intelligent decision engine 4502 may pose one or more questions. The questions may be for the purpose of obtaining additional 5202 or missing 5302 information, learning how to better assist the decision maker 104 or the like. For example, a decision may be made to produce cars, however, the intelligent decision engine 4502 determines that the ground clearance may be too high for a car. The intelligent decision engine 4502 may request more information about the vehicle or pose a question to determine if the units should be centimeters rather than inches.

In step 4614, the intelligent decision engine 4502 may suggest courses of action or provide advice 5112. The intelligent decision engine 4502 may provide one or more suggested actions 5502, one or more recommended courses of action 5504 or advice 5508. For example, the intelligent decision engine may recommend the production of four products for the next quarter, or it may advise the decision maker 104 to consult with one or more other departments or individuals of the enterprise 104. In step 4618, the user 2608, system 2610 or decision maker 104 may accept, reject and/or modify any of the recommendations 5112, 5502, 5504 of the intelligent decision engine. The intelligent decision engine 4502 may propagate the effects of the decision maker's 104 choices at step 4618 or any other step. For example, the decision maker 104 may choose to produce five products instead of four. The intelligent decision engine 4502 may, possibly in connection with the implementation engine, propagate the effects of the decision 102. The order of steps 4602 through 4616 may be modified. For example, the intelligent decision engine 4502 may request additional information before it orders the decisions 102.

Step 4620 serves as a decision point for the process. If the decision is complete a new decision object may be created or the decision 102 may simply be complete 4622. The decision 102 may be executed or implemented or sent to an approval chain 112. If the decision 102 is not complete, the method may proceed to step 4624. The intelligent decision engine 4502 may update the information and data 108 and the like to account for any feedback from the decision maker 104, it may also update or modify any remaining decisions to account for any new information or data 108, it may further re-order or divide the remaining decisions 102, or further aggregate or include other decisions in response to updates or new contextual information 5110. The process may then repeat.

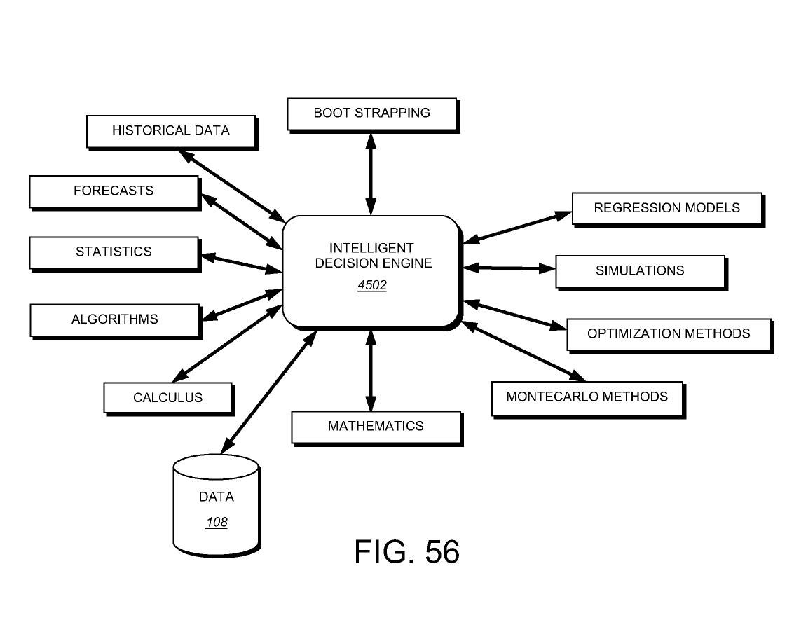

As depicted in FIG. 56, the intelligent decision engine 4502, may rely on various inputs, methods, systems 2610, processes and information, such as mathematics, statistics, calculus, algorithms, simulations, boot strapping, iterative models, econometric models, game theoretical models, Monte Carlo methods, optimization methods, regression models and the like. The intelligent decision engine 4502 may also rely on data 108 such as internal, external, historical and forecast data 108.

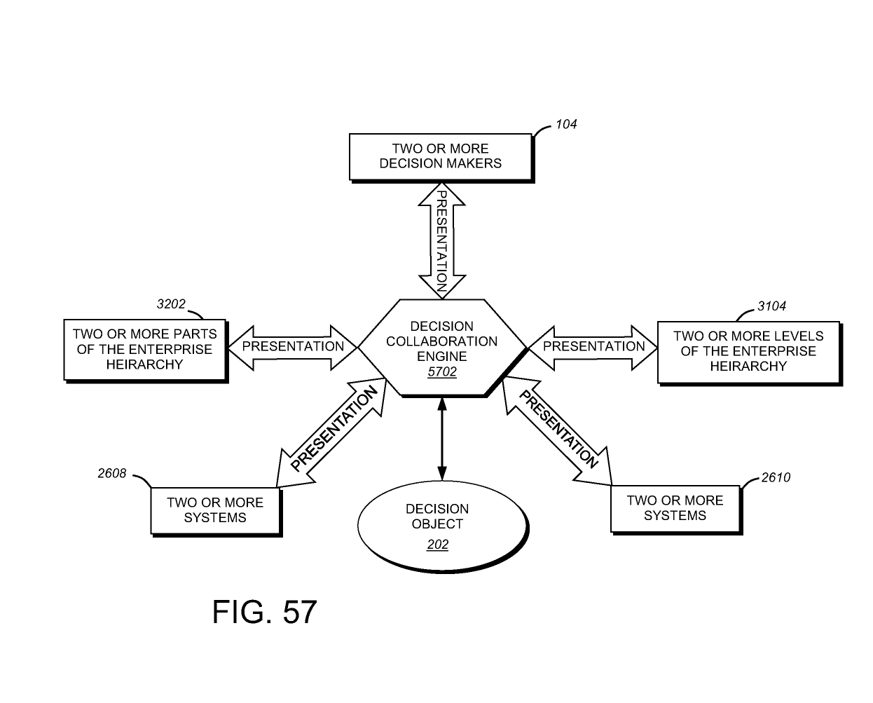

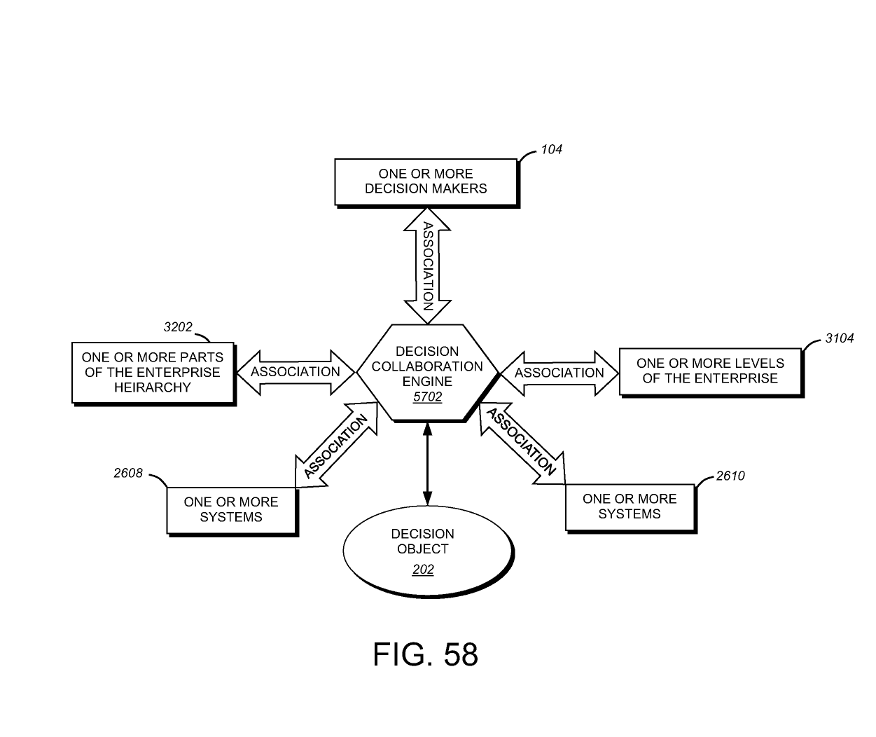

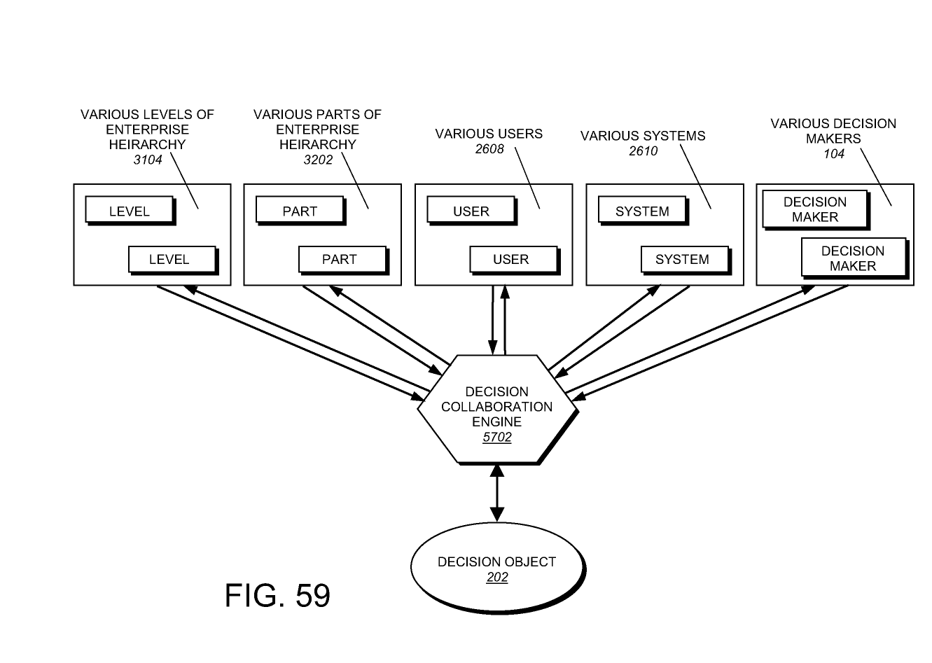

Referring to FIG. 57, a decision collaboration engine 5702 may enable collaboration among the many disparate subsets of an enterprise 106 such as units 4402, plans 4404, functions 4408, processes 4410 and/or other subsets of an enterprise 4412. An enterprise 106 may have more than one decision collaboration engine 5702. As depicted in FIG. 57 a decision collaboration engine 5702 may present a decision 102 or proposed decision to two or more levels of an enterprise hierarchy 3104, parts of an enterprise hierarchy 3102, users 2608, systems 2610 and/or decision makers 104. As depicted in FIG. 58 a decision collaboration engine 5702 may associate a decision 102 with two or more levels of an enterprise hierarchy 3104, parts of an enterprise hierarchy 3102, users 2608, systems 2610 and/or decision makers 104. The presentation or association may allow for collaboration among the many subsets of an enterprise 106. Collaboration may streamline the decision process 300 and increase the quality of decisions 102. Collaboration may allowing more parties to participate in the decision process 300 and may allow the decision maker 104 to access more relevant information and data 108. As shown in FIG. 59, a decision collaboration engine 5702 may present or associate a decision object with relevant levels of an enterprise hierarchy 3104, parts of an enterprise hierarchy 3102, users 2608, systems 2610 and/or decision makers 104. The levels of an enterprise hierarchy 3104, parts of an enterprise hierarchy 3102, users 2608, systems 2610 and/or decision makers 104 may allow the decision object to inform their other decisions 102 or may provide information or feedback in connection with the decision 102 aiding the decision maker 104. For example, the North American subsidiary of an international vehicle maker may propose a decision 102 to replace the standard five mile-per-hour bumpers with four mile-per-hour bumpers on a new truck. The decision collaboration engine 5702 may send the proposed decision object 4102 to the development team in the German subsidiary for feedback. The German team may modify the decision object 202 to include three mile-per-hour bumpers and provide data indicating that three mile-per-hour bumpers lower cost while providing a greater level of safety.

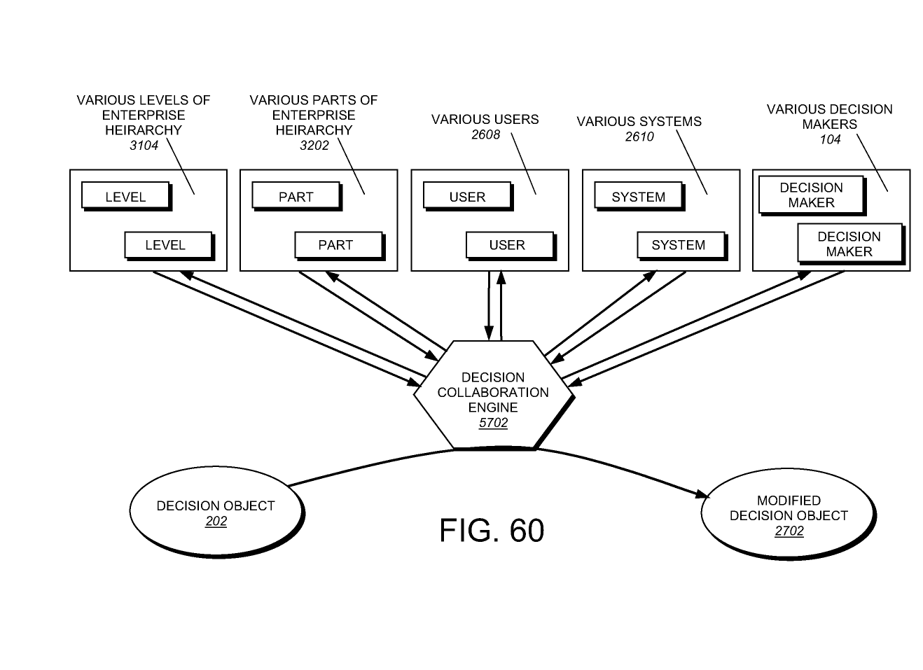

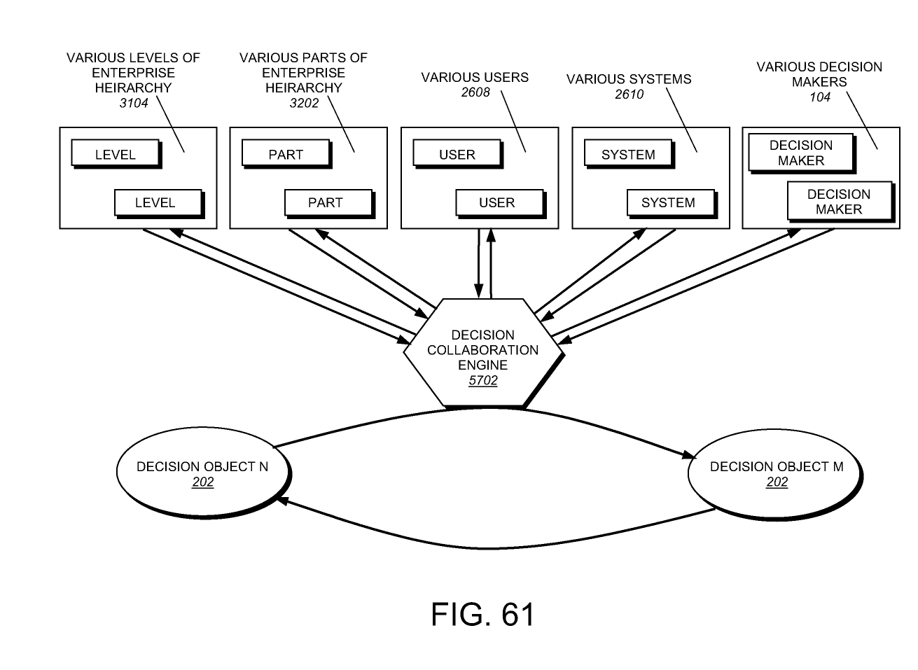

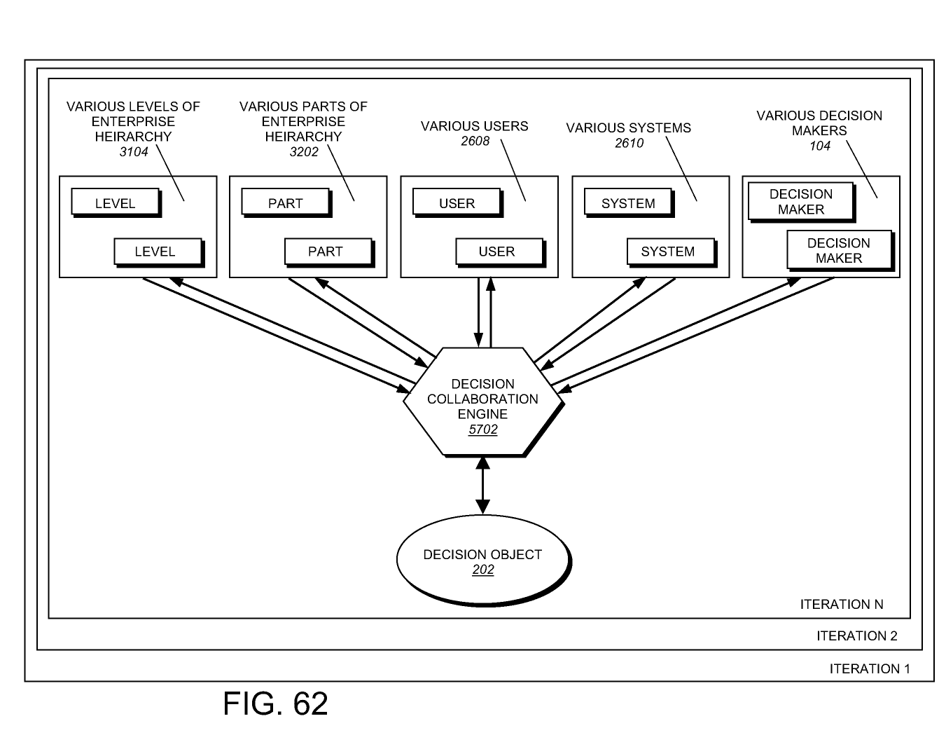

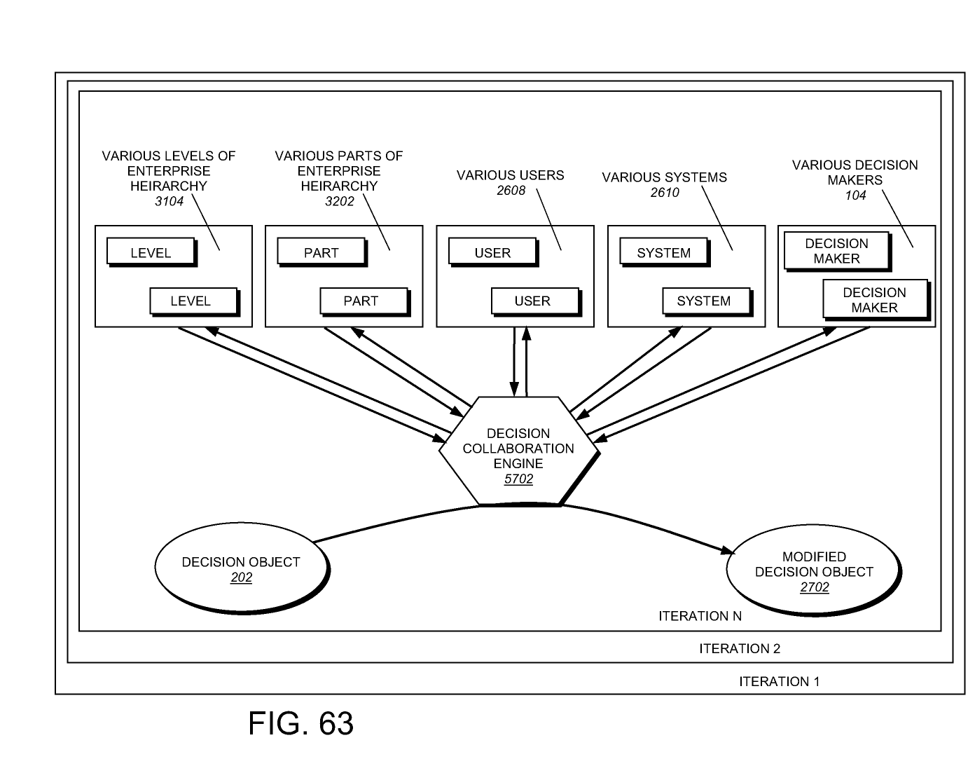

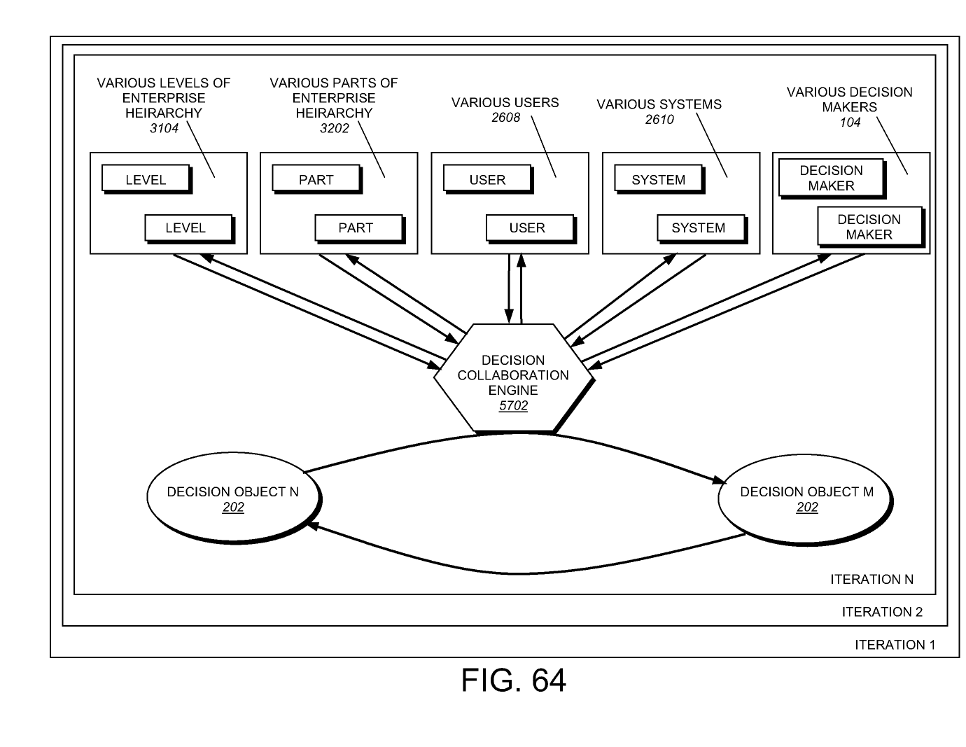

As depicted in FIG. 60, a decision 102 may be modified in response to feedback or other information resulting from the collaborative process. For example, referring to the example accompanying FIG. 59, the North American division may modify the decision object 202, reducing the bumpers to three mile-per-hour models, creating a modified decision object 2702. As shown in FIG. 61, the process can be iterative. The modified decision object 2702 can be conceptualized as a new decision object 202 which can be subject to further collaboration using the collaboration engine 5702 or other means. For example, the North American team may propose reducing the bumper rating to two miles per hour. The Japanese team may then provide data 108 indicating that bumpers rated at two miles per hour may not be acceptable for a vehicle of the proposed weight. The North American team may then propose a reduction in the weight of the vehicle. This decision may be subject to further collaboration using the collaboration engine 5702 or other means. FIGS. 62 and 63 illustrate that the process described in FIGS. 59 and 60 may also be iterative. FIG. 64 adds a layer of iteration to the process described in FIG. 61 in a different manner. In the case of FIGS. 62 through 64, the iterations may be separate related decisions, such as logically linked decisions. For example, an enterprise 106 may need to decide on several attributes 1402, such as color, size and flavor, for a new line of beverages to come out in the fall. The iterations may correspond to each separate beverage, while the decision objects related to the various attributes 1402 to be determined. The iterations may be conducted in series or in parallel or entirely simultaneously, such as through logical linking of the decision processes 300 and sharing of decision objects 202, as described in connection with FIG. 11.

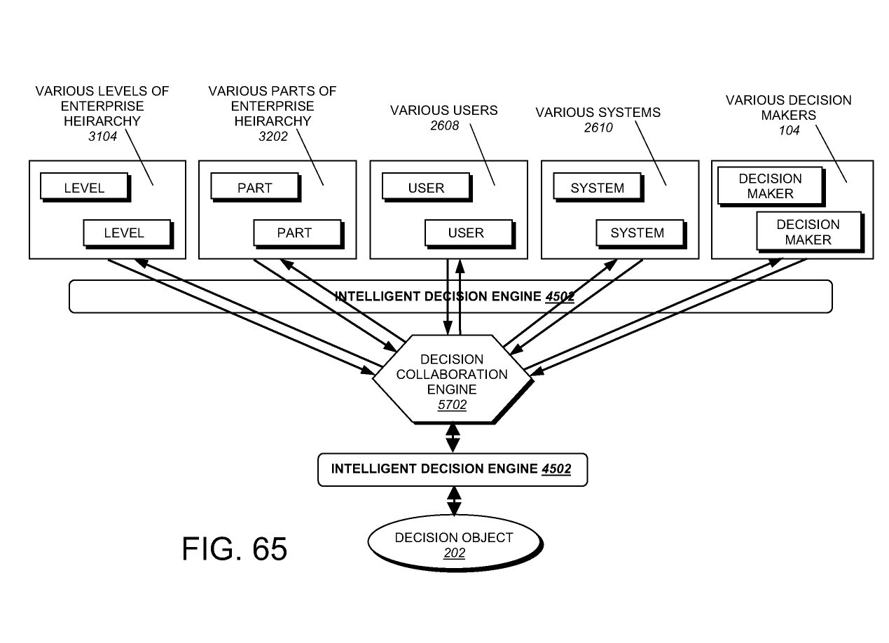

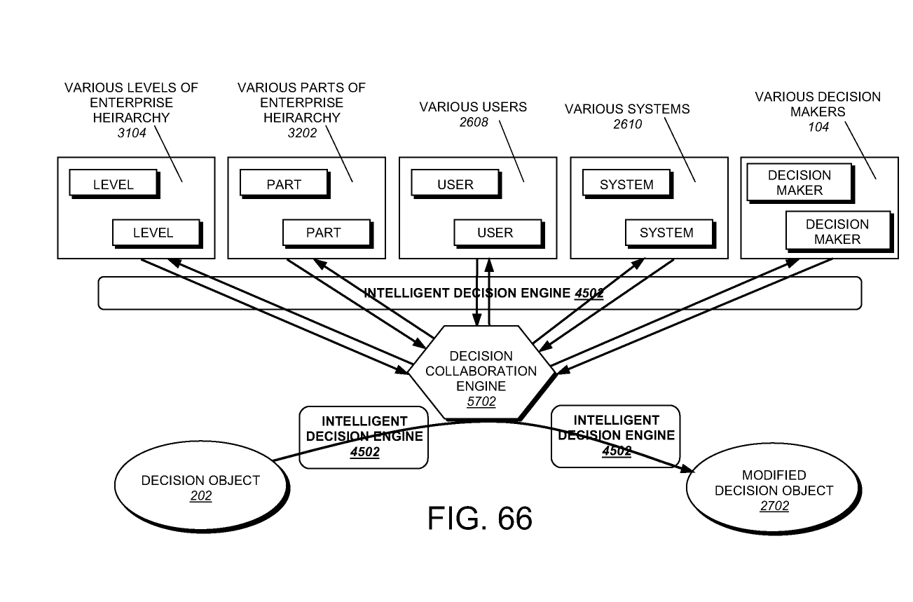

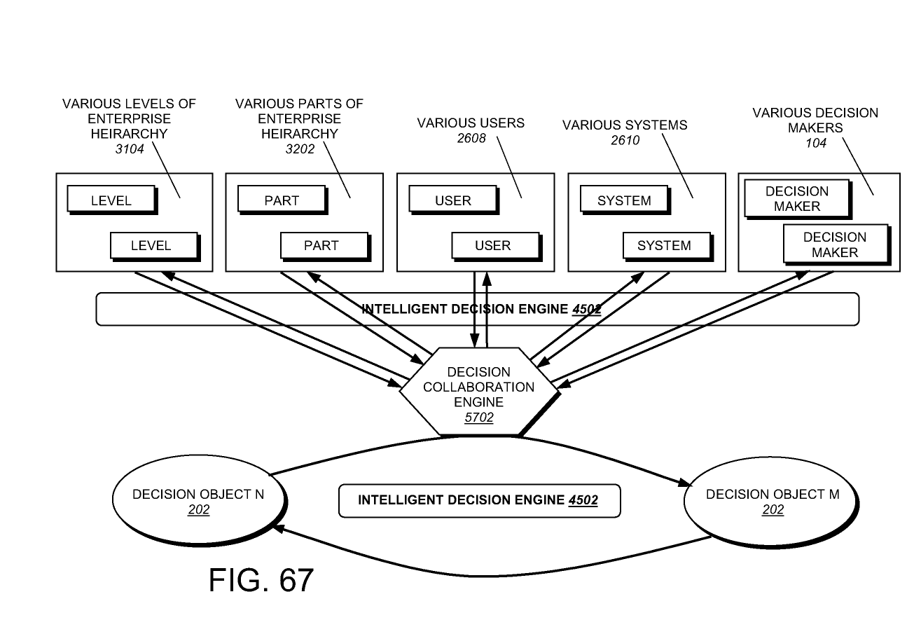

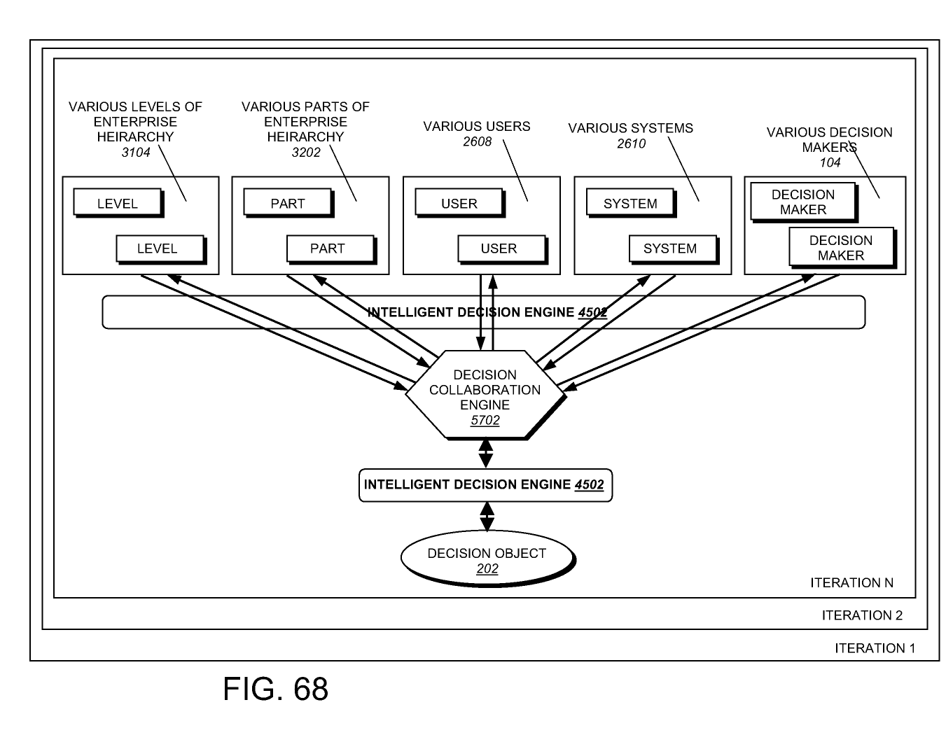

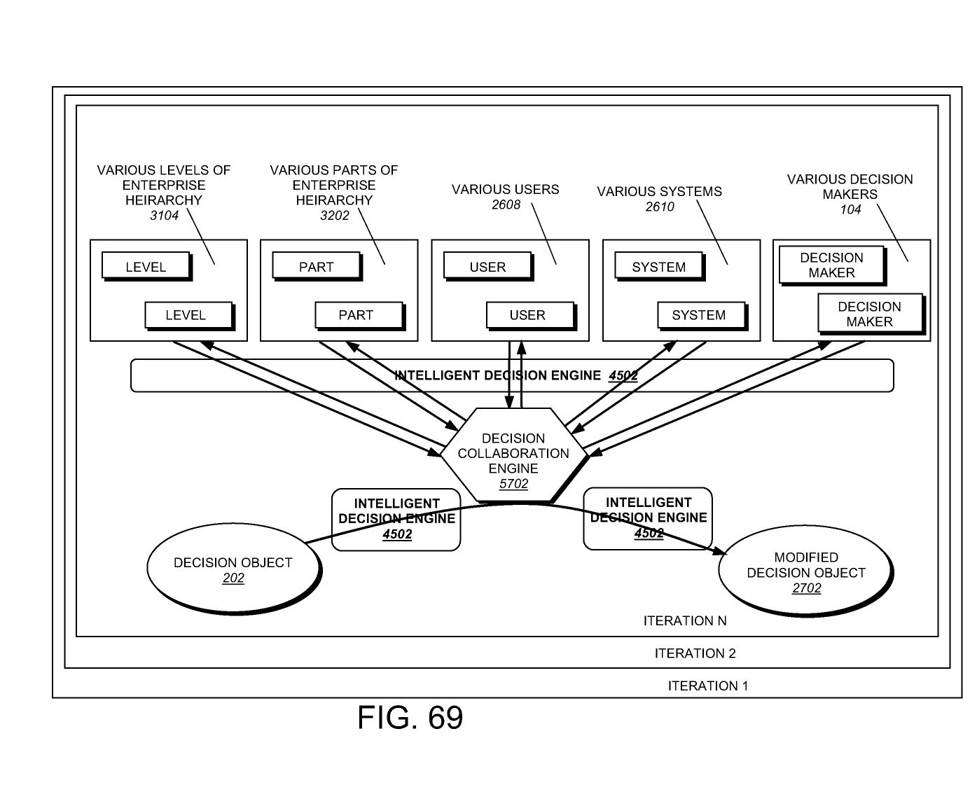

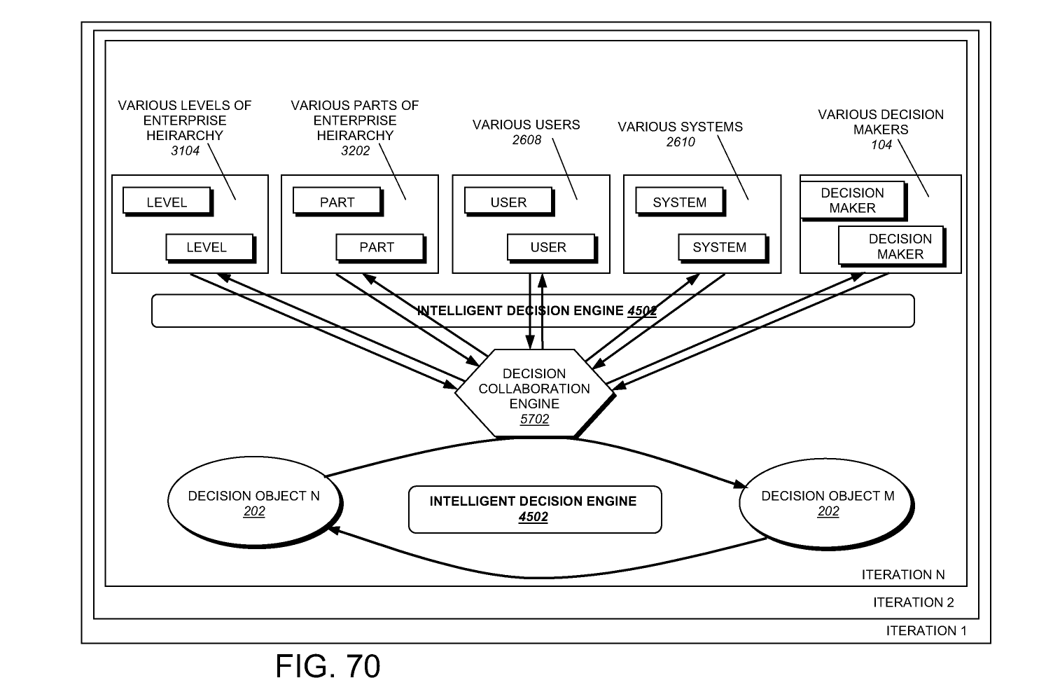

FIGS. 65 through 70 mirror FIGS. 59 through 64, with the inclusion of one or more intelligent decision engines 4502. The processes and methods are the same, except that an intelligent decision engine 4502 may aid or be involved in the processes and methods depicted in FIGS. 65 through 70. An intelligent decision engine 4502 may filter the collaboration, removing information irrelevant to the decision 102. An intelligent decision engine 4502 may aid in the determination of which subsets of an enterprise 106 should be included for collaboration in connection with each aspect or step of a decision 102. An intelligent decision engine 4502 may seek out subsets of an enterprise that may have data 102 that is identified as missing or in need or verification in step 4612. An intelligent decision engine 4502 may also guide the decision-making and collaborative processes by posing questions for the collaborators to answer. For example, an intelligent decision engine 4502 may determine which data 108 should be shared with which subsets of an enterprise 106. For example, in an acquisition context, it may be necessary to restrict certain information to a subset of an enterprise 106, until the acquisition in made public. Thus, for example, a decision object 202 can be associated with a level of permission or security, so that it can be accessed, written to, read, or forwarded only by users, departments, personnel, processes or the like that have appropriate access rights, such as determined by policies of the enterprise 106, which can be embodied in decision processes 300 that act on decision objects 202 that embody the security requirements.

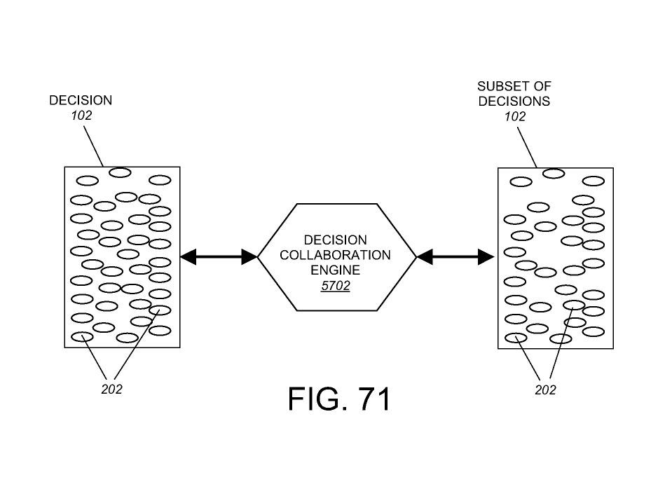

As depicted in FIG. 71 the decision collaboration engine 5702 may act on or with all or a subset of the decision objects 202 of an enterprise. The decisions 102 included in the subset of decisions 102 may be determined by one or more decision makers 104, analytical tools 114 such as the intelligent decision engine 4502 or may simply be composed of all the decision objects 202 available at the time of decision 102.

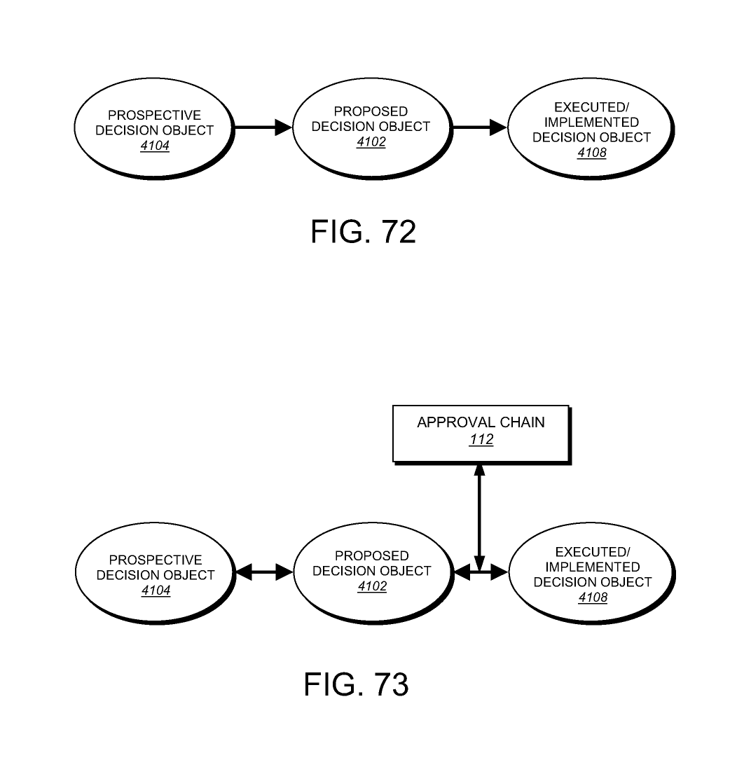

FIG. 72 depicts one possible progression of a decision object 202 through an enterprise 106. A prospective decision object 4104 may become a proposed decision object 4102, which may then proceed to become an executed decision object 4108. As depicted in FIG. 73, the progression of the decision object 202 through the enterprise 106 may involve an approval chain 112. The approval chain 112 may play a role before a decision 102 is executed or implemented, or at any other stage in the process. For example, a manager may propose that the enterprise 106 hire a consultant to perform certain services. The proposed decision object 4102 may be reviewed by an approval chain 112, consisting of members of the hiring committee and administrative assistants responsible for performing criminal background checks. The approval chain 112 may approve the decision 102 to hire the consultant. The proposed decision object 4102 may then be executed and may become an executed decision object 4108. The decision object 202 may be sent to the approval chain 112 for further review prior to implementation. A system 2610, accessing an external data facility 108, may determine that the consultant is the manager's brother. The system 2610 may then access the enterprise's 106 policy on nepotism and may determine that hiring the consultant is against policy. The system 2610 may then modify the decision object 202, adding a rationale for denial, and may then send the decision object 202 back to the manager.

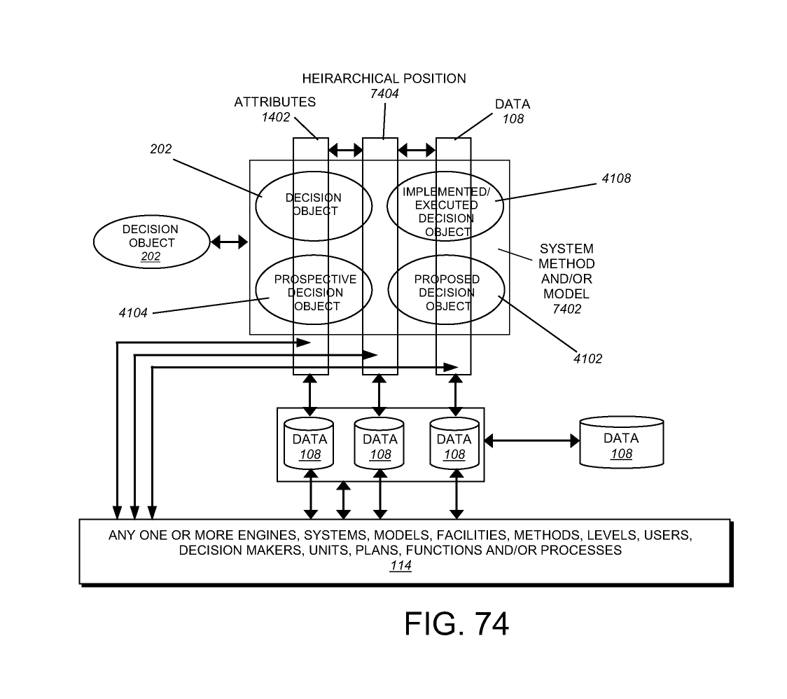

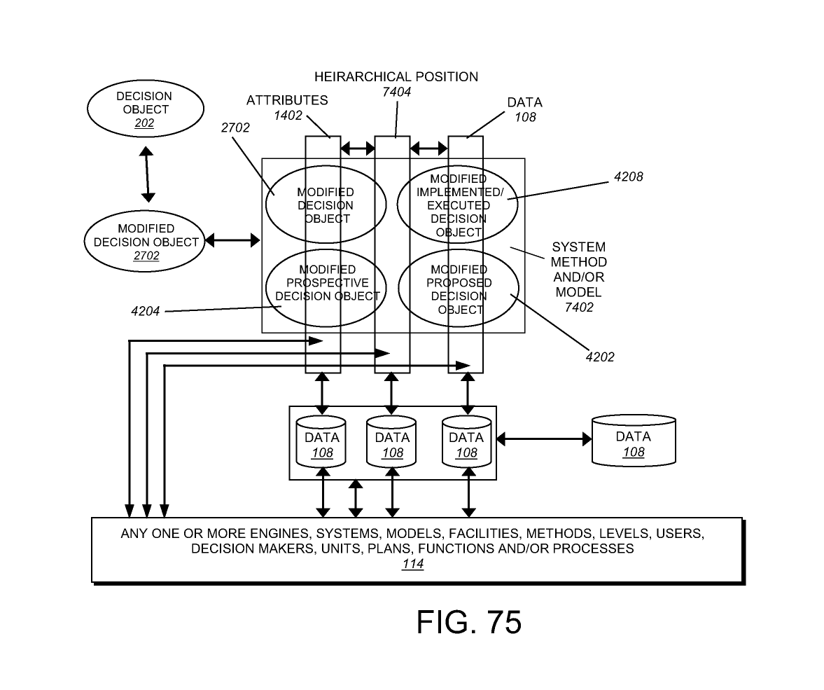

As depicted in FIG. 74 the system, method and/or model 7402, such as a system 2610 or enterprise planning method 502, may act on or in connection with a decision object 202. FIG. 75 shows that the system, method and/or model 7402, such as a system 2610 or enterprise planning method 502, may also act on or in connection with a modified decision object 2702. The decision objects 202 may be prospective, proposed, and executed or implemented. The system, method and/or model 7402 may store, maintain or associate attributes 1402, hierarchical position 7404 and data 108 in connection with the decision objects 202. Hierarchical position 7404 may include the position of a decision in the hierarchy of decision processes 1300, hierarchy of data 2002, hierarchy of levels of abstraction 2300, enterprise hierarchy 3102 and/or any other hierarchy. In this embodiment, the attributes 1402, hierarchical position 7404 and/or data 108 may be stored or maintained as data 108 in one or more corresponding data facilities 104. These data facilities 108 can then be acted upon or made available to various analytical tools 114 or other subsets of the enterprise 106. The attributes 1402, hierarchical position 7404 and/or data 108 may also be directly acted upon or made available to the various analytical tools 114 or other subsets of the enterprise 106. In this embodiment, a central data facility 108 may also store, maintain or compile the data 108 from the other data facilities 108. For example, a decision 102 may relate to the type of headlights to include on a new model of car. The relevant attributes 1402 such as brightness of the light, diameter of the headlight, type of bulb, cost of unit and the like may be stored as data 108 in a data facility 108 related to the new model of car. The data 108 may also be mirrored in a central data facility 108 for the enterprise 106. The system, method and/or model 7402 may also store the position of the decision 102 in the hierarchy of decisions processes 1300 related to the new model of car may also be stored. The attribute 1402 and hierarchical position 7404 data 108 may be made available to analytic tools 114 and other subsets of the enterprise 106. For example, the data 108 may be made available to the marketing department so that the brochure will correctly list the headlight specifications. The hierarchy of the marketing department may present the same data in a different view for that department, such as a graphical view of different headlight appearances, while the purchasing department might just see a name for each type of headlight along with a cost to acquire it from each of a set of possible vendors. The same decision object 202 or other data object may be stored and accessed by both departments, allowing changes made by one (such as proposed decisions) to be automatically viewed by the decision processes 300 and tools of the other, so that the two processes can optionally be logically linked (and optionally linked to one or more other processes, including approval processes).

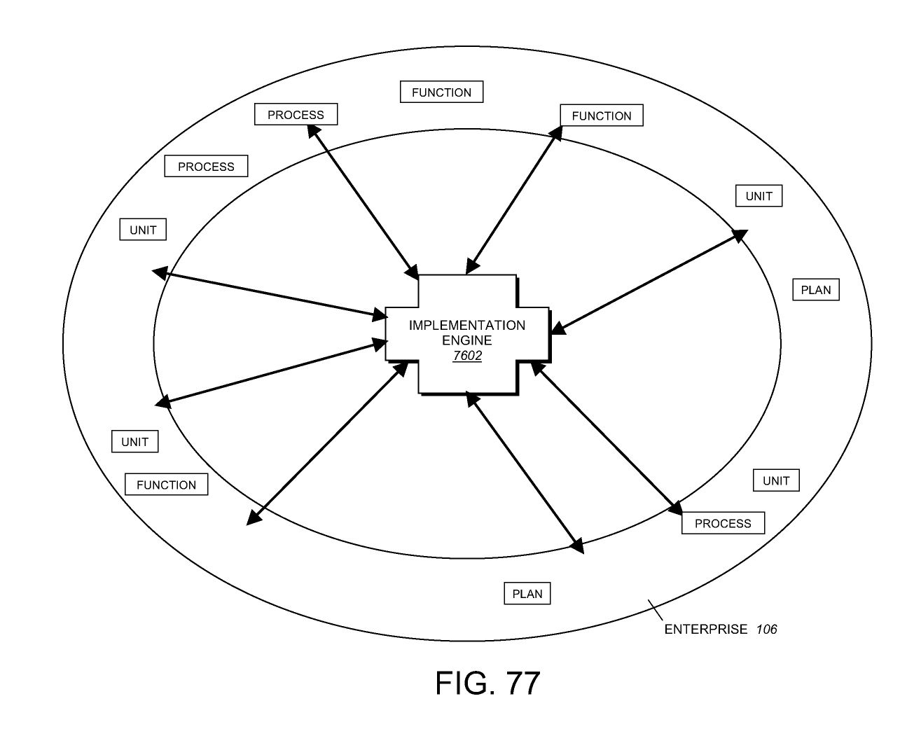

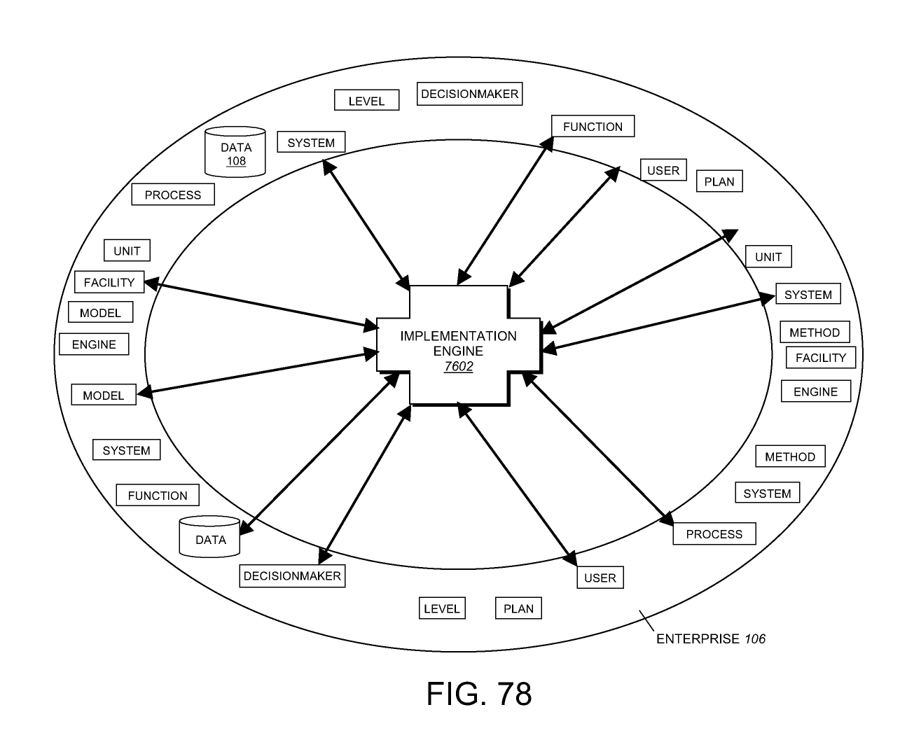

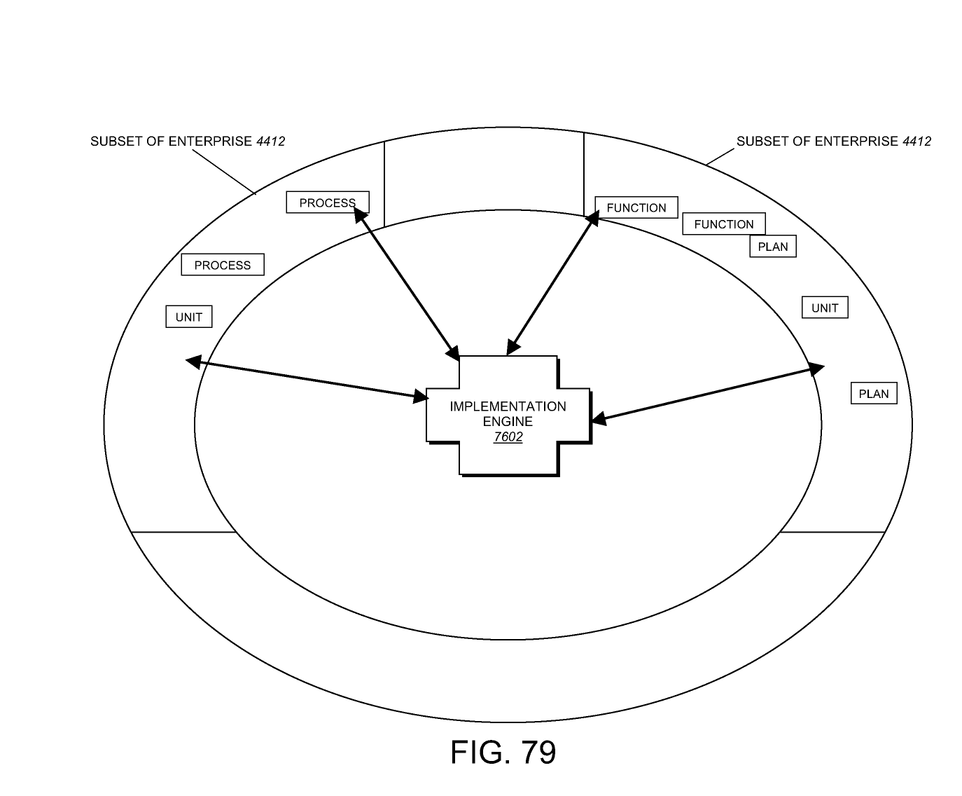

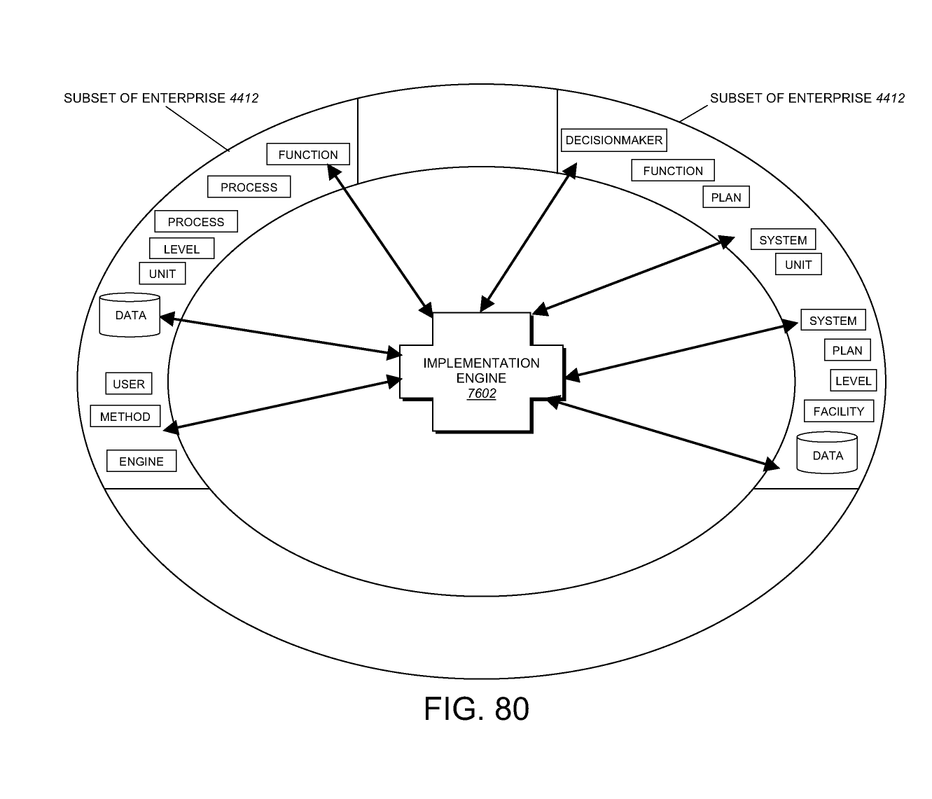

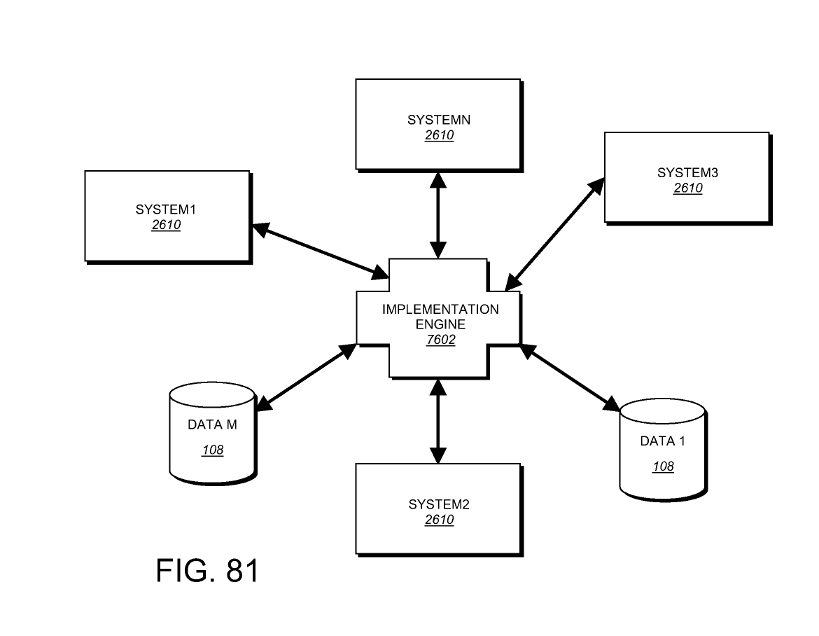

An implementation engine may assist with or effect the implementation of a decision object 202 throughout an enterprise 106 or within a subset of an enterprise 106. The implementation engine may act upon or in connection with any decision object 202 including modified, proposed, executed or implemented decision objects 202. The implementation engine may effect or propagate a decision throughout an enterprise 106. FIG. 76 depicts a process that may be common in many enterprises 106. A decision may be proposed and proceed to execution. The step of moving from a proposed decision object 4102 to an implemented decision object 4108 may be complex and involved many aspects of an enterprise 106. An implementation engine 7602 may aid in the implementation of a decision 102. As depicted in FIG. 77, the implementation engine 7602 may communicate with, notify, act upon or interact with various units, plans, functions, processes or other subsets of an enterprise 802. As depicted in FIG. 78, the implementation engine 7602 may also communicate with, notify, act upon or interact with various data facilities, users 2608, systems 2610, decision makers 104, levels, parts, engines, methods, such as an enterprise planning method 502, analytic tools 114 or other subsets of an enterprise 4412. As depicted in FIGS. 79 and 80, the various units, plans, functions, processes or other subsets of an enterprise 802 and data facilities 108, users 2608, systems 2610, decision makers 104, levels, parts, engines, methods, such as an enterprise planning method 502, analytic tools 114 or other subsets of an enterprise 4412 may compose a subset of an enterprise 106. The subset may be defined or decided by a user 2608, system 2610, decision maker 104, implementation engine 7602 or other means. As depicted in FIG. 81, the implementation engine 7602 may also write an array of values to various systems 2610 or data facilities 108 of an enterprise 106.

For example, a heavy machine manufacturer may decide to increase the stiffness of the suspension on its vehicles. The related decision object 202 is executed and an implementation engine 7602 may begin the implementation process. The implementation engine 7602 may notify the engineering departments, the related assembly line function, the marketing team and other relevant subsets of the enterprise 106. The decision 102 may only be implemented in North America, as this information was specified in the decision object 202. Alternatively, the implementation engine 7602 may have determined that the decision 102 was only relevant to North American operations. It may have based this determination of the relevant subset of the enterprise on the fact that the stiffness measurements pertained to hydraulic suspensions, but the vehicles manufactured outside of North America use spring-based shock absorbers.

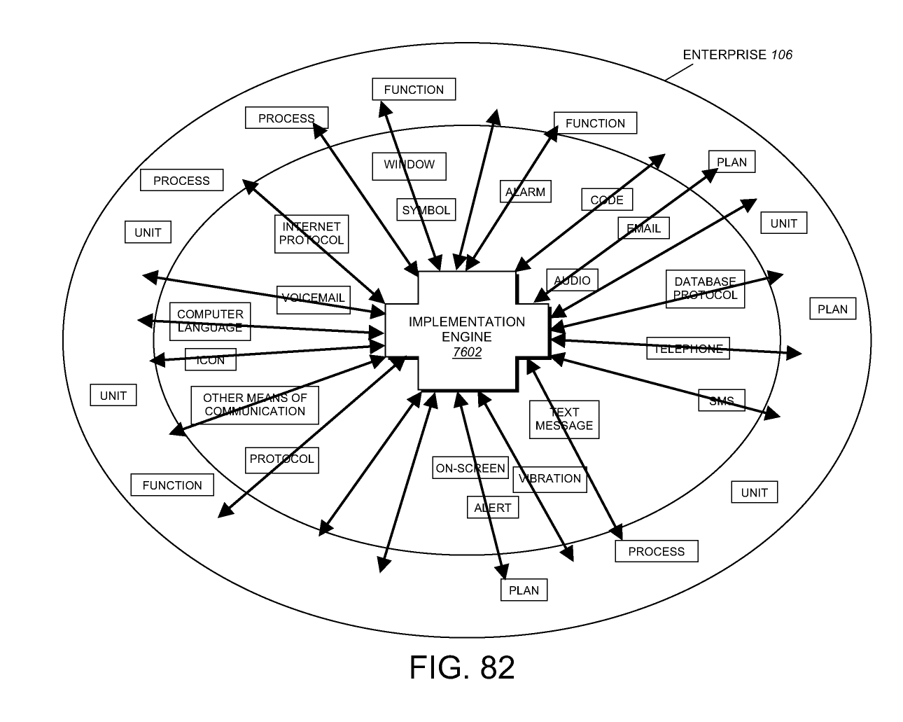

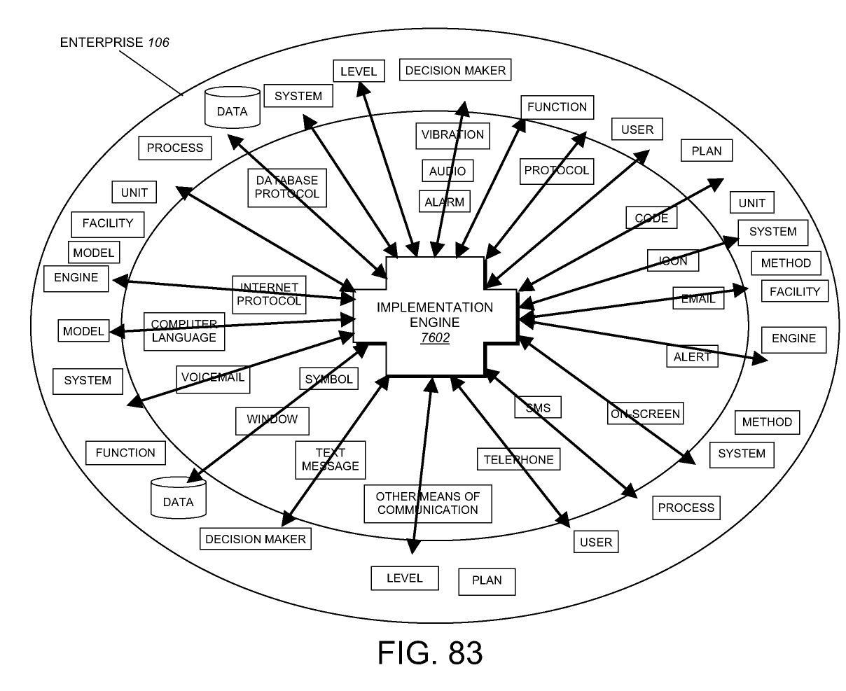

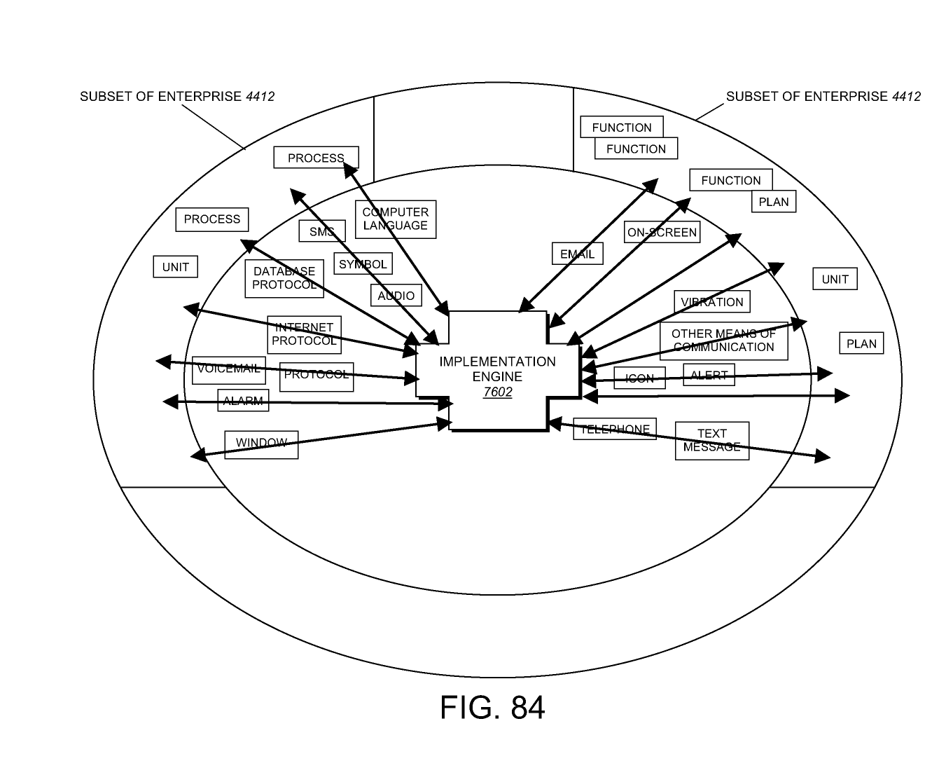

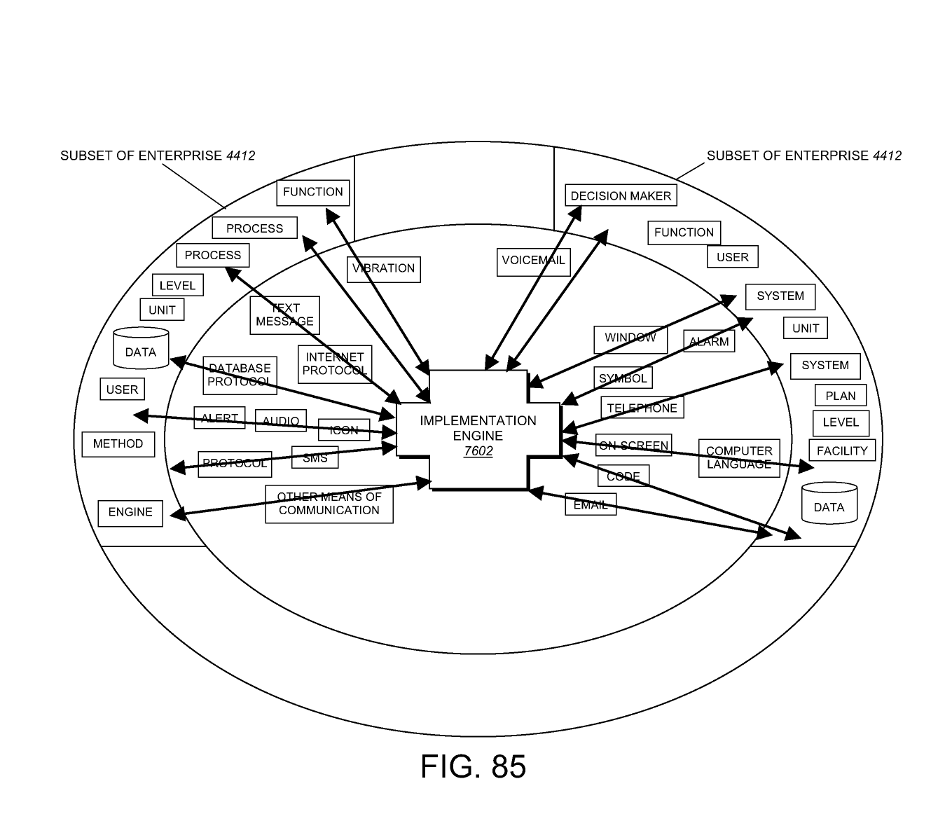

As depicted in FIGS. 82 through 85, an implementation engine 7602 may communicate or interact with the various units, plans, functions, processes or other subsets of an enterprise 106, data facilities 108, users 2608, systems 2610, decision makers 104, levels, parts, engines, methods, such as an enterprise planning method 502, analytic tools 114 or other subsets of an enterprise 4412 through a plurality of means. For example, an implementation engine 7602 may communicate or interact using a protocol, database protocol, Internet protocol, computer language, code, email, voicemail, telephone, text message, SMS, on-screen method, symbol, icon, window, audio, alert, alarm, vibration or any interaction with any of the senses or by any other means of communication. The implementation engine 7602 may communicate or interact with a given subset of an enterprise 106, such as a decision maker 104, unit 4402 or model, in one or more ways. For example, an implementation engine 7602 may notify a decision maker 104 via audio and email, or may send a text message to a user 2608 using an Internet protocol. An implementation engine may also provide an alert using voicemail or display a symbol on a graphical user interface.

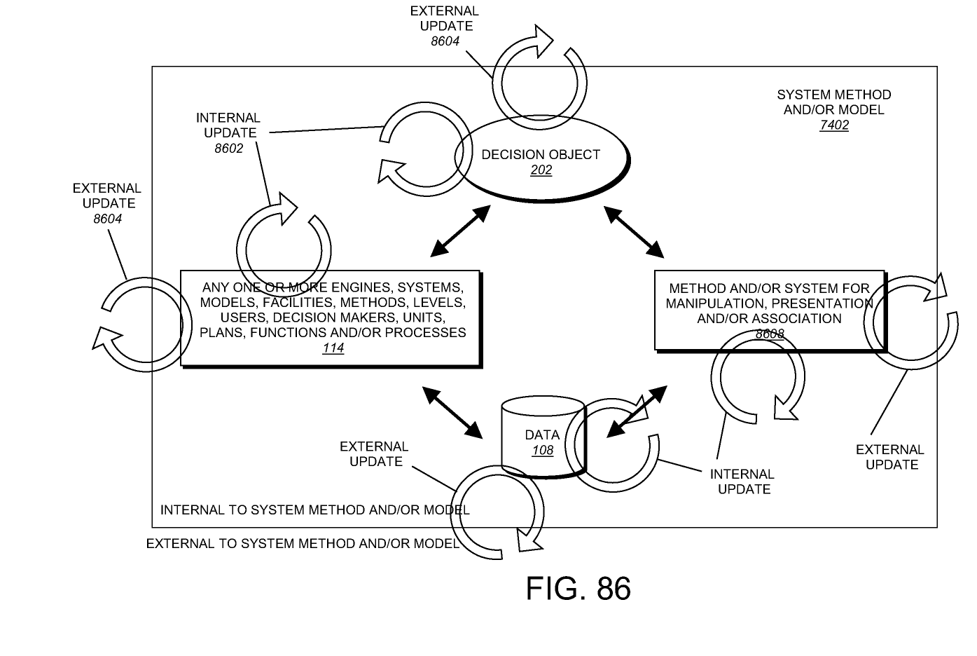

FIG. 86 depicts the periodic updating of various elements of an enterprise 106. The updates may be either internal updates 8602 or external updates 8604. Internal updates 8602 may come from sources internal to the system, method and/or model 7402 and external updates 8604 may come from sources external to the system, method and/or model 7420. Any decision object 202, data facility 108, analytical tool 114, method and/or system for manipulation, presentation and/or association or any other subset of an enterprise 106 may be updated. The update may be internal 8602 or external 8604. The period of an update or the intervals between updates may be a year, quarter, month, week, day, hour, minute, second or any other unit of time. In embodiments the updates 8602 relate to decision objects 202 for proposed or executed decisions taken from logically linked decision processes 300.

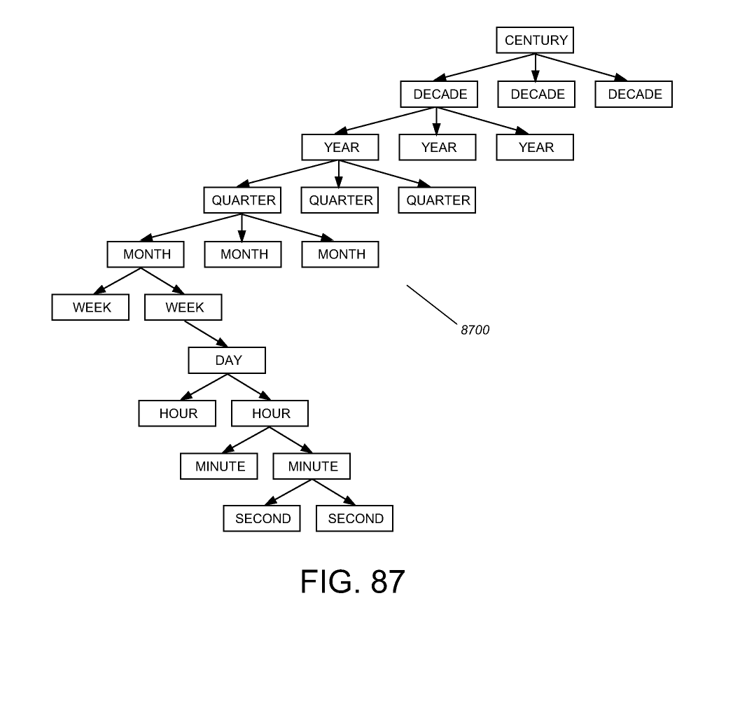

FIG. 87 depicts a hierarchy of various units of time. The updates may also be done at intervals or with a period defined by a user 2608, system 2610 or other decision maker 104. The updates may also be done in real-time or on a continuous basis.

For example, a personal banker at a lending institution may need to decide whether to approve a client for a mortgage. The personal banker may access the institution's internal databases to learn the client's balances in her various accounts with the bank. The personal banker may also access the institution's internal credit card database to determine the balance outstanding on the client's credit cards. The personal banker may then access several external databases to gather information about the client's relationship with other financial institutions. Since the databases are updated in real-time, the personal banker may learn that the client took out a second mortgage that morning. On this basis the personal banker may decide to deny the client an additional mortgage. The personal banker may also update the institution's internal data facilities 108 to reflect this information.

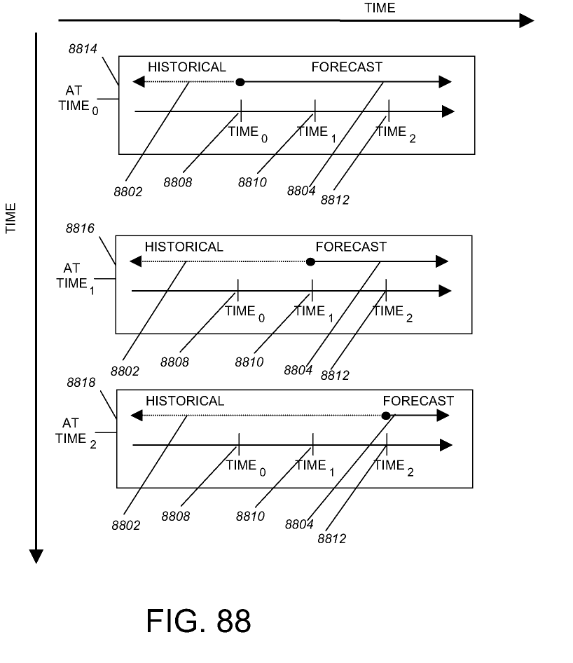

FIG. 88 depicts the transitions from forecasted 8804 to historical 8802 data 108, values, attributes 1402 or other information over time. In the example, time may progress from Time₀ 8808 to Time₁ 8810 and then to Time₂ 8812. At Time₀ 8814, the data 108, values, attributes 1402 and other information corresponding to times before Time₀ is historical 8802 and the data 108, values, attributes 1402 and other information corresponding to times after Time₀ is forecasted 8804. At Time₁ 8816, the data 108, values, attributes 1402 and other information corresponding to times before Time₁ is historical 8802 and the data 108, values, attributes 1402 and other information corresponding to times after Time₁ is forecasted 8804. At Time₂ 8818, the data 108, values, attributes 1402 and other information corresponding to times before Time₂ is historical 8802 and the data 108, values, attributes 1402 and other information corresponding to times after Time₂ is forecasted 8804. Decision points or nodes in a process may also be redefined, modified or updated in the same manner with the passage of time. A data facility 108 may contain data 108 about the price of a particular stock over time. The data facility may also contain forecast 8804 data 108 regarding the stock price in the future. As time passes, the data facility may be updated in real-time and the forecast 8804 data 108 may become actual or historical 8802 data 108.

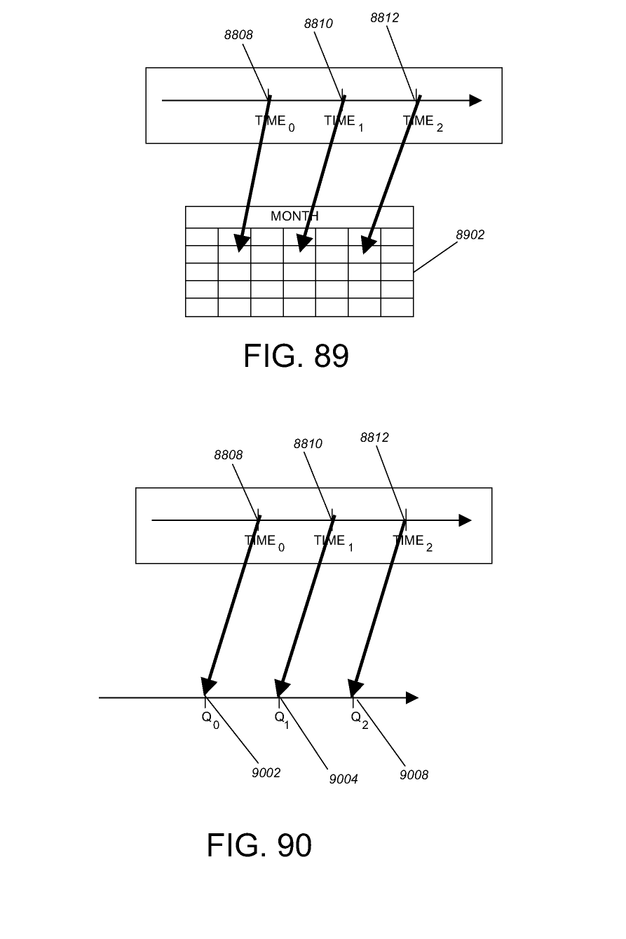

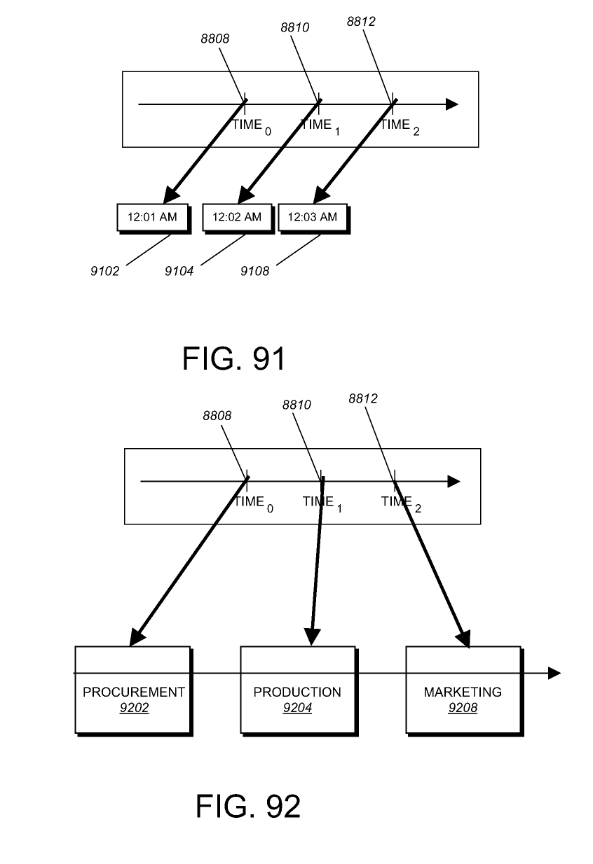

The time points, Time₀, Time₁ and Time₀, depicted in FIG. 88 may correspond or map to points in time which may be related to various intervals, processes or units of time. For example, as depicted in FIG. 89 the time points may map to days, such as days on a calendar. As depicted in FIG. 90, the time series may correspond to the financial quarters of a fiscal year. The time points may also correspond to minutes of the day as depicted in FIG. 91. As depicted in FIG. 92, the time series may relate to the various stages of a business process, such as bringing a new product to market.

A decision tracking facility may allow for the tracking of decisions 102 throughout an enterprise and/or over time or another dimension. A decision tracking facility may allow for the tracking, review and analysis of decisions 102. A decision tracking facility may allow a decision 102 to be revisited in context. A decision tracking facility may act upon, interact with or be utilized in connection with any decision 102 or decision object 202, which may be modified, proposed, executed and/or implemented.

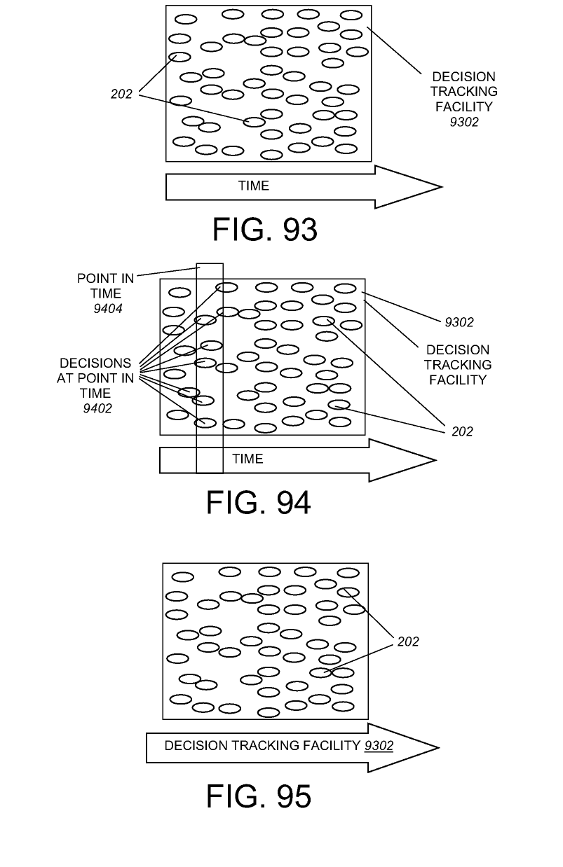

FIG. 93 depicts a decision tracking facility 9302 which may track decision objects 202 over time. As depicted in FIG. 94 a decision tracking facility 9302 may emphasize, act upon or interact with decisions at a particular point in time 9402. The point in time 9404 may be specified by a user 2608, system 2610, decision maker 104 or other subset of the enterprise 106. For example, a decision maker 104 may want to review all the decisions 102 taking place on Jul. 6, 2004 or on Jul. 6, 2004 at 10:00 a.m. A decision tracking facility 9302 may present these decision objects 202 to the decision maker 104. The decision maker 104 may also review other data from Jul. 6, 2004 to place the decision 102 in context. The decision maker 104 may also specify a point in time 9404 in the future. The decision tracking facility 9302 may forecast or project the decisions 102 that may be occurring at that point in time, as well as any relevant contextual data 108. In this manner, the decision maker 104 may be able to determine how the enterprise 106 or a particular subset of the enterprise 4412 may appear or behave in the future.

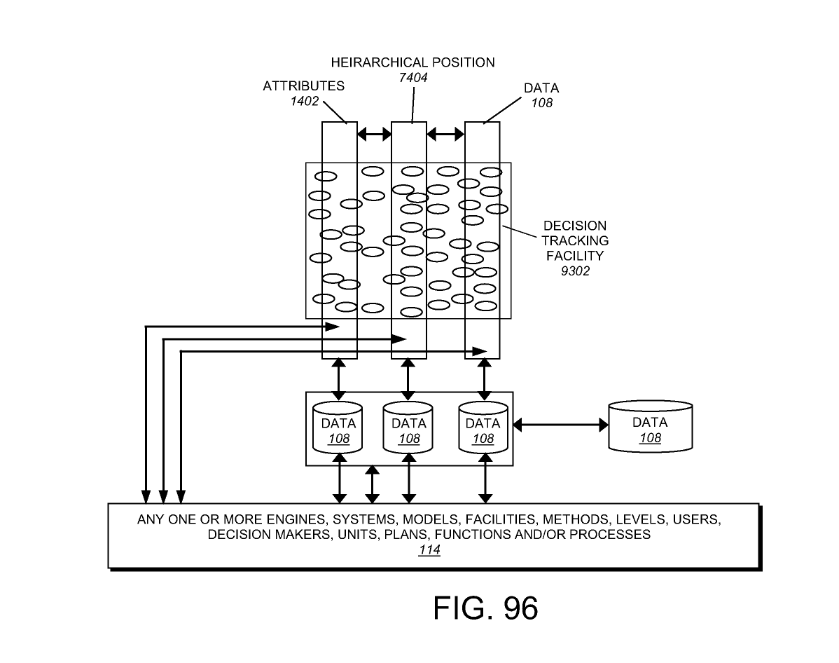

FIG. 95 depicts a decision tracking facility 9302 tracking decision objects 202 in general. The decision tracking facility 9302 may track decisions 102 within and across or between various levels of abstraction 2302, parts of an enterprise, levels of an enterprise, hierarchies or other subsets of the enterprise 4412. FIG. 96 is a simplified high-level schematic diagram that illustrates the various information flows involving a decision tracking facility 9302. The decision tracking facility 9302 may store, maintain or associate attributes 1402, hierarchical position 7404 and data 108 in connection with the decision objects 202. Hierarchical position 7404 may include the position of a decision in the hierarchy of decision processes 1300, hierarchy of data 2002, hierarchy of levels of abstraction 2300, enterprise hierarchy 3102 and/or any other hierarchy. In this embodiment, the attributes 1402, hierarchical position 7404 and/or data 108 may be stored or maintained as data 108 in one or more corresponding data facilities 104. These data facilities 108 can then be acted upon or made available to various analytical tools 114 or other subsets of the enterprise 106. The attributes 1402, hierarchical position 7404 and/or data 108 may also be directly acted upon or made available to the various analytical tools 114 or other subsets of the enterprise 106. In this embodiment, a central data facility 108 may also store, maintain or compile the data 108 from the other data facilities 108.

For example, upon request, a decision tracking facility 9302 may make available, such as by display through a graphical user interface, a past decision 102 for review. The decision may have related to selection of headlights to include on a new model of car. The decision tracking facility 9302 may display the attributes 1402 of the decision 102, such as brightness of the light, diameter of the headlight, type of bulb, cost of unit, decision makers 104 involved with the decision 102 and the like. These attributes 1402 may have been stored as data 108 in a data facility 108 related to the new model of car. The data 108 may also have been mirrored in a central data facility 108 which maintains all the decision objects 202 for an enterprise 106 organized by date of creation. A decision maker 104 may have requested the decision object 102 in connection with an evaluation of the decision maker 104 responsible for the selection of the headlights. The decision tracking facility 9302 may present the data 108 and information available to the decision maker 104 at the time the headlight decision 102 was made. The current decision maker 104 can then assess performance based on the information available at the time.

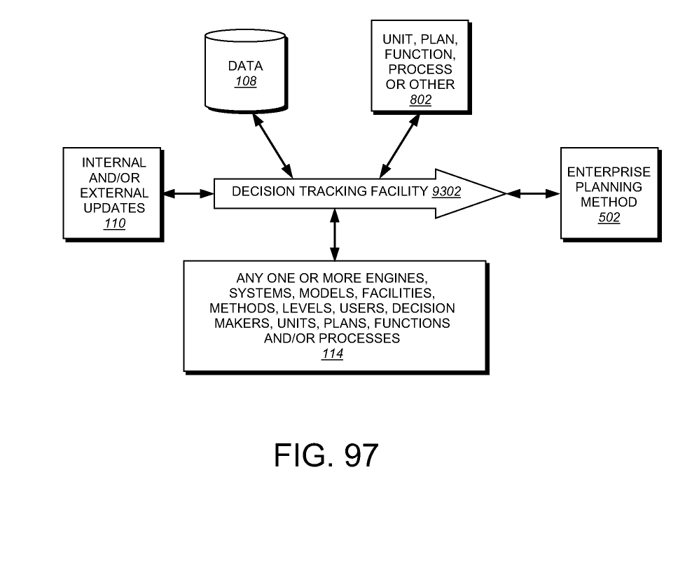

A decision tracking facility 9302 may also interact with various other elements of an enterprise 106. As depicted in FIG. 97 the decision tracking facility may interact with data 108, which may be stored or maintained in a data facility 108, units, plans, functions, processes or other subsets of an enterprise 801, an enterprise planning method 502, analytical tools 114, internal and/or external updates 110 or any other aspect of an enterprise 106. For example, a decision tracking facility 9302 may access analytical tools 114 to produce forecasts based on data 108 from an earlier time to create the forecast a decision maker 104 would have had available at that earlier time.

A decision tracking facility 9302 may allow for revisiting a decision 102 in context. In one embodiment, a decision tracking facility 9302 may present a decision 102 from an earlier time in context at any number of later times.

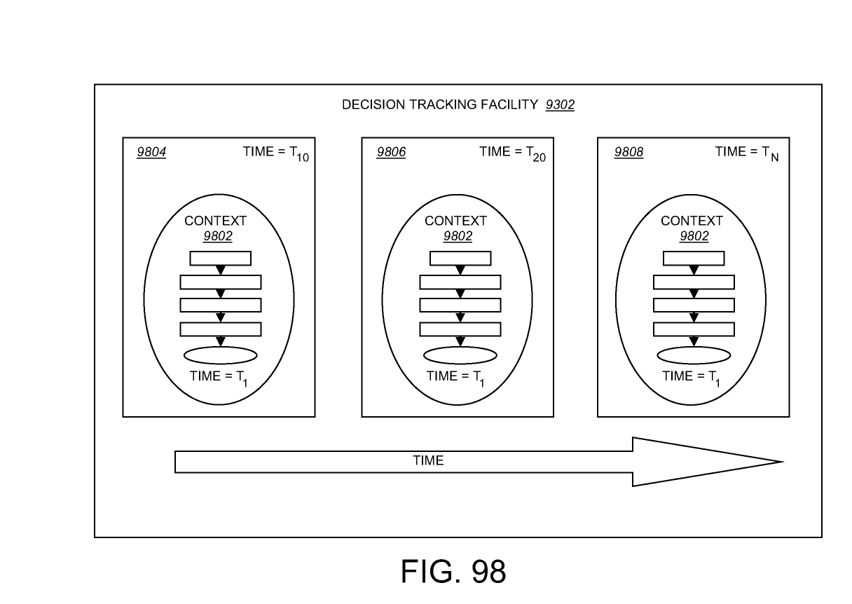

As depicted in FIG. 98 a decision process 300 from Time=T₁ may presented in context 9802. The decision process 9802 may be presented at Time=T₁₀ 9804, Time=T₂₀ 9806 or any other time 9808. For example, a decision 102 may be made on Jul. 1, 2003. On Jul. 1, 2004 a user 2608 may request the Jul. 1, 2003 decision for review. The decision tracking facility 9302 may display the decision 102 along with its attributes 1402 and other relevant contextual data 108. On Jul. 3, 2004 a different user 2608 may request the Jul. 1, 2003 decision for review. The decision tracking facility 9302 may display the decision 102 along with its attributes 1402 and other relevant contextual data 108 which may include the fact that the decision was viewed on Jul. 1, 2004 and identify the other user 2608. On Jul. 10, 2004 the first user 2608 may request the decision for additional review.

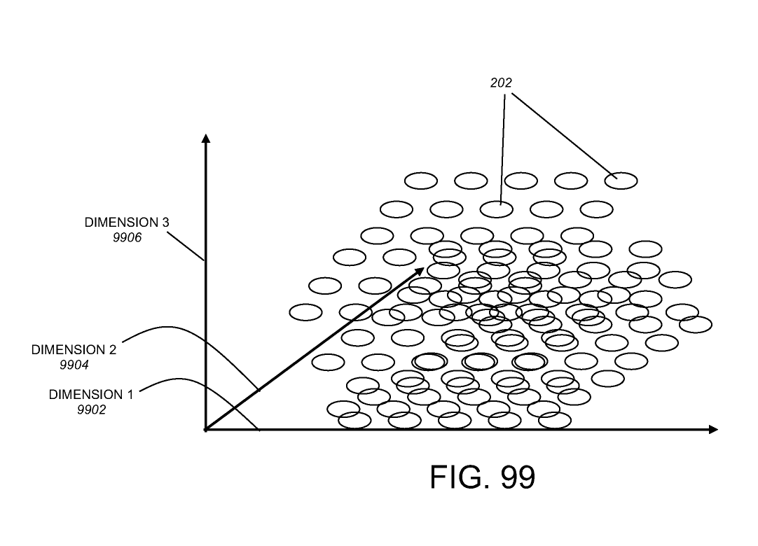

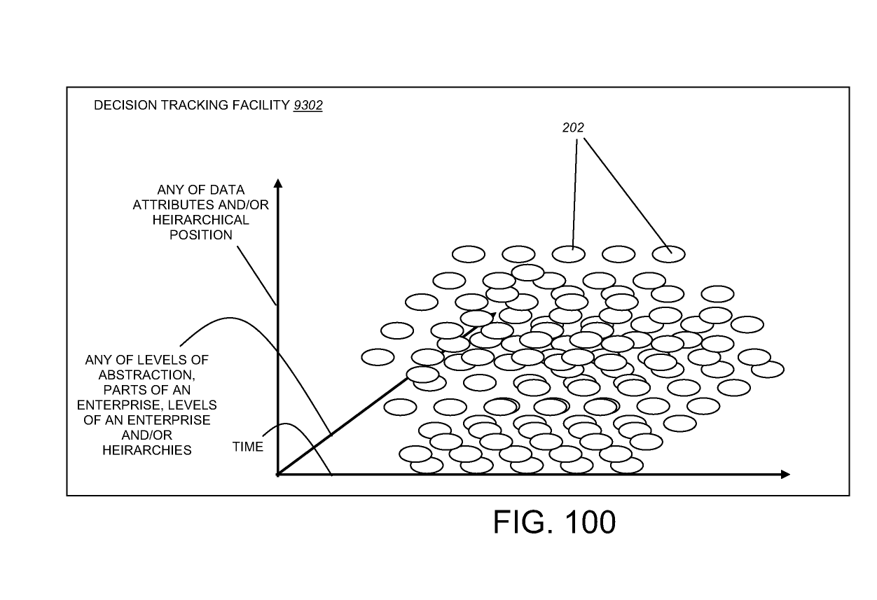

A decision tracking facility 9302 may track decision objects 202 along many dimensions. FIG. 99 shows three possible dimensions along which a decision tracking facility 9302 may track decision objects 202. A decision tracking facility 9302 may track more or fewer than three dimensions, it may also track the dimensions simultaneously or in sequence. In the embodiment of FIG. 99 the dimensions may be any of time, unit, plan, function, process, division, branch, subsidiary, decision maker 104, stage of approval, stage of implementation, type of decision object 202. For example, dimension 1 9902 may be time, dimension 2 9904 may be identification of decision makers 104, and dimension 3 may be context. It will be possible to track decisions 102 along any of the three dimensions. For example, a user 2608 may review all the decisions of a particular decision maker 104, or all the decisions of a particular decision maker 104 over a specified time period. In another embodiment, depicted in FIG. 100, at first dimension may be time, a second dimension may be any of levels of abstraction 2302, parts of an enterprise and/or hierarchies and a third dimension may be attributes 1402, hierarchical position 7404, and data 108. It may be possible to analyze the attributes 1402 of decisions 102 according to their level of abstraction or hierarchical position 7404.

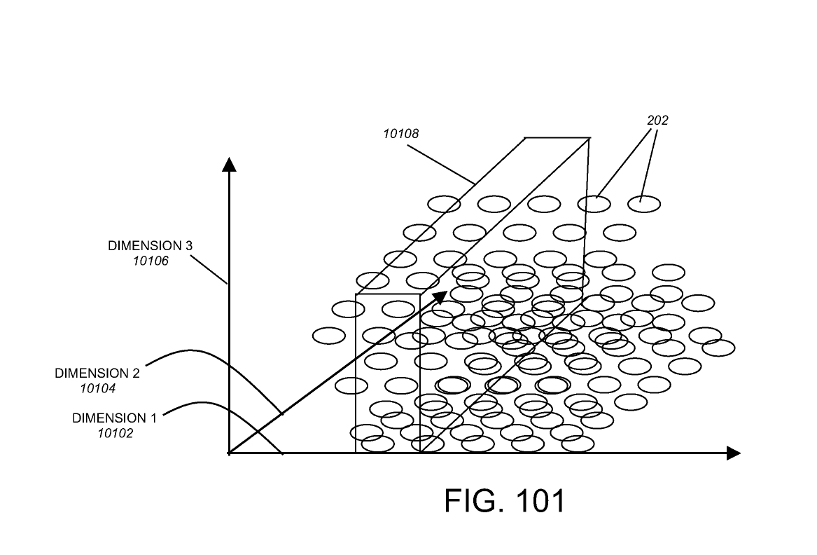

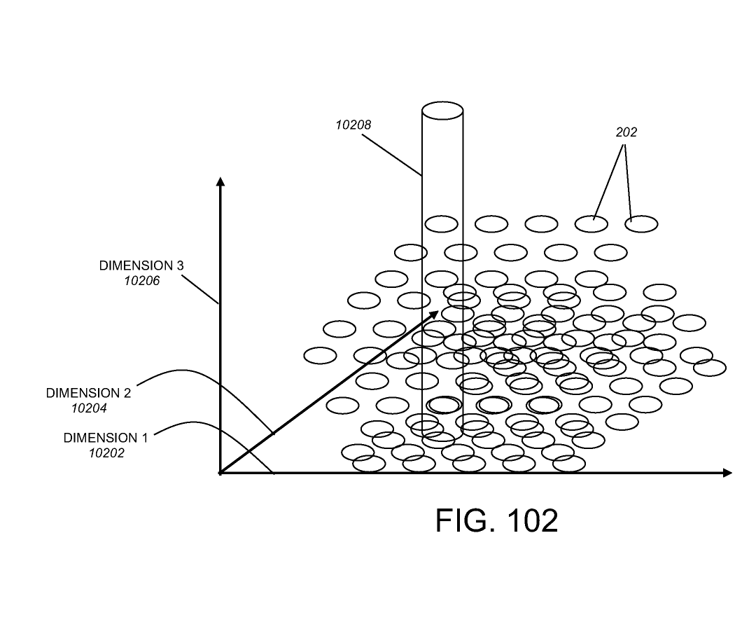

In one embodiment, the various dimensions along which decisions 102 may be tracked may be used to search or limit the number of decision objects 202 relevant to a certain request. As depicted in FIG. 101 a range may be specified along one dimension, for example dimension 10102, which may limit the corresponding values in the other dimensions. For example, the first dimension 10102 may be decision maker 104 identity, the second dimension 10104 may be time and the third dimension may be accuracy of the decision. It may be possible to identify a particular decision maker 104 in the first dimension 10102 and track the accuracy of his decisions 102 over time. The relevant decision objects 202 fall within the volume 10108. As depicted in FIG. 102, a point may be specified in two dimensions allowing for the limiting of the corresponding values in the third dimension 10206. For example, a first dimension 10303 may be unit of the enterprise 106, a second dimension 10204 may be geographic region and a third dimension 10206 may relate to the names of the decision objects 202. In this manner, it is possible to specify a particular unit, such as the procurement unit, and a particular region, such as North America, and obtain the names of all the decision objects 202 created by the North American procurement unit. The intersection is represented by the volume 10208.

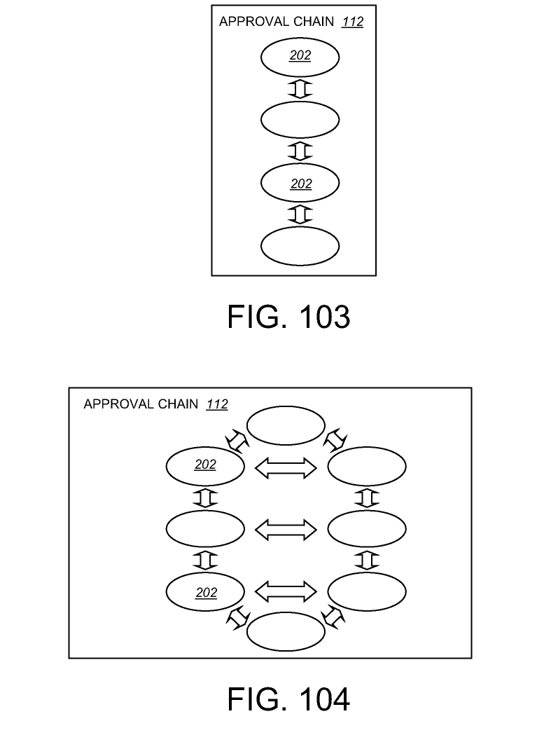

FIG. 103 depicts a simple approval chain 112. Decision objects 202 may move up or down the approval chain 112. FIG. 104 depicts a more complex approval chain 114 in which the decision objects 202 may move laterally as well as up and down. The lateral movement may correspond to collaboration in the approval process within a level or part of an enterprise 106. The approval process 112 may lead to modification of a decision object 202. The approval process 112 and/or other processes and methods of an enterprise 106 may benefit from simulations, modeling and analysis in connection with a decision object 202. For example, a manager may begin her work day and be presented with ten decision objects on her screen. The system and/or method may allow her to explore various scenarios where she accepts all or a subset of those decisions. The individual decision makers 104 below her in the approval chain may make decisions 102 that they believe are in line with the goals, objectives and/or mission of an enterprise. However, lower-level decision makers 104 may not have the most up to date information or may not be aware of the current or most important objective or goal of an enterprise. For example, lower-level decision makers 104 may not be aware of an announcement by the chief financial officer the day before setting profit targets for the next quarter and emphasizing certain products. Information of this nature generally moves down an approval chain from higher to lower-levels. Thus the manager may be aware of the chief financial officer's statements, while the lower-level decision makers 104 may not. The system or method may also provide lower-level decision makers 104 with insight into the decision process and the impact of their decisions 102 on other subsets of the enterprise. In this manner, the lower-level decision makers 104 may gain new perspective on their decisions 102 and job function, and the method or system may become self-reinforcing. The system or method, through the use of an approval chain or otherwise, may also cause or increase discussion, collaboration and/or interaction between decision makers 104 at various levels of an approval chain.

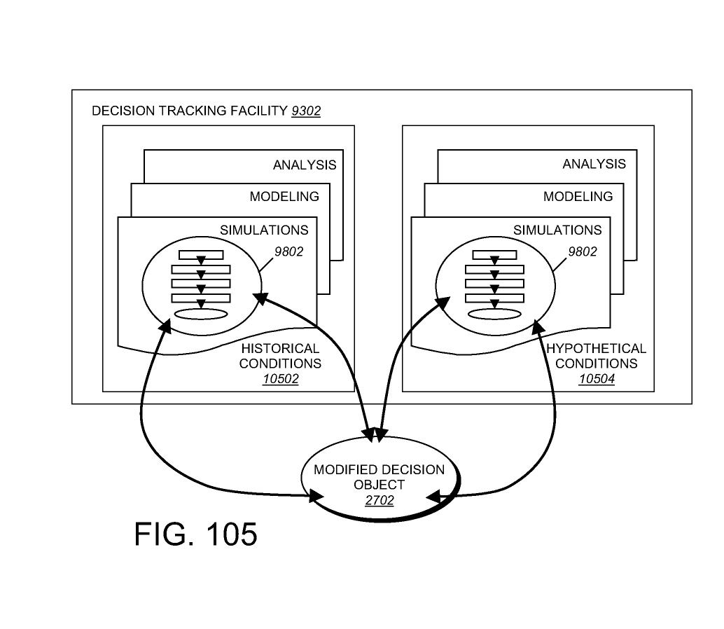

As depicted in FIG. 105, a decision tracking facility may provide, conduct or assist with simulations, modeling and/or analysis involving a particular decision process 300 in context 9802. The simulations, modeling and/or analysis may be conducted under historical conditions or hypothetical 10502 or forecasted conditions 10504. For example, for the purposes of a performance review, a supervisor may want to show an analyst that even if his assumptions had been true, his decision would have been incorrect. The supervisor may, using the decision tracking facility 9302, retrieve the relevant decision object 202, including its context and other data 108. The supervisor may then perform simulations, modeling and analysis under hypothetical conditions which correspond to the state of the world had the analyst's assumptions been true. In another example, the decision tracking facility 9302 may be used to analyze a forecasted decision object 202 under different projects of relevant data 108.

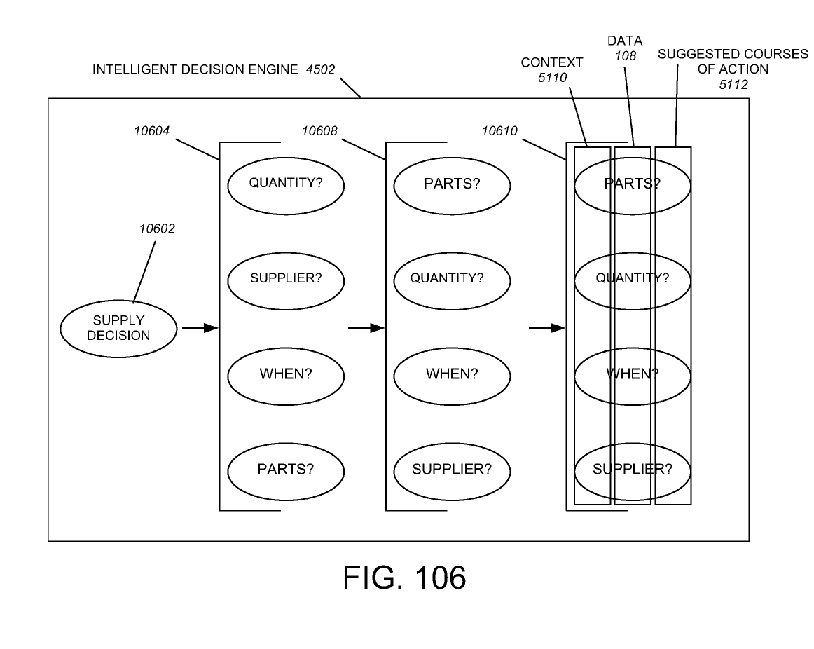

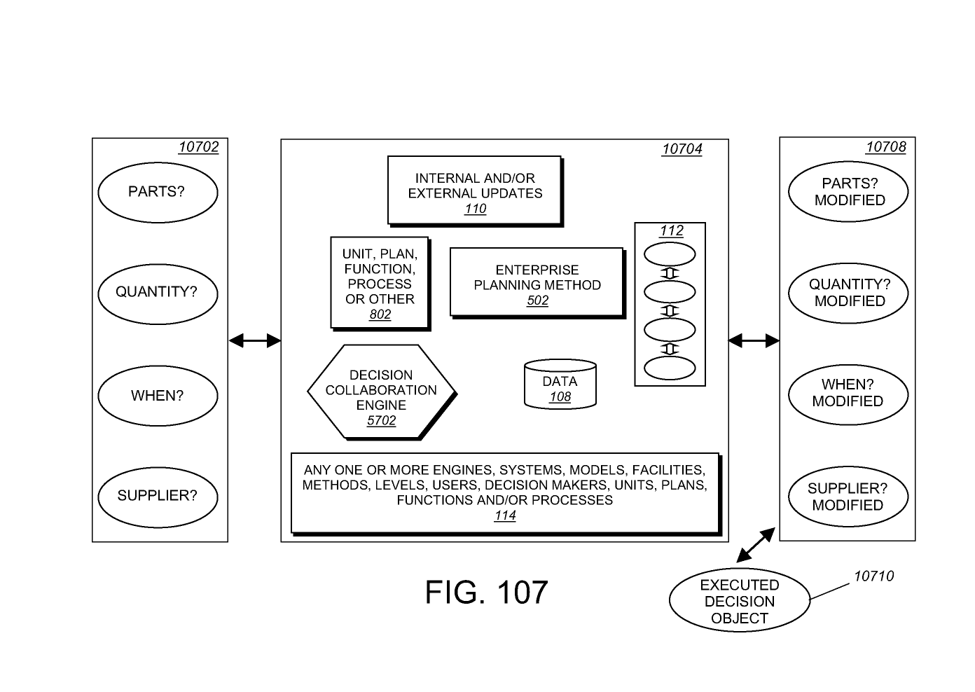

As depicted in FIG. 106, in one simple embodiment an analyst may need to order a certain type of part. An intelligent decision engine 4502 may assist with this supply decision 10602. In a first step 10604, the intelligent decision engine 4502 may break the supply decision 10602 into several component decisions 102 such as deciding on the quantity of the type of part to order, from which supplier or suppliers to order the parts, when to order the type of parts and when they are needed and which parts of that type should actually be ordered. In a second step 10604, the intelligent decision engine 4502 may order the decisions 102 in a logical order. The order may be first determining which parts of the type should be ordered, then deciding on how many are needed, then determining when they are needed and then selecting a supplier that can satisfy the order. The intelligent decision engine may then present or draw upon relevant context information 5110 and other data 108 in order to suggest possible course of action 5112 in connection with each component of the decision. For example, in connection with the parts decision 102, the intelligent decision engine 4502 may present information, from the manufacturing department, detailing which parts are interchangeable. The intelligent decision engine 4502 or another system 2610 may also present information regarding the price of each part. The intelligent decision engine 4502 may suggest a part or emphasize for the user 2608 that a particular part has been ordered for the past eight months and there have been no problems. In order to assist with the quantity and timing decisions 102, the intelligent decision engine 4502 may provide the analyst with demand forecasts and the production times for the product. From this the analyst can work out the number of products needed and then production will need to commence. She can then order enough of the part to meet the demand and ensure that the parts will arrive in time. In order to determine which supplier to select the analyst may request information regarding the past performance of each relevant supplier. This information could be in the form of past reviews of the various suppliers performance stored in an internal database. Based on the information, the analyst may decide to order to order nine-hundred automotive struts from Acme Supply. This decision 102 may be in the form of a proposed decision object 10702 and made available to the various and/or relevant subsets of the enterprise 10704. Several of the analyst's supervisors may review 112, modify and eventually approve the decision. The decision 102 may become an executed decision 10710. Via the decision collaboration engine 10704 an operations manager from another division may add a comment to the decision object 202 that the demand for struts will likely increase in the coming weeks and that Acme Supply has poor connections in the automotive industry and will likely not fulfill the order.

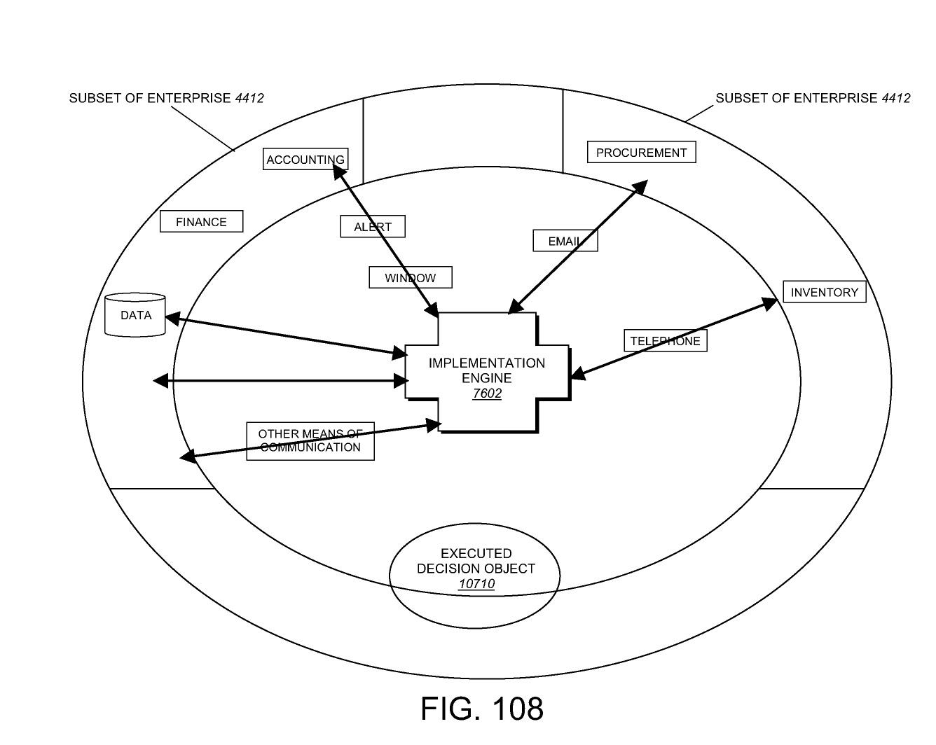

As depicted in FIG. 108, an implementation engine 7602 may assist with the implementation of the executed decision object 10710. The procurement department may receive an email providing the details of the order and instructing them to execute the order on a certain date. The inventory manager may receive a phone call advising her that nine hundred struts would be arriving on a certain data. The accountants may be notified via an alert window that they should update the account data for Acme Supply. The finance department, through a regularly scheduled data facility 108 update may learn that they should pay Acme Supply for the struts on a particular date, provided the struts are received.

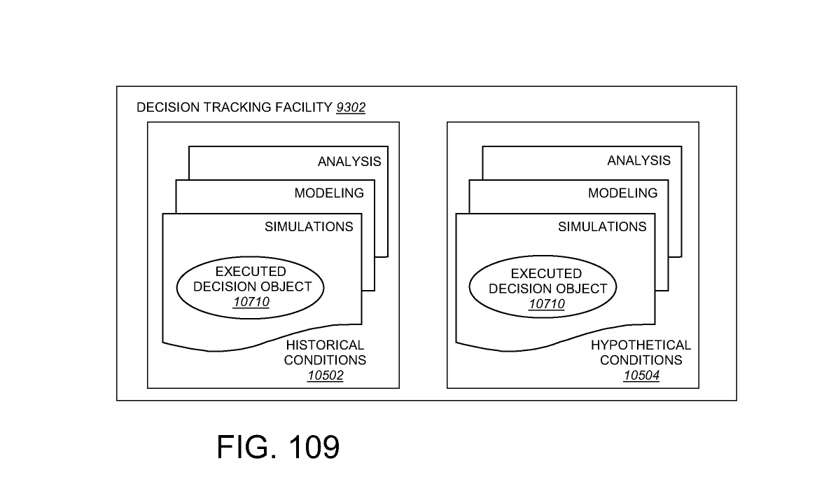

Several weeks after implementation of the decision 102 the system 2610 on the basis of an internal update 8602 notifies the analyst that the automotive struts have not yet arrived. The analyst determines several alternate suppliers and the terms on which they can supply the struts. The analyst then notifies his supervisor. The supervisor, unable to recall the details of the decision 10602, accesses the relevant decision object 10710 for review. The supervisor sees the comment from the operations manager and wants to correct the problem as soon as possible. As depicted in FIG. 109, the supervisor performs several simulations and determines that several other suppliers would have supplied the struts on time. However, upon further analysis, the supervisor notices that the demand signal on which the decision 10602 was based is erroneous. The demand did not materialize and as such no additional struts are actually required.

Several months later a new analyst joins the enterprise. Eager to learn, he accesses and reviews several past decisions, including the supply decision 10602. As depicted in FIG. 109, he may conduct simulations, modeling or analysis under historical 10502 or hypothetical 10504 conditions. In this manner the analyst may learn how small changes in the value of a certain attribute 1402 can impact the procurement process.

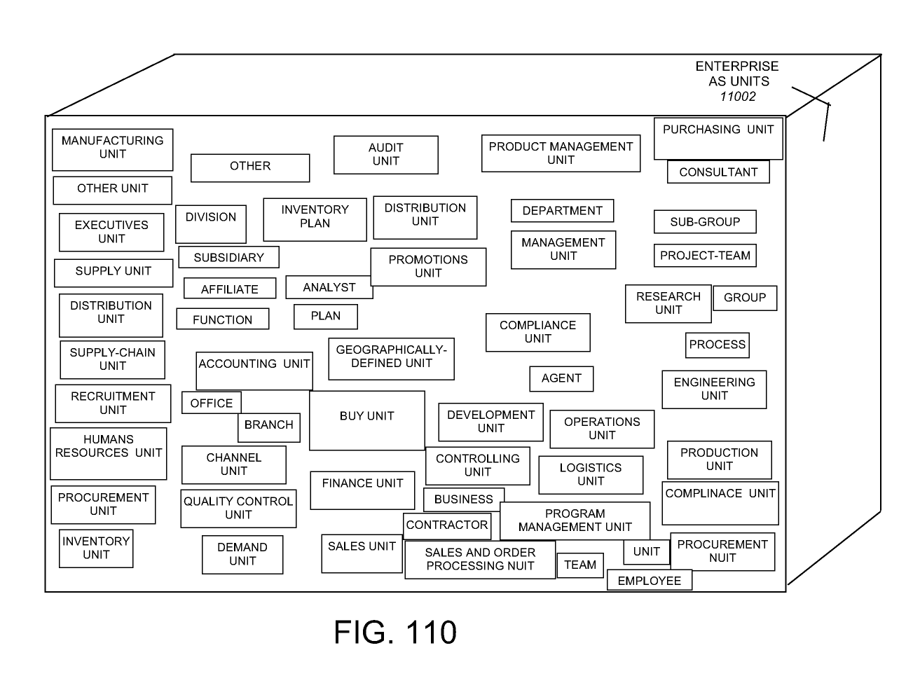

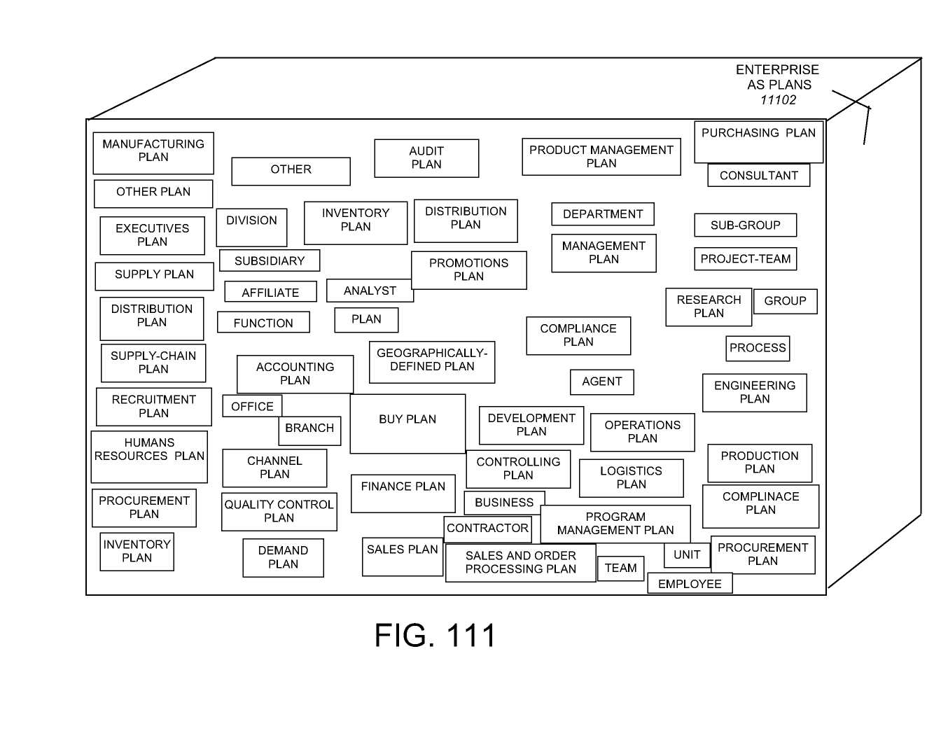

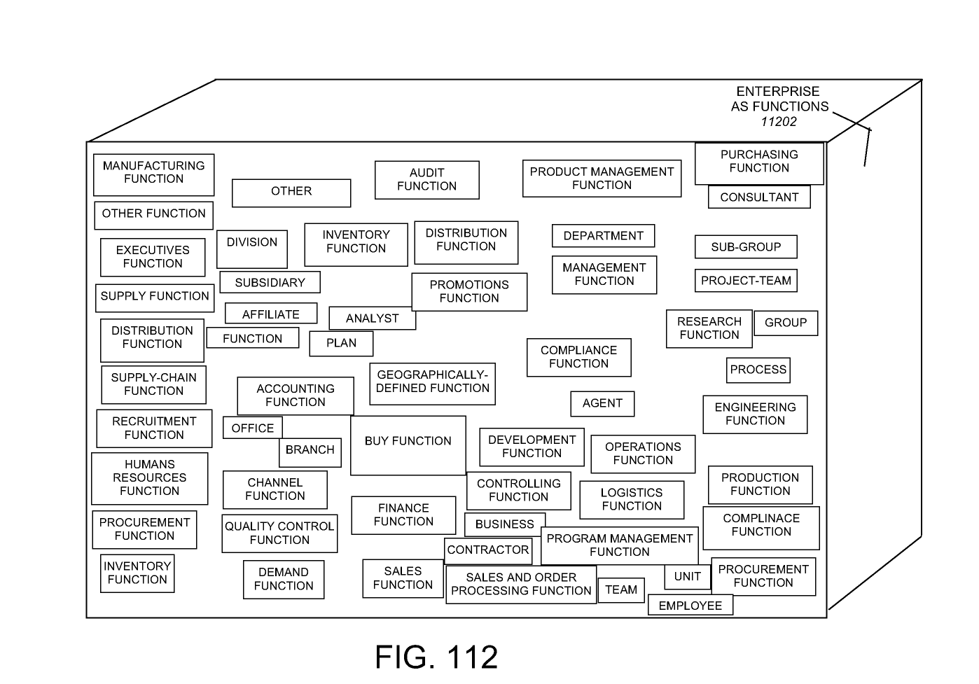

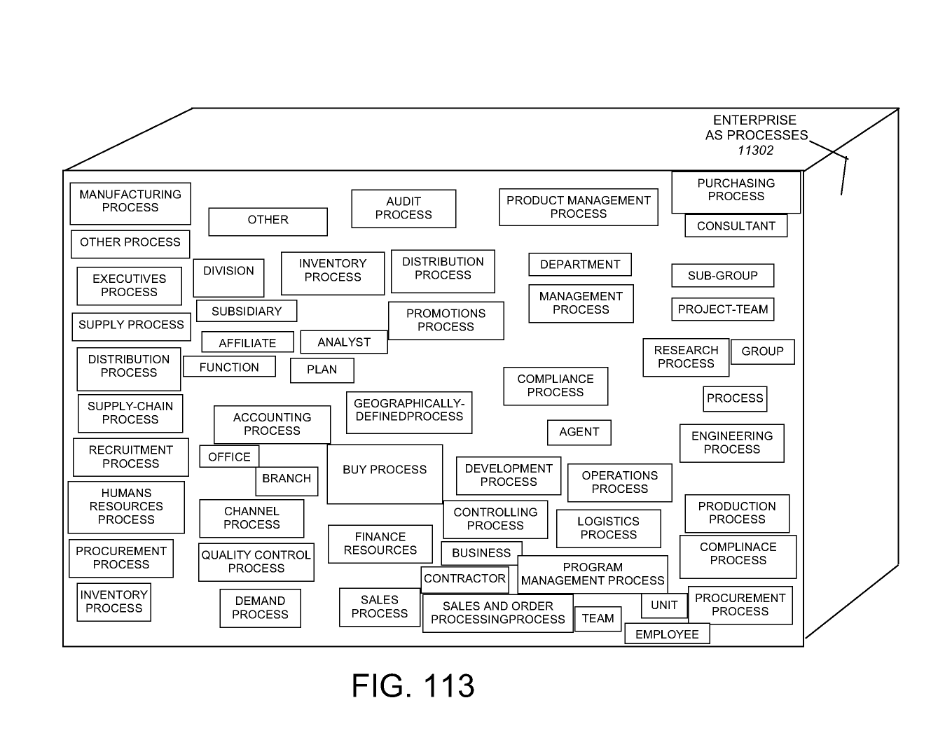

An enterprise 106 may contain, consist of or include a plurality of units, plans, functions, processes or other subsets 802. FIG. 110 depicts an enterprise 106 in terms of units 11002. FIG. 111 depicts an enterprise 106 in terms of plans 11102. FIG. 112 depicts an enterprise 106 in terms of functions 11202. FIG. 113 depicts an enterprise 106 in terms of processes 11302. The various units, plans, functions and processes may include: production, manufacturing, supply, supply-chain, human resources, recruiting, procurement, buy, purchasing, operations, logistics, product management, research, development, engineering, quality control, program management, inventory, demand, sales, sales and order processing, marketing, channel, distribution, promotion, executives, management, finance, controlling, compliance, accounting, audit and/or any other subset of an enterprise 4412.

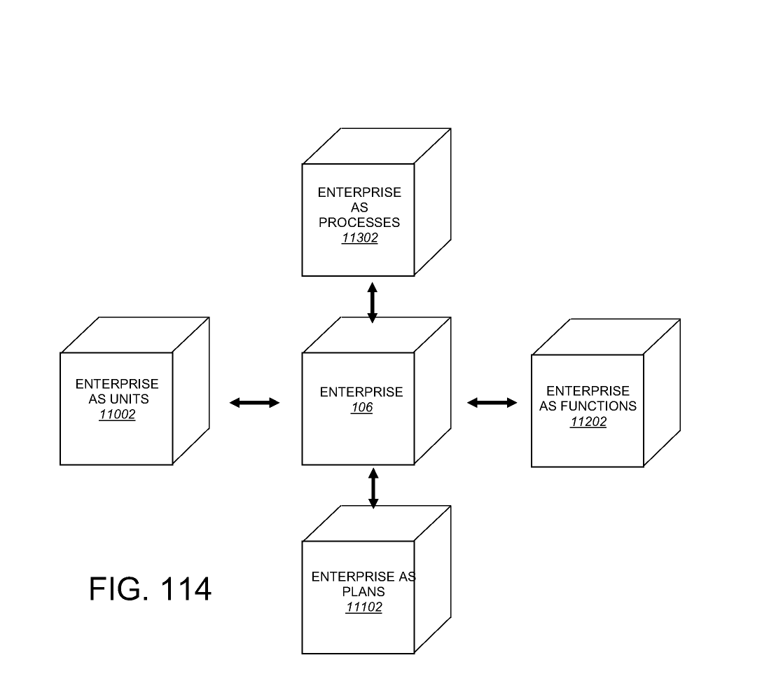

As depicted in FIG. 114, an enterprise 106 may be conceptualized as the interaction or composition of the all or a subset of a plurality of units 11002, plans 11102, functions 11202, processes 11302 or various other aspects or dimensions. For example, an enterprise 106 may contain a product development unit, a manufacturing process and an accounting function. An enterprise 106 may also be conceptualized as the interaction or composition of the all or a subset of many levels of abstraction 2302. A level of abstraction 2302 may be a division, subsidiary, affiliate, business unit, office, branch, department, group, sub-group, project team, team, geographically-defined unit, employee, contractor, agent, analyst, consultant and/or any other subset of an enterprise 4412. For example, an enterprise 106 may contain two product divisions and a branch. The product divisions may consist of several units, plans, functions and processes such as a supply plan and an assembly process. The branch may be composed of several project teams and an agent. The project teams may each contain several consultants and employees.

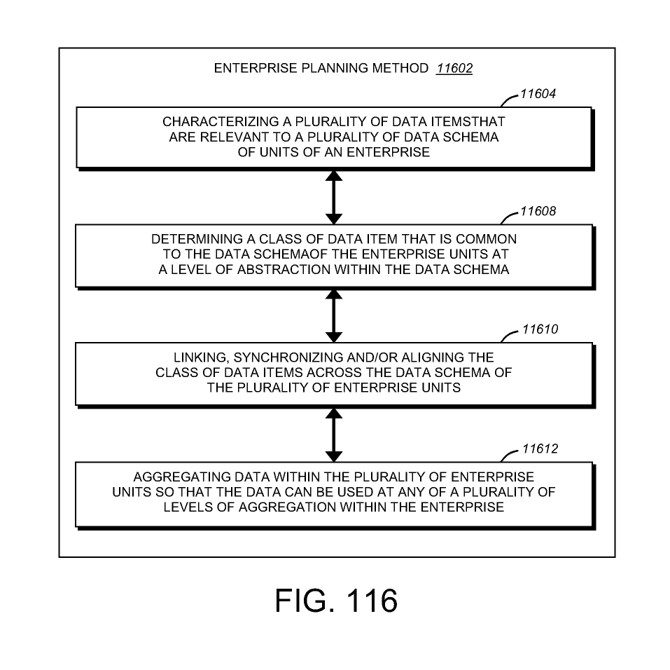

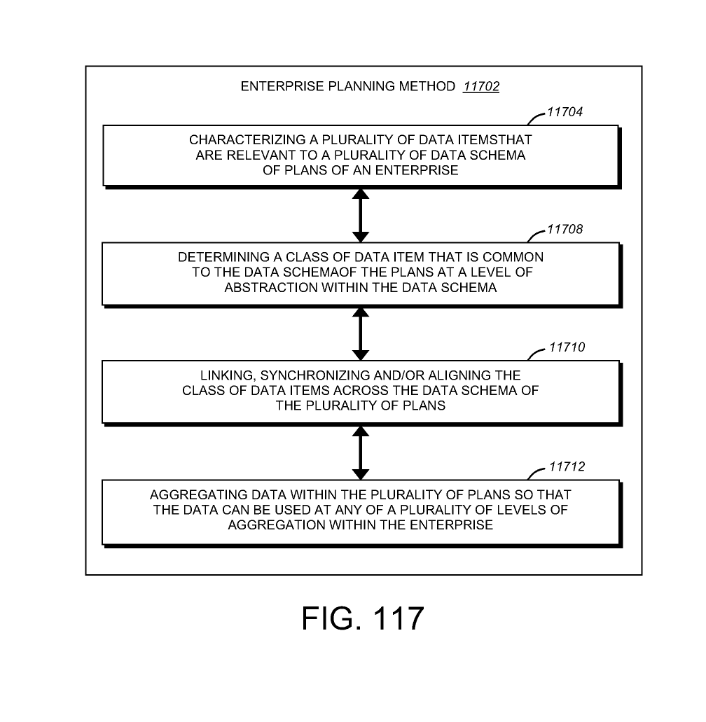

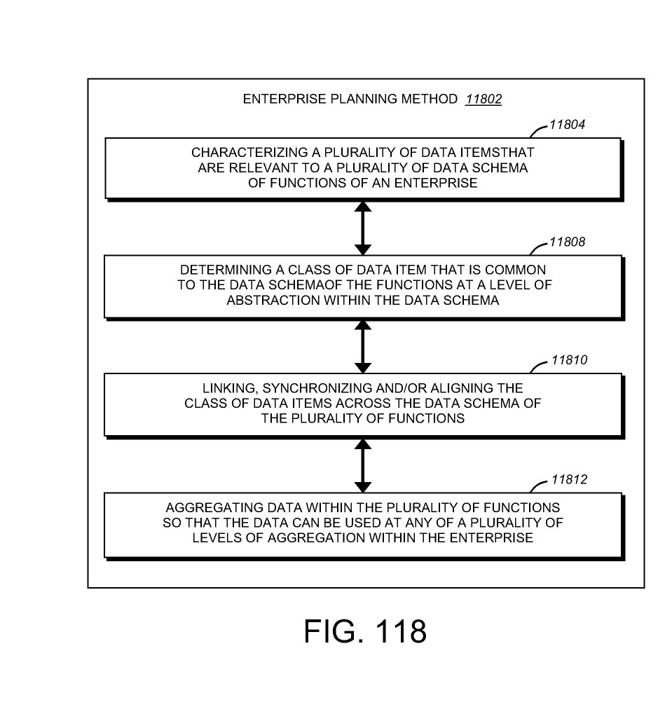

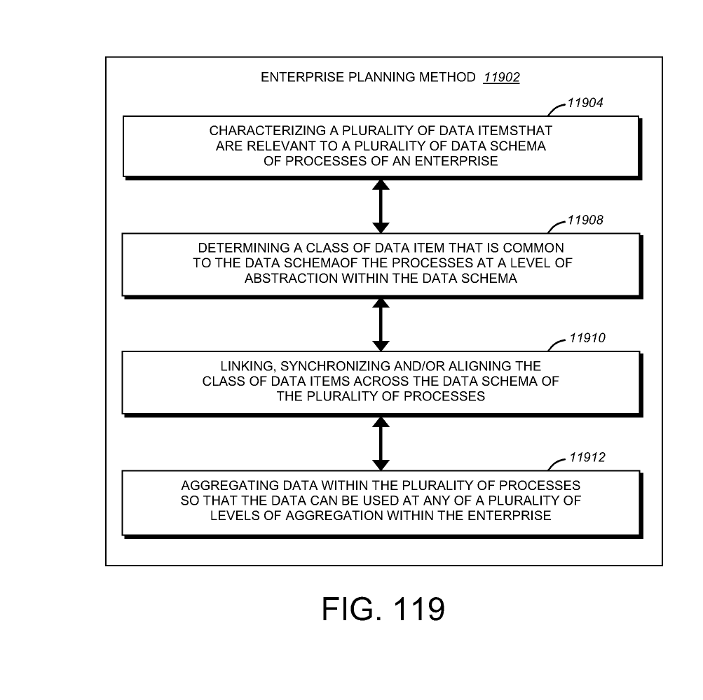

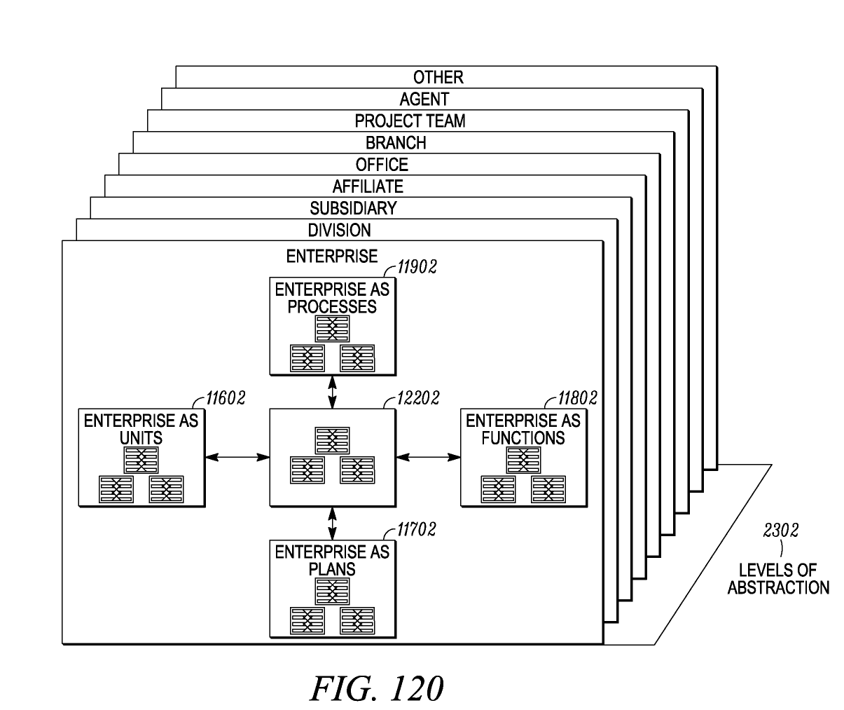

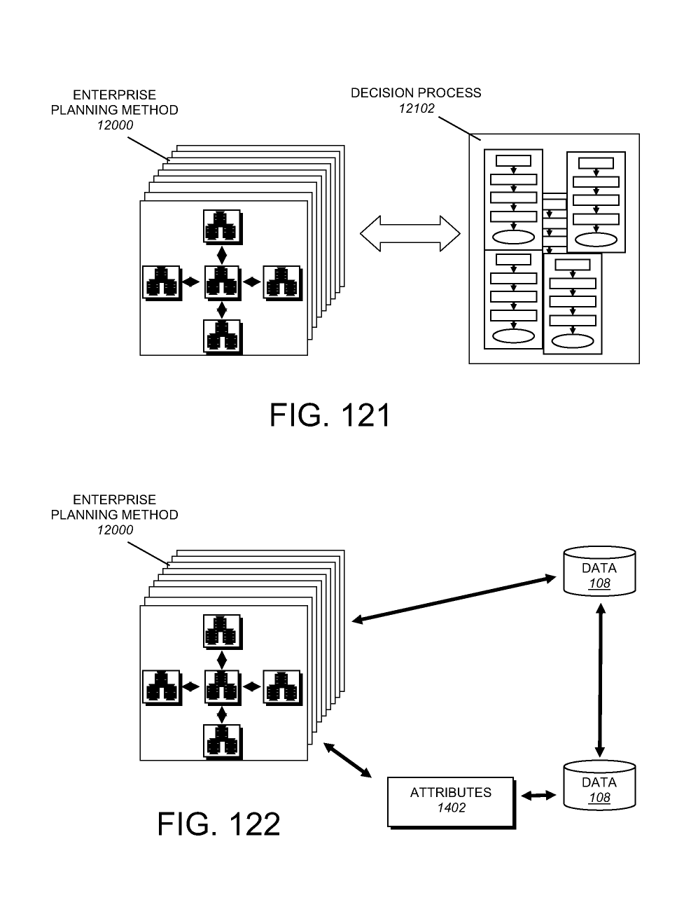

Referring to FIG. 5, an enterprise planning method 502, may link, synchronize, aggregate, associate and/or align two or more units, plans, functions, processes or other subsets of an enterprise 802, at any level of abstraction 2302. An enterprise planning method 11602, may be conceptualized or conducted in terms of units as depicted in FIG. 116. An enterprise planning method 11702, may be conceptualized or conducted in terms of plans as depicted in FIG. 117. An enterprise planning method 11802, may be conceptualized or conducted in terms of functions as depicted in FIG. 118. An enterprise planning method 11902, may be conceptualized or conducted in terms of processes as depicted in FIG. 119. Any of the foregoing may be logically linked, including by facilitating the sharing of decision objects among them at appropriate points, including points in decision processes and including sharing data sets where the data sets relate to a least common data set at one or more levels of abstraction. An enterprise planning method 502 may be any of the enterprise planning methods 11602, 11702, 11802 and/or 11902. Referring to FIG. 114, an enterprise 106 may be conceptualized as an interaction between many subsets of an enterprise 4412. An enterprise planning method 502 may provide the connections between the various units, plans, functions, processes and/or other subsets of an enterprise 802, as depicted in FIG. 120. Also as depicted in FIG. 120, the interactions may be within or span various levels of the enterprise hierarchy 3102. Referring to the example of FIG. 114, an enterprise planning method 502 may link, synchronize, aggregate, associate and/or align any two or more of the various product divisions, branches, project teams, agents, consultants and employees of the enterprise 106.

As depicted in FIG. 122, an enterprise planning method 12000, which may be any enterprise planning method such as enterprise planning methods 502, 11602, 11702, 11802 and/or 11902, may be associated with various decision processes 12102 of an enterprise. An enterprise planning method 12000 may inform or be informed by various decision processes of an enterprise 12102. An enterprise planning method 12000 may link, synchronize, aggregate, associate and/or align any two or more decision processes of an enterprise 12102 or steps of those decision processes. For example an enterprise planning method 12000 may link the decision processes dealing with the supply for a product with the decision process dealing with demand for the product. In another example, an enterprise planning method may align the steps in the supply and demand decision processes dealing with selection of information sources on which to base forecasts.

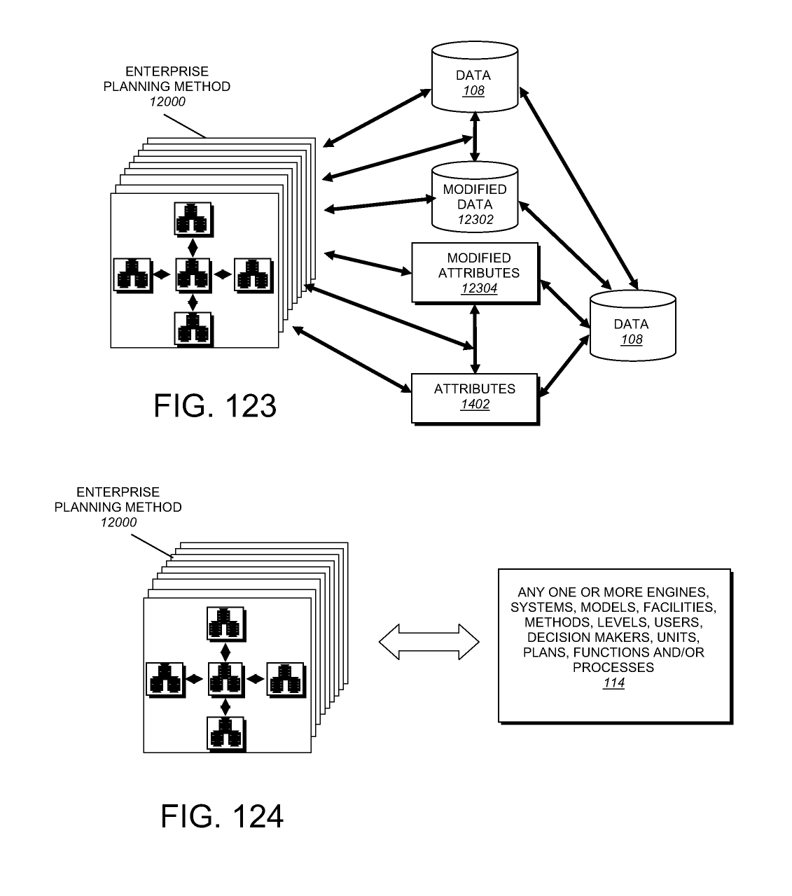

As depicted in FIG. 122, an enterprise planning method 12000, which may be any enterprise planning method such as enterprise planning methods 502, 11602, 11702, 11802 and/or 11902, may be associated with various attributes 1402, whether or not embodied in data 108, and data of an enterprise 106. An enterprise planning method 12000 may inform or be informed by various attributes 1402 and data 108 of an enterprise. An enterprise planning method 12000 may link, synchronize, aggregate, associate and/or align the attributes 1402 and data 108 of two or more decisions 102. As depicted in FIG. 123, this may lead to modification of the attributes 1402 and data 108. An enterprise planning method 12000 may also modify the attributes 1402 and data 108 through other means. As depicted in FIG. 124, an enterprise planning method 12000 may also be associated with various analytical tools 114 of an enterprise 106. For example, an enterprise planning method 12000, make link the step of determining the value of the demand forecast attribute 1402 of a demand-related decision 102 to the step of determining the value of the supply forecast attribute 1402 of the corresponding supply-related decision 102. Based on information collected using the decision collaboration engine 5702 or other various analytical tools 114 the decision maker 104 may modify the value of the demand-forecast attribute 1402 value.

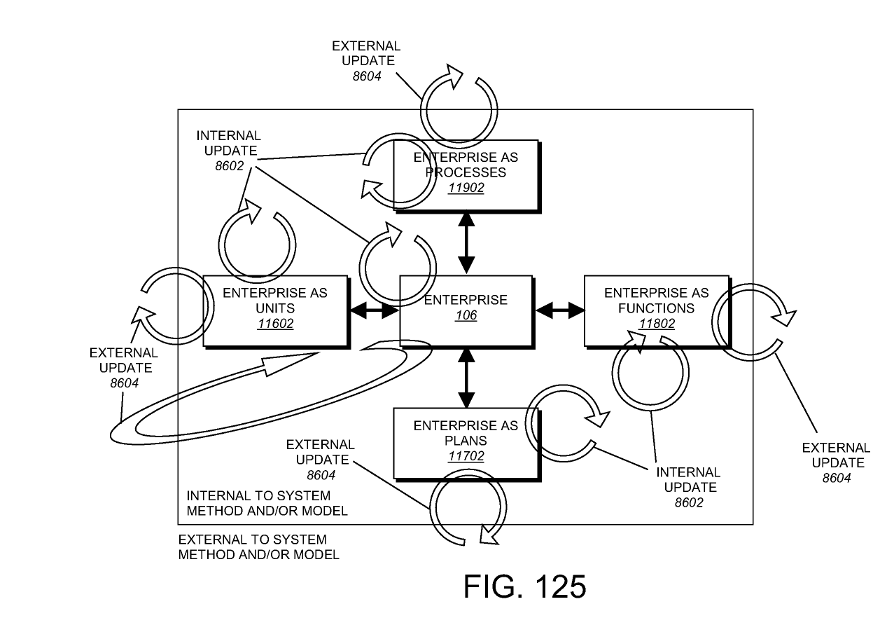

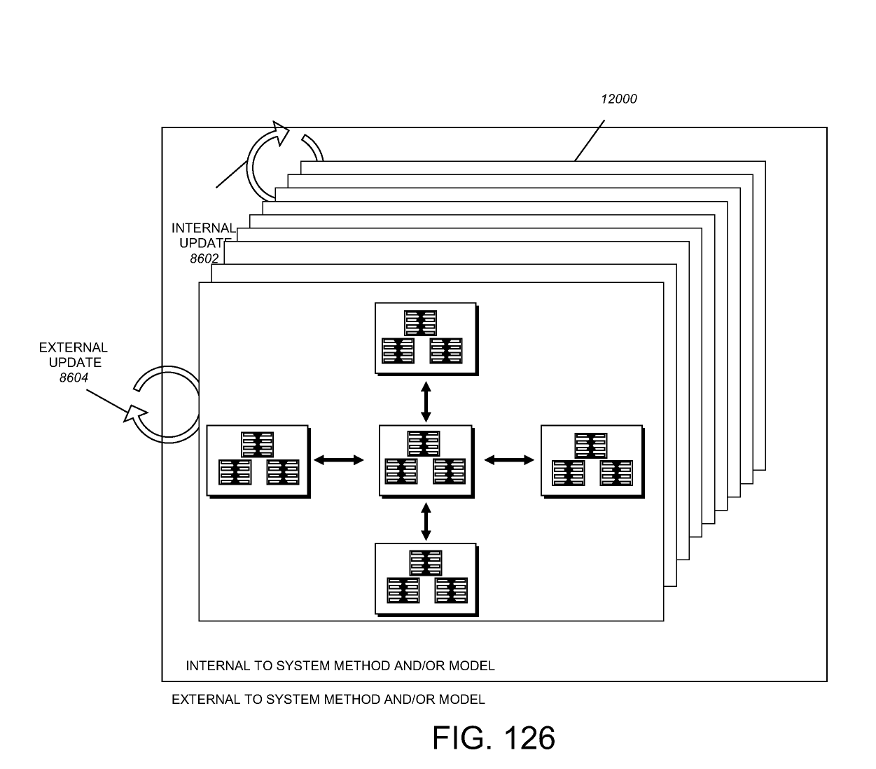

As depicted in FIGS. 125 and 126, the various enterprise planning methods such as an enterprise planning method of a unit 11602, plan 11702, function 11802, process 11902 or of the enterprise as a whole across levels of abstraction 12000 may be updated periodically. The updates may be internal updates 8602 and/or external updates 8604. The period of an update or the intervals between updates may be a year, quarter, month, week, day, hour, minute, second or any other unit of time. FIG. 87 above depicts a hierarchy of various units of time. The updates may also be done at intervals or with a period defined by a user 2608, system 2610 or other decision maker 104. The updates may also be done in real-time or on a continuous basis. For example, through an enterprise planning method 12000, a modification of an attribute 1402 of one decision object 101 may cause the automatic updating of any related or dependent attributes of other decision objects 202.

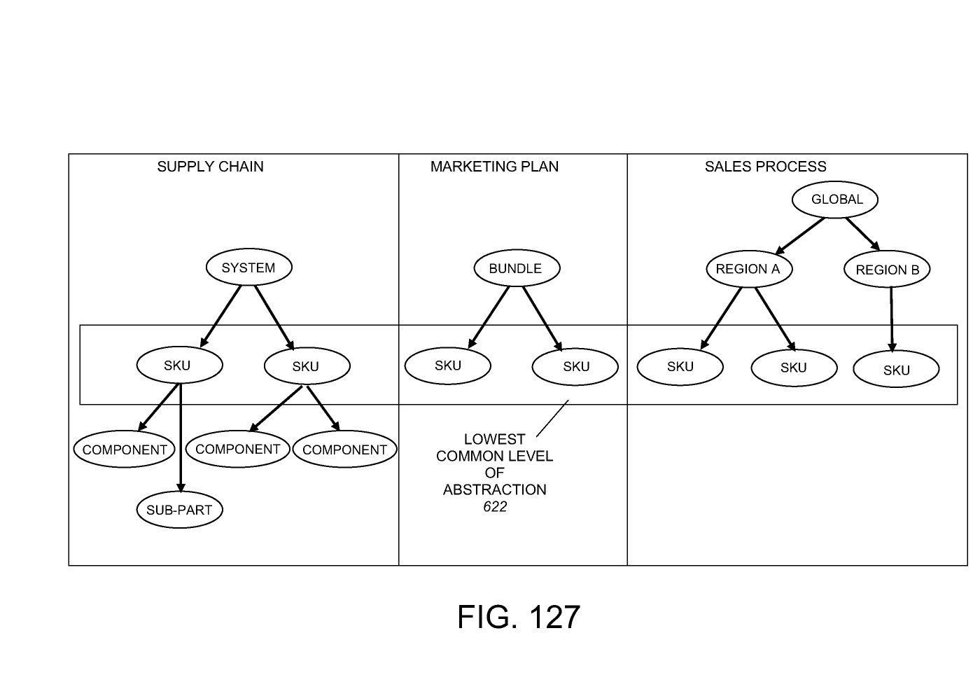

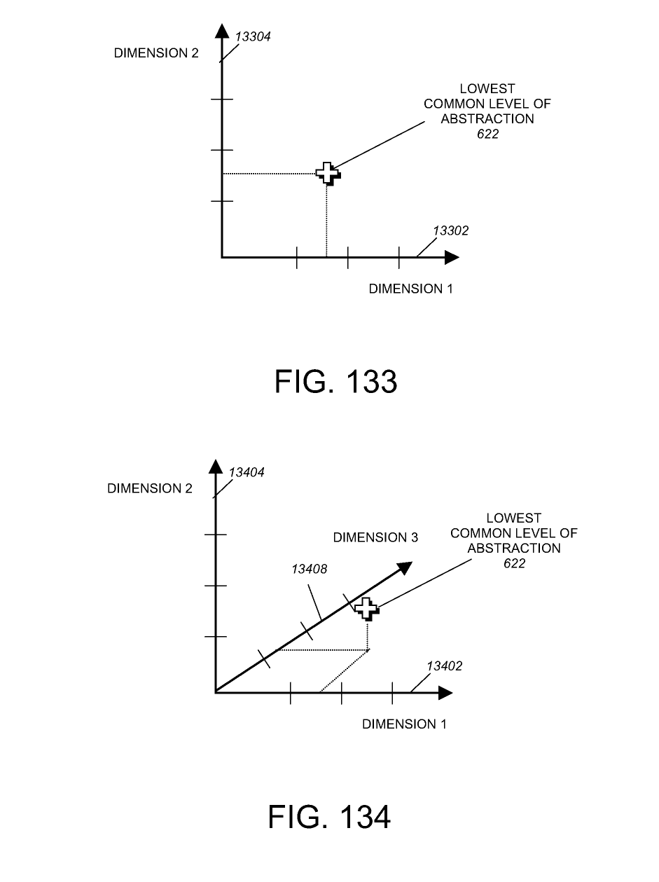

Referring back to FIG. 6, a lowest common level of abstraction 622 may enable an enterprise planning method 12000. Similar to FIG. 6, FIG. 127 presents a subset of an enterprise 106 for which the lowest common level of abstraction 622 is a stock keeping unit. A lowest common level of abstraction 622 may incorporate one or more goods, products, services or kits and/or bundles of goods, products and/or services. The lowest common level of abstraction 622 may be at, above or below the stock keeping unit level, the bill of materials level, the parts level, the components level, a unit of functionality, a unit of time, such as hours, weeks-on-hand, days-on-hand, a unit of time-on-hand. The lowest common level of abstraction 622 may be multidimensional as discussed in connection with FIGS. 133 and 134 below. The lowest common level of abstraction 622 may involve a good, product and/or service that is leased, rented, time-shared, bartered and/or licensed. The lowest common level of abstraction 622 may be higher or lower than the actual lowest common level of abstraction 622. The lowest common level of abstraction 622 may be defined or specified by a user 2608, system 2610 and/or decision maker 104.

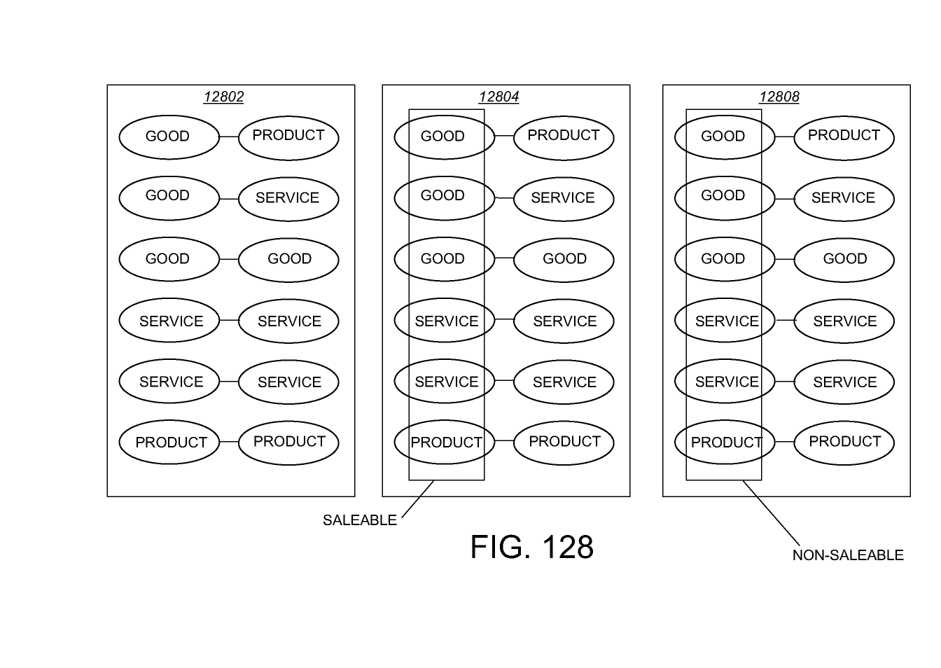

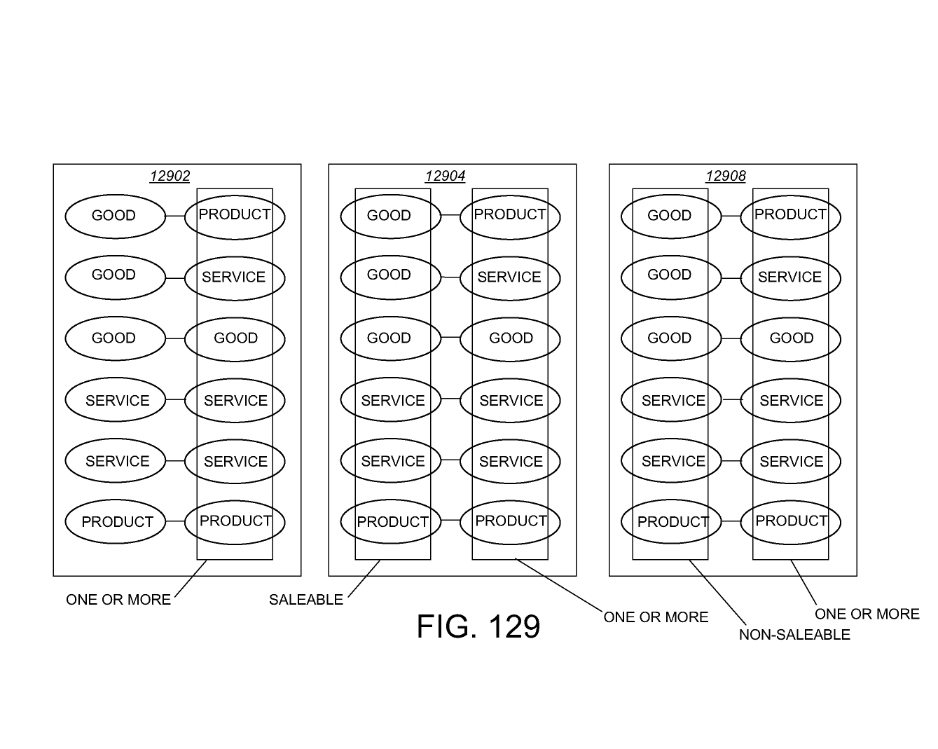

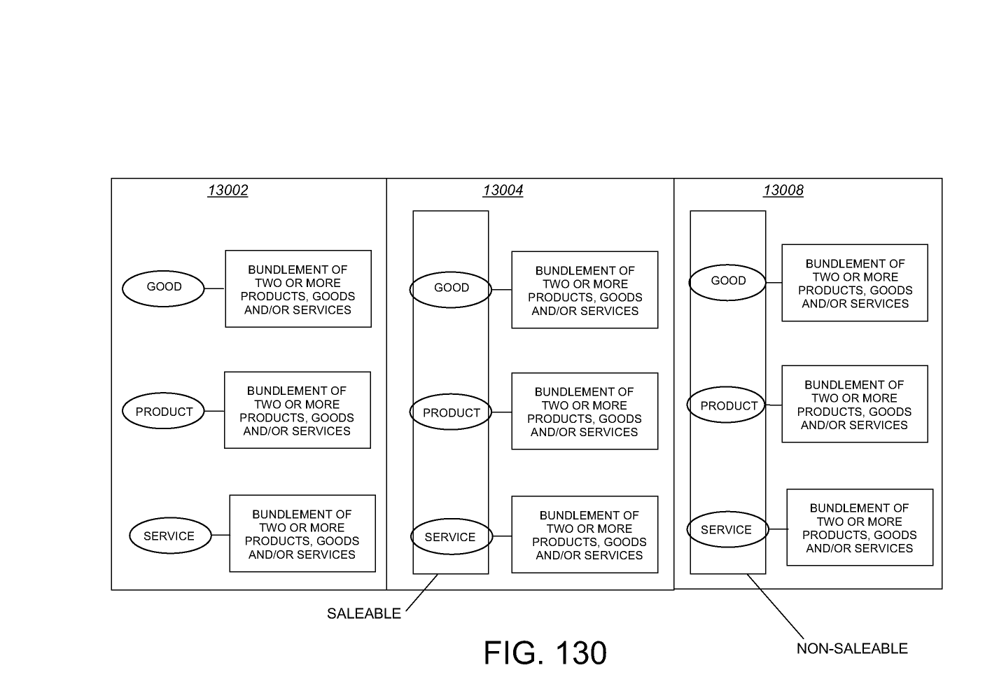

FIG. 128 depicts various two member kits and bundles of good, products and services 12802. One member of the pair may be saleable 12804, one member of the pair may be non-saleable 12808, both members may be saleable or neither may be saleable. FIG. 129 depicts various kits and bundles composed of a good, product or service along with one or more goods, products or services 12902. The good, product or service may be saleable 12904 or non-saleable 12908. FIG. 130 depicts various kits and bundles composed of a good, product or service along with one or more bundles or kits of two or more products, goods and services 13002. The good, product or service may be saleable 13004 or non-saleable 13008.

A product or good may be consumer-related, wholesale-related, durable, household-related, mechanical, business-related, medical, drugs, computer-related, electronics, microchips, semi-conductors, vehicles, clothing, food, prepared foods, groceries, fast food, restaurant foods, integrated product, a system, bundle, kit, assembly, sub-assembly, part and/or component. A unit of a good or product may be a land vehicle-load, truck-load, car-load, railcar-load, air vehicle-load, aircraft-load, airplane-load, helicopter-load, airship-load, blimp-load, water vehicle-load, ship-load, barge-load, submarine-load, hovercraft-load, inter-modal container, lot, pallet, crate, container, carton, data packet, transfer unit, integrated product, system, bundle, kit, assembly, sub-assembly, part, component, unit of a product and/or any partial amount of any of the foregoing. A kit or bundle may consist of a product or good and at least one good or product, a service, good or product accessory, service accessory, complementary good or product, complementary service, substitute good or product, substitute service and/or an unrelated good, product and/or service. For example, a kit or bundle involving a good or product may be a toothbrush and toothpaste, camera and film, computer and software, remote control vehicle and radio controller, cell phone and cell service, software and support services, software and maintenance services, software and maintenance services, a fast food serving and a drink, combination of foods, combination of beverages, combination of foods and beverages, computer keyboard and computer mouse, computer mouse and mouse pad, pens and pencils, pens of different colors, needle, thread and scissors, shampoo and conditioner, travel toiletry kits, oil and gas mix, matching clothes to make an outfit, coloring book and crayons, a bottle of wine and glasses or an automobile chassis and an automobile body.

A service may be any of the following: utilities, heating, cooling, electricity, telephone, Internet, cable, satellite television, satellite Internet, gas, healthcare, physiotherapy, chiropractic, mental health, counseling, cosmetics, beauty, hair care, personal grooming, personal assistance, fitness, personal training, veterinary, household, housekeeping, cleaning, food preparation, food service, childcare, government infrastructure, government services, legal, financial, banking, accounting, business, consulting, drawing, drafting, writing, technical writing, word processing, typing, secretarial, money management, real estate, educational, tutoring, development, maintenance, support, planning, funeral planning, software development, software maintenance, software support, product support, construction, surveying, gardening, lawn care, household maintenance, sanitation, architecture, transportation, lodging, security, police, fire, emergency, ambulance, entertainment, companionship and/or travel and tourism. A unit of service may be a unit of functionality, unit of time, unit of service, task, unit of difficulty, unit of complexity, unit of expected result, unit of actual result, unit of expected change, unit of actual change and/or any other unit. A kit or bundle may consist of a service and at least one good or product, service, a good or product accessory, service accessory, complementary good or product, complementary service, substitute good or product, substitute service and/or any unrelated good, product and/or service. For example, a kit or bundle involving a service may be a cell phone and cell service, software and support services, software and maintenance services, software and development services, Internet service and modem, vehicle cleaning and maintenance services, food and food service, dry cleaning and tailor service, digital video recorder and subscription service, satellite entertainment equipment and subscription service, movie admission and food, gym membership and personal training services, life insurance and property insurance, wash, cut and blow dry hair care, local and long distance telephone service plans, automobile and automotive maintenance services and garden, planting and/or landscaping services and garden maintenance services.

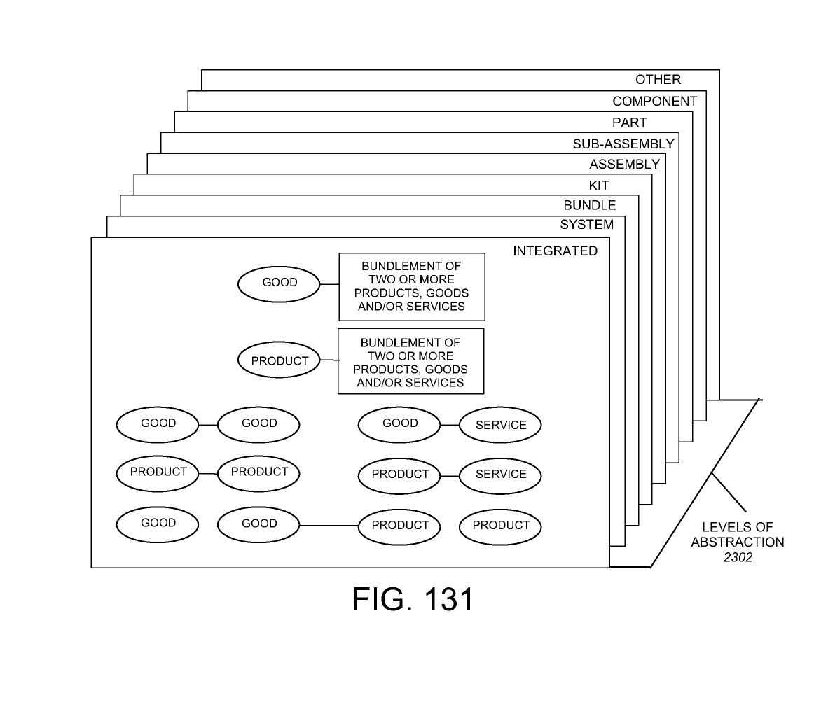

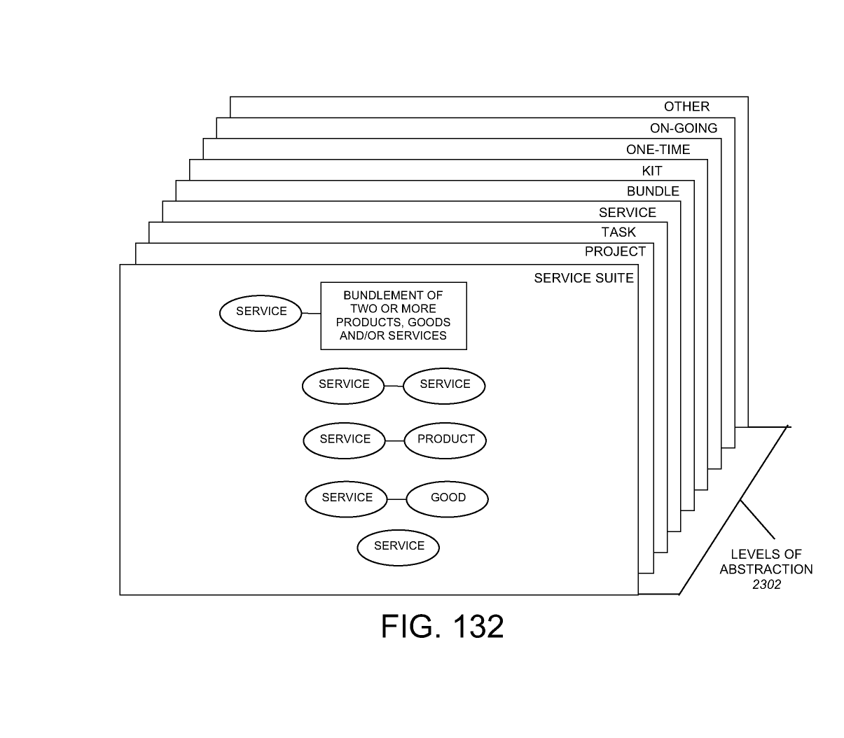

As depicted in FIG. 131, a product or good or various kits and/or bundles including a good and/or product may exist at and form various levels of abstraction 2302. For example, the levels of abstraction 2302 may be integrated good or product, system, bundle, kit, assembly, sub-assembly, part and/or component. As depicted in FIG. 132, a service or various kits and/or bundles including a service may exist at and form various levels of abstraction 2302. For example, the levels of abstraction 2302 may be a service suite, project, service, task, preparation, one-time service, on-going service, kit and/or bundle.

As depicted in FIGS. 133 and 134, the lowest common level of abstraction 622 may be multidimensional. It may be one, two, three or n-dimensional. FIG. 133 depicts a lowest common level of abstraction 622 having two dimensions and FIG. 134 depicts a lowest common level of abstraction 622 having three dimensions. The dimensions may be stock keeping units, bills of materials, parts, components, time, units of time, units of functionality, goods, products, services, geography, geographic regions, geographical units, manufacturing units, supply units, demand units, quality, quantity, processes, travel-miles, market share, market penetration or any unit of a good, product and/or service. For example, a lowest common level of abstraction may be (i) a unit of time combined with at least one other unit selected from the group consisting of: good, product, service, stock keeping unit, bill of materials, parts, components and time; (ii) a unit of a good combined with at least one other unit selected from the group consisting of: good, product, service, stock keeping unit, bill of materials, parts, components and time; (iii) a unit of a product combined with at least one other unit selected from the group consisting of: good, product, service, stock keeping unit, bill of materials, parts, components and time; (iv) a unit of a service combined with at least one other unit selected from the group consisting of: good, product, service, stock keeping unit, bill of materials, parts, components and time; (v) stock keeping units per week per manufacturing plant; (vi) products per day per distribution channel; (vii) products per day per distribution channel per country; (viii) cost per passenger mile; (ix) service hours per day per worker; (x) change in market share per advertising campaign cost; and (xi) stock keeping units per week.

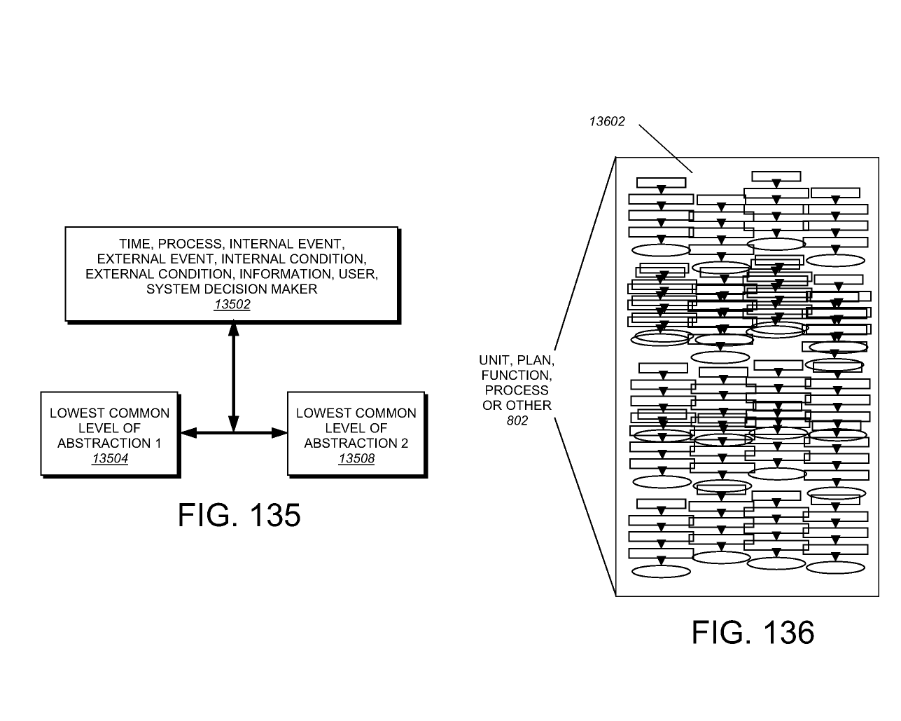

As depicted in FIG. 135, a lowest common level of abstraction 13504 may change or be changed to another lowest common level of abstraction 13508 in response to an event and/or condition 13502. The event and/or condition may be the passage of time, a process, a change in process, an internal event, an external event, an internal condition, an external condition, information and/or user 2608, system 2610 and/or decision maker 104 inputs and/or preferences.

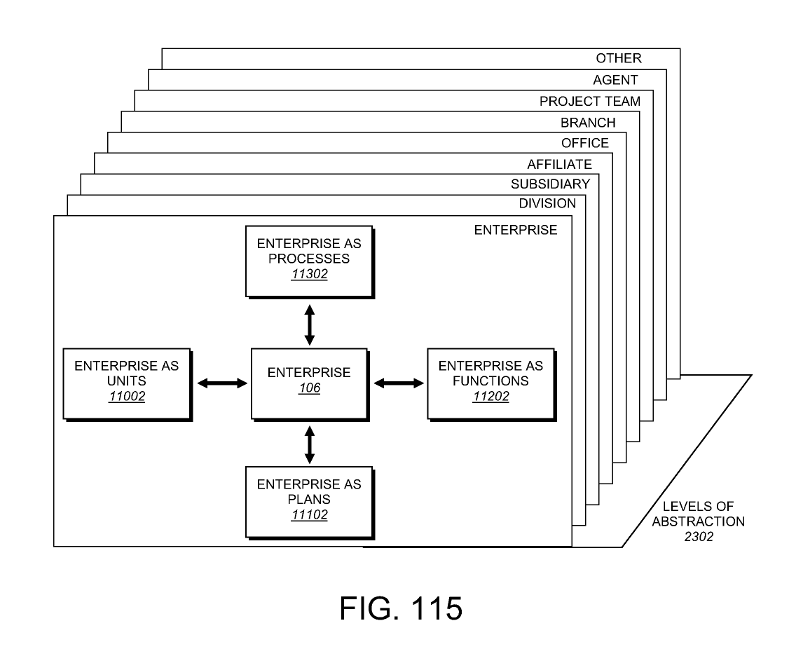

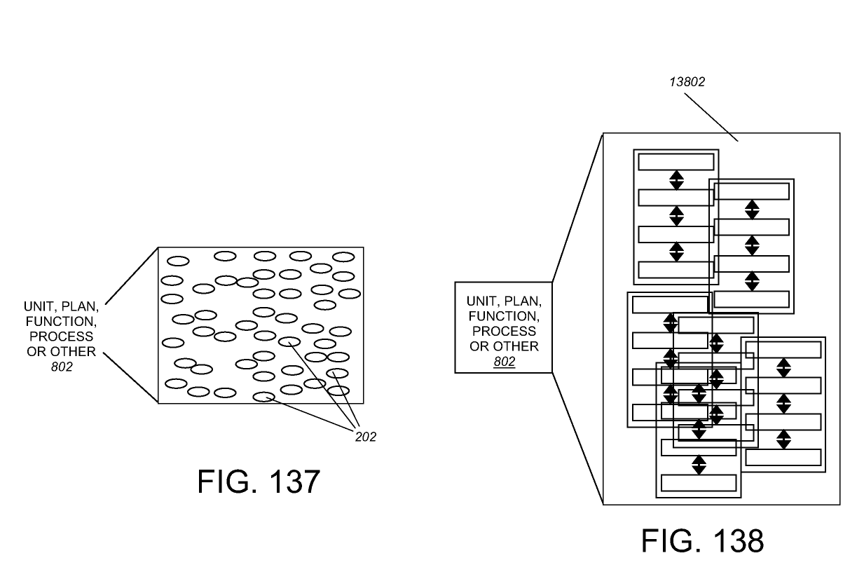

Referring to FIG. 115, an enterprise 106 may be characterized as various units 11002, plans 11102, functions 11202 and processes 11302 at various levels of abstraction 2302. Referring to FIG. 120, an enterprise 106 may be characterized as various enterprise planning methods in connection with various units 11602, plans 11702, functions 11802 and processes 11902 at various levels of abstraction 2302. As depicted in FIG. 136, each unit, plan, function, process or other subset of an enterprise 802 may be characterized as various decision processes 13602. Each unit, plan, function, process or other subset of an enterprise 802 may also be characterized as various decision objects 202, as depicted in FIG. 137. Each unit, plan, function, process or other subset of an enterprise 802 may also be characterized as various enterprise planning methods 12000, as depicted in FIG. 138. In addition, as depicted in FIG. 139, each unit, plan, function, process or other subset of an enterprise 802 may be characterized as one or more units, plans, functions, processes or other subsets of an enterprise 802.

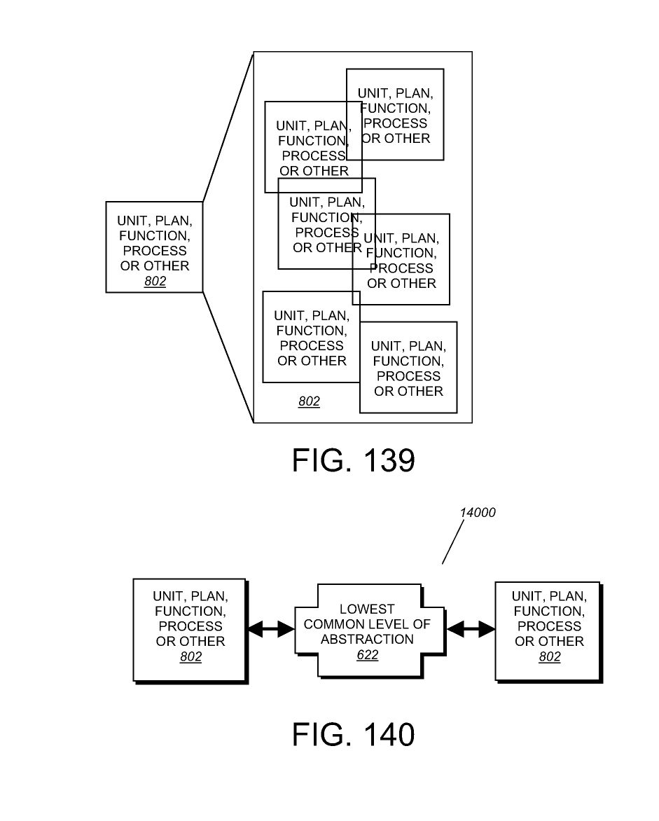

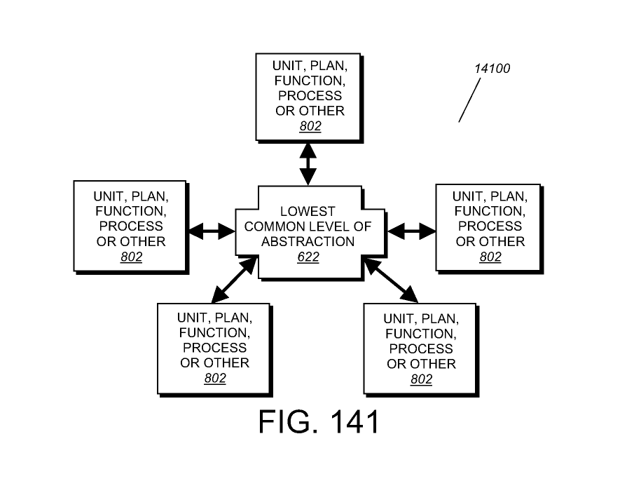

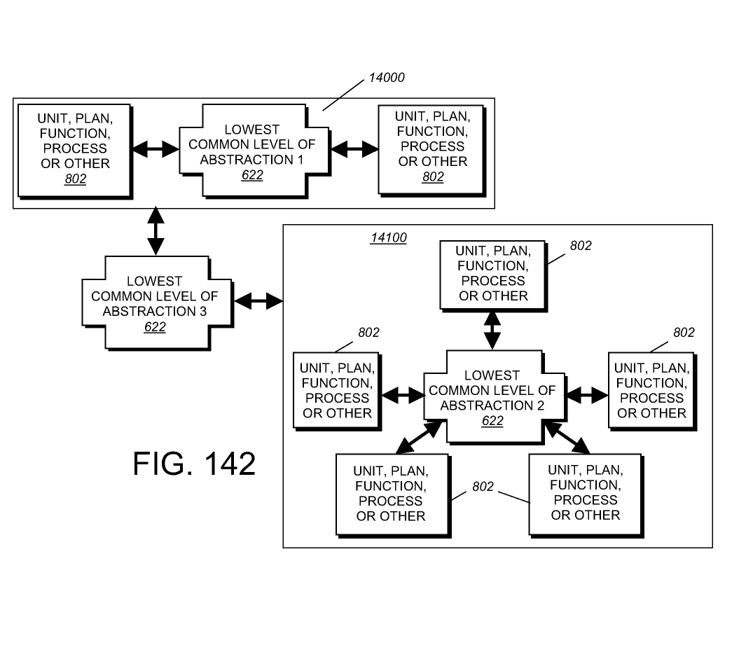

An enterprise planning method 12000, through one or more lowest common levels of abstraction 622, may link, synchronize, integrate, aggregate and/or align two or more units, plans, functions, processes or other subsets of an enterprise 802, as depicted in FIG. 140. For example, two units, plans, functions, processes and/or other subsets of an enterprise 802 may be linked by the lowest common level of abstraction 622 of profit per customer 14000. This lowest common level of abstraction 622 may be relevant to one step of a decision process 13602 common to both units, plans, functions, processes and/or other subsets 802. In another example, as depicted in FIG. 141, another lowest common level of abstraction 622, customers per region, may link, synchronize, integrate, aggregate and/or align five units, plans, functions, processes and/or other subsets of an enterprise 802 14100. These linked subsets of two and five units, plans, functions, processes and/or other subsets of an enterprise 802 may be linked to each other through another lowest common level of abstraction 622, such as profit per customer per region, as depicted in FIG. 142.

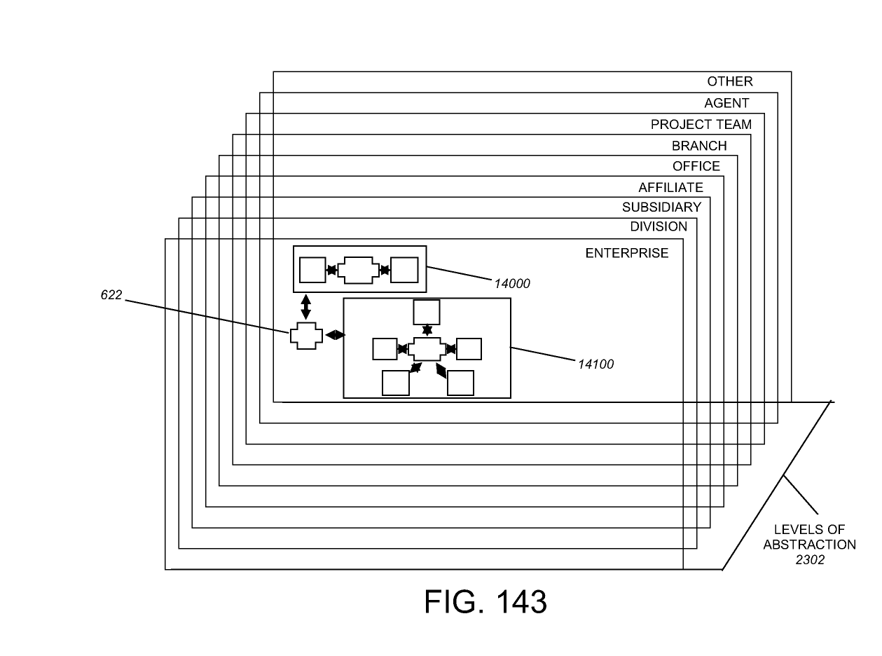

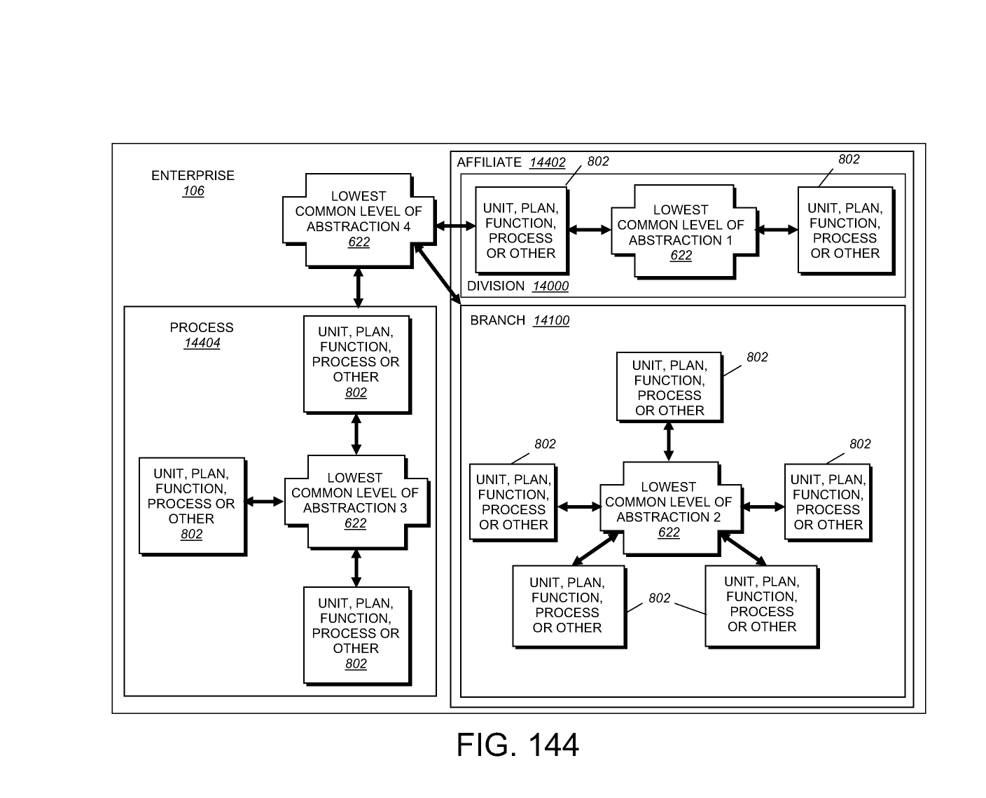

The various enterprise planning methods 12000 may also link, synchronize, integrate, aggregate and/or align at various levels of abstraction 2302, as depicted in FIG. 143. For example, referring to FIG. 140, in the example of the two units, plans, functions, processes and/or other subsets of an enterprise 802 being linked by the lowest common level of abstraction 622 of profit per customer, the two units, plans, functions, processes and/or other subsets of an enterprise 802 may form a division of a financial institution 14000. Referring back to FIG. 141, the five units, plans, functions, processes and/or other subsets of an enterprise 802 may form a branch of a financial institution 14100. At another level of abstraction the division 14000 and branch 14100 may form an affiliate 14402, as depicted in FIG. 144. The affiliate 14402 may be linked to a process 14404, through the linking of the division 14000 and branch 14100 to the process 14404, possibly through the lowest common level of abstraction 622 of profits per customer per region, in this example. The affiliate 14402 and process 14404 may form a subset of an enterprise 4412. In this manner an enterprise planning method 12000 has linked, synchronized, integrated, aggregated and/or aligned a subset of an enterprise 4412.

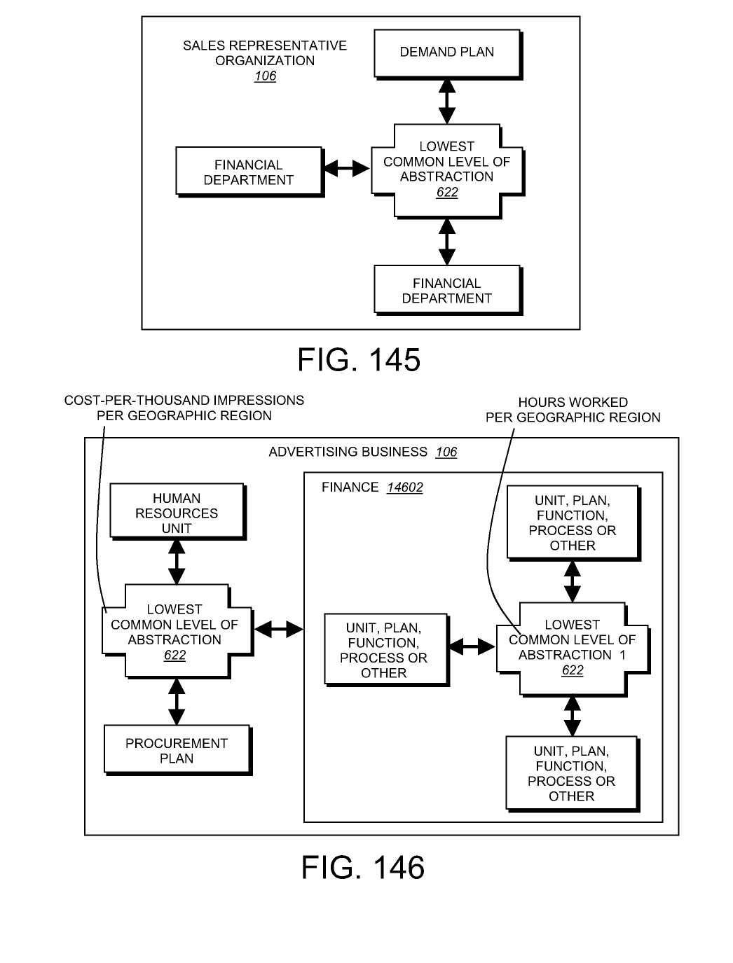

As depicted in FIG. 145, an enterprise 106 may be a sales representative organization. The dimensions of a relevant lowest common level of abstraction 622 may be any one or more of margin per product sold, price per product, time, geographic unit, total products sold, change in revenue, change in market share and/or change in market penetration. An enterprise planning method 12000, may link, synchronize, integrate, aggregate and/or align the demand plan, supply plan and finance department using the lowest common level of abstraction 622 of margin per product per region per time.

As depicted in FIG. 146, an enterprise 106 may be an advertising business. The dimensions of a relevant lowest common level of abstraction 622 may be any one or more of cost-per-thousand impressions, hours worked, geographic unit, geographic region, change in revenue, change in market share and/or change in market penetration. An advertising business may use a plurality of channels and media such as television, radio, Internet, email, banner ads, pop-up ads, text messaging, SMS messaging, mobile platforms, print, newspapers, magazines, billboards, signs, advertisements placed on vehicles, video displays, video games, movies, television programs and/or any other channel or media through which one can now, or may in the future, advertise. An enterprise planning method 12000, may link, synchronize, integrate, aggregate and/or align the human resources unit, the procurement plan and the finance department 14602 using the lowest common level of abstraction 622 of cost-per-thousand impressions per geographic region. An enterprise planning method 12000, may link, synchronize, integrate, aggregate and/or align the various units, plans, functions, processes and/or other subsets of the finance department 14602 though a lowest common level of abstraction 622 of hours worked per geographic region. In this manner, the various units, plans, functions, processes and/or other subsets of an enterprise 802 of the finance department 14602 may be linked, synchronized, integrated, aggregated and/or aligned with the human resources unit and the procurement plan.

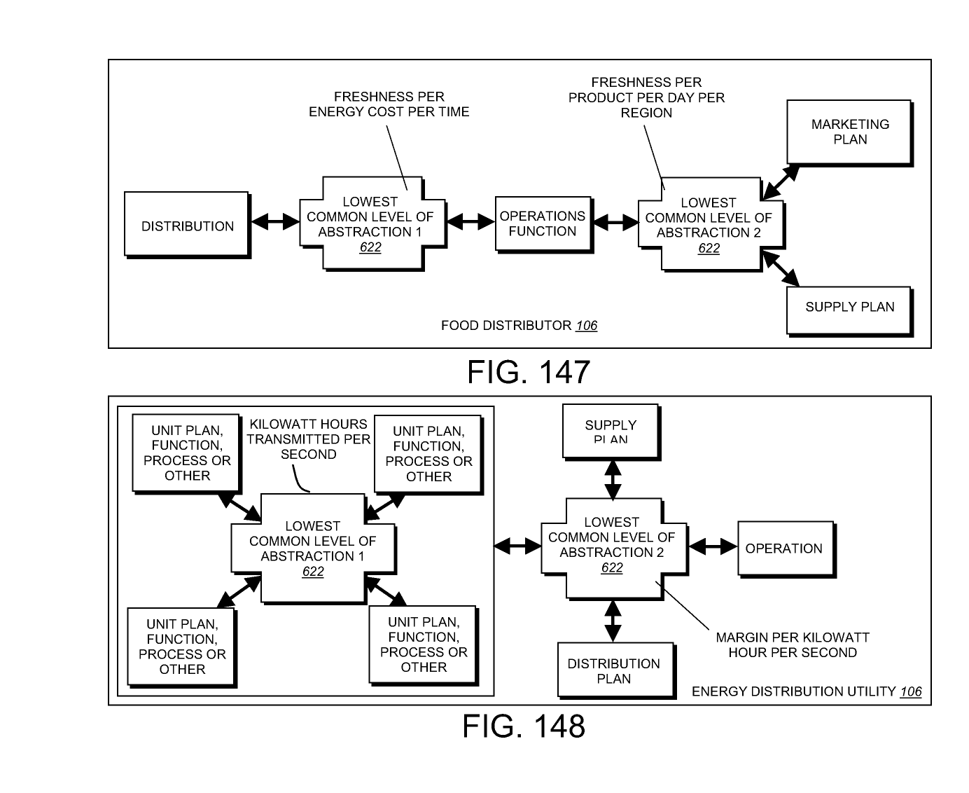

As depicted in FIG. 147, an enterprise 106 may be a food distributor or any other business or entity involved with a good, product or service which may spoil or become obsolete. For example, the business may be a restaurant, grocery store, bar, food and/or beverage distributor, food and/or beverage wholesaler, food and/or beverage manufacturer, food and/or beverage retailer, laboratory, pharmaceutical company, drug manufacturer, pharmacy, pet retailer, animal transportation, convenience store, consumer goods vendor and/or clothing retailer. For example, the good or product may be a foodstuff, beverage, chocolate, candy, computer hardware, electronics, medical supplies, drugs, a liquid gas, a compressed gas, such as oxygen, nitrogen, helium, propane and/or natural gas, animal, living organism, virus, musical instrument, flora and/or fauna. The condition of the good or product may require regulation to maintain temperature, humidity, vibration level, pressure, oxygen-level, water-level and/or travel time. For example, the service may be promotion by a celebrity, promotion of a temporary event, food service, food preparation and/or development. The dimensions of a relevant lowest common level of abstraction 622 may be any one or more of a freshness measure, lifetime, half-life, energy cost, heating cost, cooling cost, geographic region and/or percentage alive. An enterprise planning method 12000, may link, synchronize, integrate, aggregate and/or align the distribution unit with the operations function using the lowest common level of abstraction 622 of freshness per energy cost per time. An enterprise planning method 12000, may link, synchronize, integrate, aggregate and/or align the marketing plan, supply plan and operations function using the lowest common level of abstraction 622 of freshness per product per day per region. In this manner, the marketing plan and supply plan may be linked, synchronized, integrated, aggregated and/or aligned with the distribution unit.

As depicted in FIG. 148, an enterprise 106 may be an energy distribution utility. The dimensions of a relevant lowest common level of abstraction 622 may be any one or more of kilowatt hours, kilowatt hours transmitted, margin per kilowatt hour, cycles, geographic region, day, week, quality of the electricity and/or market share. An enterprise planning method 12000, may link, synchronize, integrate, aggregate and/or align the engineering department 14802, supply plan, operations department and distribution function using the lowest common level of abstraction 622 of margin per kilowatt hour per minute per region. An enterprise planning method 12000, may link, synchronize, integrate, aggregate and/or align the various units, plans, functions, processes and/or other subsets of the engineering department 14802 though a lowest common level of abstraction 622 of kilowatt hours transmitted per second. In this manner, the various units, plans, functions, processes and/or other subsets of an enterprise 802 of the engineering department 14802 may be linked, synchronized, integrated, aggregated and/or aligned with the human resources unit and the procurement plan.

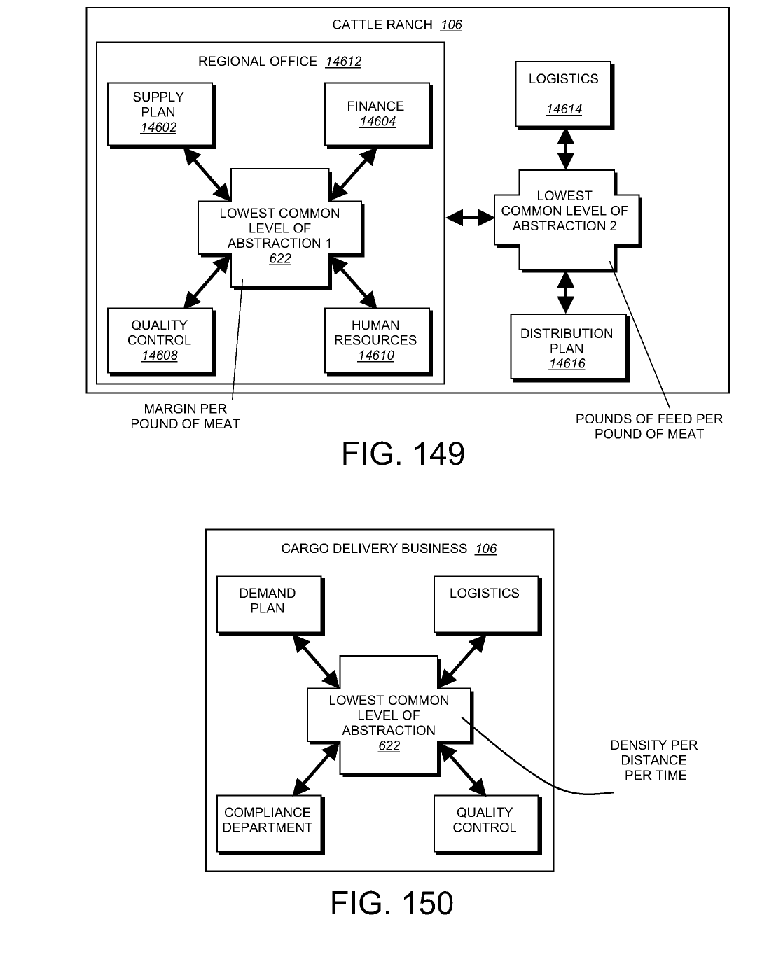

As depicted in FIG. 149, an enterprise 106 may be an agricultural business, such as a cattle ranch. In addition to cattle, the animal stock may be any of horses, pigs, sheep, lamb, deer, ostrich, bees, chickens, roosters, ducks, other poultry, other foul, rabbits and/or fish. The agricultural business may also grow crops such as corn, wheat, rice, sunflower seeds, beans, celery, rhubarb, bananas, oranges, tomatoes, strawberries, peaches, cherries, blue berries, raspberries, peanuts, walnuts, cashews, other nuts, other fruits, other vegetables and/or other grains. The agricultural business may also produce other products such as honey, meat, eggs, canola oil, vegetable oil, fruits, vegetables, nuts and/or grains. The agricultural business may also offer and perform services such as hunting, fishing, ranch tourism and/or horseback riding. The dimensions of a relevant lowest common level of abstraction 622 may be any one or more of energy cost, pounds of feed per pounds of meat, pounds of feed per pound of product, pounds of feed per gallon of output, time, input measure per unit of output measure and/or fee per hour of service.

An enterprise planning method 12000, may link, synchronize, integrate, aggregate and/or align the supply plan 14602, finance department 14604, quality control unit 14608 and human resources function of the enterprise 106 using the lowest common level of abstraction 622 of margin per pound of meat. The supply plan 14602, finance department 14604, quality control unit 14608 and human resources function may form a regional office at a higher level of abstraction 14612. An enterprise planning method 12000, may link, synchronize, integrate, aggregate and/or align the regional office 14612, through the supply plan, with logistics 14614 and the distribution function 14616 using the lowest common level of abstraction 622 of pounds of feed per pound of meat. In this manner the finance department, quality control unit, human resources function, supply plan, distribution function and logistics may be linked, synchronized, integrated, aggregated and/or aligned.

As depicted in FIG. 150, an enterprise 106 may be a transportation business, such as a cargo business. The mode of transportation of the business may be aircraft, airplane, helicopter, airship, blimp, rail, train, trolley, street car, water, sea, ship, boat, submarine, hovercraft, land, road, truck, car, motorcycle, bicycle, segway, all terrain vehicle, snow mobile and/or any other mode of transportation. The item or cargo transported may be humans, passengers, animals, food products, cargo, freight and/or merchandise purchased over the Internet. The dimensions of a relevant lowest common level of abstraction 622 may be any one or more of cost per passenger mile, revenue per passenger mile, profit per passenger mile, on-time trips, weight per distance, spatial dimensions, weight, volume, density, energy consumption, cost, time, equipment depreciation, distance and/or arrival time. An enterprise planning method 12000, may link, synchronize, integrate, aggregate and/or align the demand plan, logistics, compliance department and quality control using the lowest common level of abstraction 622 of density per distance per time.

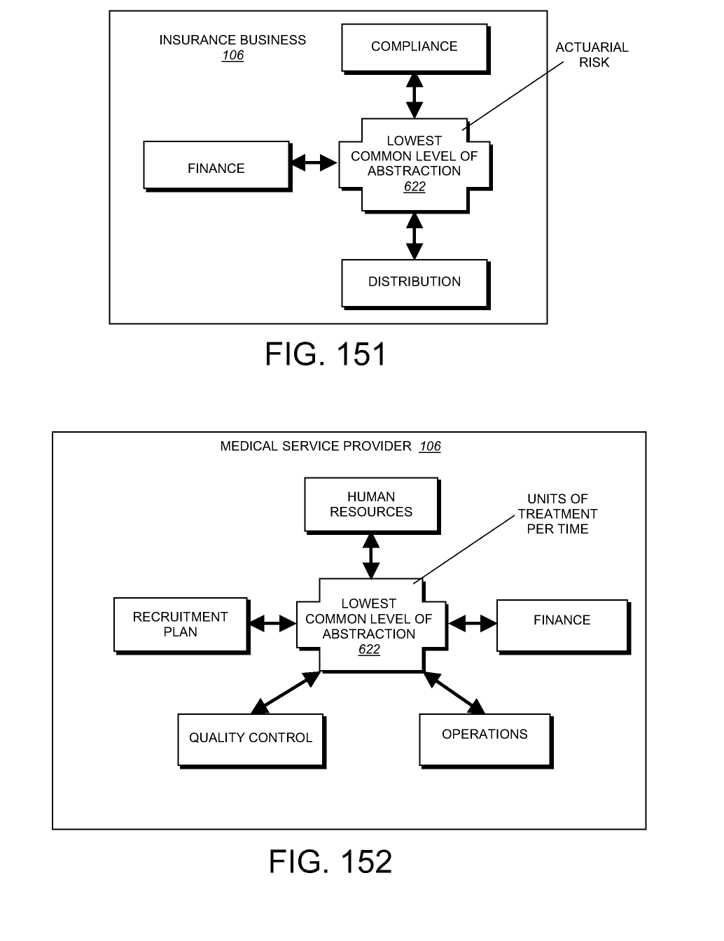

As depicted in FIG. 151, an enterprise 106 may be an insurance business. The dimensions of a relevant lowest common level of abstraction 622 may be any one or more of actuarial risk, cost per person insured, cost per item ensured, cost per business insured and/or margin per insurance policy. The item insured may be a human life, animal life, other life, real property, building, voice, part of a body, musical instrument, jewelry, contents of a home, electronics, business, client-base, car, truck, motorcycle, plane, helicopter, boat, ship, bicycle, other vehicle, shipment, cargo and/or baggage. The insurance may cover events such as fire, natural disaster, flood, earthquake, tornado, acts of war, acts of terror, fraud, theft and expropriation, trip cancellation and/or healthcare events. An enterprise planning method 12000, may link, synchronize, integrate, aggregate and/or align the compliance, finance and distribution departments using the lowest common level of abstraction 622 of actuarial risk.

As depicted in FIG. 152, an enterprise 106 may be a medical service provider. The dimensions of a relevant lowest common level of abstraction 622 may be any one or more of units of treatment, cost of treatment, doctor hours, nurse hours, margin per procedure, time, geographic region and/or risk. An enterprise planning method 12000, may link, synchronize, integrate, aggregate and/or align the human resource department, finance department, operations, quality control and recruitment plan using the lowest common level of abstraction 622 of units of treatment per time. In this manner, operations may set a business plan, including an increased target for the number of service hours and procedures to be provided per week. Quality control may determine that the quality of the services provided is declining since the doctors and nurses are overworked. Human resources may adjust staffing, and, working with human resources, the recruitment plan may decide to hire more doctors and/or nurses.

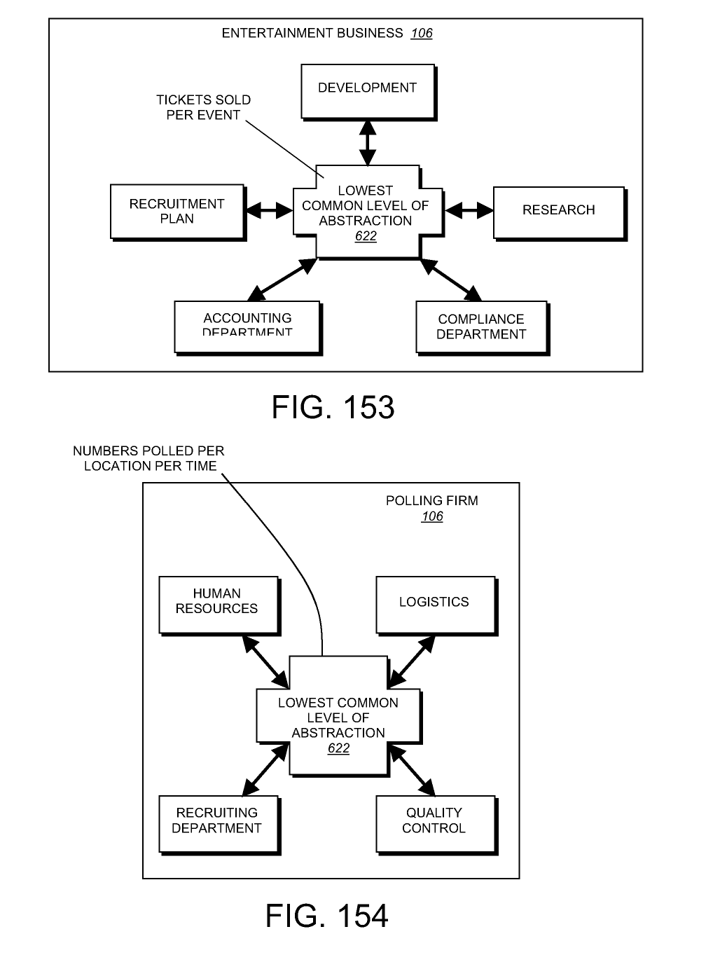

As depicted in FIG. 153, an enterprise 106 may be an entertainment business. The dimensions of a relevant lowest common level of abstraction 622 may be any one or more of box office sales, copies sold, return on investment, time, geographic location, tables filled, tickets sold, consumer reaction and ratings. An enterprise planning method 12000, may link, synchronize, integrate, aggregate and/or align the recruitment plan, accounting department, compliance department, research and development using the lowest common level of abstraction 622 of tickets sold per event. The research and development branches of the enterprise may be conducting research into and developing technologies for a new medium over which to deliver entertainment. Seeing this work, the compliance department may seek out applicable rules and regulations to ensure that the technology will comply in all relevant markets. The recruitment department may see this work and as a result review personnel files and resumes to locate employees and applicants that may be useful to the development effort.

As depicted in FIG. 154, an enterprise 106 may be a polling firm. The dimensions of a relevant lowest common level of abstraction 622 may be any one or more of number of people polled, hours, number of questions, design hours per question, location and/or achieved results. An enterprise planning method 12000, may link, synchronize, integrate, aggregate and/or align the recruiting department, human resources, logistics and quality control using the lowest common level of abstraction 622 of number polled per location per time. In this manner, the logistics department may wish to implement a new method of conducting surveys. The quality control department may ensure that the surveys and work product resulting from the new method meet enterprise 106 standards. The human resources and recruiting departments may assign relevant employees to the project, or hire additional personnel to assist with the project.

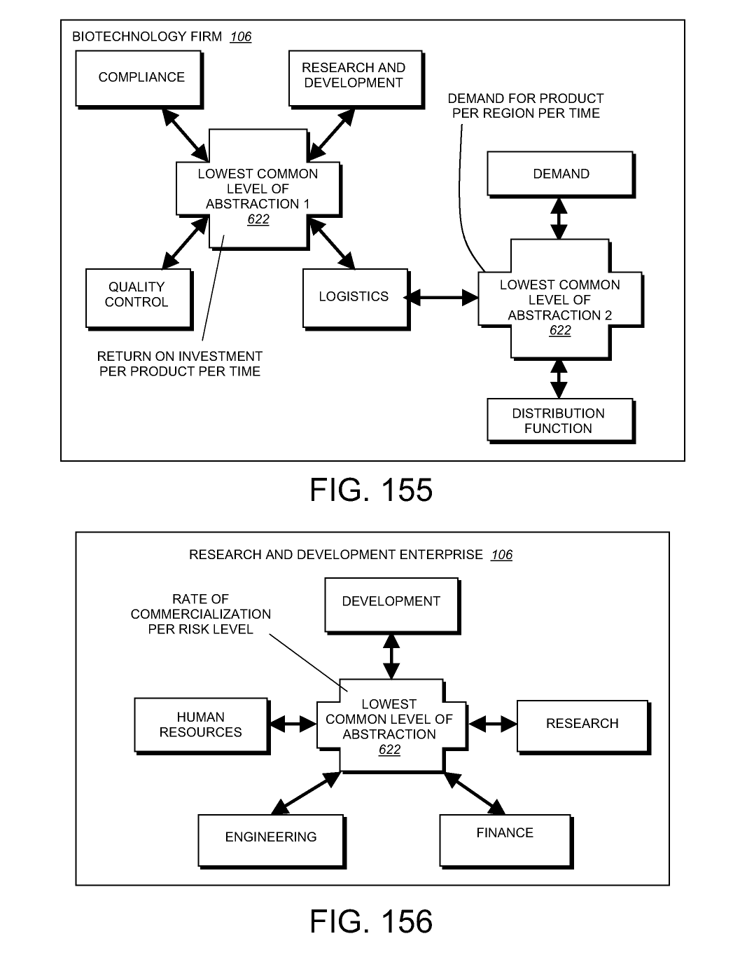

As depicted in FIG. 155, an enterprise 106 may be a biotechnology or pharmaceutical firm. The dimensions of a relevant lowest common level of abstraction 622 may be any one or more of margin, stock keeping unit, return on investment, market share, unit of disease, time, location, occurrence per population and/or saturation. An enterprise planning method 12000, may link, synchronize, integrate, aggregate and/or align compliance, research and development, logistics and quality control using the lowest common level of abstraction 622 of return on investment per product per time. An enterprise planning method 12000, may link, synchronize, integrate, aggregate and/or align the distribution function, demand and logistics using the lowest common level of abstraction 622 of demand for product per region per time. In this manner, the distribution function, demand, logistics, compliance, research and development and quality control may be linked, synchronized, integrated, aggregated and/or aligned.

As depicted in FIG. 156, an enterprise 106 may be a research and development enterprise. The dimensions of a relevant lowest common level of abstraction 622 may be any one or more of return on investment, rate of commercialization, geographic classification, time series, risk to return ratios and/or risk. An enterprise planning method 12000, may link, synchronize, integrate, aggregate and/or align finance, engineering, human resources, development and research using the lowest common level of abstraction 622 of rate of commercialization per risk level.

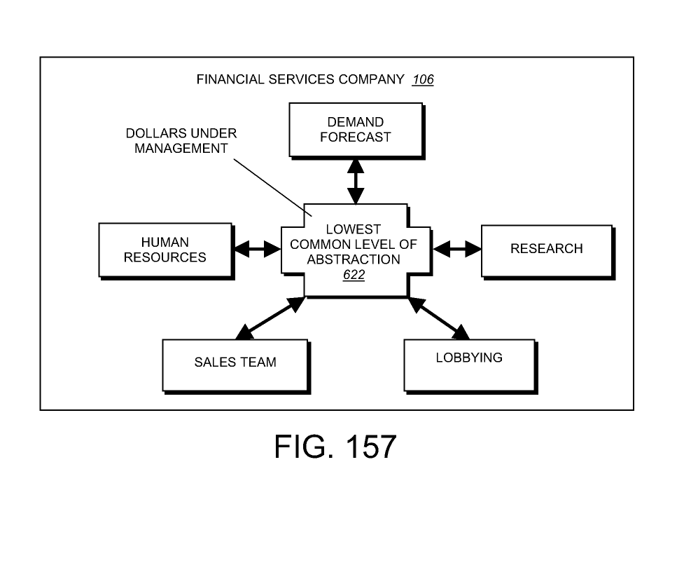

As depicted in FIG. 157, an enterprise 106 may be a financial services company. The dimensions of a relevant lowest common level of abstraction 622 may be any one or more of units sold, dollars under management, customer satisfaction, volume, time, region and/or return. An enterprise planning method 12000, may link, synchronize, integrate, aggregate and/or align the demand forecast, human resources, sales team, lobbying and research using the lowest common level of abstraction 622 of dollars under management.

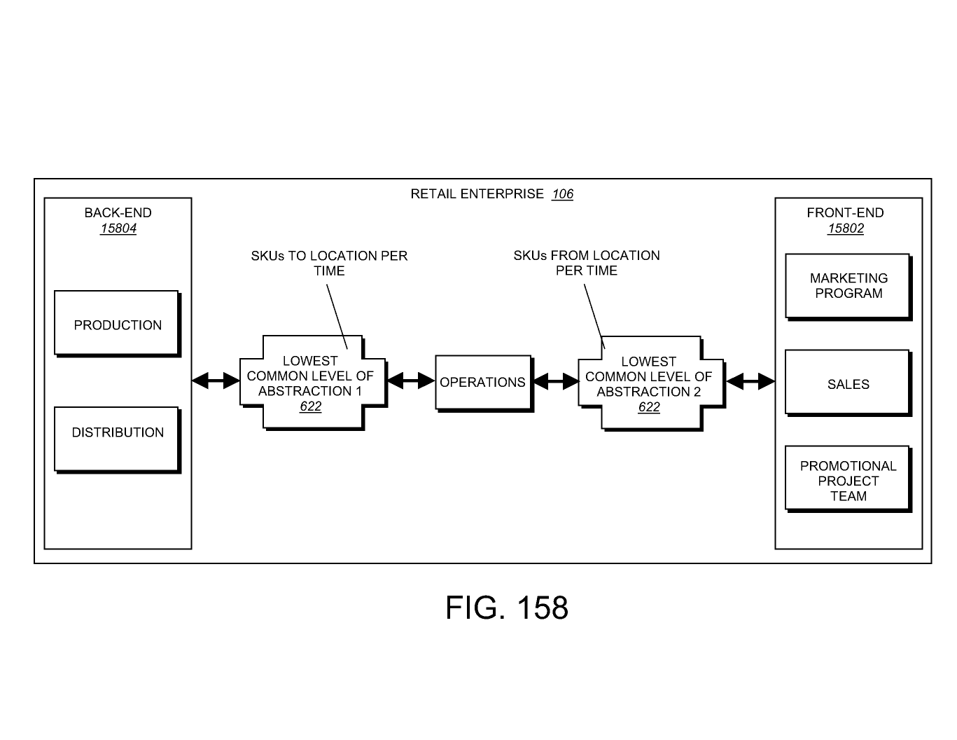

As depicted in FIG. 158, an enterprise 106 may be a retail enterprise. The dimensions of a relevant lowest common level of abstraction 622 may be any one or more of stock keeping units, pallets, lots, truck-loads, margin, shelf-space, weeks, store location, plant location, distribution facility location and/or display size. An enterprise planning method 12000, may link, synchronize, integrate, aggregate and/or align operations with the front-end of an enterprise 15802, including the marketing program, sales and the promotional project team, using the lowest common level of abstraction 622 of stock keeping units coming from a location per unit of time. An enterprise planning method 12000, may link, synchronize, integrate, aggregate and/or align operations with the back-end of an enterprise 15804, including the production and distribution using the lowest common level of abstraction 622 of stock keeping units going to a location per unit of time. In this manner, the retail enterprise 106 may control its supply chain from creation of a product through to sale to an end user.

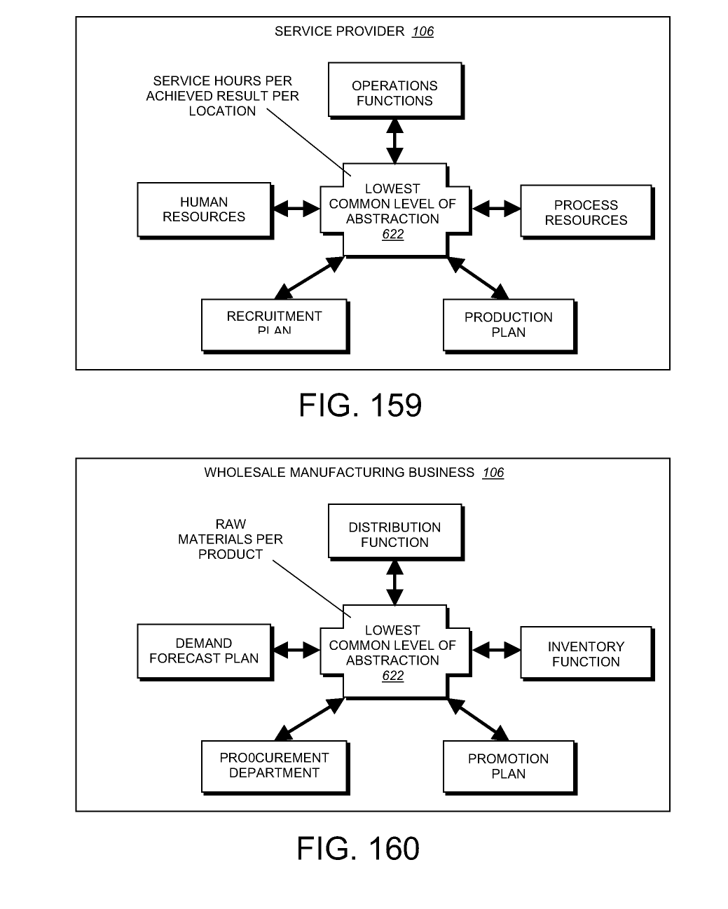

As depicted in FIG. 159, an enterprise 106 may be a service provider. The dimensions of a relevant lowest common level of abstraction 622 may be any one or more of service hours provided at a certain location, workers, hours, network bandwidth and/or achieved results. An enterprise planning method 12000, may link, synchronize, integrate, aggregate and/or align the promotion plan, the recruitment plan, human resources, the operations function and finance processes using the lowest common level of abstraction 622 of service hours per achieved result per location. For example, the service provider may be a telephone company running a long distance plan promotion. An enterprise planning method 12000 may allow the company to ensure that its network bandwidth is sufficient to meet demand and that it staffs enough customer service representatives to respond to customer queries and complaints.

As depicted in FIG. 160, an enterprise 106 may be a wholesale manufacturing enterprise. The dimensions of a relevant lowest common level of abstraction 622 may be any one or more of components of the product produced, parts, bill of materials, raw materials and/or sub-assemblies. An enterprise planning method 12000, may link, synchronize, integrate, aggregate and/or align the distribution function, inventory function, promotion plan, procurement department and demand forecast plan using the lowest common level of abstraction 622 of raw materials per product.

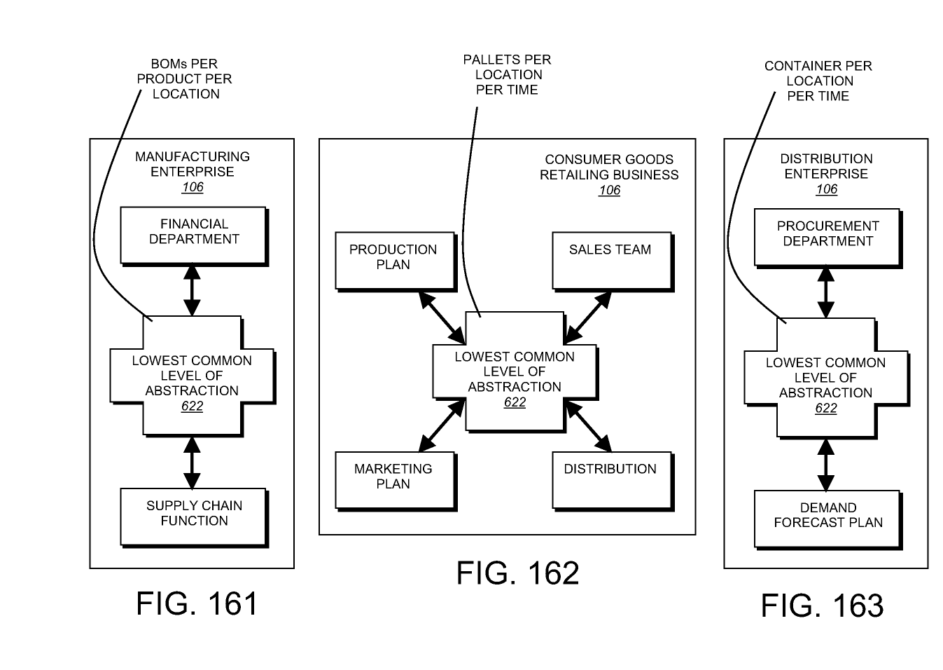

As depicted in FIG. 161, an enterprise 106 may be a manufacturing enterprise. The dimensions of a relevant lowest common level of abstraction 622 may be any one or more of bill of materials, unit of raw material, location of production, date of production and/or lots produced. An enterprise planning method 12000, may link, synchronize, integrate, aggregate and/or align the finance department and supply chain function using the lowest common level of abstraction 622 of bills of materials per product per location.

As depicted in FIG. 162, an enterprise 106 may be a consumer goods retailing business. The dimensions of a relevant lowest common level of abstraction 622 may be any one or more of pallets, bulk lots, stock keeping units, source, time available, transportation time and/or location of demand. An enterprise planning method 12000, may link, synchronize, integrate, aggregate and/or align distribution, the production plan, marketing plan and sales team using the lowest common level of abstraction 622 of pallets per location per time. In this manner, an enterprise planning method 12000 may enable the coordination of production and distribution with marketing and sales, to ensure that supply is adequate to meet the demand.

As depicted in FIG. 163, an enterprise 106 may be a distribution enterprise. The dimensions of a relevant lowest common level of abstraction 622 may be any one or more of stock keeping units, intermodal containers, pallets, transportation time, source location, destination location and/or lead-time. An enterprise planning method 12000, may link, synchronize, integrate, aggregate and/or align the procurement department and demand forecast plan using the lowest common level of abstraction 622 of container per location per time. In this manner, an enterprise planning method 12000 may assist in the coordination of procurement with demand, to ensure raw materials are not over purchased and that the amount of parts purchased will enable production sufficient to meet demand.

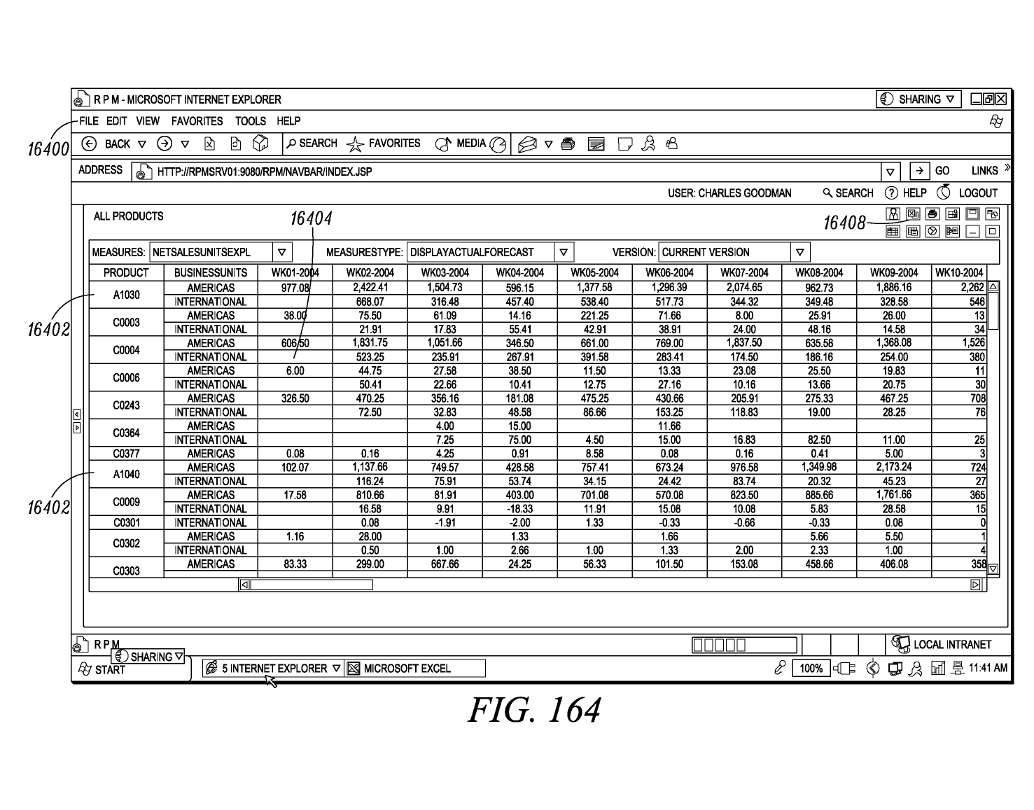

Referring to FIG. 164, in embodiments of the invention a planning function or decision process 300 of an enterprise 106 can be aided by providing one or more decision makers 104 with a software application, such as a desktop software application, that includes a graphical user interface, or GUI 16400. The software applications can connect, such as by a network through one or more servers, to one or more data facilities 108 of the enterprise 106, so that data from the data facilities 108 can be reflected in the GUI 16400 of the software application. In embodiments the software application may be a standalone software application, a web-enabled application, or other form of software application. The GUI 16400 of FIG. 164 shows independent and dependent demand numbers for an analyst for a range of products. A table 16404 includes rows and columns. The rows correspond to product categories and particular products. The columns correspond to weeks of the year. The cells correspond to independent or dependent demand data for the product in the corresponding row for the week of the particular column. Past date columns represent actual purchases made during past weeks, such as populated from a database of past purchases stored in a data facility 108 of the enterprise 106. Columns with future dates represent forecast data going out into the future for every product family and product sub-family. The forecasts can be those manually entered by analysts, or they may be generated by various methods, such as forecasting tools associated with the software application or separate forecasting tools. In embodiments the GUI may be populated with data that represents decisions 102, or proposed decisions, of other decision makers 104 in the enterprise, such as other forecasts and the like. Thus, the GUI 16400 can serve as a mechanism for supporting linked decision processes as described in connection with FIG. 11 and other figures herein. In the GUI 16400, the user can click on a cell to adjust the forecast for a future cell. The user can also use various navigation buttons 16408, such as to save a decision, save a version of a decision, open a file, open a forecasting tool, initiate a collaboration with another user or the like. It should be noted that the software application may not need to be custom coded for each enterprise or type of enterprise. The software application may be built around certain themes or scenario and/or work flows which make it possible to apply the software to many problems with little or no modification. Screens or sections of the GUI may correspond to the main steps or sub-steps of the scenario and/or work flows.

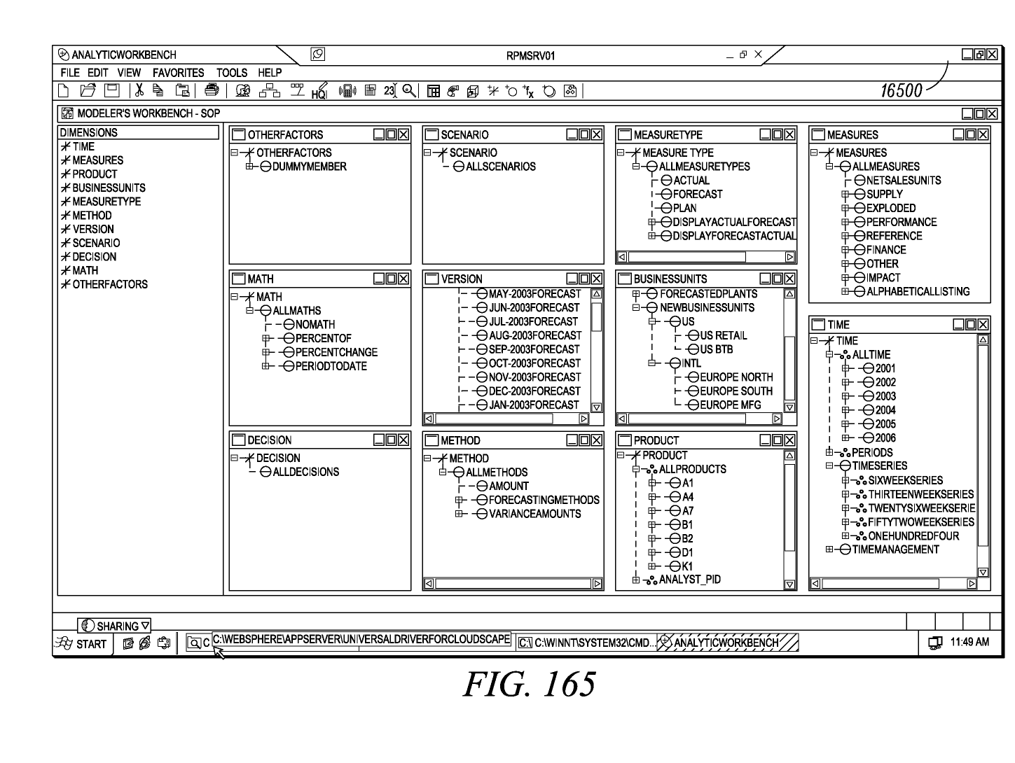

Referring to FIG. 165, an analyst can be provided with a workbench 16500 that includes various tools for aiding decision-making. The tools include a range of hierarchies that are relevant to an enterprise 106, such as hierarchies of measures, metrics, scenarios, mathematical tools, utilities for saving versions, business units, time, products, methods, decisions and the like. The workbench 16500 allows an analyst to view various hierarchies of data for the enterprise 106, such as to help the analyst identify data relevant to decisions to be made by the enterprise and to make decisions based on the data.

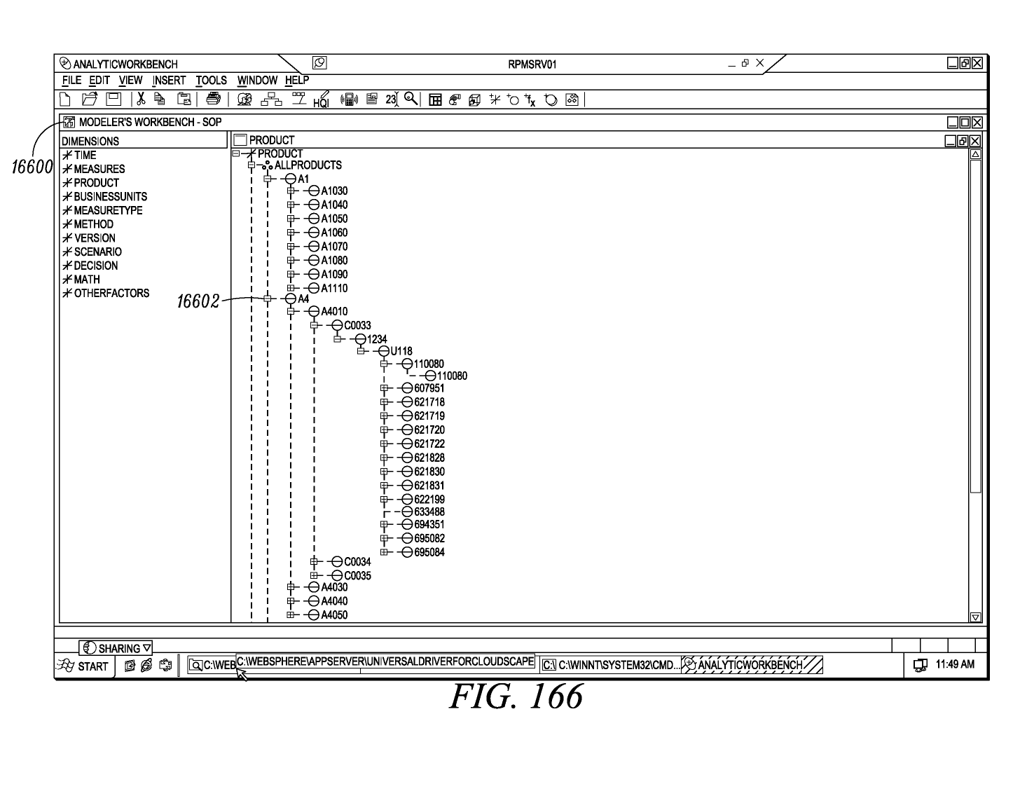

Referring to FIG. 166, a GUI 16600 may assist a modeler in modeling relationships among enterprise hierarchies, such as the product hierarchy 16602, such as to assist in logically linking business processes, such as by linking data associated with different hierarchies to different GUIs for different business processes. The GUI 16600 may allow an analyst to view and manipulate various types of hierarchies, such as those related to time, products, business units, products, measure types, measures, methods, versions, scenarios, decisions, mathematical tools and other hierarchies.

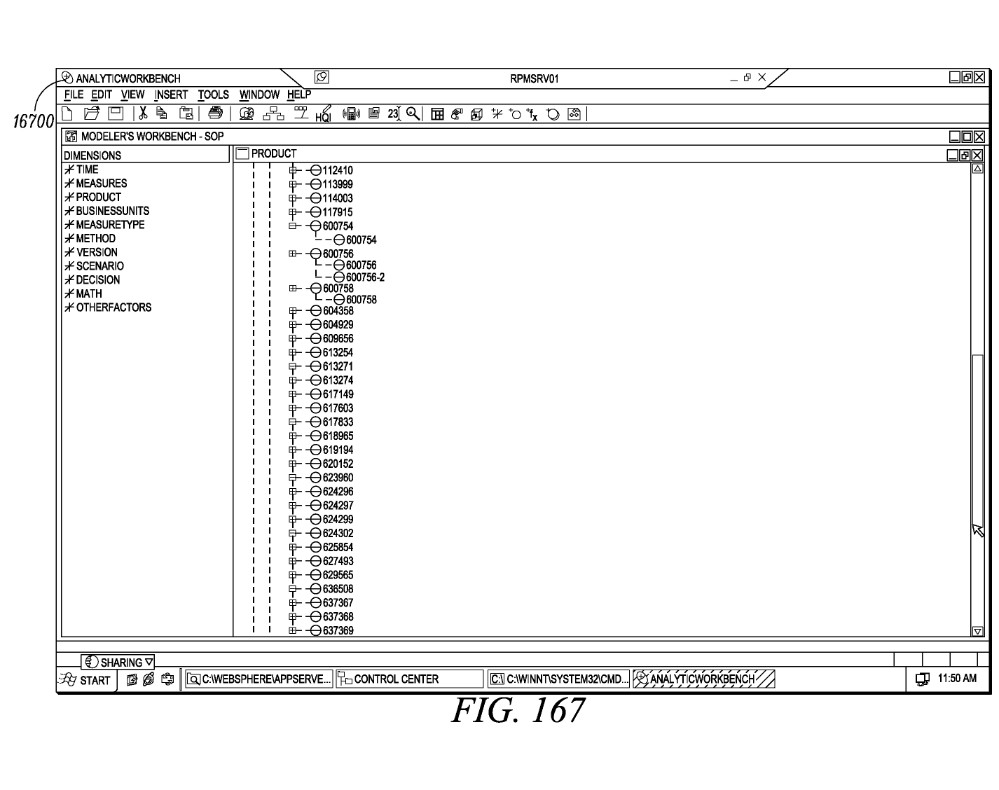

Referring to FIG. 167, a GUI 16700 may display hierarchies of products. A given product may appear in different hierarchies, such as if the product is sold in different regions, or if the product is sold on a standalone basis as well as in a kit with another products.

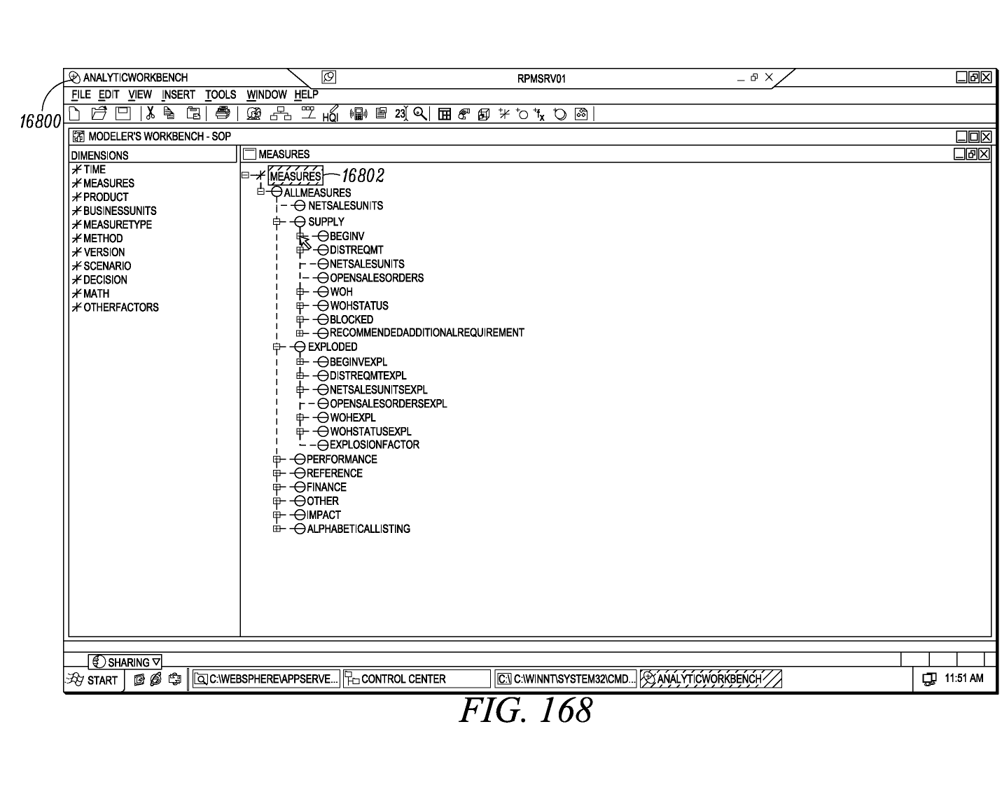

Referring to FIG. 168, a GUI 16800 may display a hierarchy of measures 16802 that are relevant to various decisions 102 of an enterprise 106, such as to assist a modeler in developing models that assist in decision-making. The measures may include summary measures and detailed measures related to sales, supply, inventory, distribution, open orders, blocked time periods, performance, financial measures, reference measures, measures relating to analysis of impacts and others.

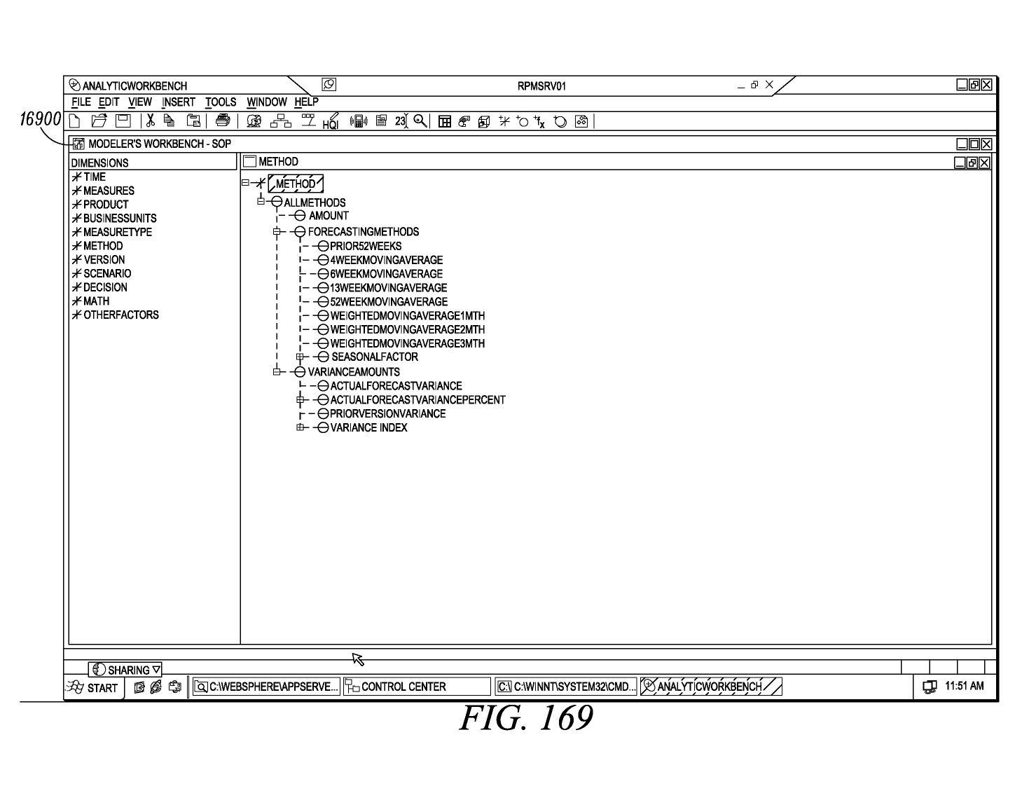

Referring to FIG. 169, a GUI 16900 may display a hierarchy of methods that can be used, such as for forecasting. Forecasting methods may include various moving averages, as well as statistics-based forecasting methods.

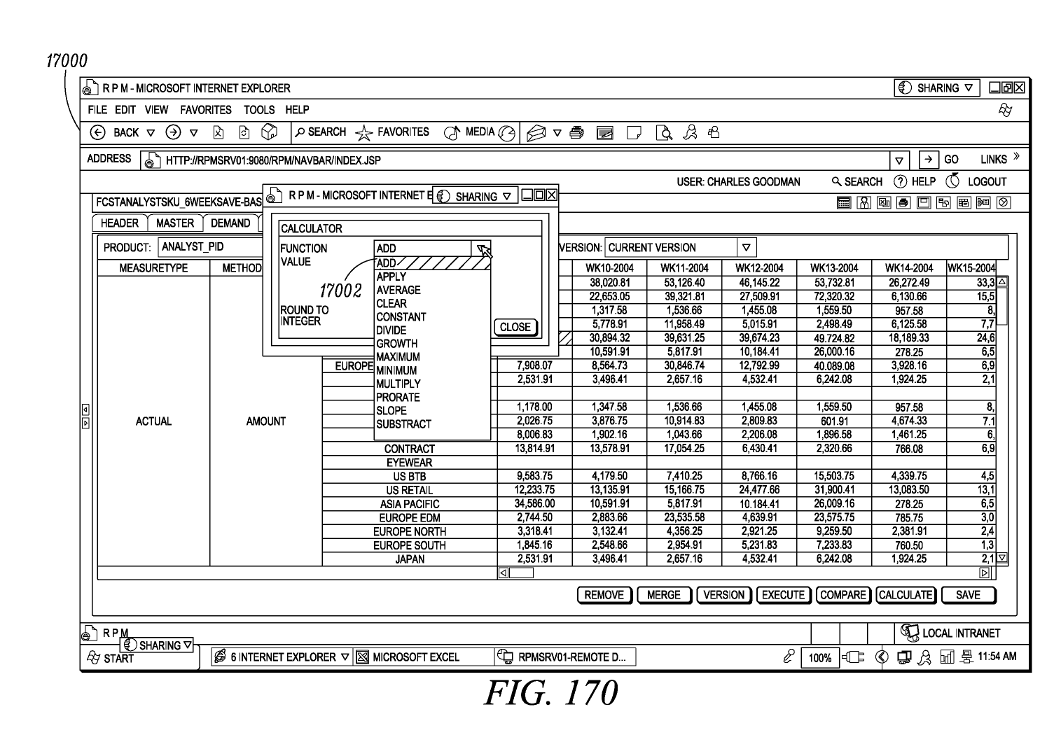

Referring to FIG. 170, a GUI 17000 may display a calculator function 17002 for assisting a user in performing various mathematical calculations, such as to assist in developing forecasts to be entered into cells that represent forecasts. The calculator functions 17002 can help the analyst add, average, divide, multiply, subtract, apply minimums and maximums, apply various growth models, perform weighted-average calculations, prorate, apply slope calculations, apply calculations, clear entries and the like.

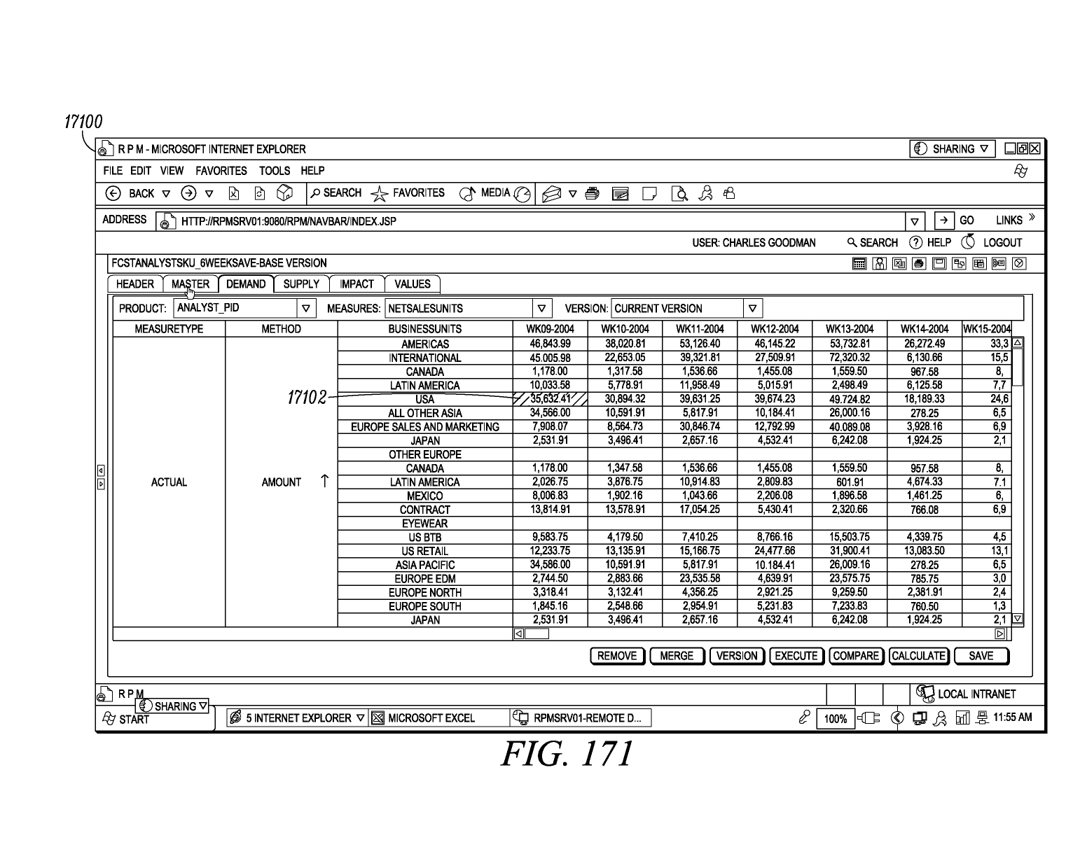

Referring to FIG. 171, a GUI 17100 may display a demand forecast, where the rows represent demand for a product related to different regions. For example, the cell 17102 can be populated with past data related to a particular week for demand associated with the USA. The demand forecast may assist in purchasing decisions, such as described in connection with the purchasing process 1102 of FIG. 11.

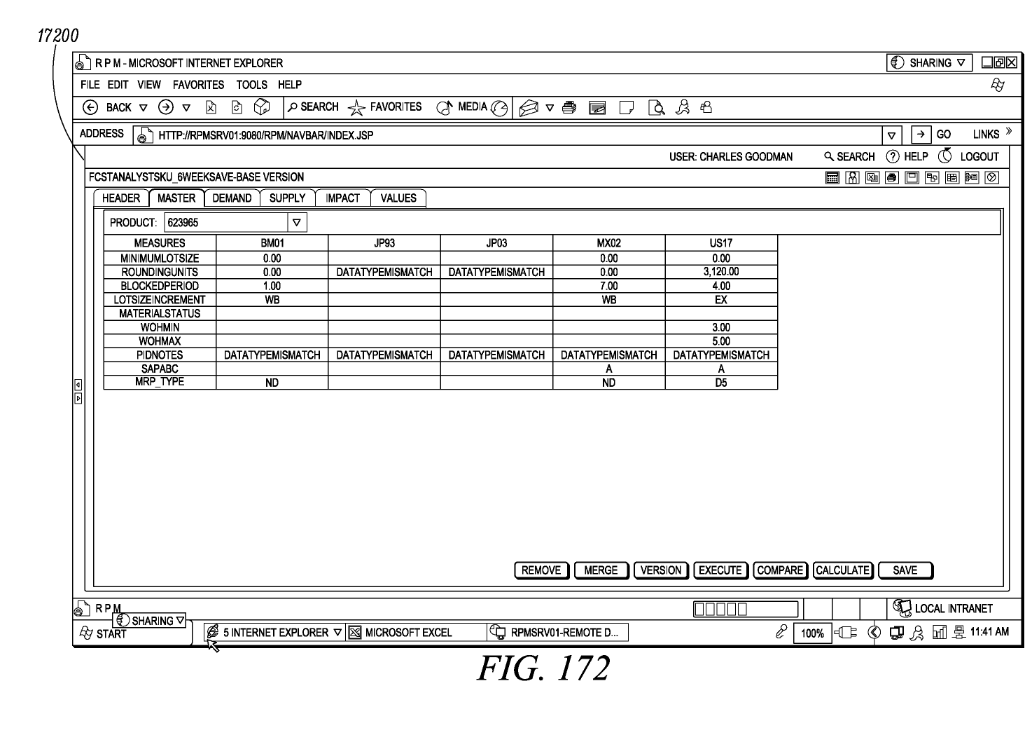

Referring to FIG. 172, a GUI 17200 may display a master set of properties associated with a product, which can characterize the product for purposes of the process embodied in the demand forecast of FIG. 171. Product properties that may be relevant to the forecasting process can include minimum lot sizes, rounding units, blocked periods (such as to allow for the time to build and transport inventory), lot size increments, materials status, notes and various codes that can be used by various relational databases, such as SAP databases.

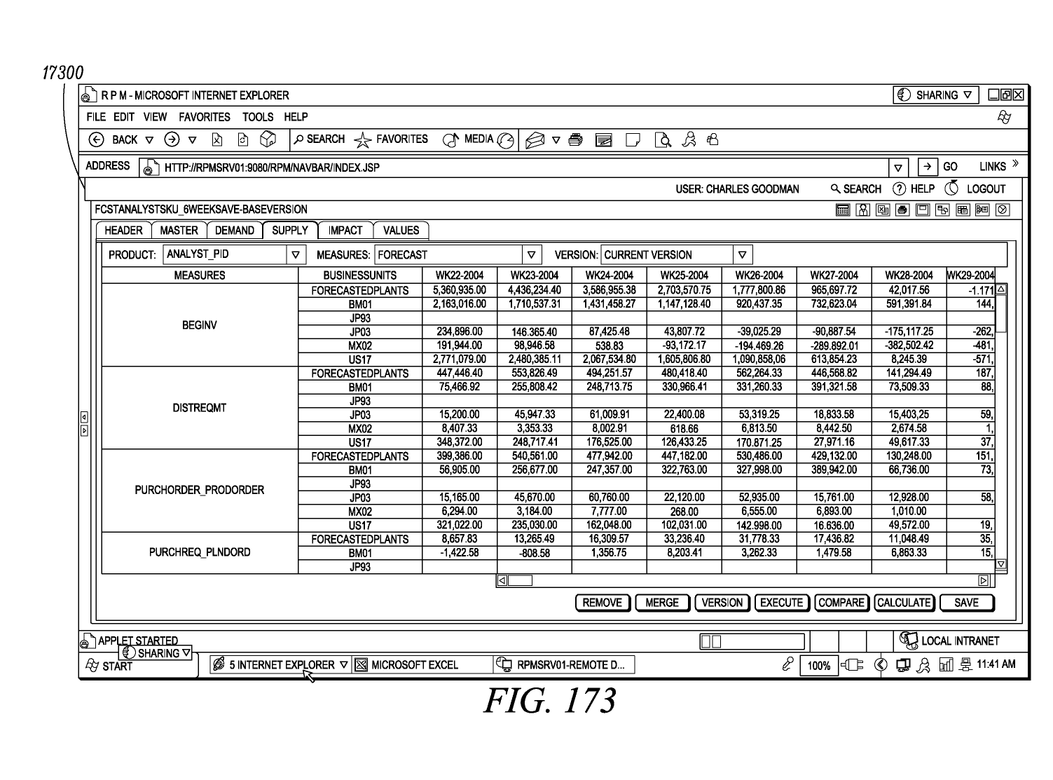

Referring to FIG. 173, a GUI 17300 may display data relating to a supply decision. The GUI 17300 may include a table with rows that correspond to various data that relate to the supply decision, such as the beginning inventory, distribution requirements, purchase orders or the like. Columns can correspond to weeks, with past weeks representing actual data and future weeks relating to forecasts. The cells can correspond to data stored in data facilities 108 of the enterprise 106, such as data that reflect decision objects 202, such as from logically linked decision processes 300 as described in FIG. 11.

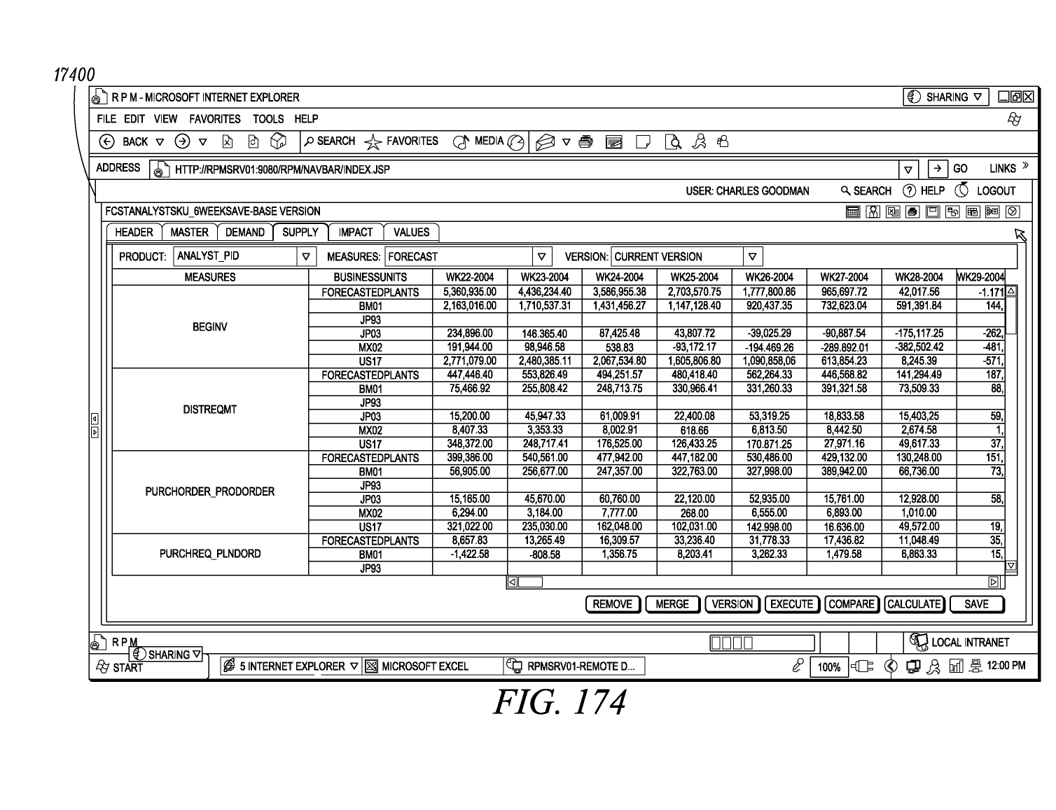

Referring to FIG. 174, the GUI 17400 shows another embodiment of a GUI for assisting with a supply forecast.

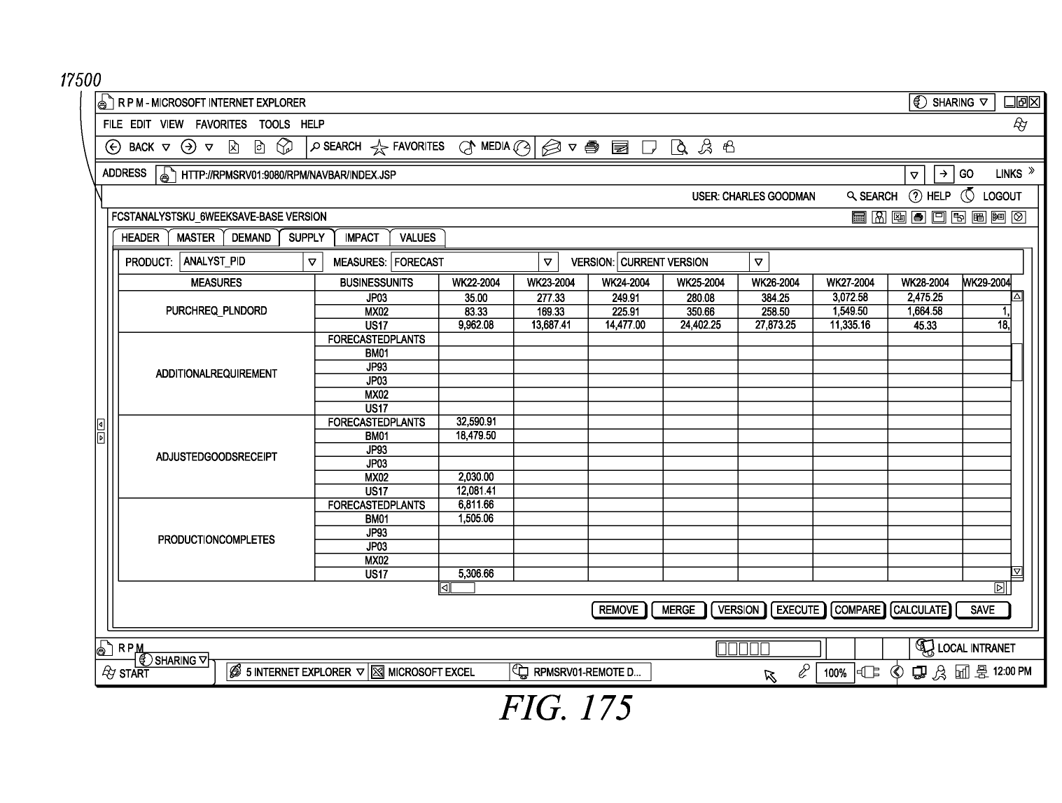

FIG. 175 shows additional details of a GUI for assisting with a supply forecast, where additional rows relate to additional requirements, adjusted goods received, completed production data and the like.

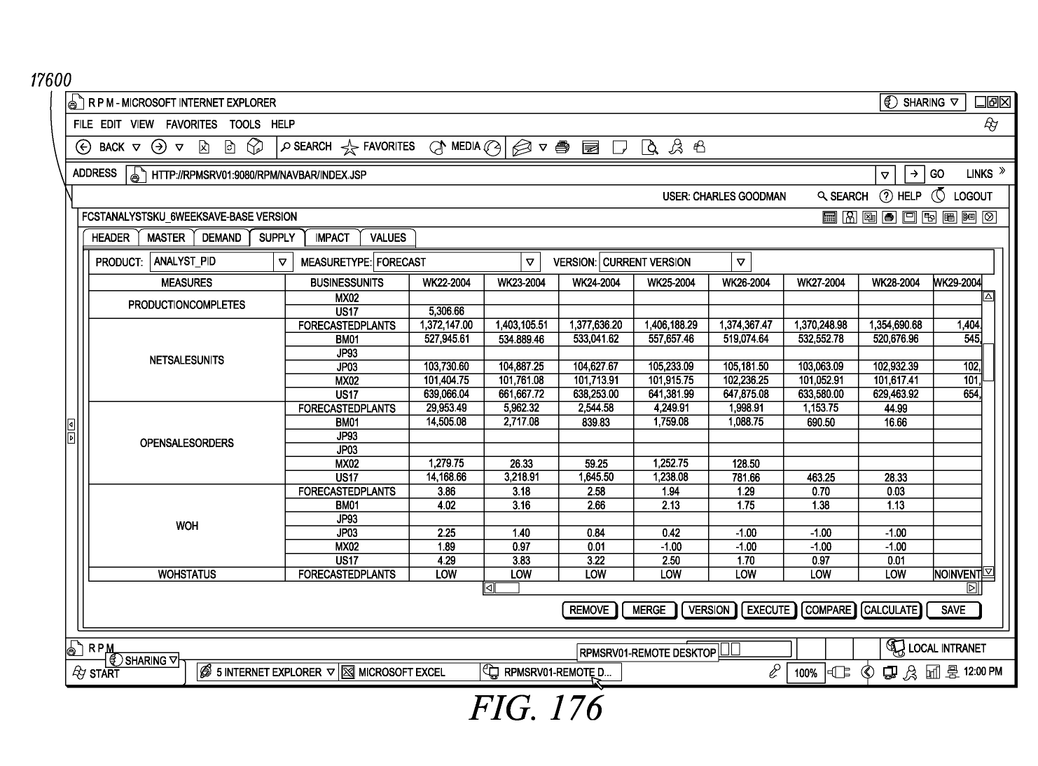

Referring to FIG. 176, the GUI 17600 shows additional details of a GUI 17600 for assisting with a supply forecast, where rows relate to data for net sales units, open sales orders and other features.

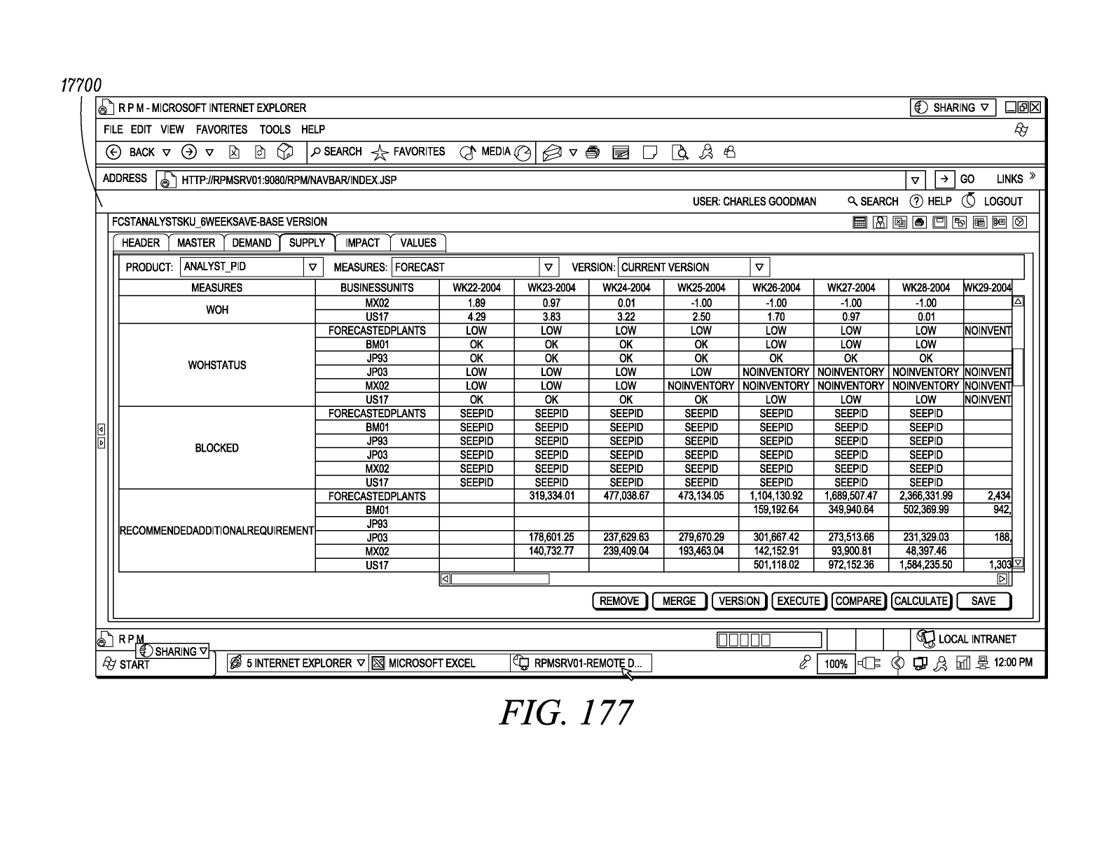

Referring to FIG. 177, the GUI 17700 shows additional details of a GUI 17700 for assisting with a supply forecast, where rows relate to data for order status, blocked orders, recommended additional requirements and other data.

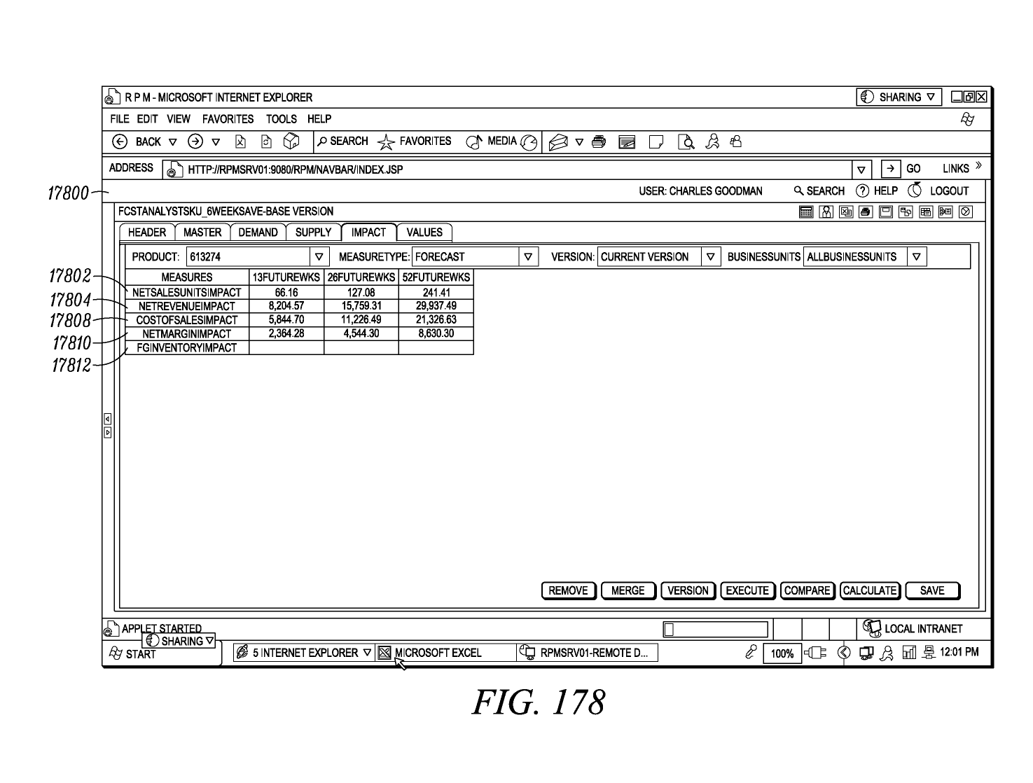

Referring to FIG. 178, in embodiments the software application may include a GUI 17800 for showing the impact of various decisions, such as those made in the demand and supply forecasting GUIs described above. Using the same data that populates the cells that appear in the supply and demand GUIs, along with appropriate formulas, the GUI can display impacts on net sales 17802, net revenues 17804, cost of sales 17808, net margins 17810 and inventory 17812. Thus, these metrics for the product line can reflect actual data or forecast data for a product line. Because these same metrics are used with respect to measurement of an entire enterprise 106, it can be seen that the methods and systems described throughout this disclosure enable better enterprise planning, because high-level strategic plans can be rolled up (such as by aggregating data for various product lines) from the actual data that is used for forecasting and decision-making, including decision-making among linked decision processes as described in connection with FIG. 11.

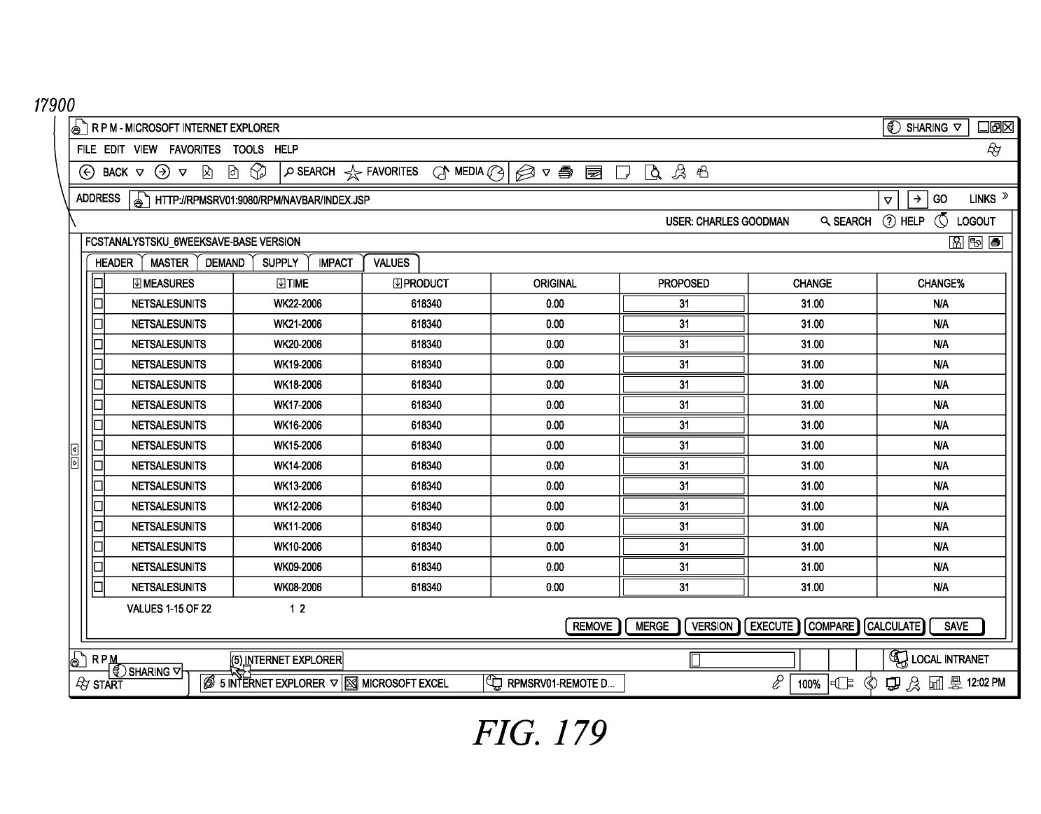

Referring to FIG. 179, a GUI 17900 can allow a user to see and optionally populate or manipulate the specific data for specific cells that appear in the properties GUI, the supply forecast GUI, the demand forecast GUI and the impact GUI.

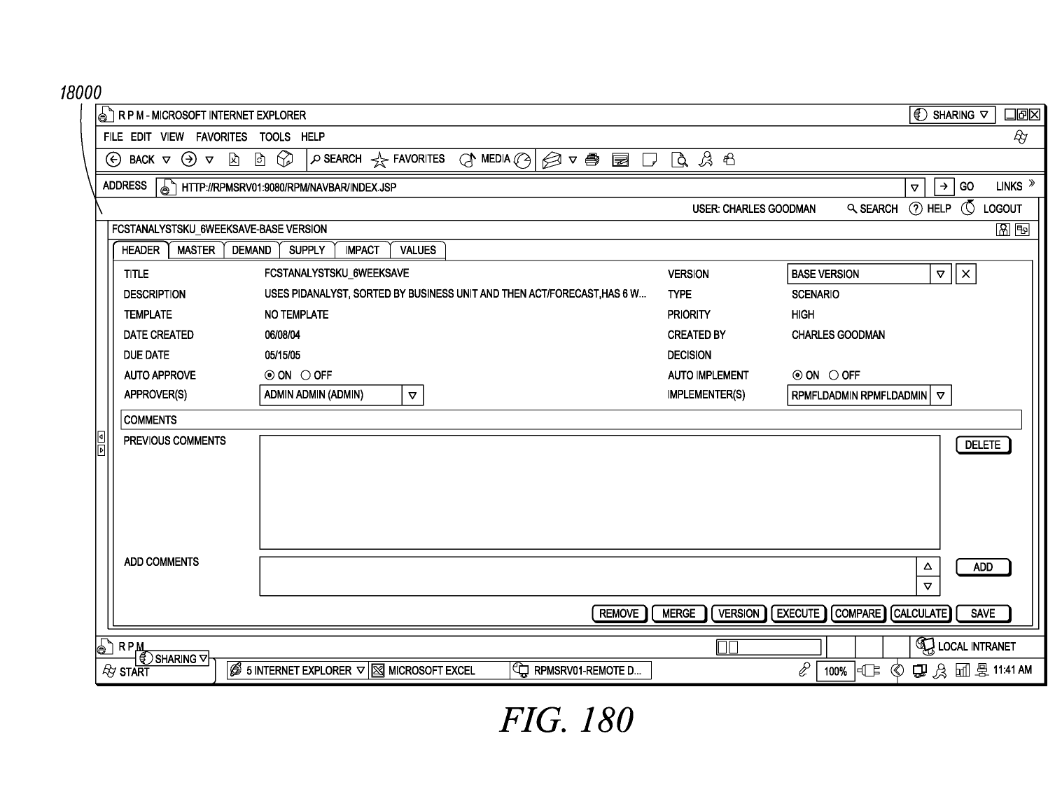

Referring to FIG. 180, a GUI 18000 may include a header tab that provides identification and property information for the planning scenario that appears in the supply forecast GUI, demand forecast GUI and impact GUI. The header tab may indicate who created a scenario, when it was last saved, the name of the scenario, whether the scenario is subject to approval, whether decisions made in the scenario are implemented automatically or require separate action, the version of the scenario, an indication of priority and other data that characterizes the planning scenario reflected in the GUIs.

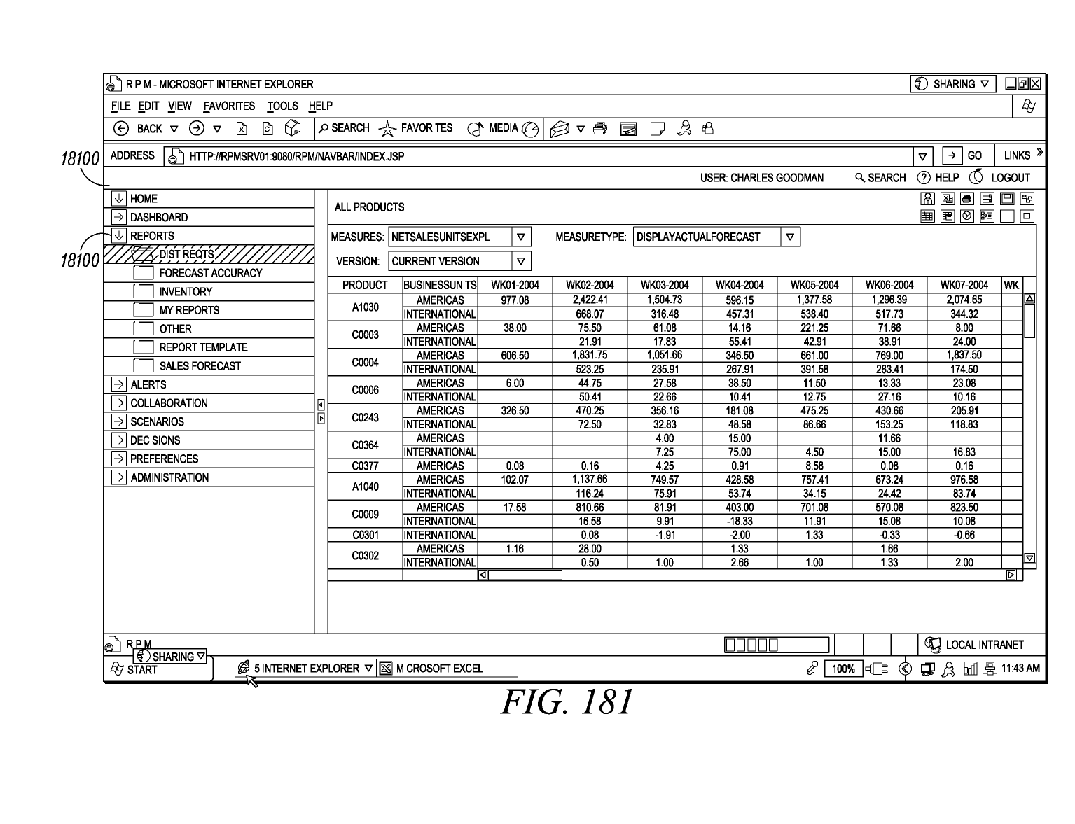

Referring to FIG. 181, a GUI 18100 can include a navigation menu 18102 that allows a user 2608 to select various reports the user 2608 would like to see, such as reports that relate to a planning scenario, such as planning the purchasing of products. The reports can include distribution requirements, reports on the accuracy of forecasts, reports on inventory, customized reports, template reports, and sales forecast reports, among other possible reports. A distribution requirements report can show the forecasted distribution requirements for various weeks in the future.

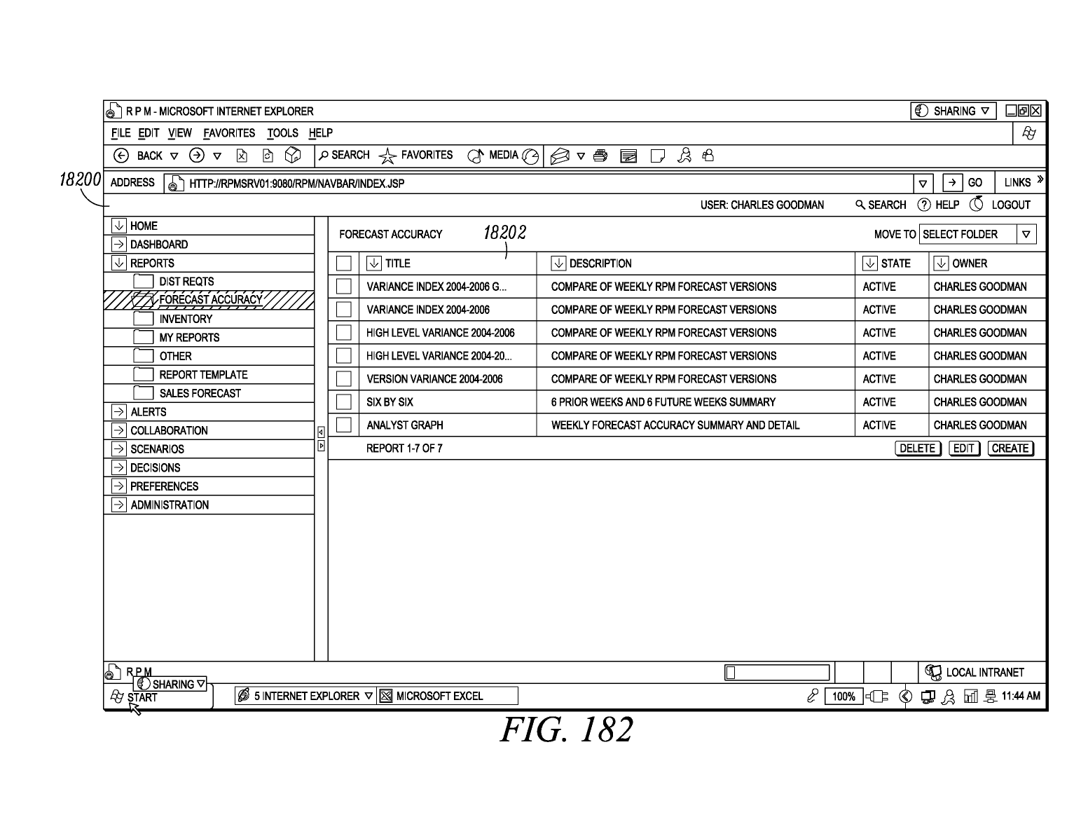

Referring to FIG. 182, a GUI 18200 can show various reports 18202 on forecast accuracy. The forecast accuracy report can show the variance between forecast data (such as was stored in decision objects 202) and actual data for various time periods and types of forecasts.

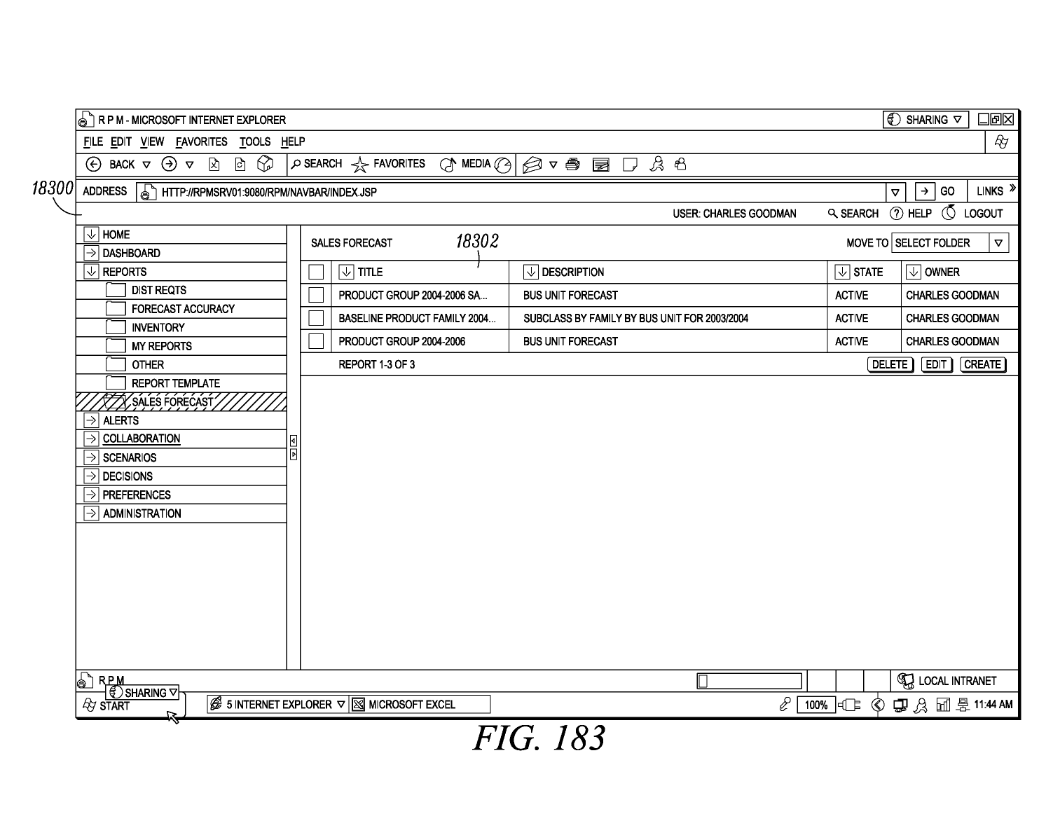

Referring to FIG. 183, a GUI 18300 can show various reports 18302 on sales forecasts, such as reports on forecast sales for particular products, product families and regions.

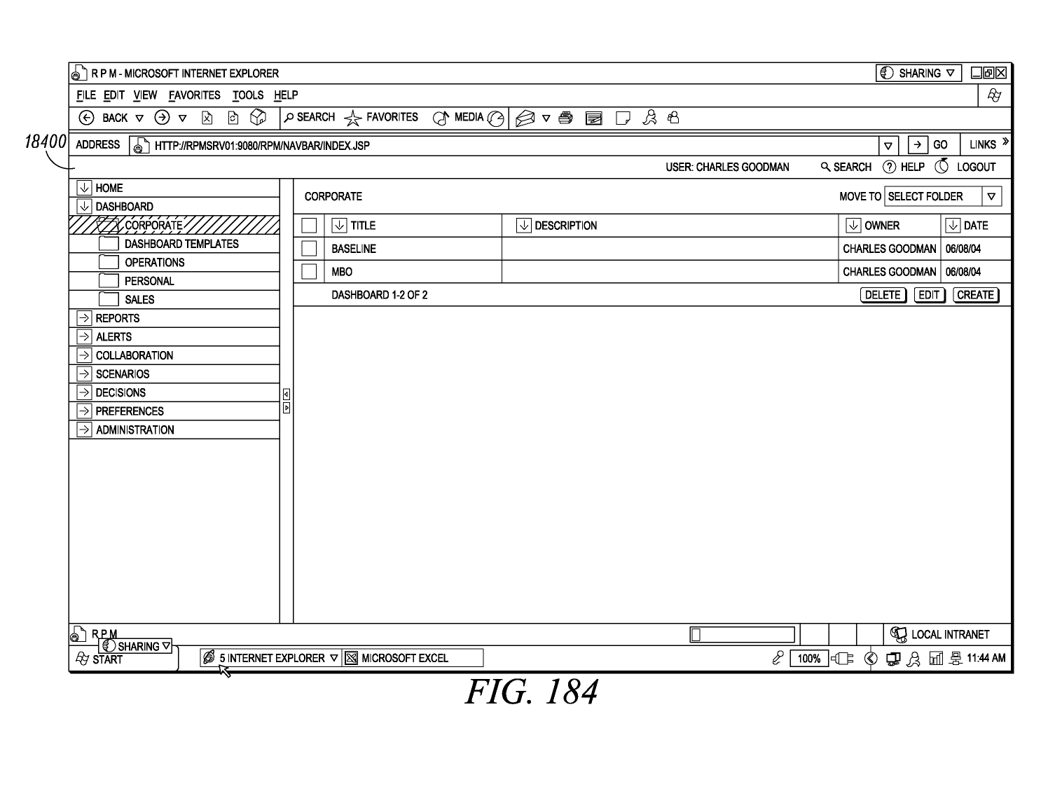

Referring to FIG. 184, a GUI 18400 can include a dashboard function, such as to present MBOs, business objectives, management objectives and other metrics, such as to show the impact of a given decision or proposed decision on those objectives.

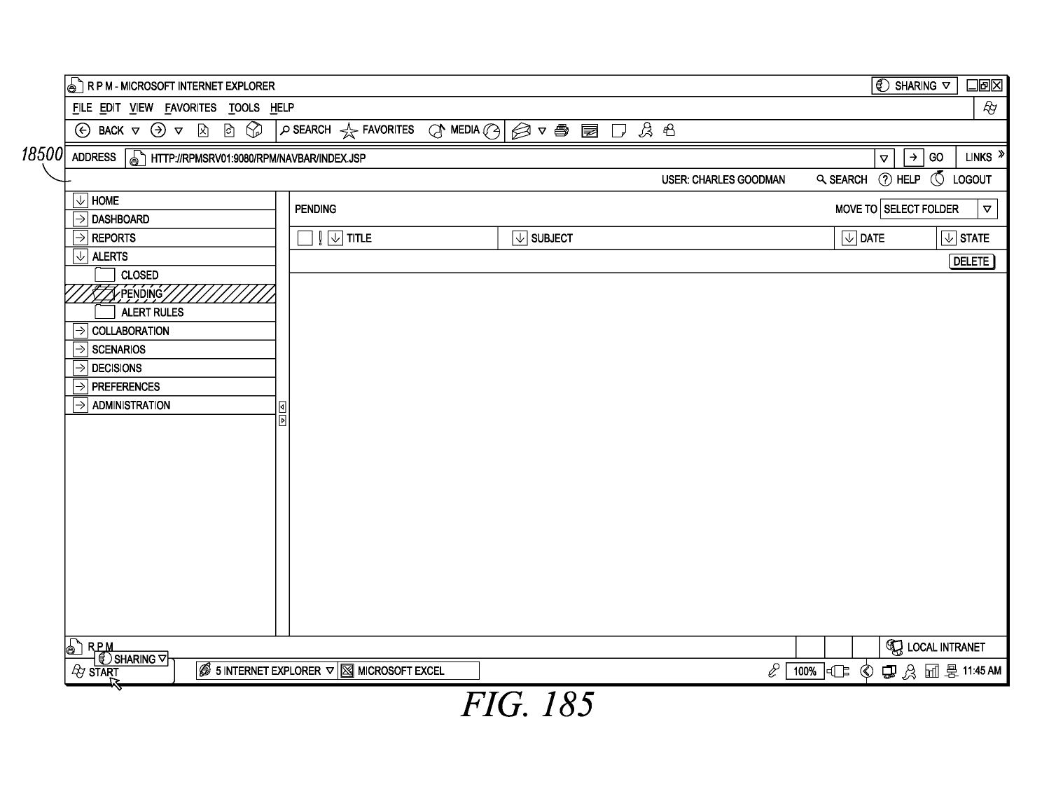

Referring to FIG. 185, a GUI 18500 can show alerts, such as a series of alerts that have been triggered by decisions or proposed decisions that have been entered by users of the forecasting tools, such as the supply and demand forecasting GUIs described above. For example, the GUI 18500 can show an alert if a change in the supply forecast causes the demand forecast to be out of line by more than a certain amount, if a demand plan calls for more items than can be delivered from a given plant or a group of plants by a certain date, if data items, including decision objects, from other parts of the enterprise 106 create conditions that require attention by a user, such as if major corporate objectives have changed, or if initiatives such as promotions have been cancelled, if a user's decisions are out of line with the user's objectives, as indicated by metrics that measure the user's performance, or any other type of alert as described above.

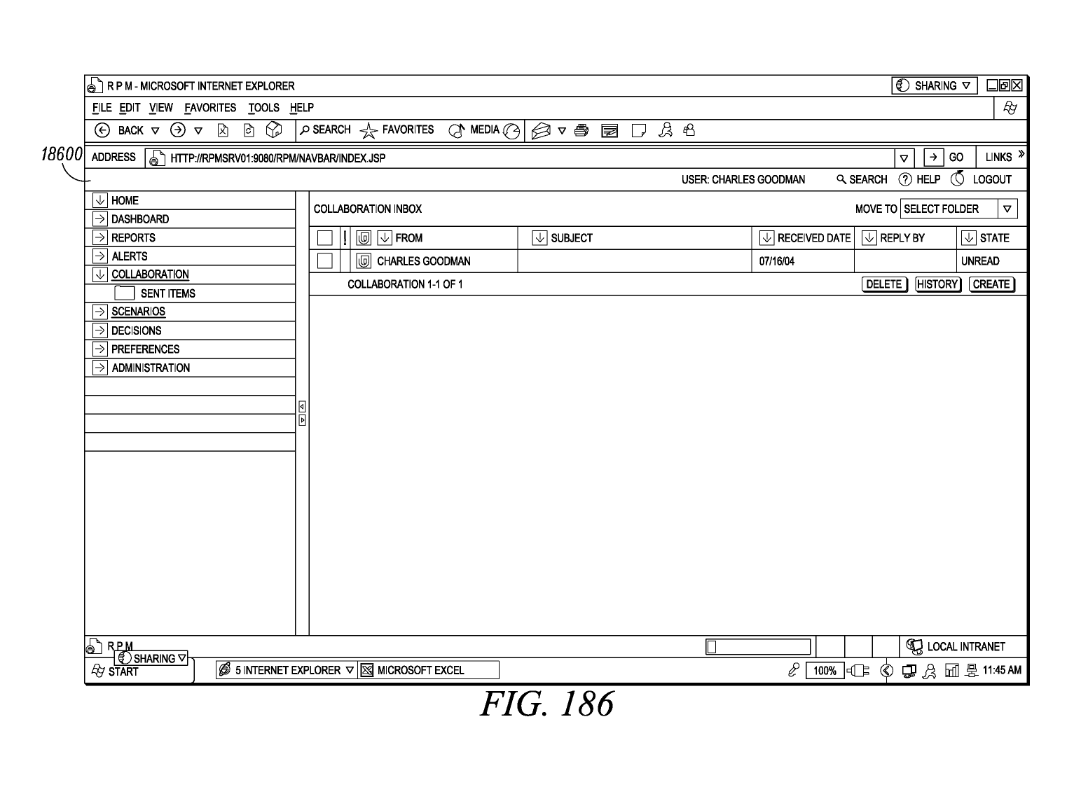

Referring to FIG. 186, a GUI 18600 of a software application can include a GUI for helping a user 2608 collaborate with other users 2608 or decision makers 104 of an enterprise 106. The GUI 18600 can allow a user 2608 to invite collaboration on a decision 102, such as by having a meeting, exchanging email, having a telephone conference, having a networked meeting, having a video conference, sharing a document in a shared space or iterating a pair or set of linked decision processes 300 through a series of proposed decisions to reach equilibrium. These and any other known collaboration tools can be used to assist decision-making in connection with decision objects 202 and logically linked decision processes 300.

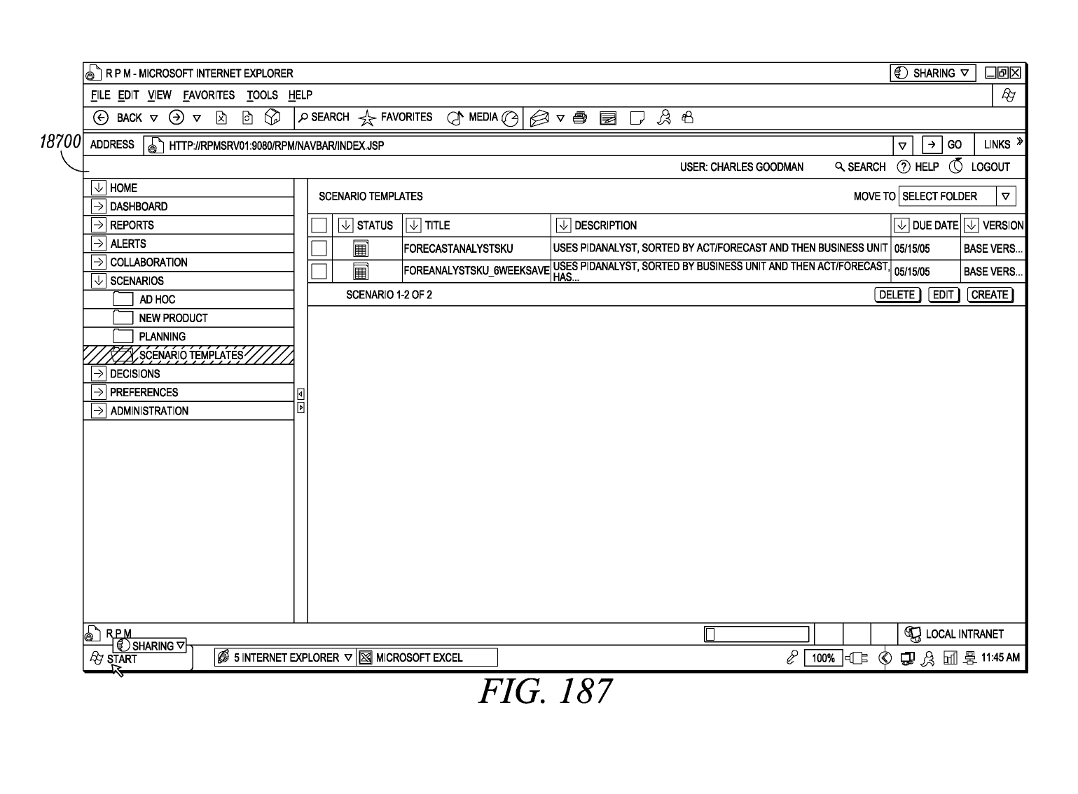

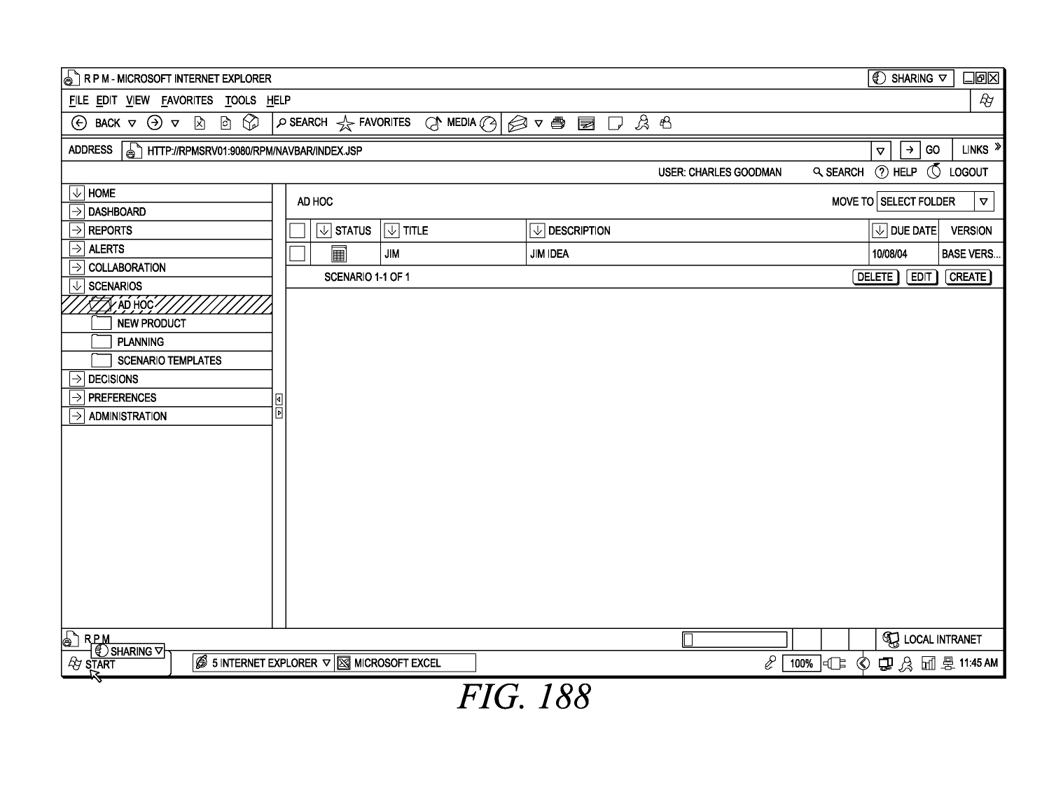

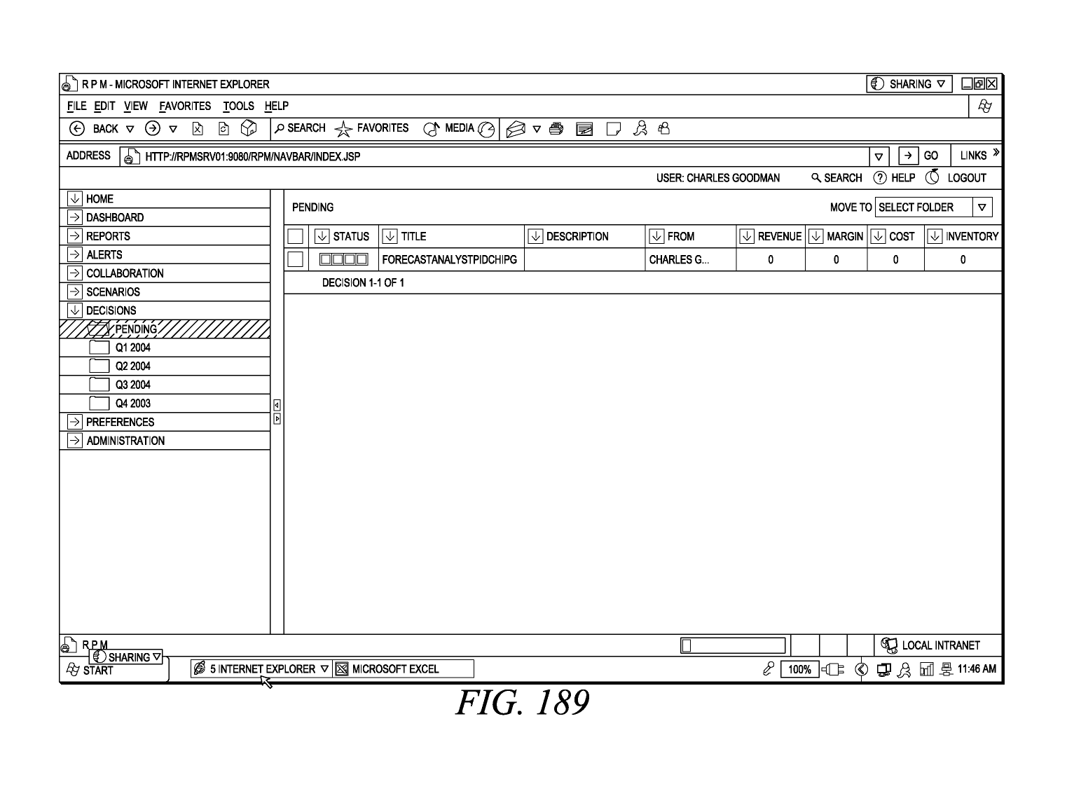

Referring to FIG. 187, a GUI 18700 can offer various planning and decision scenarios to a user 2608, such as an analyst. For example, scenarios can take a user 2608 through a series of steps in a decision process 300, with screens associated with each of the decision steps, such as in a decision wizard or similar functionality. For example, a user 2608 can make a demand or supply forecast for a SKU, with different scenarios showing different aspects of the scenario. For example, a forecast might show demand for a SKU sorted first by account and then by business unit, while another scenario might sort first by business unit and then by account. A wide range of planning scenarios, as described in the embodiments of this disclosure, can be allowed in scenario GUIs 18700.

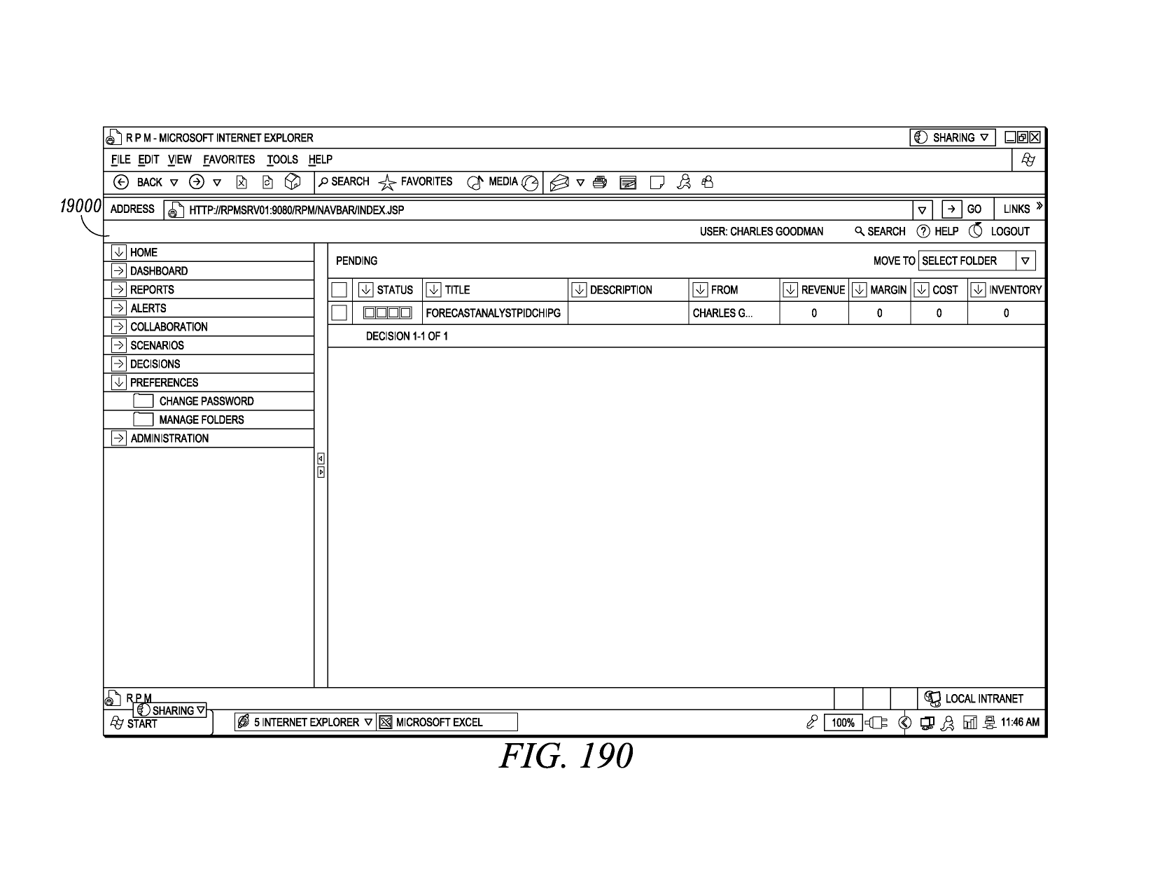

Referring to FIG. 190, a GUI 19000 may offer the user 2608 the ability to indicate preferences, such as relating to various aspects of the planning process.

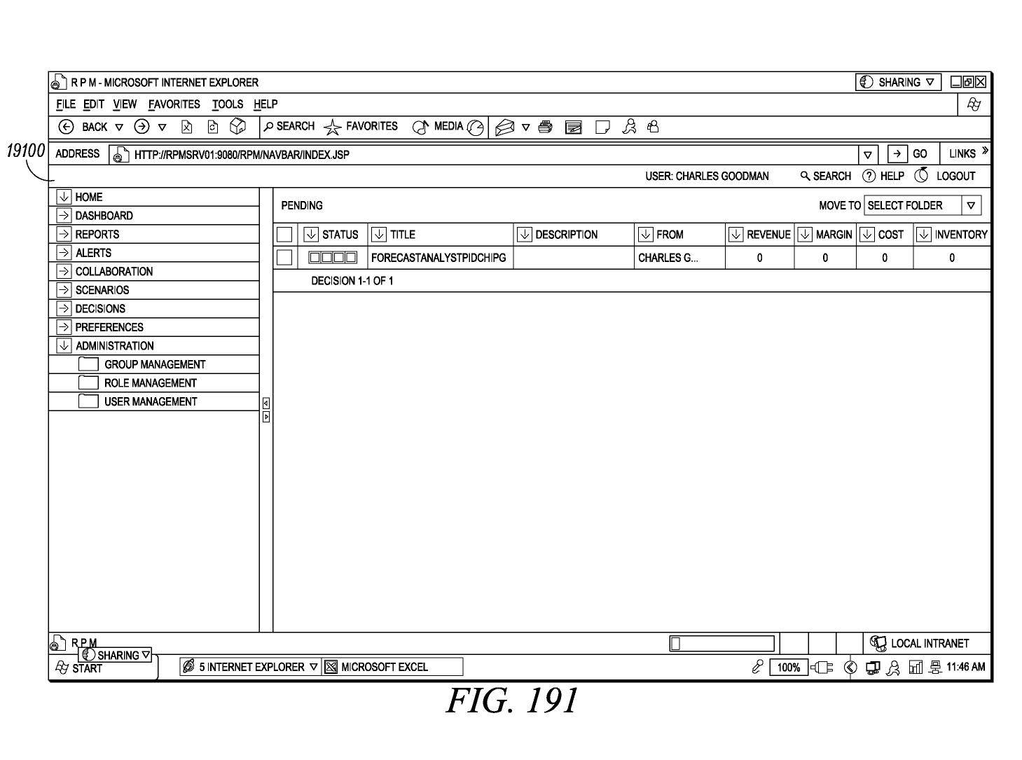

Referring to FIG. 191, a GUI 19100 can offer the user the ability to manage various administration functions.

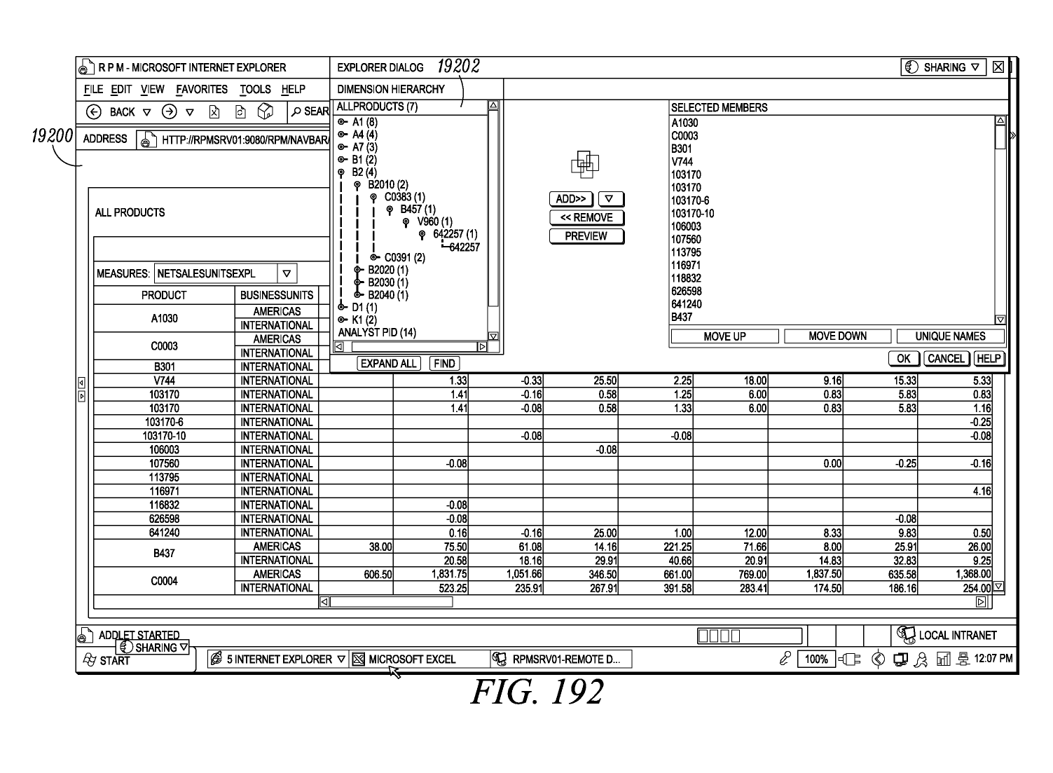

Referring to FIG. 192, a GUI 19200 can display and allow a user 2608 to manipulate a dimension hierarchy 19202, such as a hierarchy of the dimensions of a product hierarchy, such as dividing products by groups, subgroups and the like.

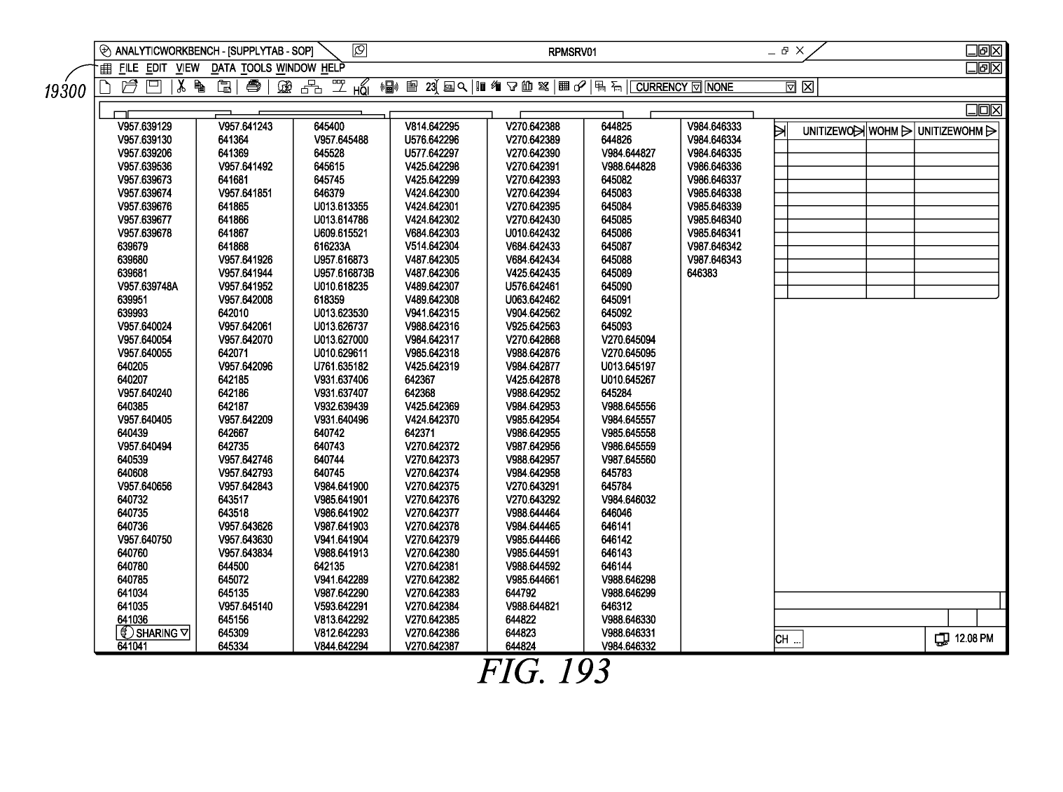

Referring to FIG. 193, a GUI 19300 can list all of the different elements or attributes that can be used to build a hierarchy, such as any enterprise hierarchy as described above.

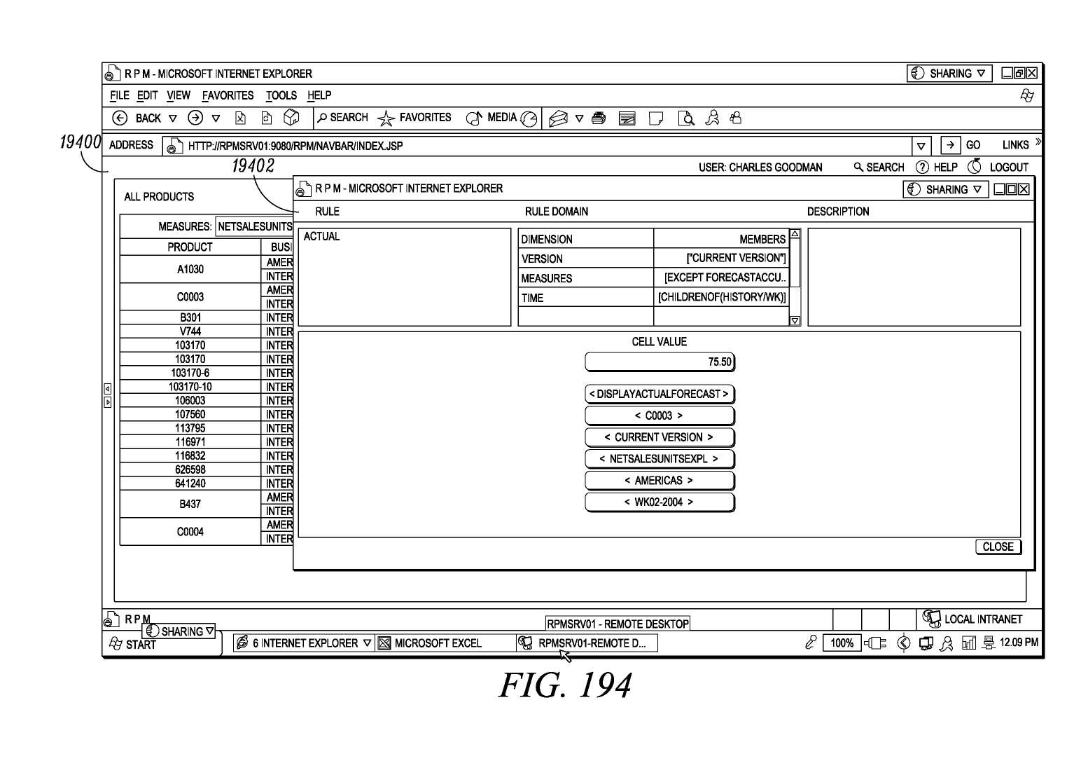

Referring to FIG. 194, a GUI 19400 can show a display 19402 that displays the rule that governs the behavior of a cell in one of the other GUIs, such as the forecasting tools. Clicking on the cell, right clicking on the cell, or the like can show the rule. The rule can show where the cell draws data, the linking of the data to other data of the enterprise 106, the linking of the cell to decision objects 202 for decisions made by other decision makers 104, such as in connection with logically linked decisions as described in FIG. 11, mathematical rules used to generate the cell, aggregation rules, such as to relate independent and dependent demand for a product, rules used to aggregate the data for the cell as data is displayed at different levels of a hierarchy and the like.

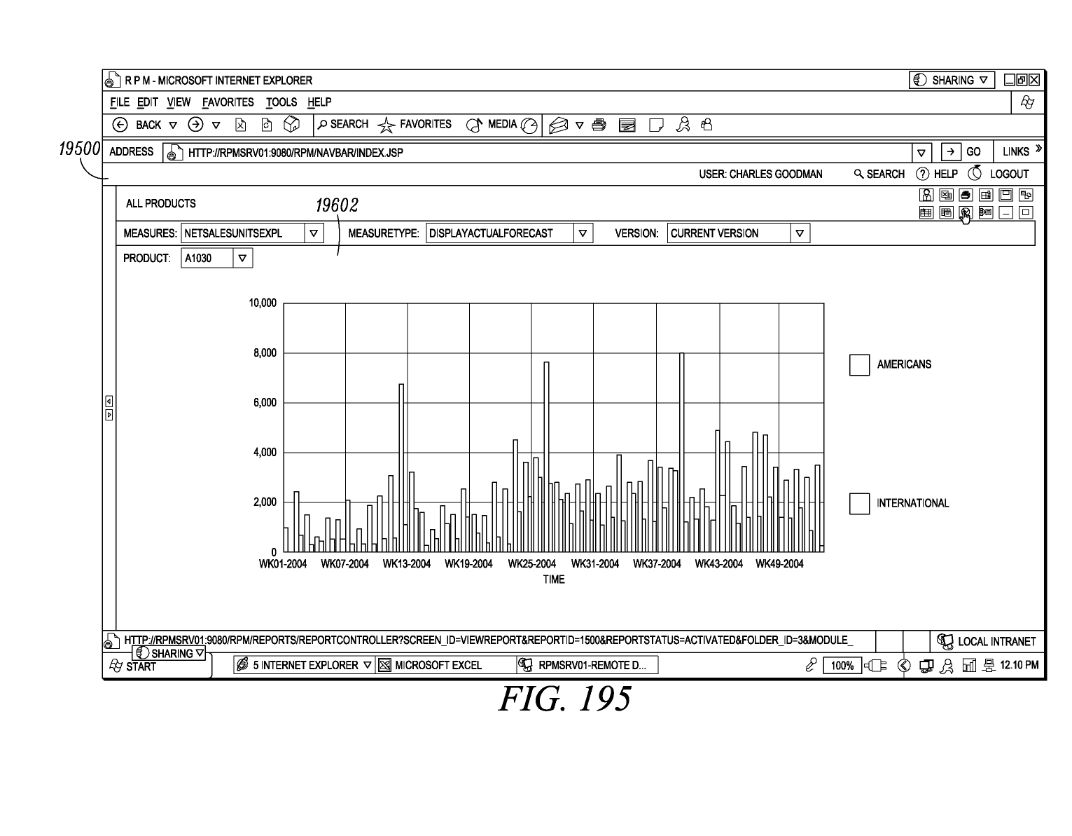

Referring to FIG. 195, a GUI 19500 shows that data, such as data in a supply, demand or other forecast screen, can be displayed in graphs, tables, or other formats, as opposed to being displayed as numbers in cells in a row-column format. A user can select which way to display data in each of the GUIs described herein.

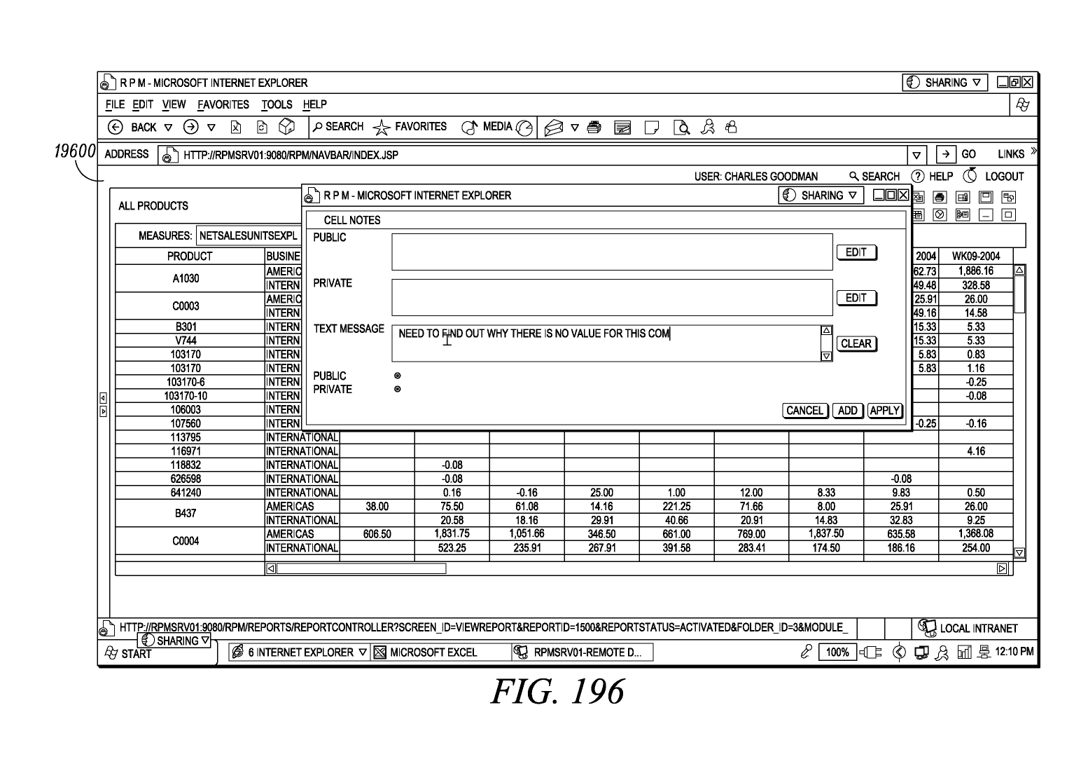

Referring to FIG. 196, a GUI 19600 can allow a user to toggle between a graph format and a cell format for the same data.

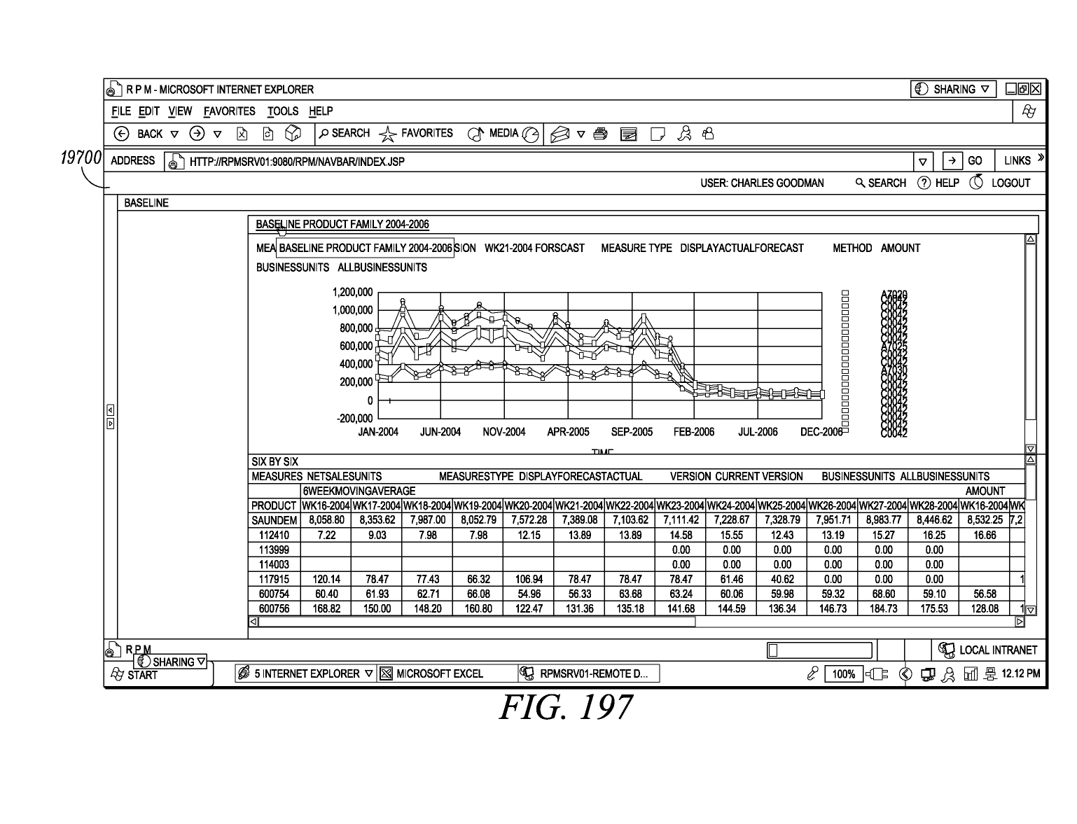

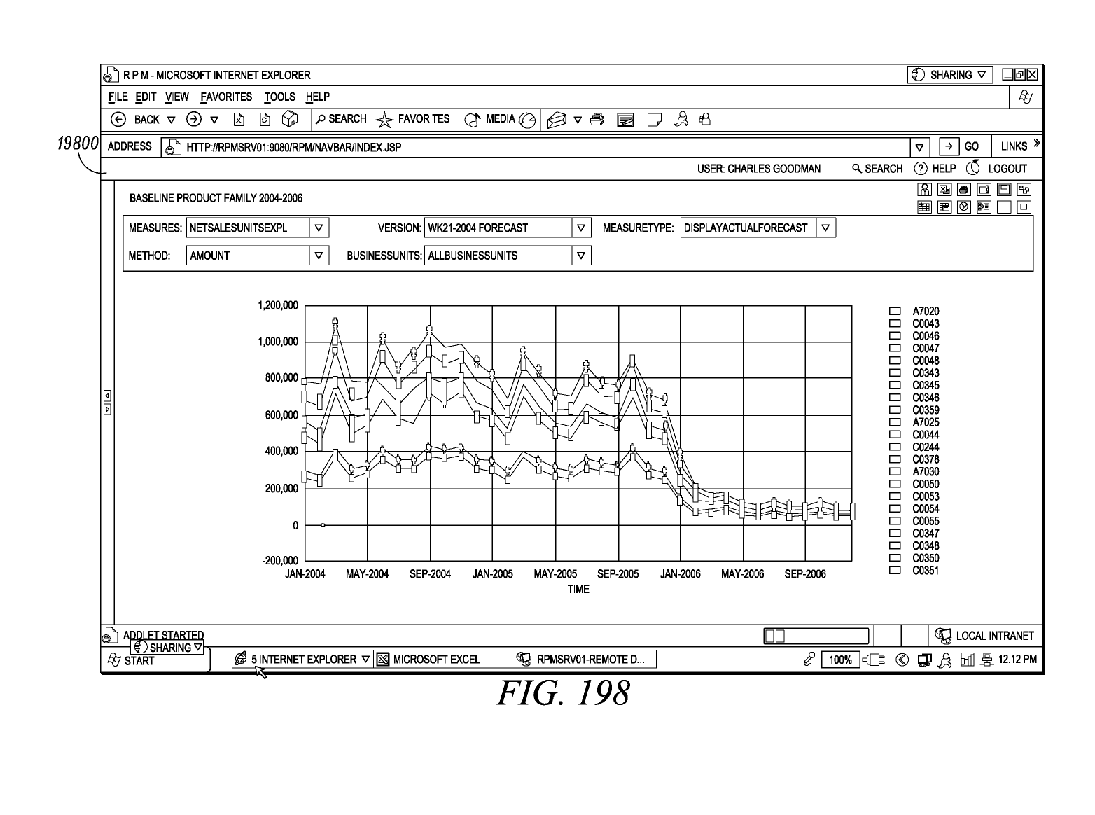

Referring to FIG. 197, a GUI 19700 can allow a user to see more than one view in a dashboard format, such as the same forecast in graph and cell format, or different forecasts side-by-side or scrolling top to bottom. Referring to FIG. 198, the user can optionally drill down by clicking on a particular format in the GUI 19700 of FIG. 197, such as to see it in full-screen format of the GUI 19800 of FIG. 198. While the invention has been described in connection certain preferred embodiments, other embodiments may be recognized by those of ordinary skill in the art and are encompassed herein. All patents, patent applications and other documents mentioned herein are hereby incorporated by reference.

What is claimed is:

1. An enterprise planning method, comprising:
identifying at least one attribute of a decision type for a type of decision of an enterprise; and
defining a decision object to capture at least one value of the at least one attribute in connection with a specific decision.
